(19) United States
(12) Patent Application Publication
(10) Pub. No.: US 2025/0241280 A1
(43) Pub. Date: Jul. 31, 2025

(54) LOW IMPACT FOOTROPE AND METHODS

(71) Applicant: Hampidjan hf, Reykjavik (IS)

(72) Inventors: Tore Ringstad, Tennfjord (NO); Sherif Safwat, South Sinai (EG); Haraldur Arnason, Gardabaer (IS); Eirik Husoy Lie, Alesund (NO)

(21) Appl. No.: 19/036,753

(22) Filed: Jan. 24, 2025

Related U.S. Application Data
(60) Provisional application No. 63/625,270, filed on Jan. 25, 2024.
(60) Provisional application No. 63/663,127, filed on Jun. 22, 2024.
(60) Provisional application No. 63/684,774, filed on Aug. 19, 2024.
(60) Provisional application No. 63/710,192, filed on Oct. 22, 2024.
(60) Provisional application No. 63/712,604, filed on Oct. 28, 2024.
(60) Provisional application No. 63/720,888, filed on Nov. 15, 2024.
(60) Provisional application No. 63/741,192, filed on Jan. 2, 2025.

(51) Int. Cl. A01K 73/04

(52) U.S. Cl. CPC A01K 73/04

(57) ABSTRACT

A footrope for a bottom trawl that has markedly reduced carbon footprint and dust cloud formation compared to known footropes, thereby conserving sequestered carbon in the seafloor. The footrope has a plurality of footrope unit bodies. At least one of the footrope unit bodies has a bent plate body. Each bent plate body includes a wall that is a curving and/or bending wall having opposing forward and rearward facing surfaces. Each forward facing surface is mainly convex and/or convex. Each rearward facing surfaces is mainly concave and/or concave. Each bent plate body is configured so that, in side plan and/or cross sectional view, it comprises the curving and/or bending wall. At least one of the footrope unit bodies has a greater material mass proximal its lower region proximal to and/or in contact with a lower edge of the footrope unit body compared to its material mass at other regions.

### RELATED APPLICATIONS

This application claims priority from: U.S. Provisional Application 63/741,192, filed 2 Jan. 2025; U.S. Provisional Application 63/720,888, filed 15 Nov. 2024; U.S. Provisional Application 63/712,604, filed 28 Oct. 2024; U.S. Provisional Application 63/710,192, filed 22 Oct. 2024; U.S. Provisional Application 63/684,774, filed 19 Aug. 2024; U.S. Provisional Application 63/663,127, filed 22 Jun. 2024; and U.S. Provisional Application 63/625,270, filed 25 Jan. 2024, the subject matter of each and all of which is incorporated herein by reference in its entirety for all purposes.

### TECHNICAL FIELD

The present disclosure relates to the engineering, manufacture and use of bottom trawls that typically are employed to harvest fish and other marine species used for human food resources. Yet more specifically, the present disclosure pertains to the engineering, manufacture and use of bottom trawls equipped with footropes configured to prevent harming the bottom of the sea and/or ocean so as to prevent undue disturbance to sedimentary layers responsible for carbon sequestration and so as to preserve marine life that grows and lives on and near the bottom of the sea and/or ocean and that is not intended to be collected by the trawling operation.

### BACKGROUND

The bottom of seas and oceans have certain regions that are responsible for a large proportion of the earth's carbon sequestration. Therefore, it is important to minimize disturbance to the sedimentary layers of the bottom of the sea and/or ocean. Seafood harvested from the bottom of seas and oceans by bottom trawls is far less and even dramatically less impactful on the earth's environmental health than agriculturally produced food resources or animal husbandry. Therefore, it is critical to the earth's environmental health that food resources sourced from seafood collected by bottom trawls not be replaced with food resources generated by animal husbandry, as the former is the most carbon economic food resource while the later is the most carbon generating food resource. Accordingly, it is important to utilize bottom trawl footrope gear that minimizes disturbance to the bottom of seas and oceans, with the amount of disturbance of the sea and/or ocean bottom being readily measured by the magnitude of a dust cloud caused by a bottom trawl's footrope. However, it is problematic that traditional and conventional bottom trawl footropes such as the most widely used footrope, known as rockhopper gear, raises a rather considerable dust cloud during trawling operations and thus is capable of negatively impacting sequestered carbon contained in the sedimentary layers of the sea and ocean floors. For this reason, government bodies, private bodies, both commercial and research driven, have for nearly a decade sought to create a footrope for a bottom trawl that has minimal impact on the bottom of seas and/or oceans and that in particular generates a lesser dust cloud than rockhopper gear does while also catching similar to or better than rockhopper gear catches.

A primary focus of these research efforts and commercial attempts at minimizing the dust cloud generated by a bottom trawl's footrope while also minimizing fossil fuel consumption and towing time with its concurrent linear potential to damage the ocean and/or sea floor as well as to cause bycatch include employing a footrope construction known as semi-circle gear (also abbreviated “SCG”). However, despite the combined efforts of government funded research and private funded research initiatives in creating a workable SCG footrope, none in the field have proposed a SCG footrope that the industry considered superior to traditional rockhopper gear footropes.

To continue, in addition to preserving sequestered carbon, in order to prevent carbon release into the environment it is important to minimize fossil fuel consumption during trawling operations. Similarly, as virtually all commercial fishing within territorial waters is governed by a quota system whereby an industry participant is permitted to harvest only a specific amount of any specific species per year and/or season, with concurrent restrictions as to size limits and seasons permitted for harvesting, it is important to facilitate harvesting the allocated quota with minimal fossil fuel consumption as well as minimum time of fishing operations as the longer the time a trawl is being towed in the sea and/or ocean and/or along the bottom of a sea and/or ocean the greater the opportunity for inadvertent negative environmental impact to occur such as for example the unintended catch of a non-target animal, i.e. “bycatch”.

To continue the above discussions regarding SCG footropes, prior art FIG. 154 illustrates a side plan view of a prior art SCG plastic plate, indicated by reference numeral 3. The drawing is not cluttered by reference numerals and drawing lines as any person ordinarily skilled in the art shall undoubtedly understand the drawing and the terminology in this text in relation to the drawing. To continue in reference to FIG. 154, imaginary straight line g indicates a plane perpendicular to the earth's gravitational force vector and/or parallel to a plane within which lies a level surface upon and/or above which is situated the SCG footrope and where such surface may be a level floor, or the bottom of the sea and/or ocean, or the bottom of a flume tank within which is situated a SCG plate of the present invention and/or a scale model of a SCG plate of the present invention and/or a scale model of a bottom trawl having attached to it a scale model of a SCG footrope of the present invention, where the flume tank's floor may be a moving floor such as a conveyor belt type floor or may be a stationary floor. That portion of any SCG plate and/or footrope of the present invention situated most proximal an imaginary line g associated with a particular drawing figure of a particular embodiment of a SCG plate and/or footrope of the present invention is to be known in this present disclosure as the bottom of that particular embodiment of a SCG plate and/or footrope of the present invention, and, similarly but oppositely, that portion of that same SCG plate and/or footrope of the present invention that is furthest in a vertical direction from that same imaginary line g is to be known in this present disclosure as the top of that particular embodiment of a SCG plate and/or footrope of the present invention. In addition to being depicted in reference to illustrations depicting the prior art, imaginary line g also is depicted in several illustrations of various embodiments of the present invention, including when it is not necessarily indicated by further reference characters g so as to not unnecessarily clutter the drawings.

FIG. 155 illustrates a back plan view of a segment of a prior art SCG footrope, formed by interconnecting several of the SCG plates of FIG. 154.

FIG. 156 illustrates a front plan view of a segment of the prior art SCG footrope illustrated in FIG. 155.

FIG. 157 illustrates a top plan view of a segment of the prior art SCG footrope illustrated in FIG. 155 and FIG. 156.

To this date, prior art SCG plates 3 have been made of plastic half pipes cut into segments having a height and/or diameter (d) equal to their width (w), see FIG. 154 and FIG. 155. Key features of the prior art SCG plates are that:
a) as shown in FIG. 154, the prior art's semi-circle curved plates are formed with a uniform wall thickness WT and define in cross section a portion of an annulus having a front side surface F exhibiting an arc of a circle corresponding to a semi-circle and having a back side surface B also exhibiting an arc of a circle corresponding to a semi-circle, where both arcs are from concentric circles and thus result in a uniform thickness to the plate and/or wall forming the plastic SCG of the prior art, where the cross section is viewed lying in a plane perpendicular to the long dimension of an elongated plastic pipe of circular cross section from which the SCG plate was formed. Although this shape is known in the industry as a semi-circle plate, as mentioned above, this shape corresponds to a “half of an annulus” cross sectional form, and is accomplished by manufacturing the SCG plates by filleting a cylindrical plastic pipe having a uniform wall thickness (i.e. cutting in half a length of cylindrical plastic pipe with the cutting done in a direction parallel to the pipe's long dimension); following by cutting the half pipes into shorter and smaller segments, thus arriving at the cross section of the prior art's SCG plates that corresponds to half of an annulus where the exterior concave side surface and the interior convex side surface define in side plan view an arc of a circle that is a semi-circle.
b) the prior art's SCG plastic plates have a smooth convex cambered front facing surface F (see FIG. 154 and FIG. 156), that includes an upper portion FU and a lower portion FL, where the separation between the upper and lower portions of the smooth convex cambered from facing surface F of the prior art SCG plates is the region on the cross section of the plate that includes the attachment hardware connecting the SCG plate to the main tow chain (see FIG. 154), and/or the connection point of the main tow chain itself to the SCG plate. (For purposes of the present disclosure, the term “main tow chain” shall be synonymous with the term “tow chain” and these terms shall include the term “main tow line” and “tow line” and shall have the meaning as understood by those of ordinary skill in the art when referring to a “main tow chain” and/or “tow chain” for the footrope of a bottom trawl, and also shall include any strength member situated in place of and/or serving the purpose of the main tow chain and/or tow chain, and preferably is formed of multiple segments of chain connected together by connectors such as may for example be hammerlocks and/or quick links, and may be formed of any strength member and/or plurality of interconnected lengths and/or segments of strength members, that while preferably are chain, also may be steel wire and/or rope and/or other cable, and the tow chain may comprise a plurality of interconnected segments of one or more types of strength member, e.g. segments of chain connected to segments of steel wire and/or rope and/or other cable, or segments of wire connected to one another, and so on. However, preferably, the tow chain comprises either a plurality of interconnected segments and/or lengths of chain or a single length of chain.)

The prior art's SCG plastic plates also have a smooth concave cambered rear-facing surface B (see FIG. 154 and FIG. 155). The only disruption made to the prior art's SCG curved plastic plates formed of segments of lengths of plastic half-pipes was to form through-holes into certain regions of the plastic wall of each plate for situating a steel quick-link through the hole in such a way that a portion of the quick-link protrudes from both the back side as well as from the front side surface of a prior art SCG plastic plate. The steel quick-links are attached at the aft end of each of the quick-links to a distinct link of the main tow chain per quick-link on the back/concave side of the SCG plates (see FIG. 154 and FIG. 155), and has one or more lengths of backing cable threaded through the fore-end of the quick-links protruding from the forward facing/convex side of the SCG plates (see FIG. 156). The purpose of said backing cable is to retain in position the quick-links within their associated through-hole so that they cannot slide out of the through-holes formed into the plastic walls of the SCG plastic plates. This method of attaching the SCG plastic plates to the main tow chain maintains a loose, slidable attachment of the plates to the main tow chain of a footrope for a bottom trawl. Proximal to the top edge TE (see FIG. 154) of the SCG plastic plates are other through-holes to which are fitted other U-bolts and/or links and/or quick-links (aggregately hereinafter also referred to as “quick links” and/or “links” and/or “hardware”) configured to permit attaching the trawl's fishing line to those other quick-links (as shown in FIG. 157 which illustrates a top plan view of the section of the prior art SCG footrope illustrated in FIG. 155 and FIG. 154 except that included is a view of the trawl's fishing line whereas the fishing line is not actually a part of the footrope but is a part of the trawl and thus the fishing line is shown for explanation purposes only) and thus to the top of the SCG plates. Otherwise, besides the formation of the through-holes in the plastic wall of the sections of half-pipes forming the curved plates of the semi-circle gear, no deformation or disruption is made to the smooth plastic surface of both the convex as well as the concave side surface of the prior art semi-circle gear curved plastic plates used in forming the SCG footrope of the prior art.

It is the state of the art and the trend of the industry to form the cambered SCG plates with a uniform wall thickness, and with a cross sectional form of a semi-circle when viewed in a portion of a SCG plate not including the prior art's attachment hardware and/or not including the hardware that permits connecting the SCG plates to the main tow chain and/or to the fishing line, it being believed that this construction is necessary in order to minimize the weight of the cambered plates, to make their manufacture economically viable, and in order to maximize their smoothness, it also being believed that the smoothness is necessary in order to ensure minimal bottom contact and maximize the ability to easily deflect and/or “ride over” bottom obstacles.

Another widely held belief in the industry that also is the state of the art and the trend in the industry is that the cambered plates used in forming the footrope must be loosely connected to the main tow chain and/or tow line in order to maximize the free play potential for each plate so as to minimize the energy required for it to deflect and/or “ride over” an obstacle on the bottom of the sea and/or ocean. Consequently, in order to maximize the ability of each cambered SCG plate to deflect and/or “ride over” objects so as to impart minimal force to those objects on the sea and/or ocean floor, it is the widely held belief in the industry that the maximal amount of free play possible should be retained when connecting the SCG cambered plates to the main tow line, and in the prior art the use of through-holes in the plate walls with the quick-links loosely situated within the through-holes (see FIG. 154) and held in place by a “backing cable” piece (see FIG. 156) on the forward side of each plate and attaching to the main tow chain on the back side of each plate (see FIG. 155), as described above, is employed for this reason, and no attachment hardware is permanently affixed to and/or formed onto and/or or formed integral with and/or into the bent plastic plates forming the prior art's SCG footrope for purpose of connecting the SCG plastic plates to the main tow chain. Rather, due to the construction configurations described supra, the plates were loosely and pivotably and slidably back and forth connected to the main tow chain in the prior art SCG footropes. This connection allows maximal free play of the plastic SCG plates, the idea being so as to allow the plates to easily be deflected over obstacles situated on the bottom of the ocean and/or sea, as discussed supra, it being the widely held belief by those in the industry that such free play was essential in order to minimize the dust cloud and bottom impact of the footrope with the sea and/or ocean bottom. Accordingly, and furthermore, known semi-circle gear does not have any portion of itself protruding beyond any surface of any part of the plate and that is formed with a mold and/or by a molding process where such portion of itself is configured to be connectable to the main tow chain and/or main tow line and to provide a rigid and/or fixed and/or non-moveable connection between that portion of itself configured to be connectable to the main tow chain and the remainder of the SCG cambered plate, i.e. that portion of the SCG cambered plate that is a cambered plate.

Similarly, no hardware has been permanently and/or rigidly attached to the plates of the semi-circle gear to provide an object capable of being connected to the main tow chain and thereby connecting the SCG plate to the main tow chain.

Another feature of the prior art SCG footrope gear is that the cambered plastic plate has a smoothly cambered forward facing surface (see FIG. 154 and FIG. 156), and no disruption is made to the smoothly cambered forward facing surface of the plates except where necessary to generate the through-holes with the quick-links situated within them, and the backing cable retaining the quick-links in place for purposes of attached the prior art's SCG plastic plates to the tow chain and fishing line, as described supra. Especially, the prior art's SCG footropes are made in such a way that nothing permanently attached to the plastic SCG plates protrudes forward from the forward facing convex cambered surface of the plates; and, that the plates define when viewed in cross section a semi-annulus, as described supra, and when viewed in a cross section of the prior art's SCG plastic plate where the cross section lies in a plane perpendicular to the long dimension of the taught footrope main tow chain at a region adjacent to the SCG plate being viewed in cross section and not including either: (a) a connection point and/or connection hardware connecting the tow chain to the SCG plastic plates; and/or (b) a connection point and/or connection hardware connecting the fishing line to the SCG plastic plates. That is, the cross section described above is everywhere in each of the shown SCG plastic plates except at the regions where a SCG plastic plate is physically connected to hardware and/or bodies configured to permit the SCG plastic plate to be connected to another object (such as for example hardware configured to connect the plates to the main tow chain, and/or hardware configured to permit connecting the plates to a False Fishing Line (see further figures and description below describing a False Fishing Line), and/or at the upper edge of the plates where the plates are physically connected to quick-links that are in place to then permit connecting the quick-links to the fishing line). In the prior art, the connection point of the tow chain to each SCG plate is more proximal the SCG plates top edge than it is its lower edge, in order to achieve more of a “sled” or “ski” shape when the SCG footrope as in operation. In order to maximize the desired “sled” or “ski” effect, the region of the SCG plates indicated by reference character “FL” and situated between the connection hardware of the SCG plates to the main tow chain and the bottom most edge of the plates is completely smooth in all of the prior art, and also defines a portion of an arc of a circle, which is a deliberate intention of those skilled in the art who worked on generating a useful version of a SCG footrope, the idea of those in the art being that by having a completely smooth and continuous curvature corresponding to a portion of an arc of a circle to the forward facing surface of the SCG plates in the region of the plates situated between their attachment point to the main tow chain and the terminal lower edge of each plate, that the SCG plates would, due to the smoothness of their forward facing surface, easily slide and/or ride over the bottom of the sea and/or ocean, thus, in theory, resulting in minimal disturbance to the sea and/or ocean floor. However, in practice, this effect was not realized, and the real world results of fishing attempts made using the prior art SCG footropes continued to be essentially the same as known rockhopper gear and thus such that there was no clear motivation to adopt the prior art SCG and all attempts by all entities to provide a workable SCG footrope, both government funded and commercial enterprise funded, have not been adopted.

As discussed supra, a feature of the prior art's SCG plastic plates is that they are formed with a uniform wall thickness WT, see FIG. 154. To accomplish this, the method for forming prior art SCG footropes includes forming the SCG cambered plates by steps including: providing a length of plastic half pipe having a cylindrical form with a uniform wall thickness; then cutting the length of plastic half pipe into two lengths of plastic half-pipe, and then cutting any or both of the lengths of plastic half-pipe (in a direction perpendicular to their long axis) into segments having lengths corresponding to the diameter of the original pipe, so as to form multiple smaller segments of plastic half pipe, each having a diameter (d) identical in length in comparison to its width (w) as shown in FIG. 154 and FIG. 155, that thus form and define the prior art SCG plastic plates exhibiting a uniform wall thickness WT throughout the entirety of the SCG plastic plate.

The above-described construction features apply to all of the prior art and were envisioned as necessary to minimize dust cloud formation while still retaining suitable fishing efficacy and also while permitting economically feasible manufacturing costs. However, in practice, these attempts failed in real world industrial application, for reasons not well understood by the industry, and resultantly the prior art semi-circle gear has not been adopted by the industry and, in fact, has been generally rejected by the industry.

Consequently, it readily can be understood that a long felt need continues to exist in the field and industry for bottom trawls equipped with a footrope construction that minimizes environmental impact to the ocean and/or sea floor and that in particular minimizes dust cloud formation so as to maximize fixed carbon retention in the sea and/or ocean floor, while simultaneously exhibiting sufficient fishing efficacy that industry participants are willing to adopt it.

### Definitions

For purposes of the present disclosure, the term “chain” shall have the meaning as widely known in engineering, and in addition shall also mean a serial assembly of connected pieces. Therefore, for purposes of the present disclosure, the term “chain” shall include, but not be limited to, any one single continuous strength member formed of identical interconnected pieces whether or not such pieces are identical or non-identical to one another, and also shall mean any plurality of interconnected lengths of chain as well as the pieces connecting them that may be for example “hammerlocks” and/or “quick-links” and/or portions formed of synthetic or metallic wire rope and/rope and/or cable and/or wire and/or other pieces and/or objects that connect together the various pieces forming an assembly of connected pieces.

For purposes of the present disclosure, the term “delta plate” shall have the meaning as widely known in the field of bottom trawling to those of ordinary skill in bottom trawl manufacture and engineering and also shall mean any object that serves to distribute tensile forces from one or more (and usually one) strength members capable of being connected to one or more connection points of a first group that are integral the object to a plurality of strength members capable of being connected to a plurality of connection points situated at locations in the object which are aft of the one or more connection points of the first group.

For purposes of the present disclosure, the term “plate” and/or “sheet” includes a structural element which is characterized by a three-dimensional solid whose thickness is lesser than its other dimensions, and, where the thickness may or may not be uniform.

For purposes of the present disclosure, the term “wall” can be used interchangeably to refer to a “wall” in the traditional sense of the word, and to refer to a structural element that is characterized by a three-dimensional solid whose thickness is lesser than its other dimensions, and where the three-dimensional solid may be formed of either a homogenous substance or may be formed of heterogenous substances, and where the three-dimensional solid may be curved and/or bent in side plan view and or cross-section view, and may be formed from differing materials or may be formed from a single type of material, and may have a same and/or uniform thickness or may have differing thicknesses (e.g., where different regions of the three-dimensional solid have different thickness compared to one another).

For purposes of the present disclosure, the term “footrope unit body” does not require that attachment hardware used for connecting the footrope unit body to a footrope's main tow chain and/or to a trawl's fishing line be present on the footrope unit body, and, likewise, the presence of such attachment hardware does not alter the fact that the footrope unit body is a footrope unit body of the present disclosure. Likewise, the term “footrope unit body” may sometimes be shortened to the terms “unit body” or “unit” or “body”.

### SUMMARY

The present disclosure seeks to provide an environmentally safe footrope for bottom trawls that causes minimal dust cloud formation and minimal to no negative environmental impacts while simultaneously being sufficiently efficacious in terms of catching an industry participant's allowed quota to be adopted by industry participants.

As of yet, none of the prior art has proposed an apparatus and method as disclosed herein.

It is an object of the present disclosure to provide an apparatus and method for a bottom trawl's footrope that causes minimal dust cloud formation and lesser dust cloud formation than known footropes while concurrently permitting sufficiently efficacious harvest of allocated quotas that industry participants shall voluntarily stop using less environmentally protective footropes and in place use the present disclosure's environmentally protective footrope.

Most broadly, in a particular presently preferred embodiment of the present disclosure, the footrope of the present disclosure is formed of a series of interconnected bodies each comprising a wall having a convex exterior forward facing surface and at least a portion of a rearward facing surface that defines a concavity, and where the forward facing surface may preferably be a convex forward facing surface that may be a convex cambered forward facing surface and/or a convex sloping forward facing surface, and where a plurality of the interconnected bodies each may comprise at least a synthetic portion including a plastic portion, and where at least a plurality of the bodies comprises at least one region of the wall forming the forward facing surface having a different thickness in comparison to at least one other region of the wall forming the forward facing surface.

In further description of certain embodiments of the particular embodiment of the present invention described immediately supra, in a particular presently preferred embodiment of the present disclosure, the footrope of the present disclosure is formed of a series of interconnected bodies each comprising a wall having a convex exterior forward facing form and/or surface that may preferably be a convex forward facing surface that may be a convex cambered forward facing surface and/or a convex sloping forward facing surface, and where a plurality of the interconnected bodies each may comprise at least a synthetic portion including a plastic portion, that may exhibit a “half of an annulus” when viewed in side plan view, and where the wall of at least a plurality of the bodies having the convex exterior forward facing form of at least one of the interconnected bodies and preferably of a plurality of the interconnected bodies comprises at least one region of the wall having a different thickness in comparison to at least one other region of the wall.

In a particularly presently preferred embodiment, the bodies are formed of a cambered wall formed from plastic and/or synthetic material, where the portion of the wall formed from the plastic and/or synthetic material comprises a “half of an annulus” form in at least most of its cross section, and where the different thickness of the body is formed by attaching at least one portion of metal and/or solid material and preferably attaching a plurality of portions of metal and/or solid material to at least one and preferably a plurality of portions of the plastic and/or synthetic wall comprising a “half of an annulus” form in at least most of its cross section, thereby forming at least one and preferably a plurality of bodies comprising the convex exterior forward facing surface of the body and comprising a wall having at least one region of the wall having a different thickness in comparison to at least one other region of the wall.

In yet another embodiment, the bodies are formed of a cambered wall formed from steel, metal or other natural material, where the portion of the wall formed from the steel, metal or other natural material comprises a “half of an annulus” form in at least most of its cross section, and where the different thickness of the body is formed by attaching at least one portion of metal and/or solid material, and preferably attaching a plurality of portions of metal and/or solid material, to at least one and preferably a plurality of portions of the wall formed of steel, metal or other material where the wall comprises a “half of an annulus” form in at least most of its cross section, thereby forming at least and preferably a plurality of bodies comprising the convex exterior forward facing surface of the body and comprising a wall having at least one region of the wall having a different thickness in comparison to at least one other region of the wall.

A method for the construction of the particularly preferred embodiment described immediately above comprises steps of providing a SCG plastic plate, and/or providing a body having a convex forward facing surface, providing at least one portion and preferably a plurality of portions of metal and/or solid material, and attaching the portion(s) of metal and/or solid material to the SCG plastic plate and/or to the body having a convex forward facing surface. Preferably, the portion(s) of metal and/or solid material is/are attached to regions of the SCG plastic plates and/or to the body having a convex forward facing surface that are situated between the lower terminal edge of the SCG plastic plate and/or the body having a convex forward facing surface and the connection of the main tow chain to the SCG plastic plate and/or to the body having a convex forward facing surface. However, in certain embodiments, other portions of metal and/or solid material are situated more proximal the upper terminal edge of the SCG plastic plate and/or to the body having a convex forward facing surface in comparison to their proximity to the lower terminal edge of the SCG plastic plate and/or to the body having a convex forward facing surface. Preferably again, the portions of metal and/or solid material may be formed as elongated strips and/or plates of metal and/or solid material that may extend the entire distance between lateral edges of the SCG plate and/or the body having the convex forward facing surface, where the portions of metal and/or solid material also may be lesser in length in comparison to the width of the SCG plastic plate and/or to the body having the convex forward facing surface to which they attach, such as by way of example, may be one to six centimeters lesser. Preferably, one, two and/or a plurality of such elongated strips and/or plates and yet more preferably three and/or at minimum three of such elongated strips and/or plates are attached to the regions of the SCG plastic plates and/or to the body having a convex forward facing surface that are situated between the lower terminal edge of the SCG plastic plate and/or the body having a convex forward facing surface and the connection of the main tow chain to the SCG plastic plate and/or to the body having a convex forward facing surface, and preferably the elongated strips and/or plates of metal and/or solid material may be situated parallel to one another, or may be randomly oriented relative to one another, or may have any outline shape other than rectangular. Preferably, the elongated strips and/or plates of metal and/or solid material are attached to the forward facing surface of the SCG plastic plate and/or the body having a convex forward facing surface, thus forming a particularly preferred construction of the present invention. Alternatively, plastic and/or synthetic material may be welded, bolted, adhered and/or otherwise connected to the exterior of the SCG plastic plate and/or to the body having a convex forward facing surface in order to form the region or regions having a greater thickness in comparison to the remainder of the wall of the SCG plastic plate and/or to the body having a convex forward facing surface. Yet alternatively again, another method for forming a body comprising a SCG plastic plate and/or body having a convex forward facing surface differing from known SCG plastic plates in that it has a region or regions to its wall that are thicker in comparison to the remainder of the wall of the SCG plastic plate is to extrude plastic such as HDPE or HMPE through a die having the desired shape, or through a die having a shape of a annulus except that the annulus includes enlarged regions of greater thickness in comparison to the majority of the annulus' wall, and then cutting the extruded pipe in half so as to arrive at two half annuluses each having an enlarged region and/or regions in comparison to the remainder of the half annuluses wall.

### BRIEF DESCRIPTION OF THE DRAWINGS

For a better understanding, reference may be made to the accompanying drawings (wherein the drawings and drawing elements may not necessarily be to scale), in which:

FIG. 1 is a front plan view of a footrope unit body of the present disclosure, where the unit is shown unencumbered by attachment hardware used for connecting the unit to a footrope's main tow chain and/or to a trawl's fishing line in order to not clutter the drawing;

FIG. 2 is a side plan view of the footrope unit body of FIG. 1;

FIG. 3 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 4 is a side plan view of the footrope unit body of FIG. 3;

FIG. 5 is a front plan view of an alternative embodiment of the footrope unit body of FIG. 1;

FIG. 6 is a side plan view of the footrope unit body of FIG. 5;

FIG. 7 illustrates a first process step useful for forming the footrope unit body of FIG. 5 and for forming a footrope and/or a section of a footrope of the present disclosure from a plurality of the footrope unit body of FIG. 5;

FIG. 8 illustrates a second process step useful for forming the footrope unit body of FIG. 5 and for forming a footrope and/or a section of a footrope of the present disclosure from a plurality of the footrope unit body of FIG. 5;

FIG. 9 illustrates a third process step useful for forming the footrope unit body of FIG. 5 and for forming a footrope and/or a section of a footrope of the present disclosure from a plurality of the footrope unit body of FIG. 5;

FIG. 10 illustrates a fourth process step useful for forming the footrope unit body of FIG. 5 and for forming a footrope and/or a section of a footrope of the present disclosure from a plurality of the footrope unit body of FIG. 5;

FIG. 11 illustrates a fifth process step useful for forming the footrope unit body of FIG. 5 and for forming a footrope and/or a section of a footrope of the present disclosure from a plurality of the footrope unit body of FIG. 5;

FIG. 12 illustrates a sixth process step useful for forming the footrope unit body of FIG. 5 and for forming a footrope and/or a section of a footrope of the present disclosure from a plurality of the footrope unit body of FIG. 5;

FIG. 13 illustrates a seventh process step useful for forming the footrope unit body of FIG. 5 and for forming a footrope and/or a section of a footrope of the present disclosure from a plurality of the footrope unit body of FIG. 5;

FIG. 13A is a side plan view of an alternative embodiment of the footrope unit body of FIG. 13;

FIG. 13A-P is a side plan view of an alternative embodiment of the footrope unit body of FIG. 13A;

FIG. 14 is a front plan view of the footrope unit body of FIG. 13;

FIG. 14A is a front plan view of the footrope unit body of FIG. 13A;

FIG. 14A-P is a front plan view of the footrope unit body of FIG. 13A-P;

FIG. 14B is a back plan view of the footrope unit body of FIG. 13A;

FIG. 14B-P is a back plan view of the footrope unit body of FIG. 13A-P;

FIG. 14C is a top plan view of a footrope of the present disclosure formed of multiple footrope segments;

FIG. 14D is a front plan view of a portion of the footrope of FIG. 14C;

FIG. 14E is a top plan view of a portion of the footrope of FIG. 14C;

FIG. 14X is a front plan view of a portion of an alternative embodiment of the footrope of FIG. 14C;

FIG. 14X-Y is a front plan view of a portion of an alternative embodiment of the footrope of FIG. 14X;

FIG. 14Y illustrates a top plan view of an embodiment of the present disclosure's footrope connected to a bottom trawl of the present disclosure, where in order to show the relative disposition, orientation and situation of the footrope's main tow chain and False Fishing Line compared to the trawl's fishing line, shown are the footrope's main tow chain, the footrope's false fishing line and the trawl's fishing line, and the footrope unit bodies are not shown;

FIG. 15 illustrates an eighth process step useful for forming the footrope unit body of FIG. 5 and for forming a footrope and/or a section of a footrope of the present disclosure from a plurality of the footrope unit body of FIG. 5;

FIG. 15A is a front plan view an alternate embodiment of a footrope segment of FIG. 15;

FIG. 15X is a front plan view of an alternative embodiment of the footrope segment depicted in FIG. 15;

FIG. 16 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 17 is a side plan view of the footrope unit body of FIG. 16;

FIG. 18 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 19 is a side plan view of the footrope unit body of FIG. 18;

FIG. 20 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 21 is a side plan view of the footrope unit body of FIG. 20;

FIG. 22 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 23 is a side plan view of the footrope unit body of FIG. 22;

FIG. 24 is a front plan view of an alternative embodiment of the footrope unit body of FIG. 1, where the unit is shown unencumbered by attachment hardware used for connecting the unit to a footrope's main tow chain and/or to a trawl's fishing line in order to not clutter the drawing;

FIG. 25 is a side plan view of the footrope unit body of FIG. 24;

FIG. 26 is a front plan view of an alternative embodiment of the footrope unit body of the present disclosure, where the unit is shown unencumbered by attachment hardware used for connecting the unit to a footrope's main tow chain and/or to a trawl's fishing line in order to not clutter the drawing;

FIG. 27 is a side plan view of the footrope unit body of FIG. 26;

FIG. 28 is a front plan view of a portion of an alternative embodiment of the footrope of FIG. 15, where the footrope is formed of footrope unit bodies of the present disclosure modified to comprise perforations and/or perforated slits in their walls;

FIG. 29 is a front plan view of a portion of an alternative embodiment of the footrope of FIG. 28, where the footrope is formed of footrope unit bodies of the present disclosure modified to comprise perforations and/or perforated slits in their walls;

FIG. 30 is a side plan view of an alternative embodiment of the footrope unit body of FIG. 1 attached to a trawl's fishing line;

FIG. 31 is a side plan view of an alternative embodiment of the footrope unit body of FIG. 30 attached to a trawl's fishing line;

FIG. 32 is a side plan view of an alternative embodiment of the footrope unit body of FIG. 31 attached to a trawl's fishing line;

FIG. 33 is a side plan view of an alternative embodiment of the footrope unit body of FIG. 30 attached to a trawl's fishing line;

FIG. 34A is a side plan view of a plate of the present disclosure in a first orientation;

FIG. 34B is a side plan view of the plate of FIG. 34A in a second orientation;

FIG. 34C is a side plan view of the plate of FIG. 34A in a third orientation;

FIG. 34D is a side plan view of the plate of FIG. 34A in a fourth orientation;

FIG. 34E is a side plan view of the plate of FIG. 34A in a fifth orientation;

FIG. 35A is a side plan view of an alternative embodiment of the plate of FIG. 34A in a first orientation;

FIG. 35B is a side plan view of the plate of FIG. 35A in a second orientation;

FIG. 35C is a side plan view of the plate of FIG. 35A in a third orientation;

FIG. 35D is a side plan view of the plate of FIG. 35A in a fourth orientation;

FIG. 35E is a side plan view of the plate of FIG. 35A in a fifth orientation;

FIG. 36 is a side plan view of an alternative embodiment of the footrope unit body of FIG. 30 attached to a trawl's fishing line;

FIG. 37 is a side plan view of an alternative embodiment of the footrope unit body of FIG. 1 attached to a trawl's fishing line;

FIG. 38 is a side plan view of an alternative embodiment of the footrope unit body of FIG. 37 attached to a trawl's fishing line;

FIG. 39 is a front plan view of a footrope segment of the present disclosure as may be used to form an alternative embodiment of the footrope of FIG. 15;

FIG. 40 is a front plan view of a plurality of the footrope segments of FIG. 39 connected to one another along a chain;

FIG. 41 is a side plan view of an alternative embodiment of the footrope unit body of FIG. 37 attached to a trawl's fishing line;

FIG. 42 is a front plan view of the footrope unit body of FIG. 41;

FIG. 43 is a front plan view of a segment of a footrope that may be the center of the footrope that is formed of multiple of the footrope unit bodies of FIG. 41;

FIG. 44 is a side plan view of an alternative embodiment of the footrope unit body of FIG. 37 attached to a trawl's fishing line;

FIG. 45 is a side plan view of an alternative embodiment of the footrope unit body of FIG. 37 attached to a trawl's fishing line;

FIG. 46 illustrates a first example airfoil profile for a footrope unit body of the present disclosure, where the first example airfoil profile is shown in various “tilts” and orientations relative to a level bottom;

FIG. 47 illustrates a second example airfoil profile for a footrope unit body of the present disclosure, where the second example airfoil profile is shown in various “tilts” and orientations relative to a level bottom;

FIG. 48 illustrates a third example airfoil profile for a footrope unit body of the present disclosure, where the third example airfoil profile is shown in various “tilts” and orientations relative to a level bottom;

FIG. 49 illustrates a fourth example airfoil profile for a footrope unit body of the present disclosure, where the fourth example airfoil profile is shown in various “tilts” and orientations relative to a level bottom;

FIG. 50 illustrates a fifth example airfoil profile for a footrope unit body of the present disclosure, where the fifth example airfoil profile is shown in various “tilts” and orientations relative to a level bottom;

FIG. 51 illustrates a sixth example airfoil profile for a footrope unit body of the present disclosure, where the sixth example airfoil profile is shown in various “tilts” and orientations relative to a level bottom;

FIG. 52 illustrates a seventh example airfoil profile for a footrope unit body of the present disclosure, where the seventh example airfoil profile is shown in various “tilts” and orientations relative to a level bottom;

FIG. 53 illustrates an eighth example airfoil profile for a footrope unit body of the present disclosure, where the eighth example airfoil profile is shown in various “tilts” and orientations relative to a level bottom;

FIG. 54 illustrates a ninth example airfoil profile for a footrope unit body of the present disclosure, where the ninth example airfoil profile is shown in various “tilts” and orientations relative to a level bottom;

FIG. 55 illustrates a tenth example airfoil profile for a footrope unit body of the present disclosure, where the tenth example airfoil profile is shown in various “tilts” and orientations relative to a level bottom;

FIG. 56 illustrates an eleventh example airfoil profile for a footrope unit body of the present disclosure, where the eleventh example airfoil profile is shown in various “tilts” and orientations relative to a level bottom;

FIG. 57 illustrates a twelfth example airfoil profile for a footrope unit body of the present disclosure, where the twelfth example airfoil profile is shown in various “tilts” and orientations relative to a level bottom;

FIG. 58 illustrates a thirteenth example airfoil profile for a footrope unit body of the present disclosure, where the thirteenth example airfoil profile is shown in various “tilts” and orientations relative to a level bottom;

FIG. 59 illustrates a fourteenth example airfoil profile for a footrope unit body of the present disclosure, where the fourteenth example airfoil profile is shown in various “tilts” and orientations relative to a level bottom;

FIG. 60 illustrates a fifteenth example airfoil profile for a footrope unit body of the present disclosure, where the fifteenth example airfoil profile is shown in various “tilts” and orientations relative to a level bottom;

FIG. 61 illustrates a sixteenth example airfoil profile for a footrope unit body of the present disclosure, where the sixteenth example airfoil profile is shown in various “tilts” and orientations relative to a level bottom;

FIG. 62 illustrates a seventeenth example airfoil profile for a footrope unit body of the present disclosure, where the seventeenth example airfoil profile is shown in various “tilts” and orientations relative to a level bottom;

FIG. 63 illustrates an eighteenth example airfoil profile for a footrope unit body of the present disclosure, where the eighteenth example airfoil profile is shown in various “tilts” and orientations relative to a level bottom;

FIG. 64 illustrates a nineteenth example airfoil profile for a footrope unit body of the present disclosure, where the nineteenth example airfoil profile is shown in various “tilts” and orientations relative to a level bottom;

FIG. 65 illustrates a twentieth example airfoil profile for a footrope unit body of the present disclosure, where the twentieth example airfoil profile is shown in various “tilts” and orientations relative to a level bottom;

FIG. 66 illustrates a twenty-first example airfoil profile for a footrope unit body of the present disclosure, where the twenty-first example airfoil profile is shown in various “tilts” and orientations relative to a level bottom;

FIG. 67 illustrates a twenty-second example airfoil profile for a footrope unit body of the present disclosure, where the twenty-second example airfoil profile is shown in various “tilts” and orientations relative to a level bottom;

FIG. 68 illustrates a twenty-third example airfoil profile for a footrope unit body of the present disclosure, where the twenty-third example airfoil profile is shown in various “tilts” and orientations relative to a level bottom;

FIG. 69 illustrates a twenty-fourth example airfoil profile for a footrope unit body of the present disclosure, where the twenty-fourth example airfoil profile is shown in various “tilts” and orientations relative to a level bottom;

FIG. 70 illustrates a twenty-fifth example airfoil profile for a footrope unit body of the present disclosure, where the twenty-fifth example airfoil profile is shown in various “tilts” and orientations relative to a level bottom;

FIG. 71 illustrates a twenty-sixth example airfoil profile for a footrope unit body of the present disclosure, where the twenty-sixth example airfoil profile is shown in various “tilts” and orientations relative to a level bottom;

FIG. 72 illustrates a twenty-seventh example airfoil profile for a footrope unit body of the present disclosure, where the twenty-seventh example airfoil profile is shown in various “tilts” and orientations relative to a level bottom;

FIG. 73 is a back plan view of a portion of an alternative embodiment of the footrope of FIG. 15;

FIG. 79 is a front plan view of a bent plate footrope unit body of the present disclosure;

FIG. 79a is a side plan view of the bent plate footrope unit body of FIG. 79;

FIG. 101 is a back plan view of an alternative embodiment of the bent plate footrope unit body of FIG. 79;

FIG. 101a is a side plan view of the bent plate footrope unit body of FIG. 101;

FIG. 102 is a back plan view of an alternative embodiment of the bent plate footrope unit body of FIG. 79;

FIG. 102A is a side plan view of the bent plate footrope unit body of FIG. 102;

FIG. 102X is a back plan view of an alternative embodiment of the bent plate footrope unit body of FIG. 102;

FIG. 102AX is a side plan view of the bent plate footrope unit body of FIG. 102X;

FIG. 103 is a back plan view of an alternative embodiment of the bent plate footrope unit body of FIG. 102;

FIG. 103A is a side plan view of the bent plate footrope unit body of FIG. 103;

FIG. 103X is a back plan view of an alternative embodiment of the bent plate footrope unit body of FIG. 103;

FIG. 103AX is a side plan view of the bent plate footrope unit body of FIG. 103X;

FIG. 104 is a back plan view of an alternative embodiment of the bent plate footrope unit body of FIG. 102;

FIG. 104A is a side plan view of the bent plate footrope unit body of FIG. 104;

FIG. 105 is a back plan view of an alternative embodiment of the bent plate footrope unit body of FIG. 103;

FIG. 105A is a side plan view of the bent plate footrope unit body of FIG. 105;

FIG. 111 is a side plan view of a bent plate of the present disclosure;

FIG. 112 is a side plan view of an alternative embodiment of the bent plate of FIG. 111;

FIG. 113 is a side plan view of an alternative embodiment of the bent plate of FIG. 112;

FIG. 114 is a side plan view of an alternative embodiment of the bent plate of the FIG. 112;

FIG. 115 is a side plan view of an alternative embodiment of the bent plate of FIG. 112;

FIG. 116 is a side plan view of an alternative embodiment of the bent plate of FIG. 112;

FIG. 117 is a side plan view of an alternative embodiment of the bent plate of FIG. 111;

FIG. 118 is a top plan view of an alternative embodiment of the footrope unit body of FIG. 1;

FIG. 119 is a perspective front plan view of the footrope unit body of FIG. 118;

FIG. 120 is a side plan view of the footrope unit body of FIG. 118;

FIG. 121 is a top plan view of an alternative embodiment of the footrope unit body of FIG. 118;

FIG. 122 is a perspective front plan view of the footrope unit body of FIG. 121;

FIG. 123 is a side plan view of the footrope unit body of FIG. 121;

FIG. 124 is a top plan view of an alternative embodiment of the footrope unit body of FIG. 118;

FIG. 125 is a perspective front plan view of the footrope unit body of FIG. 124;

FIG. 126 is a side plan view of the footrope unit body of FIG. 124;

FIG. 127 is a top plan view of an alternative embodiment of the footrope unit body of FIG. 121;

FIG. 128 is a perspective front plan view of the footrope unit body of FIG. 127;

FIG. 129 is a side plan view of the footrope unit body of FIG. 127;

FIG. 130 is a front plan view of a SCG bent plate footrope unit body of the present disclosure;

FIG. 131 is a side plan view of the footrope unit body of FIG. 130;

FIG. 132 is a front plan view an alternative embodiment of the footrope unit body of FIG. 130;

FIG. 133 is a side plan view of the footrope unit body of FIG. 132;

FIG. 134 a top plan view of an alternative embodiment of the footrope of FIG. 14C;

FIG. 135A is a front plan view of an alternative embodiment of the footrope unit body of FIG. 1;

FIG. 135B is a front plan view of the footrope unit body of FIG. 135A, including a quick-link connector;

FIG. 135C is a front plan view of the footrope unit body of FIG. 135A, including a chain link connector;

FIG. 136A is a side plan view of the footrope unit body of FIG. 135A;

FIG. 136B is a side plan view of the footrope unit body of FIG. 135B;

FIG. 136C is a side plan view of the footrope unit body of FIG. 135C;

FIG. 137 is a front plan view of an alternative embodiment of the footrope unit body of FIG. 1;

FIG. 138 is a side plan view of the footrope unit body of FIG. 138;

FIG. 139 is a front plan view of an alternative embodiment of the footrope unit body of FIG. 1;

FIG. 140 is a side plan view of the footrope unit body of FIG. 139;

FIG. 141 is a front plan view of an alternative embodiment of the footrope unit body of FIG. 1;

FIG. 142 is a side plan view of the footrope unit body of FIG. 141;

FIG. 143 is a top plan view of the footrope unit body of FIG. 141;

FIG. 144 is a front plan view of an alternative embodiment of the footrope unit body of FIG. 1, where the footrope unit body has a plurality of through hole apertures formed into a wall of the footrope unit body;

FIG. 145 is a side plan view of the footrope unit body of FIG. 144;

FIG. 146 is front plan view of the footrope unit body of FIG. 144, where a moveable connector of the present disclosure is joined to the footrope unit body;

FIG. 147 is a side plan view of the FIG. 146;

FIG. 148 is a side plan view of a rigidly attached connection assembly of the present disclosure as viewed when situated in a footrope unit body of the present disclosure;

FIG. 149 is a top plan view of the rigidly attached connection assembly of FIG. 148;

FIG. 150 is a back plan view of the rigidly attached connection assembly of FIG. 148;

FIG. 151 is a back side plan view of an alternative embodiment of the footrope unit body of FIG. 1;

FIG. 152 is a side plan view of an alternative embodiment of the footrope unit body of FIG. 151;

FIG. 153 is a side plan view of the footrope unit body of FIG. 151

FIG. 154 is a side plan view of a prior art SCG plastic plate;

FIG. 155 is a back plan view of a segment of a prior art SCG footrope, formed by interconnecting several of the SCG plates of FIG. 154;

FIG. 156 is a front plan view of a segment of the prior art SCG footrope illustrated in FIG. 155; and

FIG. 157 is a top plan view of a segment of the prior art SCG footrope illustrated in FIG. 155.

### DETAILED DESCRIPTION

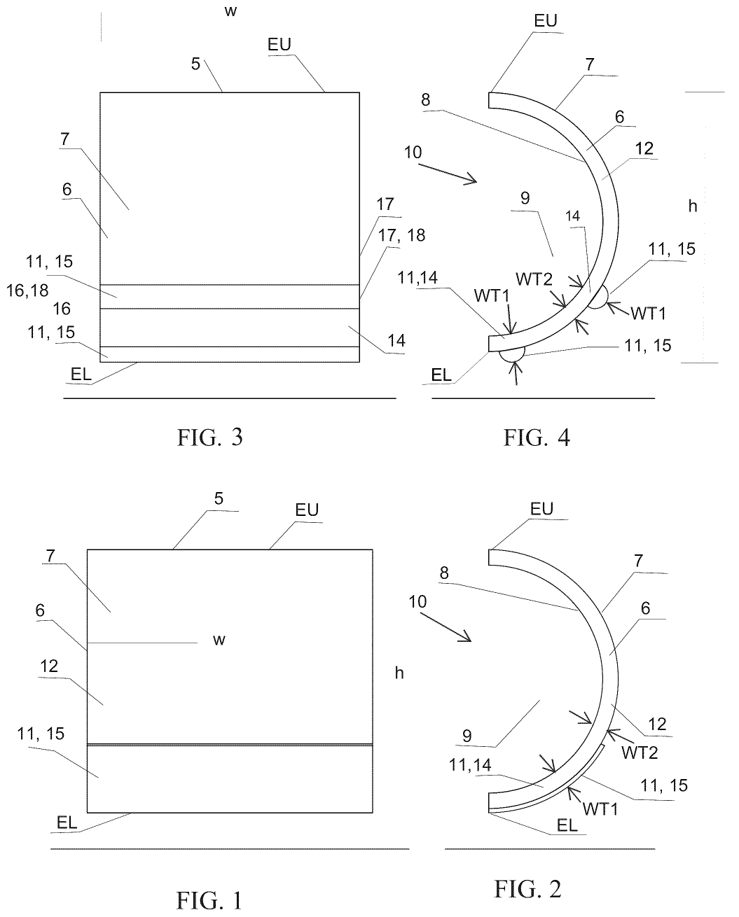

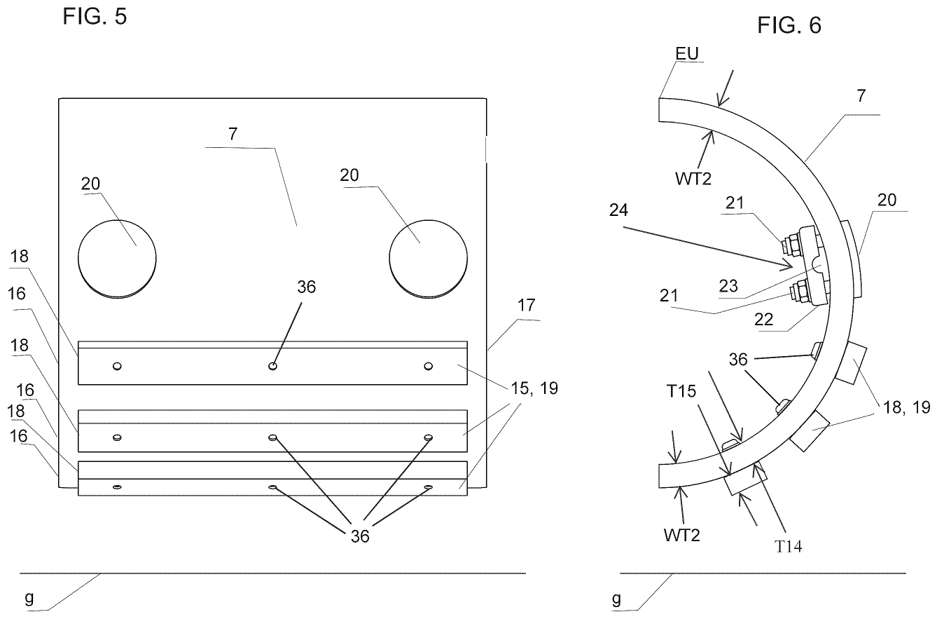

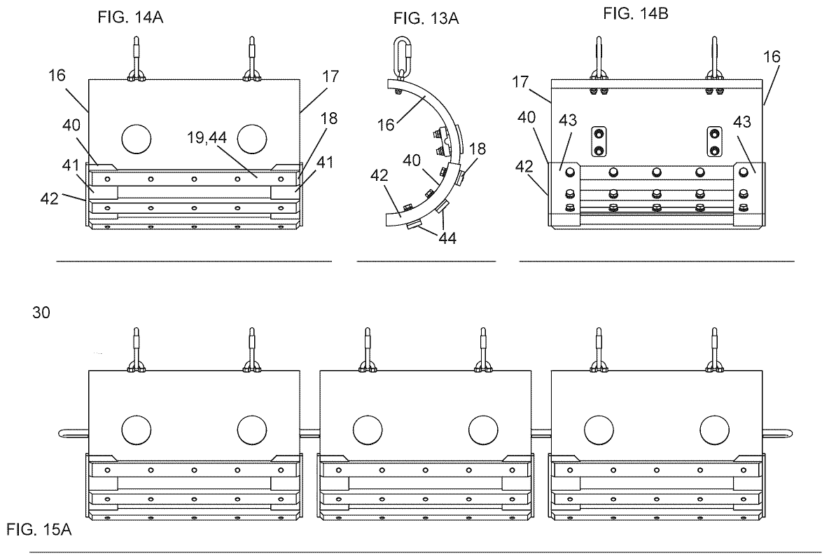

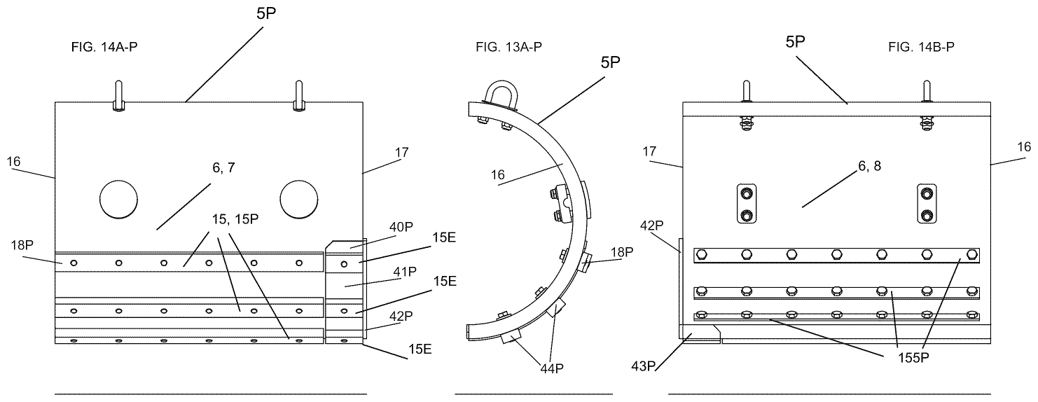

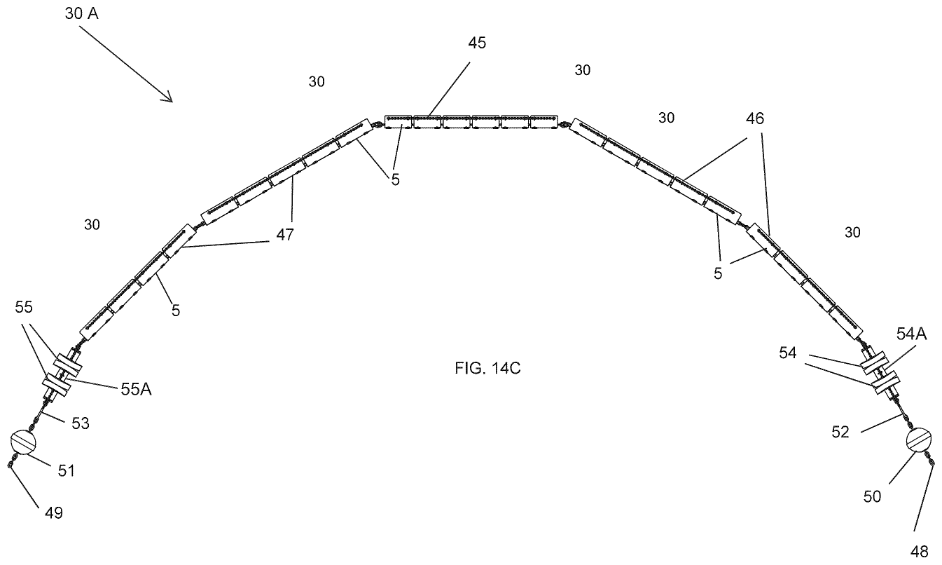

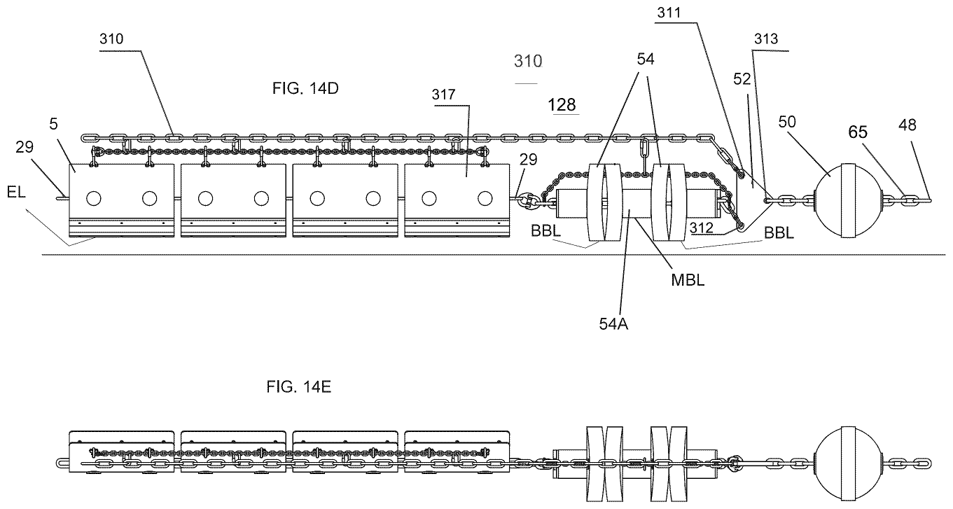

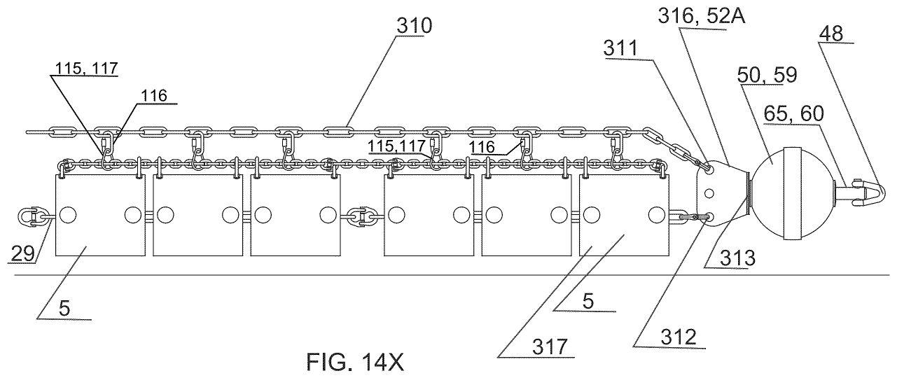

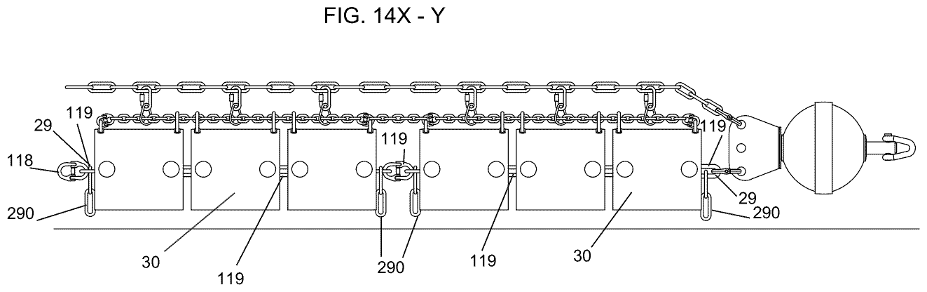

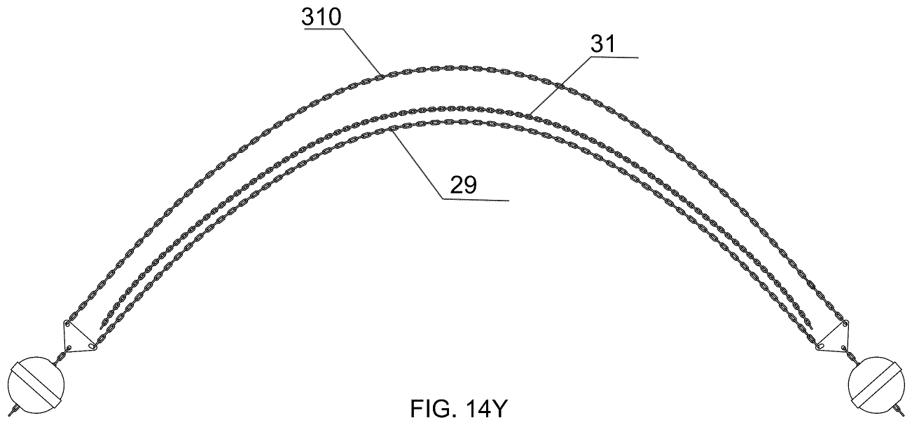

In reference to at least FIG. 1, FIG. 2, FIG. 3, FIG. 4, FIG. 5 and FIG. 6, in a particular presently preferred embodiment of the present disclosure, the footrope of the present disclosure is formed of a series of interconnected footrope unit bodies 5, each comprising a wall 6, the wall 6 has a convex exterior forward facing surface 7 and at least a portion of a rearward facing surface 8, that may be a concave surface, as is presently preferred, and that defines a concavity 9 where the concavity, preferably, may have an opening 10, where concavity 9 may be visible at least in side plan view of a footrope unit body 5 as illustrated in FIG. 2, FIG. 4 and FIG. 6. As is presently preferred, the concavity 9 may communicate to the outside environment at cavity opening 10 that also may be visible at least in side plan view also in reference to FIG. 2, FIG. 4 and FIG. 6. The exterior forward facing surface 7 may preferably be a convex forward facing surface that may be a convex cambered forward facing surface and/or a convex sloping forward facing surface and/or a convex bent and/or multiply bent forward facing surface (such as for example may be a portion of a polygon), and where a plurality of the interconnected footrope unit bodies 5 each may comprise at least a synthetic portion (the term “synthetic” shall include the term “plastic” in the present disclosure) forming at least a portion of their wall 6, including a plastic portion, and where at least a plurality of the bodies 5 comprises at least a first wall region 11 of the wall 6, where the at least a first wall region 11 has a different thickness WT1 in comparison to a thickness WT2 of at least a second wall region 12. The thickness WT1 of wall region 11 may be a thickness that is greater in comparison to the thickness WT2 of wall region 12, as is presently preferred. The wall region 11 may comprise a combination of a plastic and/or synthetic wall portion 14 and a metallic wall portion 15, as is presently preferred. The thicker wall portion 11 may protrude forward and/or outward from the convex forward surface 7 of the footrope unit body, as may be accomplished by configuring all or a portion of wall portion 15 to protrude and/or project outwards from the forward and/or convex side surface 7 of the wall 6 of the footrope unit body 5, as shown in FIG. 1 to FIG. 6. However, in other embodiments, the wall region 11 may comprise a combination of a plastic and/or synthetic wall portion 14 in combination with a wall portion 15 formed from a synthetic and/or plastic material that may be either a same material as the material forming wall portion 14 or that may be a different material in comparison to the material forming wall portion 14 and that may be a material formed of a different synthetic substance in comparison to the synthetic substance forming the wall portion 15, as for example may be synthetic rubber, vulcanized rubber, or material used in forming tires and/or tire treads, and/or material used in forming conveyor belts; and/or a combination of woven fabric material and rubber material such as may be synthetic woven material infused with rubber material, with or without a treaded pattern to the exterior surface of this material. However, in other embodiments, the wall region 11 may comprise a combination of a plastic and/or synthetic wall portion 14 in combination with a wall portion 15 formed from a metallic chain and/or a length of metallic chain and/or metallic chain mail. In yet other embodiments, a majority of and/or the entirety of the wall 6, and/or the majority and/or entirety of the forward facing convex surface 7 of the wall 6 is formed of a laminate having a synthetic and/or metallic exterior layer, where the outermost layer on the forward facing surface 7 of wall 6 may be formed from a hard synthetic material such as a hard synthetic bar comprising a synthetic material as used in forming tires for heavy machinery that operates on gravel or off-road environments and/or that is a metallic bar and/or a bent metallic sheet and/or plate, with the metallic exterior affixed to the remainder of the wall 6 that may be formed from a synthetic and/or plastic portion upon the exterior of which is affixed the exterior layer, that may comprise one or a plurality of wall portions 15, and that may comprise a synthetic and/or metallic exterior layer affixed to the remainder of wall 6 and/or affixed to one or a plurality of wall portions 14 by either adhesion, vulcanization, and/or by mechanical fasteners 36 (see FIG. 13 and FIG. 14) such as bolts and/or screws and/or rivets and similar fasteners. When using fasteners to connect wall portions 14 and 15, preferably, prior to attaching the fasteners to wall portions 14 and 15, through-holes 37 (see FIG. 10 and FIG. 11) are formed into the wall portions 14 and/or wall 6 and other through-holes 38 (see FIG. 12) are formed into wall portions 15 in locations that correspond to locations that the fasteners must pass through wall portions 14 and/or wall 6 and also wall portions 15 in order to connect them, and, the fasteners may preferably be bolts, and the bolts may preferably be threaded bolts, and the bolts preferably have washers situated between the bolts' heads' and/or a nut and/or tightening nut situated at opposite ends of the bolts, where the washers are configured so as to distribute compressive and/or other forces between the synthetic portion of one side surface of wall portion 14 and the exterior side surface of wall portions 15 (i.e. that most forward projecting side surface of wall portions 15 that is most distal from wall portions 14 and/or not mating with wall portions 14), that may be a metallic and/or synthetic wall portion 15 as stated supra. However, when wall portions 15 are metallic, such as steel, washers may not necessarily be used, and, further, recessed depressions may preferably be formed into the exterior side surfaces of metallic wall portions 15 where the recessed depressions are both situated at the exterior side surface of wall portions 15 and are coaxial with the through-holes and thus coaxial with the bolts and/or other fasteners that are situated within the through-holes and where the recessed depressions further are configured to receive into the depression they form the head of a bolt and/or a nut threaded onto the bolt and/or the combination of a bolt head and a washer and/or the combination of a washer and nut threaded onto the bolt in such a manner that no portion of the fastener protrudes beyond the exterior side surface of the wall portion 15 but rather is either level with it or depressed beneath it. Furthermore, bolts once situated in final position may be welded and/or tack welded to ensure they do not move from their desired position, especially when the bolts are contacting a metallic portion of the footrope unit body. The number of through-holes formed into wall 6 and/or wall portion 14 per wall portion 15, and thus the number of through-holes formed into each wall portion 15 per each wall portion 14, may comprise one through-hole; or may comprise two through-holes; or may comprise three through-holes; or may comprise four through-holes; or may comprise five through-holes. At present, the minimum number of through-holes for providing the optimal balance between manufacture cost and convenience of use may be a quantity of through-holes comprising three through-holes; with a quantity of through-holes comprising four through-holes being more preferred; with a quantity of through-holes comprising five through-holes being yet more preferred, with a quantity of through-holes comprising between 7 to 14 through holes being useful. While various fasteners are may be useful, bolts may be the most suitable fasteners and the fasteners that shall provide the best balance between manufacture cost and convenience of use.

At present, the minimum number of fasteners and/or bolts for providing the optimal balance between manufacture cost and convenience of use is a quantity of fasteners and/or bolts comprising three fasteners and/or bolts; with a quantity of fasteners and/or bolts comprising four fasteners and/or bolts being more preferred; with a quantity of fasteners and/or bolts comprising five fasteners and/or bolts being yet more preferred, with a quantity of fasteners comprising between 7 to 14 fasteners being useful.

Presently, the minimum diameter of the through-holes 37 and 38 (that may by hollow cylindrical in form, as is presently preferred) and of fasteners 36 (that may have circular cross sectional forms when viewed in a plane bisecting and perpendicular to a fastener's long dimension) is a minimum diameter of eight millimeters, and more preferably a minimum diameter of nine millimeters, and may be in a range of eight millimeters to thirty millimeters, with from 15 millimeters to 20 millimeters being presently preferred. However, a range of ten millimeters to eleven millimeters may be useful; and that a range of eleven millimeters to twelve millimeters may be useful; and that a range of twelve millimeters to thirteen millimeters may useful; and that a range of thirteen millimeters to fourteen millimeters may be useful, and that a range of fourteen millimeters to fifteen millimeters may be useful; and that a minimum diameter of either or both fasteners 36 that may be bolts and/or other fasteners and the through holes 37, 38 comprising a diameter of 11 millimeters may be useful, with a diameter comprising a diameter of twelve millimeters being more useful; with a diameter comprising a diameter of thirteen millimeters being even more useful; with a diameter comprising a diameter of fourteen millimeters being yet more useful; and with a diameter comprising a diameter of fifteen millimeters being even yet more useful, with a diameter of from about 15 millimeters to thirty millimeters being more preferred. Preferably, the fasteners comprise bolts that are capable of being bent and/or creeped without breaking. Preferably, the fasteners comprise bolts that are capable of being creeped and/or permanently stretched and/or elongated without breaking and so as to tolerate an increase in their length that is in a range of a minimum of two percent and/or in a range of from one percent to two percent; and/or in a range of from one percent to three percent; and/or in a range of from one percent to five percent; and/or in a range of from one percent to six percent; and/or in a range of from one percent to seven percent; and/or in a range of from one percent to eight percent; and/or in a range of from one percent to nine percent; and/or in a range of from one percent to ten percent; and/or in a range of from one percent to eleven percent; and/or in a range of from one percent to twelve percent; and/or in a range of from one percent to thirteen percent; and/or in a range of from one percent to fourteen percent; and/or in a range of from one percent to fifteen percent; and/or in a range of from one percent to sixteen percent; and/or in a range of from one percent to seventeen percent; and/or in a range of from one percent to eighteen percent; and/or in a range of from one percent to nineteen percent; and or in a range of from one percent to twenty percent; and/or in a minimum range of from one percent to thirty percent. Preferably, the washers, nuts, and bolts are comprised of similar (including same) metal properties that are compatible with a salt water application, and can be black steel. Preferably again, all metallic bodies and/or pieces affixed to a footrope unit body of the present disclosure are compatible to be situated proximal each other in a salt water environment without experiencing undue electrolytic degradation and/or other degradation and/or oxidation, for example black steel is suitable and/or the same steel and bolts used in forming trawl doors. Metal bolts having an ISO (International Standards Organization) grade and/or grade class that is a grade that is lesser than and/or below class 12.9 grade bolts may be most useful, with ISO class 8.8 grade bolts potentially providing the best balance between strength, hardness, and ability to bend and elongate without breaking.

Although in FIG. 2 and FIG. 4 the thicker wall regions 11 are shown as having a uniform wall thickness when there is either one (FIG. 2) or a plurality (FIG. 4) of first wall regions 11, disclosed is where the first wall regions 11 may have thicknesses that vary, for example that may vary in comparison to one another. For example, where a plurality, that may be two, three, four or more first wall regions 11 are formed into the wall 6 of the footrope unit body, one or a plurality of the wall regions 11 may each have a different thickness in comparison to one or a plurality of the other wall regions 11. Similarly, although the thickness WT2 of second wall regions 12 is shown as having a uniform thickness throughout the entirety and/or majority of those regions of the wall 6 that do not include wall regions 11, i.e. that lack wall regions 11, that in the instant example comprises the majority of wall 6 as well as the second wall region and/or regions 12, as shown in the instant illustrations. Wall regions 12 and/or those regions of the wall 6 that do not include wall regions 11 may also be formed with a varying thickness(es) and/or may be formed with a uniform. For example, a synthetic portion of wall 6 itself may be formed with either a uniform thickness to its synthetic portion or with a non-uniform and/or varying thickness to the synthetic portion of wall 6. Each footrope unit body 5 also has an upper edge EU and a lower edge EL, that may define straight edges, as is presently preferred. Each footrope unit body 5 also has lateral edges 16 and 17, that may define straight edges when measured from the upper edge “EU” to the lower edge “EL”, especially when the unit body 5 has a width W equal to its greatest diameter and/or equal to its greatest height “h”. Alternatively, and not shown, when the footrope unit body defines a non-quadratic form when viewed in front plan view, the lateral edges may not define a straight edge when measured from the upper edge “EU” to the lower edge “EL”. However, in some preferred embodiments, the width W and/or the average width W of any footrope unit body of the present disclosure may exceed its height “h” and/or its average height “h”; where, the ratio of the width W to the height “h” may be in a minimum range of 1.01:1 to 22:1; or may be 1.05:1 to 22:1; or may be 1.1:1 to 22:1; or may be 1.15:1 to 22:1; or may be 1.2:1 to 22:1; or may be 1.25:1 to 22:1; or may be 1.3:1 to 22:1; or may be 1.4:1 to 22:1; or may be 1.45:1 to 22:1; or may be 1.5:1 to 22:1; or may be 1.55:1 to 22:1; or may be 1.6:1 to 22:1; or may be 1.65:1 to 22:1; or may be 1.7:1 to 22:1; or may be 1.75:1 to 22:1; or may be 1.8:1 to 22:1; or may be 1.85:1 to 22:1; or may be 1.9:1 to 22:1; or may be 1.95:1 to 22:1; or may be 2:1 to 22:1. Furthermore, the footrope of the present disclosure may comprise footrope unit bodies of the present disclosure where the middle third of the footrope of the present disclosure's overall length from starboard wing end point to port wing end point comprises footrope unit bodies where at least one of the footrope unit bodies has a lesser width “W” in comparison to at least one footrope unit body comprising the remainder of the footrope (e.g. the starboard third of the footrope's length and/or the port third of the footrope's length). In other terms, the central region of the footrope may comprise footrope unit bodies and/or at least one footrope unit body having a lesser width W in comparison to a width W of footrope unit bodies and/or at least one footrope unit body comprising the wings of the footrope. Furthermore, all or a plurality of footrope unit bodies situated in the footrope's central portion and/or in the central third of the footrope may be formed with wall portions 15 without angles and/or with a sloping and/or curved and/or beveled forward facing side surface when viewed in a plane perpendicular to the long dimension of the wall portion 15 as shown in FIG. 3 and FIG. 4, whereas all or a plurality of footrope unit bodies situated in the wings of the footrope may formed with wall portions 15 having a ninety degree angle to the intersection of their exterior forward facing surfaces and/or of a bar and/or plate of solid material such as may be steel or metal where the bar comprising footrope unit body 15 has a quadratic cross section when viewed in a plane perpendicular to the long dimension of the wall portion 15.

The wall portions 15 may preferably be metallic, and may be steel, and may be steel bars, or steel plates, or steel half round bars, or steel strips, and may be formed by cutting steel plate and/or steel sheeting and/or by cutting steel pipe into half pipe and/or may be formed by cutting steel round bars into half round bars. Wall portions 15 may preferably span the entire width W of the portion of wall 6 that they form, e.g. wall region 11, and thus the wall portions 15 may extend the entire distance from lateral edge 16 to lateral edge 17 of any portion of wall 6 of a footrope unit body 5 which is comprised of wall portion(s) 15 and wall portion(s) 14. In this way, the lateral edges 16 and 17 of that portion of wall 6 comprising wall portion(s) 15 is flush with and/or is in contact with the lateral edges 18 of wall portion(s) 15, and, in such embodiment, wall portions 15 may have the portion of their distal ends that is not in contact with wall portion 14, i.e. that is their more exterior and/or more forward portion of their distal ends, rounded off and/or beveled and/or cut at an angle (not shown) so that the exterior side surfaces of distal ends of wall portions 15 curve down toward the lateral edges 16, 17 of the wall 6 and/or have an obtuse angle and/or angle greater than ninety degrees but lesser than one hundred eighty degrees, that may be a forty five degree angle. For example, wall portion(s) 15 may comprise metal plate(s), as indicated in FIG. 1 and FIG. 2; and/or wall portion(s) 15 may be metal half-round bars, with the flat side of the metal half round bars in contact with the plastic and/or synthetic wall portion 14, as indicated in FIG. 3 and FIG. 4. Additionally, wall portion(s) 15 may comprise other shapes besides rectangular and quadradic plates and bars and/or half round bars. Wall portion(s) 15 also may be either adhered to and/or bolted to and/or screwed to and/or welded to (the term “welded” in this text includes but is not limited to the term “plastic welded” and “plastic welding”) the synthetic and/or plastic wall portion(s) 14, irrespective of what material wall portion(s) 15 are formed from. Alternatively, wall portions 15 may span less than the entire distance from lateral edge 16 to lateral edge 17 (see FIG. 5 and FIG. 6).

In further reference to FIG. 5 and FIG. 6, the thickness T15 of wall portion(s) 15 may be the same as, lesser than, or greater than the thickness T14 of wall portion(s) 14 and/or of the thickness WT2 of any regions(s) of wall 6 lacking wall regions 11 and/or of wall region(s) 12. In one presently preferred embodiment shown reference to at least FIG. 1 to FIG. 6, the thickness WT2 of those regions of the wall 6 that do not include wall regions 11, i.e. that lack wall regions 11, is same as the thickness T14 of wall portions 14. In a presently preferred embodiment, the thickness T15 of wall portion(s) 15 is about 25 mm plus or minus 5 mm, and thickness WT2 of regions of wall portions 12 and/or of those portions of wall 6 lacking wall portions 11 and/or the thickness T14 of wall portions 14 is about 30 mm plus or minus 5 mm. Wall portions 15 may be less thick than the thickness T14 of wall portion(s) 14 and/or of portions of wall 6 lacking either wall regions 11 and/or 12. Alternatively, wall portions 15 may be greater in thickness than the thickness T14 of wall portion(s) 14 and/or of portions of wall 6 lacking either wall regions 11 and/or 12. Alternatively again, wall portions 15 may be equal in thickness and/or about the same thickness in comparison to the thickness WT2 of wall portion(s) 14 and/or of portions of wall 6 lacking either wall regions 11 and/or 12. Wall portions WT2 may be of any thickness that provides sufficient durability to the bent plate footrope unit body as empirically determined useful, and likewise for the thickness T15 of wall portions 15.

In further reference to FIG. 5 and FIG. 6, wall portions 15 may preferably span less than the entire width W of the portion of wall 6 that they form, e.g. wall region 11, and thus the wall portions 15 may extend less than the entire distance from lateral edge 16 to lateral edge 17 of any portion of wall 6 of a footrope unit body 5 which is comprised of wall portion(s) 15 and wall portion(s) 14. In this way, the lateral edges 16 and 17 of that portion of wall 6 comprising wall portion(s) 15 are not flush with and/or do not meet with and/or do not contact with the lateral edges 18 of wall portion(s) 15, and this embodiment is most preferred when wall portion(s) 15 are formed from a material that is harder than the material forming the majority of wall 6 and/or forming the majority of wall portion(s) 14. For example, wall portion(s) 15 may be steel bars 19, that may have a quadratic cross section viewed in a plane bisecting and perpendicular to the long dimension of wall portion(s) 15, as shown if the example illustrated in FIG. 5 and FIG. 6. In this embodiment, steel bar wall portions 15, 19 were formed by cutting a 25 mm thick metal plate into linear bars, drilling and/or otherwise forming holes into both wall portions 14 as well as the steel bars 19 so as to permit attaching the steel bars 19 forming wall portions 15 to the wall portions 14 in such a way so as to result in a portion of wall portion 14 proximal each lateral edge 16 and 17 of that is not covered by and not in contact with the wall portions 15, that may be steel bars 19 as in the instant example, but that also may be other metallic or synthetic strips and/or bars and/or plates and/or treads. In this way, the harder than plastic material comprising wall portions 15 and also the lateral edges 18 of wall portions 15 are not in contact with the lateral edges 16 and 17 of the synthetic and/or plastic material forming the remainder of wall regions 11 and/or wall portions 14.

In further reference to FIG. 5 and FIG. 6, attached to the wall 6 of the footrope unit body shown in FIG. 5 and FIG. 6 may preferably be a rigidly attached connector 24 (the term “connector” also in this text and in the present disclosure including the term “connection assembly” such as may by way of non-limiting example be formed of a plurality of individual solid objects connected together to form a connector), where the connector 24 is configured to permit connecting the footrope unit body 5 to a chain and/or cable comprising the footrope's main tow chain and/or the trawl's fishing line, where the rigidly attached connector 24 comprises a solid object rigidly attached to the remainder of footrope unit body 5 and/or to the wall 6 of footrope unit body 5.

Rigidly attached connector 24, by way of non-limiting example, may comprise hardware comprising at least one and preferably two units forming a rigidly attached connection assembly 24, where the rigidly attached connection assembly 24 is configured to permit connecting the footrope unit body to the main tow chain of a footrope and/or to the fishing line of a bottom trawl. As shown in further reference to FIG. 5 and FIG. 6, the convex front side surface 7 of the footrope unit body 5 has attached to it backing plates 20, where each backing plate 20 is connected to bolts and/or threaded bolts and/or U bolts 21 that pass through through-holes formed into wall 6 at predetermined locations and also pass through another plate 22 situated on the concave and/or rear facing surface of wall 6 at a location and/or locations experimentally determined best and preferred in order to arrive at the desired position and/or orientation of a footrope unit body during actual trawling operations. The another plate 22 may include a notch 23 configured to receive one side wire of a chain link of the main tow chain and/or a to receive a steel wire cable and/or synthetic rope and to hold it into place between the another plate 22 and the back side surface 8 of wall 6 and/or footrope unit body 5.

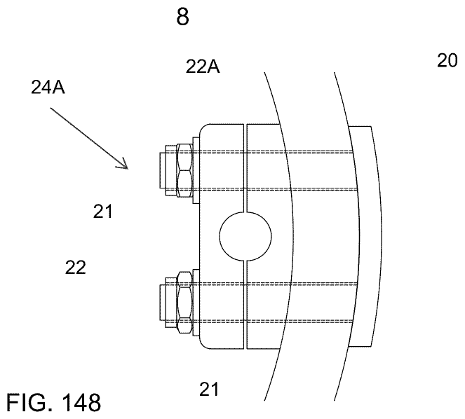

In reference to FIG. 148, illustrated is a side plan view of a detail of an alternative embodiment of rigidly attached connection assembly 24, as shown by rigidly attached connection assembly 24A, and as viewed when situated in a footrope unit body 5 that itself is being viewed in side plan view. Rigidly attached connection assembly 24A includes the same components of connection assembly 24, yet additionally includes third backing plate 22A, where third backing plate 22A is configured to be situated between the back side surface 8 of the wall 6 and/or footrope unit body 5 and the another backing plate 22 so that it contacts the back side surface 8 of the wall 6 and/or footrope unit body 5. Preferably, third backing plate 22A may be configured so that the portion of its surface that is configured to contact the back side surface 8 of the wall 6 and/or footrope unit body 5 may also be configured to mate flush to that portion it contact of the back side surface 8 of the wall 6 and/or footrope unit body 5. Third backing plate 22A may also be notched in mirror opposite to the notch formed into another backing plate 22, so as to receive one side wire of a chain's link and/or a steel cable between the two notches. The components described in reference to reference numerals 20, 21, 22, 22A and 23 together comprise hardware comprising at least one rigid connector and/or connection assembly 24, 24A per footrope unit body, and more preferably at least two connection assemblies 24, 24A per footrope unit body, where footrope connection assembly 24, 24A is configured to permit connecting a footrope unit body to a chain of a footrope and/or to a fishing line of a bottom trawl in place of the chain of the footrope. The chain (not shown in FIG. 1 to FIG. 6) may comprise a footrope main tow chain, or may comprise a bottom trawl's fishing line, and also may be formed of another strength member other than chain such as for example steel wire. When the chain or other strength member that connects to the rigid connection assembly 24, 24A is a main tow chain of a footrope and not a fishing line of a bottom trawl, then further connectors (not shown) are affixed to the wall 6 proximal its upper edge EU and those further connectors are configured to be attached to the fishing line of a bottom trawl.

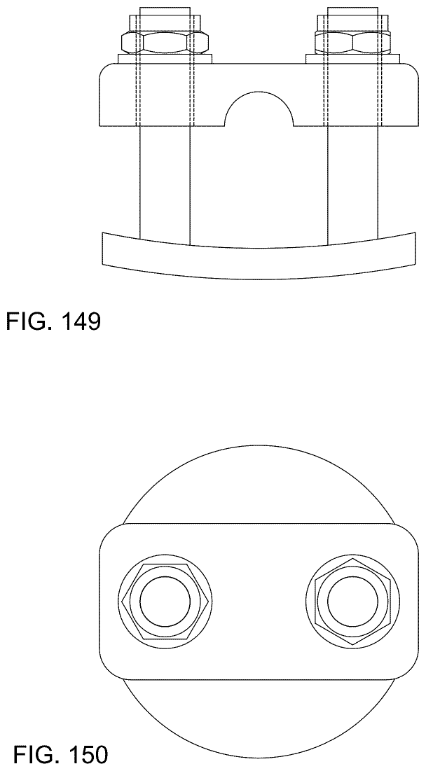

FIG. 149 and FIG. 150 are a top plan view and a back side plan view, respectively, of the rigidly attached connection assembly 24 of FIG. 148.

Each footrope unit body 5 also may define a trough shape in cross section, and may define a trough shape lacking walls occluding the trough channel on the trough shapes short sides. Not shown in FIG. 1 to FIG. 4, in order to not clutter the illustrations, are connection hardware configured to permit affixing the footrope bodies 5 to a footropes main tow chain and/or to a bottom trawl's fishing line, and such connection hardware is illustrated in further drawing figures of various embodiments of the present invention and the same such hardware as illustrated in various other drawing figures of various embodiments of footrope unit bodies of the present invention also is capable of being installed and/or utilized in combination with the footrope bodies 5 depicted in FIG. 1 to FIG. 4.

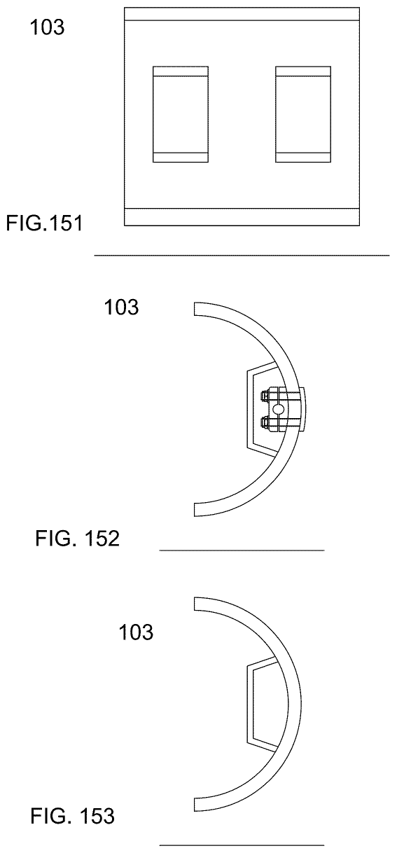

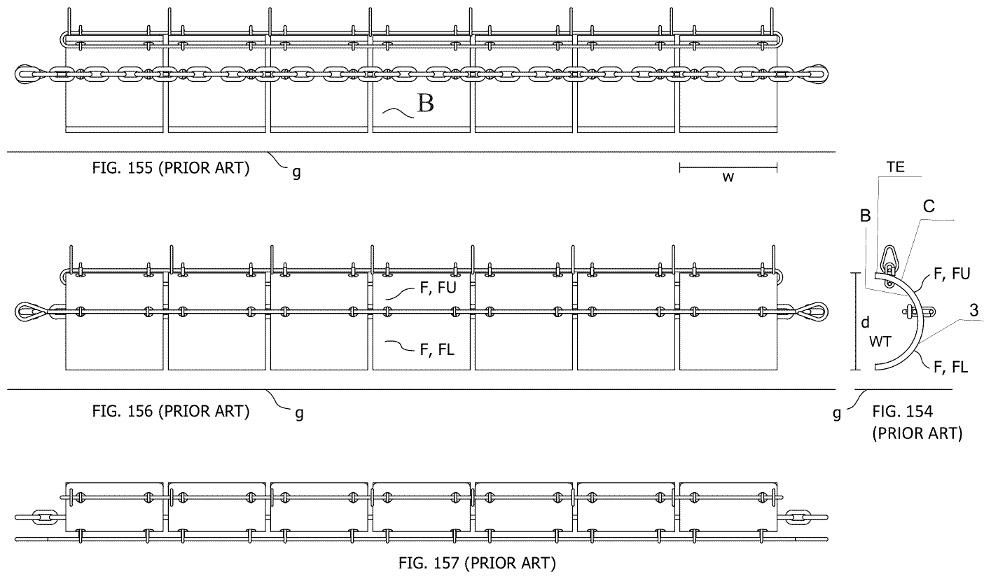

FIG. 151 is a back side plan view of a footrope unit body of the present disclosure having an alternative rigidly attached connection assembly comprising one or a plurality of sleeves 103 rigidly attached to the back side of the footrope unit body, where the sleeves are configured to permit the main tow chain to pass through and slide through the sleeves. This embodiment is may be especially useful for steel and/or metallic footrope unit bodies, and the sleeve may preferably be formed of steel. The sleeves may not include any further objects configured to permit attaching the main tow chain to the footrope unit body, as in FIGS. 151 and 153 where FIG. 153 is a side plan view of the footrope unit body of FIG. 151, and in this instant embodiment the main tow chain may be fixedly connected to other objects situated between adjacent footrope unit bodies such as may be disks and/or rockhopper disks, thus preventing the footrope unit bodies from sliding beyond a predetermined amount relative to the length of the main tow chain. Or, in reference to FIG. 152, that is a side plan view of an alternative version of the footrope unit body of FIG. 151 that differs from the version of the footrope unit body of FIG. 153 in that the footrope unit body of FIG. 152 further includes another connector situated within at least one of the sleeves 103 where the another connector is configured to permit attaching the main tow chain and/or fishing line to the footrope unit body, and may be rigidly attached connection assembly 24, 24A, or may be any other connector and/or connection assembly disclosed herein including but not limited to moveable connection assemblies disclosed herein.

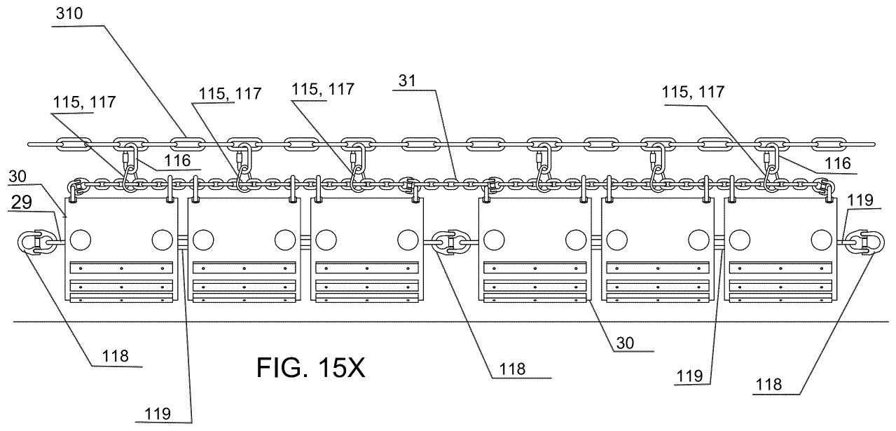

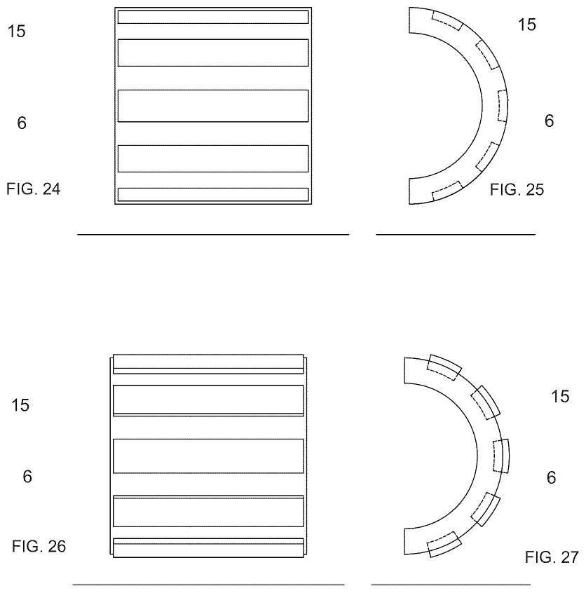

In alternative embodiments of a footrope unit body not shown in FIG. 1 to FIG. 6, but in reference to FIG. 24 to FIG. 27, one and/or a plurality of metallic and/or synthetic wall portions 15 may be recessed into the remainder of wall 6, that may be the synthetic portion of wall 6, as show in FIG. 24 and FIG. 26 that are front plan views of this alternative embodiment of the footrope unit bodies of the present disclosure, and FIG. 25 and FIG. 27 are side plan views of FIG. 24 and FIG. 26, respectively. As shown, the recessed wall portions may be flush and/or not protruding beyond the exterior most forward-facing surface of the remainder of wall 6 as shown in FIG. 15, and/or may protrude beyond the remainder of wall 6 as shown in FIG. 27, where the remainder of wall 6 may be the synthetic portion of wall 6.

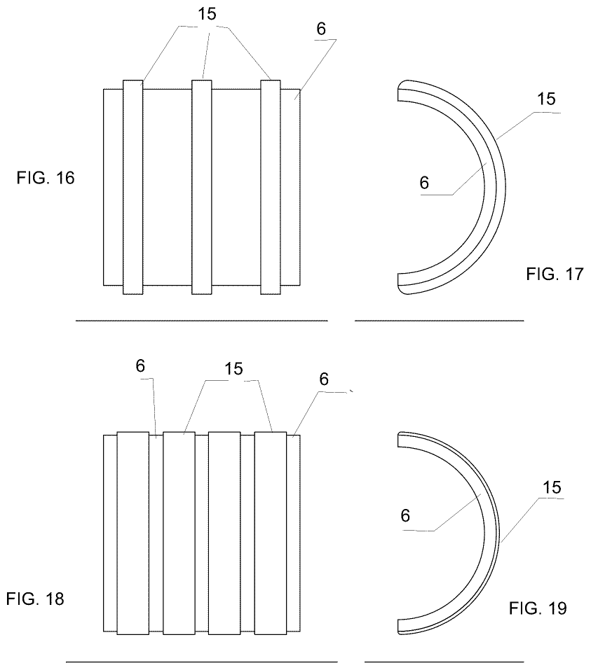

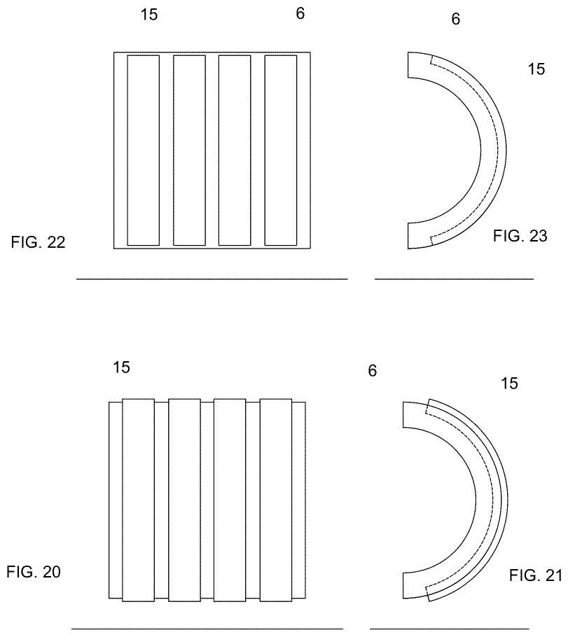

In further alternative embodiments of a footrope unit body not shown in FIG. 1 to FIG. 6, but in reference to FIG. 16 to FIG. 23, one and/or a plurality of metallic and/or synthetic wall portions 15 may be vertically and/or non-horizontally oriented with respect to the remainder of wall 6, and may be situated on the front side convex face 7 of the wall 6. FIG. 17 and FIG. 19 are side plan views of FIG. 16 and FIG. 18, respectively. The wall portions 15 also may be recessed into the remainder of wall 6, that may be the synthetic portion of wall 6, as shown in FIG. 20 to FIG. 23, where FIG. 20 and FIG. 22 are front plan views of alternative embodiments of the footrope unit bodies of the present disclosure, and FIG. 21 and FIG. 23 are side plan views of FIG. 20 and FIG. 22, respectively. As shown, the recessed wall portions may be flush and/or not protruding beyond the exterior most forward facing surface of the remainder of wall 6 and/or may protrude beyond the remainder of wall 6, where the remainder of wall 6 may be the synthetic portion of wall 6.

When the wall portions 15 are recessed into the synthetic portion of wall 6, the combination of a wall portion 14 and its associated and/or corresponding wall portion 15 are either thicker than and/or the same thickness as regions of the wall 6 not comprising the combination of a particular wall portion 14 and its associated and/or corresponding wall portion 15. In order to manufacture these embodiments, one method may be to commence with a portion of a plastic pipe of a circular, oval, airfoil or other cross section, and then to cut the pipe into pieces forming the desired wall 6, and, either before cutting the pipe into pieces to form the desired wall 6 and/or after cutting it, to machine depressions into the wall 6 where the depressions are configured to adapt to the form of at least a portion of at least one wall portion 15.

There are numerous methods to produce and/or manufacture the footrope unit bodies 5 of the present disclosure. One production method that may be particularly useful when a footrope unit body is formed entirely of synthetic material is to form an extrusion die head having the desired cross sectional shape as may be seen for example in side plan view for a particular wall 6 of a footrope unit body and to extrude a continuous plastic body having a cross section that matches that of the particular desired wall 6, and then cutting that continuous plastic body into desired widths W so as to arrive at a plurality of footrope unit bodies 5, and then attach whatever hardware is desired to the footrope unit bodies 5 to permit their being connected to a footrope main tow chain and/or to a trawl's fishing line. As the entire footrope unit body in this instant example is formed of synthetic material, the thicker wall regions 11 as well as wall portions 14 and 15 are entirely of synthetic, thus this method may be useful. However, when it is desired to form the wall regions 11 with a synthetic portion 14 and a metallic portion 15 and/or a portion 15 that cannot be simultaneously extruded through an extrusion die head, then the portion of wall 6 that is synthetic may be extruded as a continuous body having a cross section matching that of the desired synthetic portion of wall 6, and then that continuous extruded body cut into segments having desired lengths W, in order to form only the synthetic portion of wall 6, and then attach the wall portions 15 to wall portions 11 to arrive at thicker wall regions 11 and/or recessed wall regions 11 if that is what is desired. Whatever hardware is desired to be attached to the footrope unit bodies 5 to permit their being connected to a footrope main tow chain and/or to a trawl's fishing line may be installed at any time after extrusion of the continuous body. Alternatively, a pipe may be provided that is a plastic and/or synthetic pipe, that is then cut into the desired synthetic portions of wall portions 6, the side plan view form of which and/or cross sectional shape of which may be half of an annulus, or may comprise greater than half of an annulus, or may comprise less than half of an annulus, and then the synthetic portions of walls 6 may have wall portions 15 attached to the wall portions 14 to arrive at the wall portions 11. Likewise, with this method, whatever hardware is desired to be attached to the footrope unit bodies 5 to permit their being connected to a footrope main tow chain and/or to a trawl's fishing line may be installed into their desired position at any time after provision of the synthetic pipe, including before or after cutting it into various synthetic portions of wall 6.

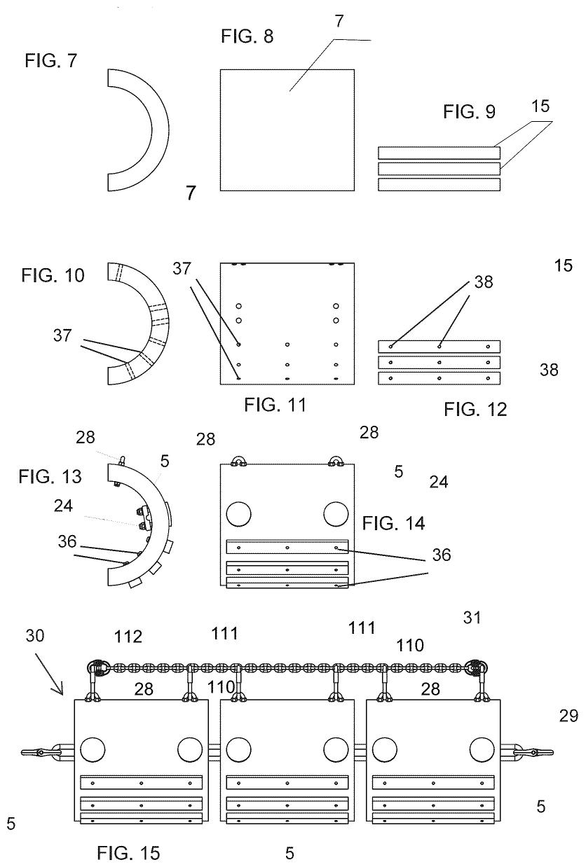

FIG. 7 to FIG. 15 illustrate elements useful for enacting one production method embodiment of the present disclosure and invention useful for forming a footrope unit body 5 (e.g., the footrope unit body 5 of FIG. 5), and also for forming a footrope of the present invention from a plurality of the footrope unit body 5 of FIG. 5, and also and alternatively useful for forming a trawl of the present invention, as more fully described below:

STEP ONE: providing the synthetic portion of at least one wall 6 where the synthetic portion of the wall 6 has a desired form, that may in cross section and/or side plan view have a form that may be half an annulus, as shown in FIG. 7, or that may be greater than half an annulus, or that may be lesser than half an annulus, or that may be a portion of an elliptical form, or that may be a portion of an airfoil shaped form, or that may be all or a portion of an elliptical form or an airfoil shaped form or an oval form or a quasi airfoil shaped form or a quasi elliptical form or a quasi oval form, or that may be a complete annulus, or any other form having at least a convex forward facing surface 7, as seen in FIG. 8 that is a front plan view of the synthetic portion of wall 6 shown in FIG. 7. In the present example, the synthetic portion of wall 6 that is provided has a cross sectional form that is half an annulus. Concurrent with providing the synthetic portion of wall 6, the method may include providing one or a plurality of wall portions 15, as shown in FIG. 9, that in the instant example may be formed of elongated metal plates such as steel bars or the like (that themselves may be formed by cutting steel plates into a desired shape for a desired wall portion 15 and may also include steps of machining their ends and/or grinding their distal ends to have rounded corners and/or cutting their distal ends to have obtuse angled corners).

STEP TWO: Through-holes and/or holes 37 are formed into the synthetic portion of wall 6 in locations that correspond to the desired locations of wall region 11 and/or of desired connection locations in wall portion 14 to which wall portion 15 is desired to be connected by bolts or other fasteners. The through-holes and/or holes may be drilled or otherwise formed into and/or perforating the wall 6 and/or wall portions 14. FIG. 10 is a view of FIG. 7 having the through-holes and/or holes formed into it, and FIG. 11 is a view of FIG. 8 having the through-holes and/or holes formed into it, and FIG. 12 is a view of FIG. 9 having the metal and/or synthetic wall portions 15 having through-holes formed into them, where the through-holes exist for the purpose of installing bolts or other fasteners, as stated supra. The number of through-holes formed into wall 6 and/or wall portion 14 per wall portion 15, and thus the number of through-holes formed into each wall portion 15 per each wall portion 14, may comprise one through-hole; or may comprise two through-holes; or may comprise three through-holes; or may comprise four through-holes; or may comprise five through-holes. At present, the minimum number of through-holes for providing the optimal balance between manufacture cost and convenience of use may be a quantity of through-holes comprising three through-holes; with a quantity of through-holes comprising four through-holes being more preferred; with a quantity of through-holes comprising five through-holes being yet more preferred. While various fasteners may be useful, bolts may be the most suitable fasteners and the fasteners that shall provide the best balance between manufacture cost and convenience of use.

At present, the minimum number of fasteners and/or bolts for providing the optimal balance between manufacture cost and convenience of use is a quantity of fasteners and/or bolts comprising three fasteners and/or bolts; with a quantity of fasteners and/or bolts comprising four fasteners and/or bolts being more preferred; with a quantity of fasteners and/or bolts comprising five fasteners and/or bolts being yet more preferred.

Presently, the minimum diameter of the through-holes 37 and 38 (that may by hollow cylindrical in form, as is presently preferred) and of fasteners 36 (that may bolts and/or that may have circular cross sectional forms when viewed in a plane bisecting and perpendicular to a fastener's long dimension) is a minimum diameter of eight millimeters, and more preferably a minimum diameter of nine millimeters, and may be in a range of eight millimeters to ten millimeters. However, a range of ten millimeters to eleven millimeters may be useful; and that a range of eleven millimeters to twelve millimeters may be useful; and that a range of twelve millimeters to thirty millimeters may be useful; and that a range of thirteen millimeters to fourteen millimeters may be useful, and that a range of fifteen millimeters to twenty millimeters may be particularly preferred as useful; and that a minimum diameter of either or both fasteners 36 that may be bolts and/or other fasteners and the through holes 37, 38 comprising a diameter of 11 millimeters may be useful, with a diameter comprising a diameter of twelve millimeters being more useful; with a diameter comprising a diameter of thirteen millimeters being even more useful; with a diameter comprising a diameter of fourteen millimeters being yet more useful; and with a diameter comprising a diameter in a range of about fifteen millimeters to twenty millimeters being even yet more useful. Preferably, the fasteners comprise bolts that are capable of being bent and/or creeped without breaking. Preferably, the fasteners comprise bolts that are capable of being creeped and/or permanently stretched and/or elongated without breaking and so as to tolerate an increase in their length that is in a range of a minimum of two percent and/or in a range of from one percent to two percent; and/or in a range of from one percent to three percent; and/or in a range of from one percent to five percent; and/or in a range of from one percent to six percent; and/or in a range of from one percent to seven percent; and/or in a range of from one percent to eight percent; and/or in a range of from one percent to nine percent; and/or in a range of from one percent to ten percent; and/or in a range of from one percent to eleven percent; and/or in a range of from one percent to twelve percent; and/or in a range of from one percent to thirteen percent; and/or in a range of from one percent to fourteen percent; and/or in a range of from one percent to fifteen percent; and/or in a range of from one percent to sixteen percent; and/or in a range of from one percent to seventeen percent; and/or in a range of from one percent to eighteen percent; and/or in a range of from one percent to nineteen percent; and or in a range of from one percent to twenty percent; and/or in a minimum range of from one percent to thirty percent. Preferably, the washers, nuts, and bolts are comprised of similar (including same) metal properties that are compatible with a salt water application. Preferably again, all metallic bodies and/or pieces affixed to a footrope unit body of the present disclosure are compatible to be situated proximal each other in a salt water environment without experiencing undue electrolytic degradation and/or other degradation and/or oxidation, and may include black steel and/or steel as used in manufacturing trawl doors (in this text the term “steel” includes but is not limited to any steel alloys).

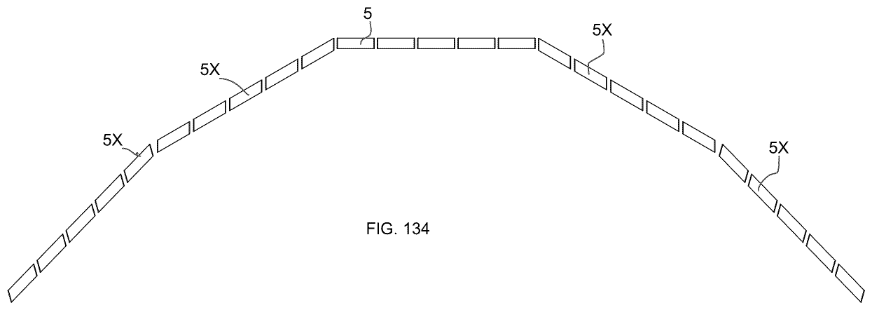

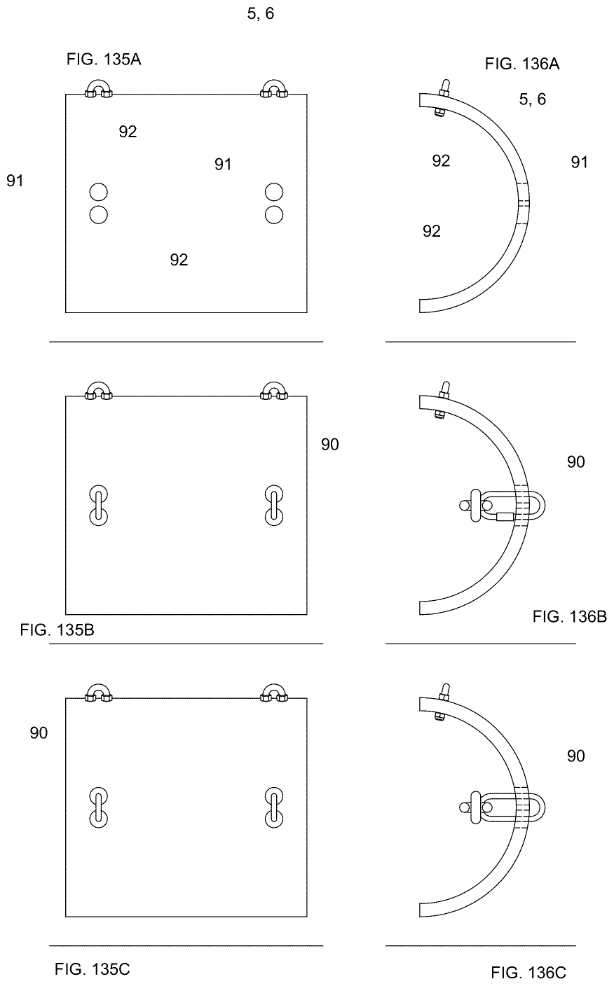

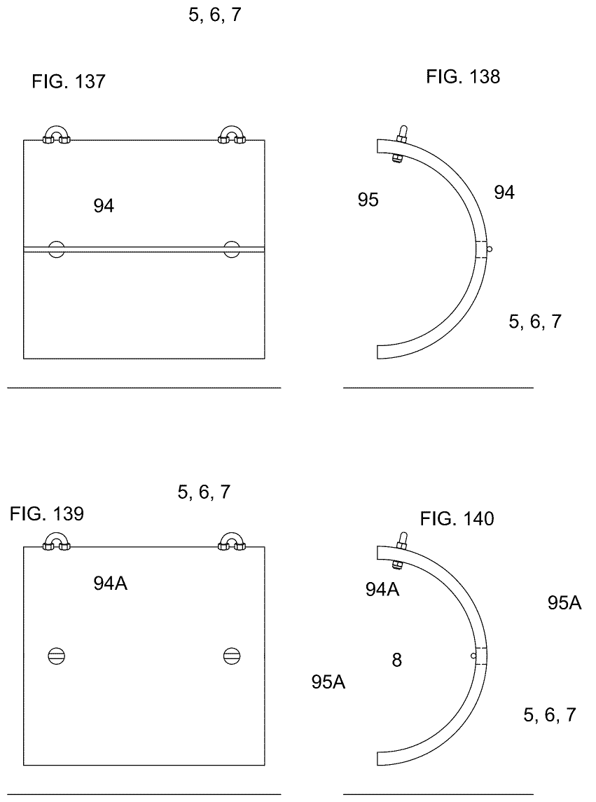

STEP THREE: attaching the wall portions 15 to the wall portions 14 comprising steps of attaching wall portions 14 and 15 using the fasteners (that preferably are bolts as stated supra) to join together wall portions 14 and 15 so as to form wall regions 11 and thus complete forming a footrope body 5 of the present disclosure, as shown in side plan view in FIG. 13 and in front plan view in FIG. 14 (and/or as shown at least in FIG. 1 to FIG. 6). Additionally, attachment hardware that is configured to be connectable and/or connected to a main tow chain and/or to a trawl's fishing line may be attached to the wall 6 of footrope unit body 5 in order to permit connecting the footrope unit body 5 to a footrope main tow chain and/or to a trawl's fishing line, and in this instant example the attachment hardware may comprise one, two or a plurality of connectors and/or units of hardware/solid objects that is/are directly connected directly to the footrope unit body itself (that is contrary to the prior art and against the trend in the industry), such as may be, by way of non-limiting example, a connector and/or connector assembly that is rigidly connected to the wall 6 and/or to the remainder of the footrope unit body 5, such as by way of example rigid connection assembly 24, 24A for attaching either to the footrope's main tow chain and/or to a trawl's fishing line; or, also contrary the prior art and against the trend in the industry, that may be, by way of non-limiting example, a connector that is moveably connected directly to the wall 6 and/or to the remainder of the footrope unit body 5 (such as, by way of non-limiting example, in reference to FIG. 135A-C and FIG. 136A-C, that are front plan views and side plan views, respectively, of an alternative embodiment of the present disclosure's footrope unit body that may comprise a connector 90—a quick-link connector in FIGS. 135B and 136B and a chain link connector in FIGS. 135C and 136C—directly attached to a portion of the wall 6 itself by connecting to an inter-wall span portion 91 of the wall 6 itself situated between two or a plurality of apertures 92 formed into wall 6; OR, such as, by way of non-limiting example, in reference to FIG. 137 and FIG. 138, that are front plan views and side plan views, respectively, of an alternative embodiment of the present disclosure's footrope unit body that may comprise a connector (not shown), such as a quick-link connector, where the connector is directly attached to a portion of a solid body 94 permanently connected to the wall 6 (such as by welding when the wall 6 is formed of metal), where the solid body is configured to be capable of being connected to the main tow chain and/or trawl's fishing line by the connector, where the solid body 94 may, by way of non-limiting example, be a metal rod connected to the forward side of the wall 6 itself, where at least a portion of the connector passes through an aperture 95 formed into wall 6; OR, such as, by way of non-limiting example, in reference to FIG. 139 and FIG. 140, that are front plan views and side plan views, respectively, of an alternative embodiment of the present disclosure's footrope unit body, that may comprise a connector (not shown) such as a quick-link directly attached to a portion of a solid body 94A such as may for example be a metal rod rigidly connected to the back side of the wall 6 itself (such as by welding when the wall 6 is formed of metal), where, in some examples, an aperture and/or indent 95A may be formed into wall 6 in such a fashion as to provide void space configured to permit situating the connector in place). Additionally, “ears” 28 may be attached to the upper regions of the wall 6 and/or to upper regions of the footrope unit body, e.g. regions proximal the upper edge EU of wall 6 and/or of the footrope unit body, where the ears may be useful for attaching the present disclosure's footrope to a trawl's fishing line, and where the ears may be formed by U bolts affixed to the wall 6 of each footrope unit body 5 proximal its upper edge EU, or may be quick-links threaded through through-holes formed into the wall 6 of each footrope unit body 5 proximal its upper edge EU. Preferably, the ears may be connected to a False Fishing Line (see FIG. 15 and FIG. 14D) and the False Fishing Line in turn is connected to the fishing line. The ears may be oriented so that their aperture allows passage of a strength member such as may be a chain to extend between multiple ears without having to be bent around any part of any ear, i.e. where a plane lying within an ear's aperture is perpendicular to the long dimension of the strength member passing through the chain (see for example FIG. 15A). Alternatively, the ears may be oriented where a plane lying within an ear's aperture that is parallel to the long dimension of the strength member extended adjacent to and proximal multiple ears.

STEP FOUR: attaching and/or interconnecting multiple footrope unit bodies 5 to a main tow chain 29 (that optionally may comprise the trawl's fishing line) so as to form a footrope segment 30 of the present disclosure and invention, shown in front plan view in FIG. 15. False Fishing Line 31 may be installed and connected to the ears 28 in order to facilitate attachment of the present invention's footrope segments 30 and thus the complete footrope itself to a trawl by attaching it to the trawl's fishing line, as may for example be accomplished by passing a connector forming an ear directly through a link in a chain forming the False Fishing Line and/or through a portion of a cable forming the False Fishing Line; or, as may be done by passing another connector, such as may be for example a quick-link, directly through a link in a chain forming the False Fishing Line and/or through a portion of a cable forming the False Fishing Line Accordingly, and contrary to the prior art and against the trend in the industry, as shown in FIG. 15X and also FIG. 14X, the present disclosure's footrope comprises a construction and/or apparatus where the False Fishing Line 31 is connected by a connector 110 to the at least one footrope unit body 5 in such a way that the connector connecting the False Fishing Line to the footrope unit body is not able to freely slide along a portion of the entire exterior surface of the False Fishing Line. A presently preferred connector is a quick-link, and a presently preferred connection includes where the ears 28 attached to the footrope unit body are connected to the False Fishing Line by means of a quick-link passing through and joining at least one ear 28 and at least one link 111 in a chain 112 forming the False Fishing Line 31. As shown in FIG. 14D and FIG. 14X, the terminal end 113 of a distal end of the False Fishing Line is connected to a last and/or terminal footrope unit body 128 situated on either the port or starboard side of the present disclosure's footrope, rather than connecting to the delta plate. As shown in FIG. 15X, that is an alternative embodiment of the footrope segment depicted in FIG. 15, the False Fishing Line may be attached to the trawl's fishing line by means of slidable connectors 115 (see also FIG. 14X) configured and positioned so as to be capable of sliding along portions of the False Fishing Line 31, that may be portions of the False Fishing Line that are situated between adjacent ears 28. In the current example, the slidable connectors 115 may be formed by a combination of quick links 116 and Pear Links 117, where the quick links connect to both the Pear Links to the trawl's fishing line 310, and where the Pear Links connect to both the quick links and the footropes False Fishing Line 31, thereby causing the footrope's False Fishing Line to be connected to the trawl's fishing line 310 with connectors comprising connectors configured to be capable of sliding along portions of the False Fishing line, where, preferably, the portions may be portions situated between adjacent ears 28 attached to at least one footrope unit body of the present disclosure. Therefore, and contrary to the prior art, the present disclosure comprises a footrope, where connectors comprising the connection of a trawl's fishing line to the footrope's false fishing line comprise a connector configured and situated so as to be capable of sliding along portions of the False Fishing line. Preferably, the portions of the False Fishing Line are situated between adjacent ears fixed to at least one footrope unit body 5. Furthermore, and contrary to the prior art, the present disclosure comprises a trawl in combination with the present disclosure's footrope where connectors comprising the connection of the trawl's fishing line to the footropes false fishing line comprise a connector configured and situated so as to be capable of sliding along portions of the False Fishing line. Preferably, the portions of the False Fishing Line are situated between adjacent ears fixed to at least one footrope unit body 5. As shown, and as is contrary to the prior art and against the trend in the industry, the footrope's main tow chain 29 may preferably comprise hammerlocks 118 forming connections between subsequent and adjacent portions 119 of chain associated with different and/or distinct footrope segments 30. In other terms, the present disclosure's footrope may comprise hammerlocks interconnecting a plurality of portions 119 of the footropes main tow chain where individual portions 119 of the footropes main tow chain are associated with different and/or distinct footrope segments 30.

However, and optionally, False Fishing Line 31 may be omitted and the ears of the footrope directly connected to the trawl as may be accomplished by directly connecting them to the trawl's fishing line. Alternatively, when it is desired to form a footrope using the trawl's fishing line in place of the main tow chain, which process may include not using a main tow chain but only using the fishing line, a plurality of the footrope unit bodies may be attached to a trawl's fishing line and/or to a fishing line that is then attached to a trawl, so as to arrive at a footrope of the present invention attached to a trawl, and/or so as to arrive at a trawl of the present invention having a footrope formed of a plurality of interconnected footrope unit bodies of the present invention, and in which embodiments the ears may optionally be employed used to attached the footrope to the trawl's fishing line using connector and/or directly (and, if the ears are used to attach the footrope unit bodies to the trawl's fishing line the rigid connection assemblies 24, 24A may be omitted and/or any other hardware configured to permit attaching the footrope unit bodies to a footrope's main tow chain may be omitted; or, if the footrope unit bodies are to be attached to the trawl's fishing line using the connection assemblies 24, 24A, then the connection assemblies 24, 24A may be included and/or attached to the footrope unit bodies and the ears may be omitted. It is to be understood that a fishing line may comprise any type of strength member including metallic chain and in this present disclosure fishing line is usually and/or exclusively depicted in the various drawing figures as being comprised of metallic chain.)

FIG. 13A is a side plan view depicting an alternative embodiment of the footrope unit body of FIG. 13.

FIG. 14A is a front plan view of the footrope unit body illustrated in FIG. 13A.

FIG. 14B is a back plan view of the footrope unit body illustrated in FIG. 13A and FIG. 14A.

FIG. 15A depicts an alternative embodiment of the footrope segment 30 of FIG. 15 where the footrope segment of FIG. 15A is formed of a plurality of the footrope unit bodies illustrated in FIG. 13A, FIG. 14A and FIG. 14B.

As illustrated in FIG. 13A, 14A, 14B, and FIG. 15A, wear plates and/or wear shoes 40 crown and/or cap at least the lower portions of the lateral edges 16 and 17 of the footrope unit body 5, i.e. at least those portions of lateral edges 16, 17 that are most proximal the lower edge EL of the footrope unit body and/or its wall 6. Multiple possible constructions exist to forming wear plates and or shoes. In the shown embodiment, wear plates and/or shoes 40 are formed as a “cap” or a “shoe” or a “crown” and are configured to cover that portion of the lateral edges 16, 17 as well as front side 7 and back side 8 of the wall 6 and/or of the wall portion 14 of the footrope unit body with which they are associated. Wear plates and/or shoes 40 include: an edge cap plate 42 that is configured to conform on its interior side surface to the exterior side surface of the portion of the lateral edge 16 or 17 with which it is associated; and front side surface cap plate 41 and a back side surface cap plate 43, that are configured to conform on their interior side surfaces to the exterior side surface of the portion of the front side 7 and of the back side 8 of wall 6 and/or wall portion 14 of the footrope unit body 5 with which they are associated, respectively (the term “back side” also optionally may be referred to as “rear side” in this text). Cap plates 41, 43 may be formed by rolling and/or bending a portion of plate steel or metal to a form that may be a camber and/or bend and/or series of bends that matches the form of the front and back side surface, respectively, of that portion of wall 6 and/or footrope unit body 5 that cap plates 41, 43 are to cap and/or cover, and then cutting the bent and/or curved steel plate into a plurality of, portions representing cap plates 41 and 43. Or, less preferably, cap plates 41, 43 may be formed individually, that is more labor intensive. Edge cap plates 42 may be formed by cutting them from a flat plate of steel to the required form that matches the side view outline of that portion of lateral edges 16 and/or 17 that they are to cover. Next, an edge cap plate 42 may be welded or otherwise fixedly connected at one of its edges to a lateral edge of a front side cap plate 41 and at the other of its edges to a lateral edge of a back side cap plate 43, to arrive at the wear plate and/or wear shoe 40. Next, a wear plate and/or wear shoe 40 may be installed upon the lower portion of the wall 6 and/or wall portion 14 of the footrope unit body 5, where the wear plate and/or wear shoe may be configured to cap and/or cover the lower portion of the wall 6 and/or wall portion 14, and preferably may be a portion in contact with the lower edge EL of the wall 6 and/or wall portion 14 of the footrope unit body 5, and is held into place by fasteners or other mechanic fixation, or an adhesive, or a bracket configured to slidably receive the wear plates and/or shoes. When fasteners are used, they may be bolts of the characteristics described herein, where such bolts pass through through-holes formed into the wall 6 and/or wall portion 14 of the footrope unit body 5, the wear plate and/or shoe especially through its front and back side cap plates 41, 43, and, preferably, through a portion of a wall portion 15 that is to be affixed to the edge cap plates, and especially through through-holes formed into the distal ends of the wall portions 15, as shown. Bolts having characteristics as disclosed herein are then inserted through the through holes and tightened and held into place, preferably with nuts over washers, and preferably the bolt heads also are over washers, so as to affix together the wall portions 15 over the edge cap plates 40 over the wall portions 14. Wall portions 15 formed of steel are most preferred for this embodiment of the present invention. Wall portions 15 are of a lesser thickness in their regions that overlap any part of the edge cap plates so as result in those regions of wall portions 15 that do not overlap any portion of an edge cap plate being in contact with the wall portion 14, preferably without any void space. Lateral edges 18 of wall portions 15 preferably are not perpendicular to the exterior front side surface 44 of wall portions 15, so as not to include a ninety degree angle formed by the convergence of the exterior front side surfaces 44 and the lateral edges 18 of wall portions 18. Thus, lateral edges of wall portions 18 preferably are curved and/or beveled and/or formed so as to form an obtuse angle at their convergence with exterior front side surfaces 44 of wall portions 15. Optionally, only one edge cap 40 is installed onto any wall portion 14 of any footrope unit body of the present invention, where the edge cap 40 is situated on that lateral edge 16 or 17 of the footrope unit body that is to be situated in the present invention's footrope at a location that is more proximal the wing end points of the footrope than it is proximal the center of the footrope. Optionally, but less preferable to forming the wear plates and/or shoes of metal, the wear plates and/or shoes may be formed of plastic, and may be formed by molded plastic.

FIG. 13A-P, FIG. 14A-P, and FIG. 14B-P illustrate one of the preferred embodiments for constructing and/or configuring the footrope unit body of the present disclosure. As illustrated in FIGS. 13A-P, 14A-P, and 14B-P, wear plates and/or wear shoes 40P crown and/or cap at least the lower portions of the lateral edges 16 and 17 of the footrope unit body 5P, i.e., at least those portions of lateral edges 16, 17 that are most proximal the lower edge EL of the footrope unit body and/or its wall 6. Multiple possible constructions exist to forming the wear plates and/or shoes. In the shown embodiment, the wear plates and/or shoes 40 are formed as a “cap” or a “shoe” or a “crown” and are configured to cover at least the lateral edges 16, 17 proximal the lower edge of the footrope unit body, and may also cover a minority portion of the front side 7 and back side 8 of the wall 6 that are proximal the lower edge of the footrope unit body, as shown in the instant embodiment. The wear plates and/or shoes 40P include: an edge cap plate 42P that is configured to conform on its interior side surface to the exterior side surface of the portion of the lateral edge 16 or 17 with which it is associated; and a front side surface cap plate 41P and a back side surface cap plate 43P, that are configured to conform on their interior side surfaces to the exterior side surface of the portion of the front side 7 and of the back side 8 of wall 6 with which they are associated, respectively (the term “back side” also optionally may be referred to as “rear side” in this text). The cap plates 41P, 43P may be formed by rolling and/or bending a portion of plate steel or metal to a form that may be a camber and/or bend and/or series of bends that matches the form of the front and back side surface, respectively, of that portion of wall 6 and/or footrope unit body 5 that the cap plates 41P, 43P are to cap and/or cover, and then cutting the bent and/or curved steel plate into a plurality of portions representing cap plates 41P and 43P. Or, alternatively (and, potentially, less preferably), the cap plates 41P, 43P may be formed individually, that is more labor intensive. The edge cap plates 42P may be formed by cutting them from a flat plate of steel to the required form that matches the side view outline of that portion of lateral edges 16 and/or 17 that they are to cover. Next, an edge cap plate 42P may be welded or otherwise fixedly connected at one of its edges to a lateral edge of a front side cap plate 41P and at the other of its edges to a lateral edge of a back side cap plate 43P, to arrive at the wear plate and/or wear shoe 40P. Next, a wear plate and/or wear shoe 40P may be installed upon the lower portion of the wall 6 of the footrope unit body 5P, where the wear plate and/or wear shoe may be configured to cap and/or cover the lower portion of the wall 6 as described supra and herein, and is held into place by fasteners or other mechanic fixation, or an adhesive, or a bracket configured to slidably receive the wear plates and/or shoes. When fasteners are used, they may be bolts of the characteristics described herein, where such bolts pass through through-holes formed into the wall 6 and the wear plate and/or shoe especially through its front and back side cap plates 41P, 43P, and, preferably, through a portion of a wall portion 15, 15P that may be situated between (i) a lateral edge of the footrope unit body 5P that may be a lateral edge lacking a wear plate and/or shoe and (ii) a wear plate and/or shoe that is situated on another lateral edge of the footrope unit body. Most preferably, the footrope unit bodies 5P are configured to have a wear plate and/or shoe situated on one and/or at least one lateral edge that is their lateral edge corresponding to, when viewed from in front of the complete footrope, a leading lateral edge of the footrope unit body. Backing plates 155P may be situated on the back side 8 of the footrope unit body and configured to provide pressure distribution for pressure exerted on the back side of the footrope unity body by fasteners and/or bolts that connect the backing plates 155P to the wall portions 15P and/or 15. Edge cap raised portions 15E may be formed into the edge caps and/or wear plates especially on their front side surfaces and may be coaxial with and/or in-line with wall portions 15 and/or 15P. When a wall 6 of a footrope unit body of the present disclosure is formed from plastic, wall portions 15 and/or 15P may be recessed into the plastic wall by being heated to a heat that can cause a phase change of the plastic wall 6 without destroying it, then being pressed into the plastic wall 6 so as to displace enough plastic to deform the wall 6 in such a manner as to cause a wall portion 15 and/or 15P to be seated and/or recessed into the plastic wall 6.

Installation of wall portions 15 and/or 15P on a footrope unit body of the present disclosure, that may be formed with a plastic wall 6, may be accomplished by situating a plurality of wall portions 6 side by side, such as may be done on a jig, and then installing one or a plurality of wall portions 15 and/or 15P to the wall 6 of each of the footrope unit bodies. Similarly, attachment hardware, such as connection assemblies 24, 24A for joining the footrope unit bodies to a chain (e.g., a tow chain), may also be installed onto a wall 6 of the footrope unit bodies of the present disclosure by first situating a plurality of footrope unit bodies of the present disclosure lacking said attachment hardware on a jig and then subsequently forming said attachment hardware to the walls of the footrope unit bodies.

Multiple and/or a plurality of footrope unit bodies of the present disclosure may be situated side by side such as on a jig, and subsequently jointed together by a length and/or segment of chain, so as to form a footrope segment 30 of the present disclosure. Then, a plurality of footrope segments 30 of the present disclosure may be interconnected so as to form a footrope 30 of the present disclosure.

FIG. 14C illustrates a top plan view of a footrope 30A of the present disclosure formed of multiple footrope segments 30. Footrope 30A includes: a central region 45; port and starboard wing regions 46 and 47, respectively; and port and starboard wing end points 48 and 49, respectively. Port and starboard weighted ballast bodies 50 and 51 may be situated proximal the wing end points and may be bobbins and/or may be formed from steel and/or other metal and/or from natural or synthetic materials such as wood or rubber, and may be of any shape, including but not limited to spherical, semi spherical, bullet shaped and other (the term “weighted ballast body” as used herein means a body having a negative buoyancy in salt water and also having either or both a width and/or a height that is greater than the average width and/or height of the main tow chain and/or other strength member and or fishing line to which the weighted ballast body is connected even when the weighted ballast body is in-line connected to the main tow chain and/or other strength member and or fishing line). Delta plates 52 and 53 may be situated proximal the wing end points. When delta plates are used, they may be situated aft of the weighted ballast bodies (that may be bobbins). Rockhopper disks 54, 54A and 55, 55A may be incorporated into the footrope construction of the present disclosure, and may preferably be situated between the wing end points and all and/or the majority of the footrope unit bodies 5 of the present disclosure. Footropes of the present disclosure do not include sweeps, sweeplines, bridles and the like structures, that are considered separate structures, and that may connect to and be situated forward of the wing end points.

Even though years of research and trials conducted by multiple nations' government research bodies as well as private entity attempts took place with the goal of achieving a workable SCG plastic footrope construction that generated less dust cloud than rockhopper gear footropes no prior attempts at achieving a footrope construction employing the SCG plastic plates of the prior art to form a footrope ever were sufficiently capable of improving the operating conditions of a bottom trawl including sufficiently reducing dust cloud formation to result in adoption by the industry. Incredibly, contrary to the prior art, against the trend in the field, and contrary to the widely held beliefs of those skilled in the art, it has been discovered that by combining into a single footrope construction the prior art SCG plastic plates (that may optionally be formed of metal) in conjunction with at least one and preferably a plurality of rockhopper disks situated between at least the majority of and preferably all of the SCG plastic plates (that may optionally be formed of metal) and the wing end points, that preferably may be done for each of half of the footrope (i.e. the port and starboard half of the footrope), and whether or not a delta plate is also included in the footrope construction, that a footrope construction of the present disclosure that generates less dust cloud than either the SCG plastic plate footrope of the prior art or than the rockhopper footrope of the prior art is achieved. Therefore, the present disclosure includes a footrope construction for a bottom trawl comprising in combination SCG plates that may be formed of plastic and/or of metal, where the SCG plates have a “half and annulus” profile and/or any other profile when viewed in side plan view, in combination with rockhopper gear, such as may, for example, include one or a plurality of rockhopper disks situated between adjacent SCG plates. In this embodiment of the present disclosure's footrope, at least one and preferably a plurality of rockhopper disks are situated between at least the majority of and preferably all of the SCG plates, and, preferably, at least one and preferably a plurality of rockhopper disks are situated between each delta plate situated at each of the port and starboard wing end points and any SCG plastic and/or metal plate most proximal any delta plate. Additionally, and also contrary to the prior art and against the trend in the industry and against the widely held beliefs of those in the field, in this embodiment of the present disclosure's footrope, a plurality of weighted ballast bodies are used in combination with the SCG plastic plates and the rockhopper disks and are also situated between at least the majority of and preferably all of the SCG plastic plates and the wing end points, and may be further be situated between the rockhopper disks and the wing end points.

Furthermore, contrary to the prior art, against the trend in the field, and contrary to the widely held beliefs of those skilled in the art, it has been discovered that by combining into a single footrope construction a plurality of weighted ballast bodies on each of the port and starboard side of the footrope (rather than a single weighted ballast body as traditionally used in the prior art in keeping with the widely held beliefs of those skilled in the art and in keeping with the trend in the industry), where each of the multiple weighted ballast bodies may be bobbins formed as described supra, and whether or not a delta plate is also included in the footrope construction, that a footrope construction of the present disclosure that generates less dust cloud than either the SCG plastic plate footrope of the prior art or than the rockhopper footrope of the prior art is achieved. Therefore, the present disclosure includes a footrope construction for a bottom trawl comprising in combination SCG plastic plates having a “half and annulus” profile and/or any other profile when viewed in side plan view in combination with a plurality of weighted ballast bodies situated on each half of the footrope, for a minimum of four weighted ballast bodies situated in the entire footrope. In this embodiment of the present disclosure's footrope, the plurality of weighted ballast bodies are situated between at least the majority of and preferably all of the SCG plastic plates and the wing end points, that preferably may be done for each of half of the footrope (i.e. the port and starboard half of the footrope). Additionally, and also contrary to the prior art and against the trend in the industry and against the widely held beliefs of those in the field, in this embodiment of the present disclosure's footrope, a plurality of rockhopper disks may be used in combination with the SCG plastic plates and the weighted ballast bodies and also may be situated between at least the majority of and preferably all of the SCG plastic plates and the wing end points, and may also be situated between the majority of and preferably all of the rockhopper disks and the wing end points.

FIG. 14D illustrates a front plan view of the forward facing and/or inboard facing side of a portion of the port side of the footrope 30A of FIG. 14C that includes the port wing end point, a plurality of rockhopper disks, at least one weighted ballast body that in the present example is at least one bobbin, a delta plate, and a plurality of footrope unit bodies of the present disclosure.

FIG. 14E illustrates a top plan view of the portion of the footrope 30A of FIG. 14C.

In reference to FIG. 14D and FIG. 14E, as shown, rockhopper disk bodies 54, 54A may have dimensions that differ from one another, and may be substituted by any weighted ballast bodies that also may have dimensions that differ from one another. Preferably, at least one and preferably a plurality of the rockhopper disk bodies and/or weighted ballast bodies 54 may be situated between the most forward footrope unit body 317 and the wing end point 48, and may preferably be aft of the delta plate 52, and may be dimensioned and configured so that when connected to the chain 29 their lowermost edge BBL is at least level with the lowermost edge EL of at least a plurality the footrope unit bodies 5 measured as oriented during trawling operations, and, yet more preferably, extends lower than the lower edge EL of the footrope unit bodies. Less preferably, rockhopper disks and/or weighted ballast bodies 54A may be dimensioned and configured so that when connected to the chain 29 their lowermost edge MBL extends half the distance and/or about half the distance and/or within ten percent of half the distance and/or at least half the distance from the chain 29 to the lowermost edge EL of at least a plurality the footrope unit bodies 5 measured as oriented during trawling operations. Also most preferably, the footrope's main tow chain 29 is configured to have a length shorter than the length of the fishing line 310 of a trawl to which the footrope is capable and/or configured to connect to. When measuring the length of the fishing line 310 and/or of the footrope 29, the length includes the taught straight line length of the fishing line and/or footrope including all connectors, and in addition including the distance from the fishing line and/or footrope main tow chain delta plate connection points 311 and 312, respectively, to the delta plates most forward connection point 313 to which the delta plate is ultimately connected either directly or by a length of chain or other wing strength member 65 to whichever wing end point 48 or 49 is most proximal the delta plate, that in FIG. 14D is wing point end 48 because shown is the port side wing end point.

FIG. 14X illustrates a front plan view of the forward facing and/or inboard facing side of a portion of the port side of an alternative embodiment of the present disclosure's footrope 30A of FIG. 14C that differs in comparison to that embodiment illustrated in FIG. 14D. In further reference to FIG. 14X, illustrated is a front plan view of the forward facing and/or inboard facing side of a portion of the port side of an alternative embodiment of the present disclosure's footrope 30A, that includes the port wing end point 48, at least one weighted ballast body 50 situated between the most forward footrope unit body 317 and the wing end point 48, where in the present example the ballast body is at least one bobbin 59 situated on a “spindle and ear” type bobbin apparatus, where the bobbin preferably may be a round bobbin as shown having a through hole through which is inserted the spindle 65, and where the “ear” 316 comprises an alternative delta plate 52A; and, a plurality of footrope unit bodies 5 of the present disclosure. Also most preferably, the footrope's main tow chain 29 is configured to have a length shorter than the length of the fishing line 310 of a trawl to which the footrope is capable and/or configured to connect to. When measuring the length of the fishing line 310 and/or of the footrope 29, the length includes the taught straight line length of the fishing line and/or footrope including all connectors, and in addition including the distance from the fishing line and/or footrope main tow chain delta plate connection points 311 and 312, respectively, to the delta plates most forward connection point 313 to which the delta plate is ultimately connected (either directly or by a length of chain or other wing strength member 60) to whichever wing end point 48 or 49 is most proximal the delta plate, where in FIG. 14X shown is wing end point 48 because shown is the port side wing end point, and where the shown wing strength member 60 is the spindle 65.

FIG. 14X-Y is an alternative embodiment of the footrope portion shown in FIG. 14X.

With reference to FIG. 14X, FIG. 15X, and FIG. 14X-Y, the footrope's main tow chain 29 may preferably comprise hammerlocks or other connectors 118 forming connections between subsequent and adjacent chain portions 119 of chain associated with different and/or distinct footrope segments 30 and forming segments that when connected together form the final main tow chain 29. In other words, the present disclosure's footrope may comprise hammerlocks and/or other connectors interconnecting a plurality of chain portions 119 that aggregately and/or cumulatively form the footropes main tow chain 29, wherein individual chain portions 119 of the footropes main tow chain are associated with different and/or distinct footrope segments 30.

With reference to FIG. 14X-Y, extra chain links 290 may be connected to chain portions 119 and left loose, without participating in the main load bearing function of the main tow chain, and are capable of being used to extend the length of load bearing portions of selected chain portions 19 for specific footrope segments 30 by relocating hammerlocks and/or other connectors 118 so that they connect to previously loose links 290, thereby extending and/or increasing the length of the entire main tow chain 29 (that may be done so as to cause footrope unit bodies connected to the main tow chain to shift in position so that during towing operations their top edges shift to become further aft while their lower edges shift to become more forward). Oppositely but similarly, lengths of chain portions 119 that form part of the load bearing portion of the main tow chain may be shortened in length by relocating hammerlocks and/or other connectors 118 so that they connect to links further from distal ends of any particular chain portion 119 thereby causing links 290 to not participate in the load bearing function of the main tow chain, and resulting in “loose” links 290, and thereby also shortening the length of the load bearing portion of selected chain portions 119 and resultantly reducing the length of the entire main tow chain 29 (that may be done so as to cause footrope unit bodies associated with a shortened chain portion 19 to shift in position during towing operations so that the top edges of the associated footrope unit bodies shift to be more aft, and their lower edges shift to be more forward, [i.e. as may be considered to be give the impression of the footrope unit bodies being “raised upward”]).

In reference to FIG. 14Y, that illustrates a top plan view of an embodiment of the present disclosure's footrope connected to a bottom trawl of the present disclosure, where the present disclosure's footrope is connected to the bottom trawls' fishing line 310, the only portion of the trawl that is shown is its fishing line, and the only portion of the footrope shown is that region of the footrope situated between the port and starboard delta plates is the footropes main tow chain 29 and its False Fishing Line 31, in order to allow the main tow chain and the trawl's fishing line and the False Fishing Line to be fully visible along their entire length so as to permit full visualization of their relative positions to one another. As shown, when the present disclosure's footrope in this embodiment of the present disclosure is properly configured with the footrope's main tow chain shorter in length in comparison to the length of the trawl's fishing line 310, the trawl's fishing line fishes aft of the footropes main tow chain.

Accordingly, the present disclosure comprises a method for forming a SCG and/or bent plate gear footrope where the method comprises forming the footrope's main tow chain 29 so as to be shorter in length in comparison to a fishing line of a bottom trawl to which the footrope is capable of and/or planned to be connected.

Accordingly, the present disclosure also comprises a method for forming a combination of a bottom trawl and a SCG and/or bent plate gear footrope, where the trawl has a fishing line and where the footrope has a main tow chain, where the method comprises forming the footrope's main tow chain 29 so as to be shorter in length in comparison to the trawl's fishing line.

Accordingly, the present disclosure also comprises a method for forming a combination of a bottom trawl and a SCG and/or bent plate gear footrope, where the trawl has a fishing line and where the footrope has a main tow chain, where the method comprises forming the footrope's main tow chain 29 so as to be shorter in length in comparison to the trawl's fishing line, so as to result in the fishing line being planned and/or intended to fish aft of the main tow chain.

Accordingly, the present disclosure also comprises a construction for a combination of a bottom trawl and a SCG and/or bent plate gear footrope, where the trawl has a fishing line 310 and where the footrope has a main tow chain 29, where the footrope's main tow chain 29 comprises a length shorter in length in comparison to the length of the trawl's fishing line.

Accordingly, in another embodiment of the present disclosure, that is contrary to the prior art and against the trend in the industry and that has surprisingly and unexpectedly resulted in bettered performance characteristics for a SCG and/or bent plate gear footrope for a bottom trawl, and/or for a bottom trawl including a SCG and/or bent plate gear footrope, where the bettered performance characteristics are selected from a group comprising reduced drag; increased horizontal spread; improved fishing efficacy; and, lesser dust cloud generation compared to known widely adopted and used footropes for bottom trawls, the present disclosure discloses a combination of a bottom trawl with a SCG and/or bent plate gear footrope for a bottom trawl, and/or disclosed is a SCG and/or bent plate gear footrope for a bottom trawl configured to be used with a bottom trawl, where the bottom trawl has a fishing and where the footrope has a main tow chain, where the fishing line has a length that differs from the length of the footrope's main tow chain, and preferably where the length of the fishing line is greater and/or longer than the length of the main tow chain, for example at least 0.4 percent longer, more preferably in a range of from 0.2 percent longer to 1.6 percent longer, or in a range of from 0.2 percent longer to 2 percent longer, or in a range of from 0.2 percent longer to 2.6 percent longer, or in a range of from 0.1 percent longer to 5.9 percent longer, where 2 percent longer plus or minus 0.6 percent and/or about 2 percent longer presently is preferred. In other embodiments, the main tow chain is from 0.2 percent longer to 8.7 percent longer than the bottom trawl's fishing line, with from 2 percent longer to 5.2 percent longer being presently preferred.

In another embodiment contained within the present disclosure, that is contrary to the prior art and against the trend in the industry and that has surprisingly and unexpectedly resulted in bettered performance characteristics for a SCG and/or bent plate gear footrope for a bottom trawl and/or for a bottom trawl including a SCG and/or bent plate gear footrope, where the bettered performance characteristics are selected from a group comprising reduced drag; increased horizontal spread; improved fishing efficacy; and, lesser dust cloud generation compared to known widely adopted and used footropes for bottom trawls, the present disclosure discloses is a method for combining a bottom trawl having a fishing line with a SCG and/or bent plate gear footrope for a bottom trawl, and/or disclosed is a method for forming a SCG and/or bent plate gear footrope for a bottom trawl to be connected to a bottom trawl, where the bottom trawl has a fishing line and where the footrope has a main tow chain, the method comprising configuring the footrope so as to be capable of being connected to the bottom trawl in such a fashion that the footrope's main two chain has a length that differs from the length of the trawl's fishing line, trawl's fishing line, and preferably where the length of the fishing line is greater and/or longer than the length of the main tow chain, for example at least 0.4 percent longer, more preferably in a range of from 0.2 percent longer to 1.6 percent longer, or in a range of from 0.2 percent longer to 2 percent longer, or in a range of from 0.2 percent longer to 2.6 percent longer, or in a range of from 0.1 percent longer to 5.9 percent longer, where 2 percent longer plus or minus 0.6 percent and/or about 2 percent longer presently is preferred. In other embodiments, the main tow chain is from 0.2 percent longer to 8.7 percent longer than the bottom trawl's fishing line, with from 2 percent longer to 5.2 percent longer being presently preferred.

In another embodiment contained within the present disclosure, that is contrary to the prior art and against the trend in the industry and that has surprisingly and unexpectedly resulted in bettered performance characteristics for a SCG and/or bent plate gear footrope for a bottom trawl and/or for a bottom trawl including a SCG and/or bent plate gear footrope, where the bettered performance characteristics are selected from a group comprising reduced drag; increased horizontal spread; improved fishing efficacy; and, lesser dust cloud generation compared to known widely adopted and used footropes for bottom trawls, the present disclosure discloses a method for combining a SCG and/or bent plate gear footrope for a bottom trawl with a bottom trawl, and/or disclosed is a method for forming a SCG and/or bent plate gear footrope to be connected to a bottom trawl, where the bottom trawl has a fishing line and where the footrope has a main tow chain, the method comprising forming a SCG and/or bent plate gear footrope configured so that the length of the footrope's main tow chain is shorter than the length of the bottom trawl's fishing line, where the length of the footrope's main tow chain may be for example at least 0.4 percent shorter, more preferably in a range of from 0.2 percent shorter to 1.6 percent shorter, or in a range of from 0.2 percent shorter to 2 percent shorter, or in a range of from 0.2 percent shorter to 2.6 percent shorter, or in a range of from 0.1 percent shorter to 5.9 percent shorter, where 2 percent shorter plus or minus 0.6 percent and/or about 2 percent shorter presently is preferred. In other embodiments, the main tow chain is from 0.2 percent shorter to 8.7 percent shorter than the bottom trawl's fishing line, with from 2 percent shorter to 5.2 percent shorter being presently preferred.

The present disclosure further discloses a process comprising steps of forming a SCG and/or bent plate gear footrope for use with a bottom trawl, and notifying a user and/or potential user of the footrope that the footrope must be connected to the bottom trawl in such a fashion that the length of the bottom trawl's fishing line differs from the length of the SCG footrope's main tow chain. The process further comprises steps of providing the values mentioned supra for the length differences between the SCG and/or bent plate gear footrope's main tow chain and the bottom trawl's fishing line to a user of the footrope and/or bottom trawl.

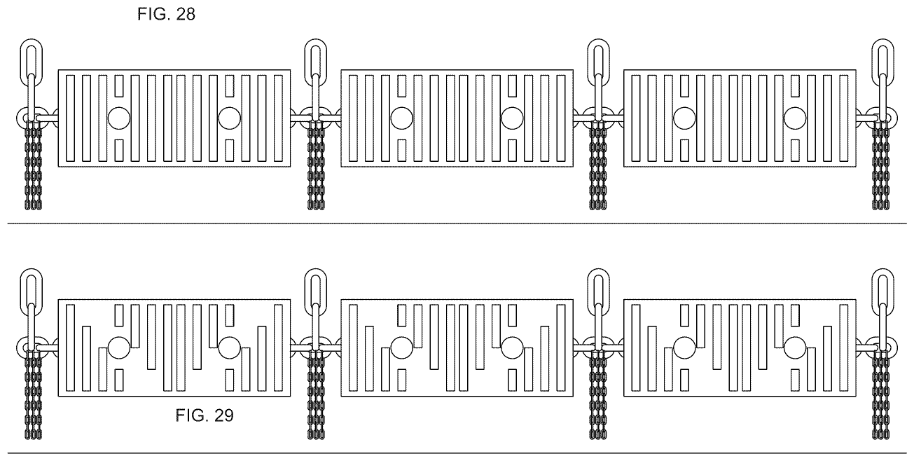

FIG. 28 and FIG. 29 illustrate front plan views of portions of a footrope of the present disclosure formed of footrope unit bodies of the present disclosure modified to comprise perforations and/or perforated slits in their wall 6. The perforations may be sized and/or configured to promote and/or permit the escape through the perforations of undersized fish and/or crustacea.

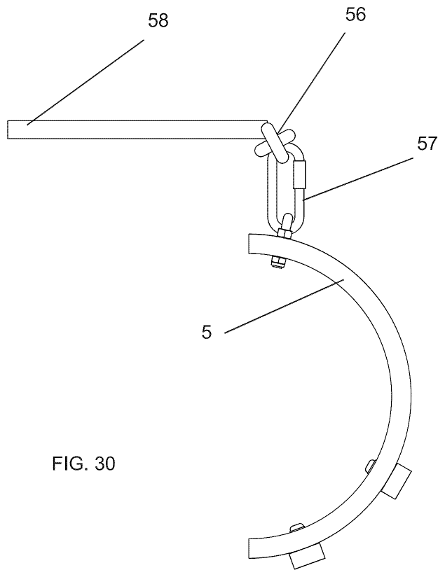

FIG. 30 is a side plan view of a footrope unit body of the present disclosure attached to a trawl's fishing line 56 at the footrope unit bodies top edge EU, as may be done by connecting each of the ears 28 to the fishing line using a quick-link 57. The trawl's bottom netting panel 58 may be connected to the fishing line and may be in the position as indicated.

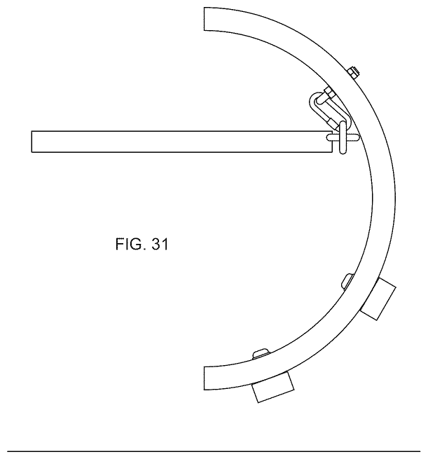

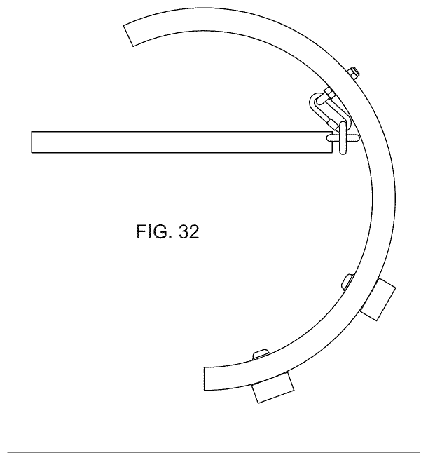

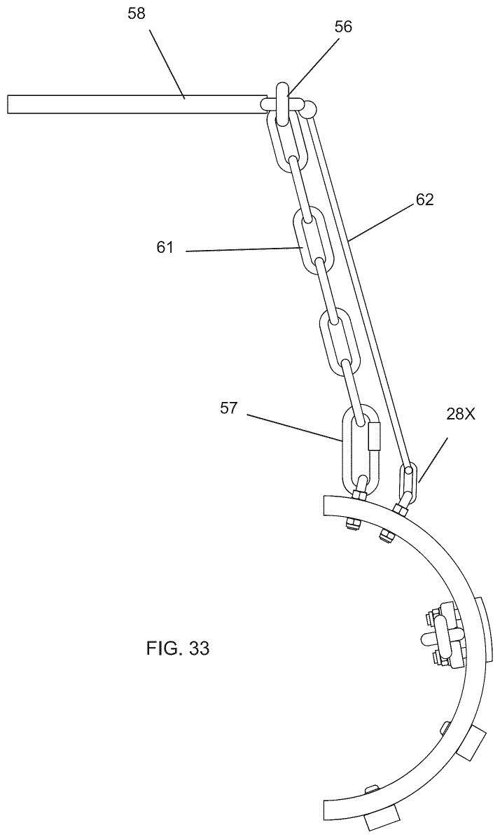

FIG. 31 is a side plan view of a modified footrope unit body of FIG. 30 where the attachment point of the fishing line to the footrope unit body is less proximal the upper edge EU of the footrope unit body and about one third of the distance between the upper and lower edges EU and EL of the footrope unit body.

FIG. 32 is a side plan view of a modified footrope unit body of FIG. 31 where the footrope unit body is formed with a shape having in side plan view a portion of an annulus that is greater than half of an annulus, and where the periphery of a circle that may match the clean/unmodified exterior sides surface of a plastic plate made from a cut cylindrical plastic pipe may for example correspond to that portion of a circle's periphery matching two hundred sixty degrees of a circle.

FIG. 33 is a side plan view of a footrope unit body of the present disclosure attached to a trawl's fishing line 56 at the footrope unit bodies top edge EU, as may be done by connecting each of the ears 28 by a quick-link 57 to a drop chain 61 depending from the fishing line. The trawl's bottom netting panel 58 connected to the fishing line may be in the position as indicated. Another set of ears 28X are also positioned proximal the footrope unit bodies upper edge EU and permit connecting a barrier netting panel 62 to the fishing line and/or bottom netting panel so as to form a barrier precluding fish and/or crustacea escape over the footrope unit body and between the footrope unit body and the trawl's fishing line and/or bottom netting panel. The barrier netting panel may be replaced by another structure that forms a suitable barrier serving the same function for example interconnected chain lengths.

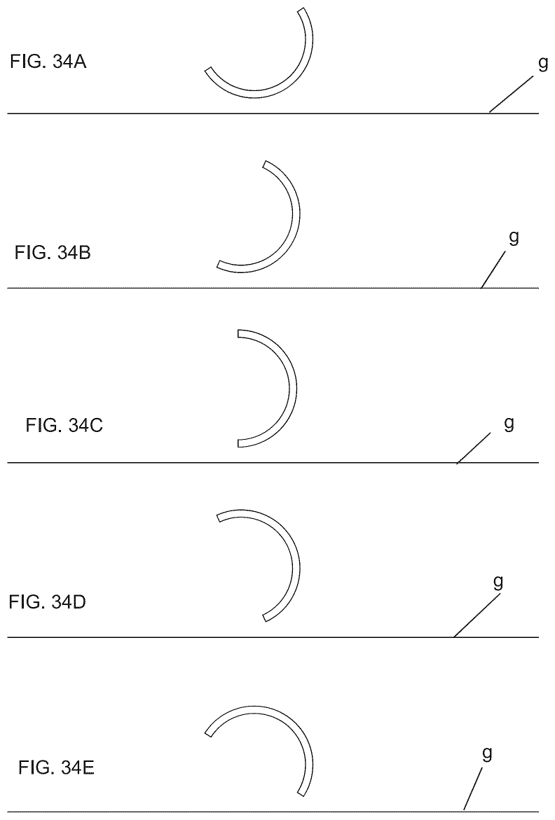

FIG. 34A to FIG. 34E illustrate side plan views of various orientations of the same basic plastic plate having a “half an annulus” side plan shape, where FIG. 34D and FIG. 34E depict a novel orientation for the footrope unit body where the concave side surface of the footrope unit body is directed toward the level surface g, that is opposite the prior art which has the concave side surface directed either upward or backward or backward and upward. Wall portions 15 may be added to the plastic “half of an annulus” side plan view form plate to arrive at a footrope unit body of the present invention for all the orientations of the “half of an annulus” in side plan view footrope unit body shown in FIG. 34A to FIG. 34E.

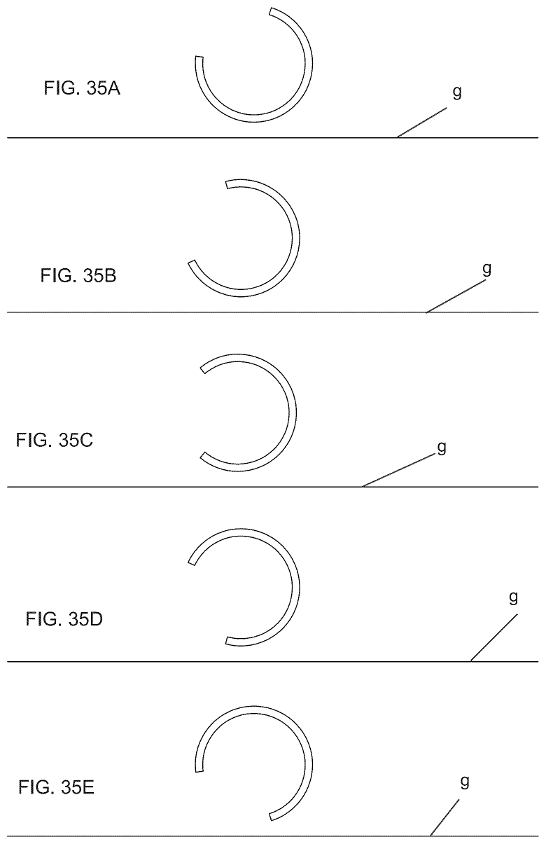

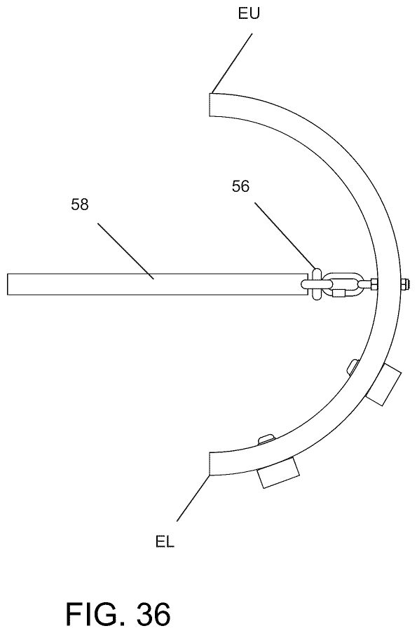

FIG. 35A to FIG. 35E illustrate side plan views of various orientations of the same basic plastic plate having a “greater than half an annulus” side plan shape, where FIG. 35D and FIG. 35E depict an orientation for the footrope unit body where the concave side surface of the footrope unit body is directed toward the level surface g, that is opposite the prior art which has the concave side surface directed either upward or backward or backward and upward. Wall portions 15 may be added to the plastic “greater than half of an annulus” side plan view form plate to arrive at a footrope unit body of the present invention for all the orientations of the “greater than half of an annulus” in side plan view footrope unit body shown in FIG. 35A to FIG. 35E. The plastic portion of the wall 6 may be formed from a cylindrical plastic pipe by existing the portion of the pipe to form the break in the completion of the annulus.

FIG. 36 is a side plan view of a footrope unit body of the present disclosure attached to a trawl's fishing line 56 at a position on the footrope unit body corresponding to midway and/or about midway between the upper and lower edges EU and EL of the plastic/synthetic portion of the footrope unit bodies wall 6. The trawl's bottom netting panel 58 may be connected to the fishing line and may be in the position as indicated.

In further description of another certain preferred embodiments of the particular embodiment of the present invention described immediately supra, in a particular presently preferred embodiment of the present disclosure, the footrope of the present disclosure is formed of a series of interconnected bodies each comprising a wall having a convex exterior forward facing form and/or surface that may preferably be a convex forward facing surface that may be a convex cambered forward facing surface and/or a convex sloping forward facing surface, and where a plurality of the interconnected bodies each may comprise a closed periphery in side plan view, and/or may comprise an airfoil shaped profile and/or a quasi-airfoil shaped profile including a teardrop profile and/or a wing profile. In other embodiments, the footrope of the present disclosure is formed of a series of interconnected bodies each comprising a wall having a convex exterior forward facing form and/or surface that may preferably be a convex forward facing surface that may be a convex cambered forward facing surface and/or a convex sloping forward facing surface, and where a plurality of the interconnected bodies each may comprise at least a synthetic portion including a plastic portion, that may exhibit a “half of an annulus” when viewed in side plan view, and where the wall of at least a plurality of the bodies having the convex exterior forward facing form of at least one of the interconnected bodies and preferably of a plurality of the interconnected bodies comprises at least one region of the wall having a different thickness in comparison to at least one other region of the wall.

In alternative embodiments of the present disclosure:

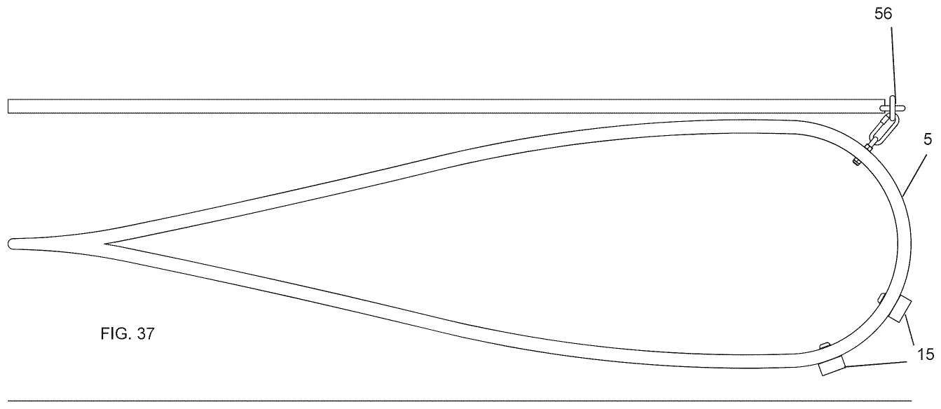

FIG. 37 is a side plan view of a footrope unit body of the present disclosure attached to a trawl's fishing line 56 at a position on the footrope unit body corresponding to proximal the upper region of its forward facing surface, that is a convex surface, where the side plan view profile of the unit body 5 is a tear drop shape and/or teardrop airfoil shape. The trawl's bottom netting panel 58 may be connected to the fishing line and may be in the position as indicated. The preferred material for the wall of the unit body 5 is a deformable plastic that has good memory to return to its original form, such as HMPE or HDPE, while the preferred material for wall portions 15 are metal.

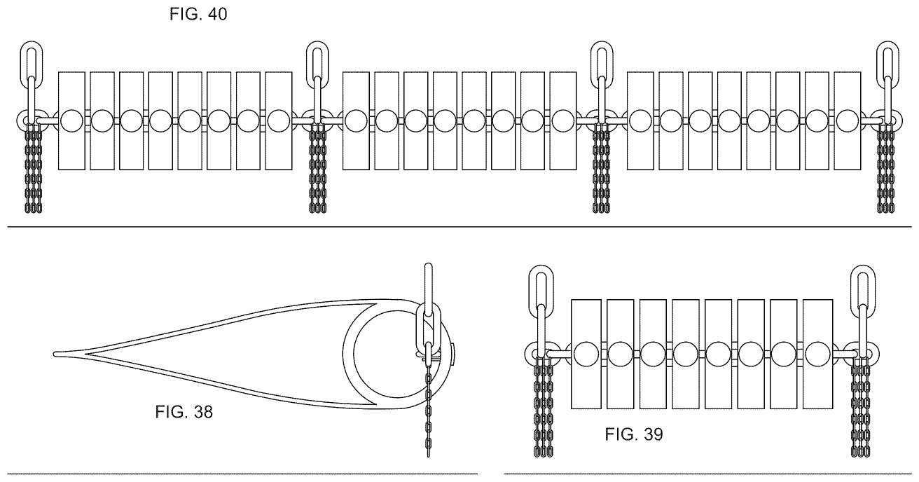

FIG. 38 is a side plan view of another footrope unit body 5 having a teardrop shaped airfoil profile in side plan view and a different construction that that of the teardrop shaped unit body 5 of FIG. 37. The unit body of FIG. 38 is formed with a cylindrical pipe to which is attached further material to make the teardrop portion of the shape, where such further material may be plastic walls or sheets of flexible and pliable material such as a conveyor belt material.

FIG. 39 is a front plan view of a footrope segment of the present disclosure as may be used to form a footrope of the present disclosure. As illustrated, the footrope segment of the present disclosure is formed of footrope unit bodies having a height greater than their width, which may be especially useful for the center segment of the footrope. The height of the footrope unit bodies may be greater than their width, with ratios of height to width of from ten times taller than wide to 1.1 times taller than wide being potentially useful.

FIG. 40 is a front plan view of a plurality of the segments of FIG. 39 connected to one another along chain 29.

FIG. 41 is a side plan view of an alternative construction for a teardrop shaped airfoil profile footrope unit body 5, where a roller is situated in a cylindrical housing situated within the forward region of the unit body, and where the tow chain and/or fishing line is attached to the roller, so that the unit body 5 can easily rotate as much as possible.

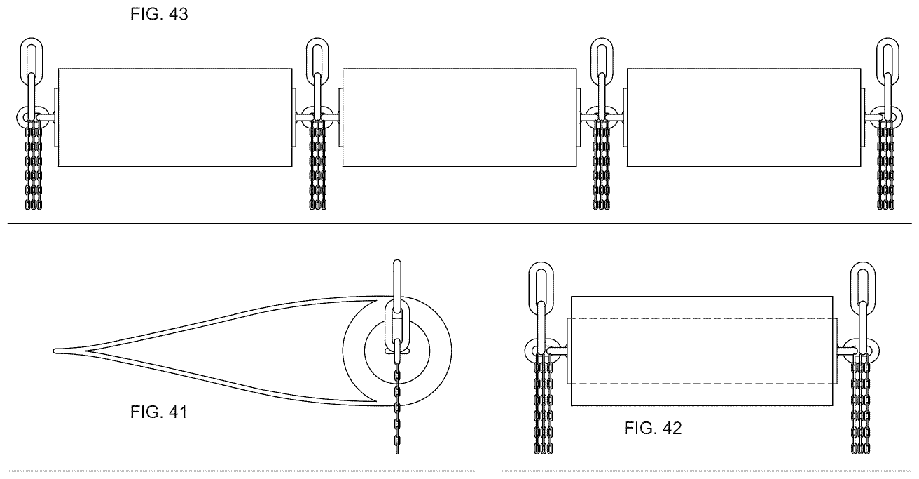

FIG. 42 is a front plan view of the footrope unit body of FIG. 41, where the roller body is shown in dashed lines.

FIG. 43 is a front plan view of a segment of a footrope that may be the center of the footrope that is formed of multiple of the footrope unit bodies of FIG. 41.

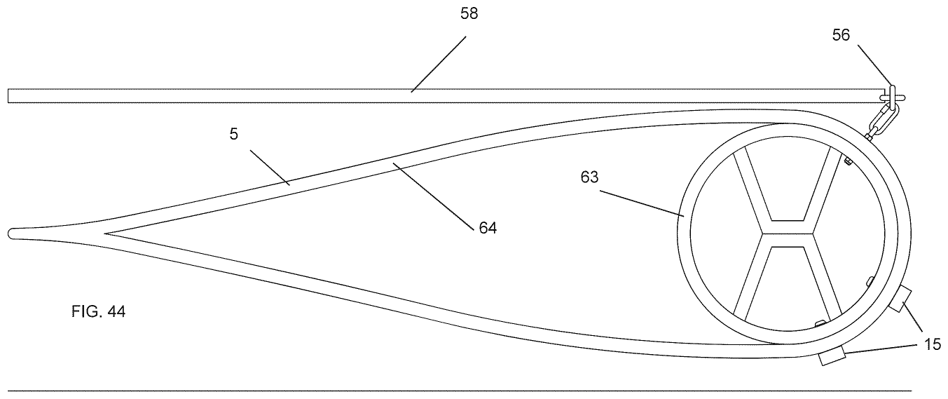

FIG. 44 is a side plan view of an alternative footrope unit body construction having a teardrop shaped airfoil profile in side plan view, where the footrope unit body 5 is formed from a cylindrical structure 63 to which is attached a flexible wall structure 64 that may be a plastic wall or that may be a pliable material, that may be conveyor belt material, to make the teardrop form in side plan view. In certain embodiments, the cylindrical structure 63 may be formed of a pliable material or sheet and have an internal strut structure to provide support to its desired form. The unit body 5 may be connected to the fishing line at the upper region of its forward-facing convex surface.

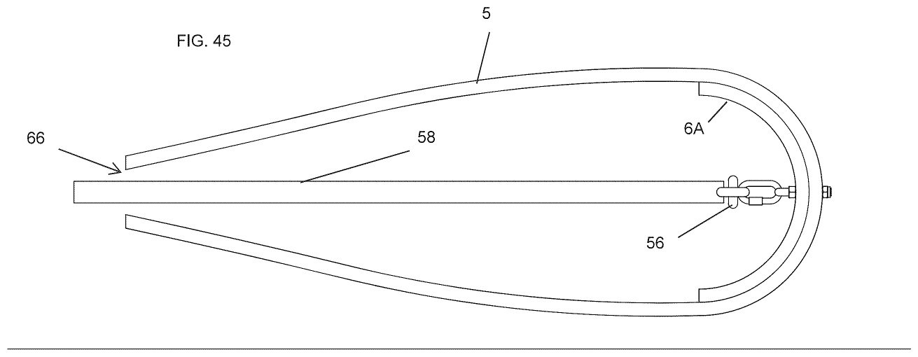

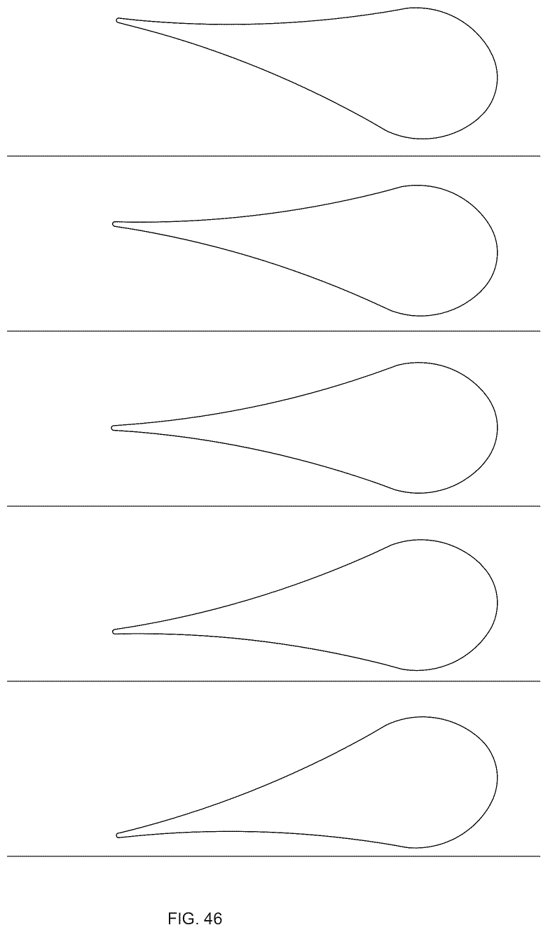

FIG. 45 is a side plan view of an alternative footrope unit body construction having a truncated teardrop shaped airfoil profile in side plan view that is open at its narrow and trailing end 66, and is configured to receive a portion of the bottom netting panel 58 proximal the fishing line 56 as well as the fishing line 56 into the interior of the unit body 5, and to attach to the fishing line 56 at the interior side of its forward facing surface, where the attachment point may be about midway between the upper and lower edges of its forward facing surface. A body having in side plan view a half an annulus 6A, as may be formed of a filleted plastic pipe that is cut into segments having a half annulus side plan view may provide a rigid structure to which the fishing line is attached and to which the remainder of the unit body 5 also may be attached, where the remainder of the unit body 5 may be formed of any suitable material, especially material that permits being deformed and returning back to its original form.

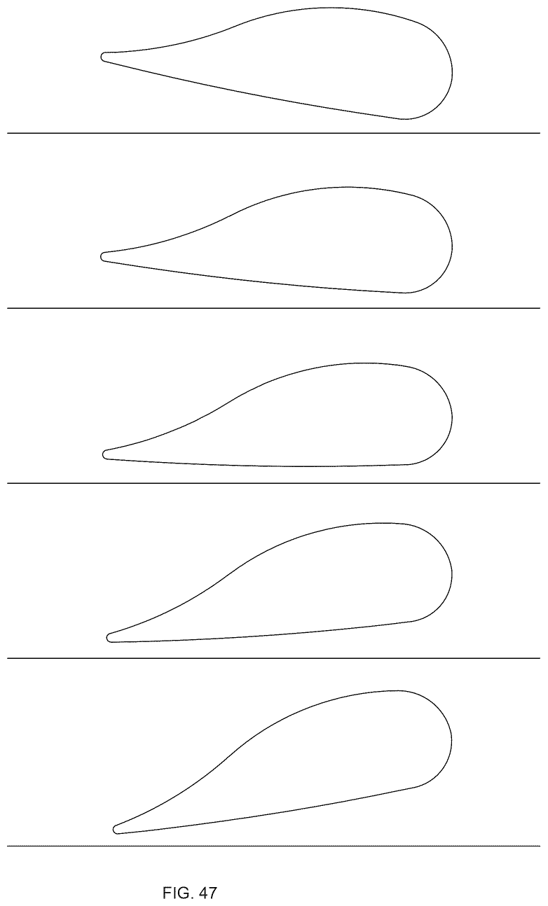

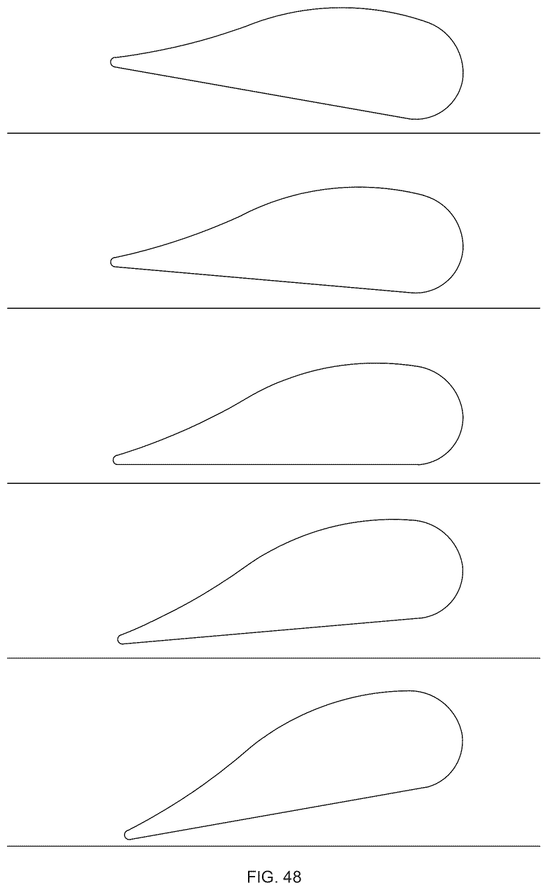

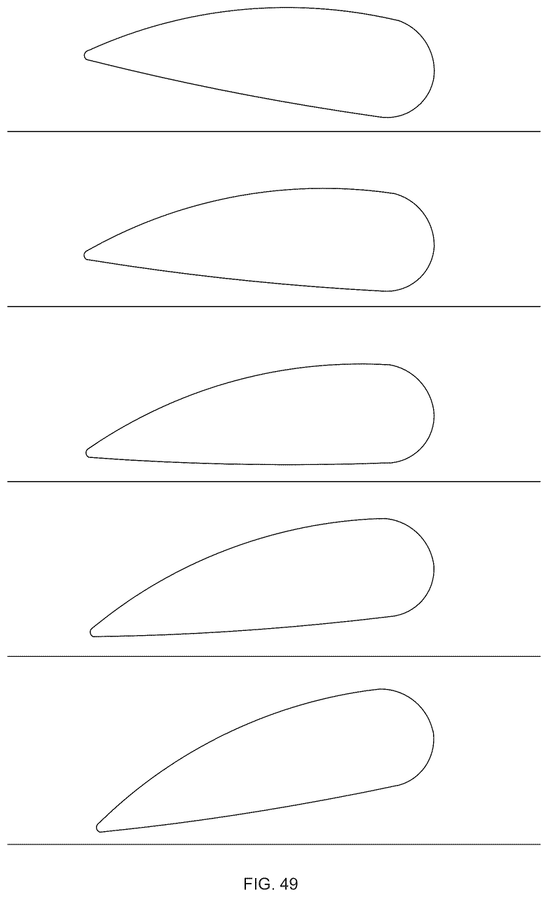

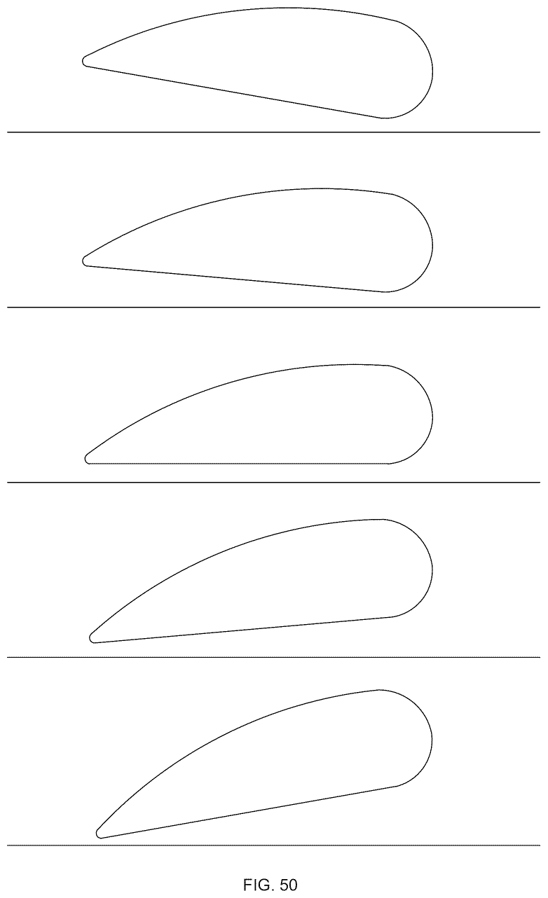

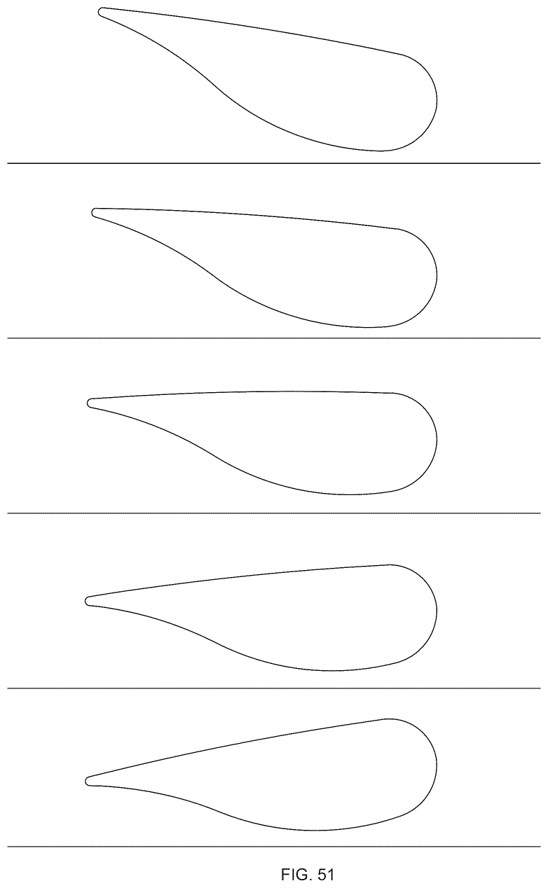

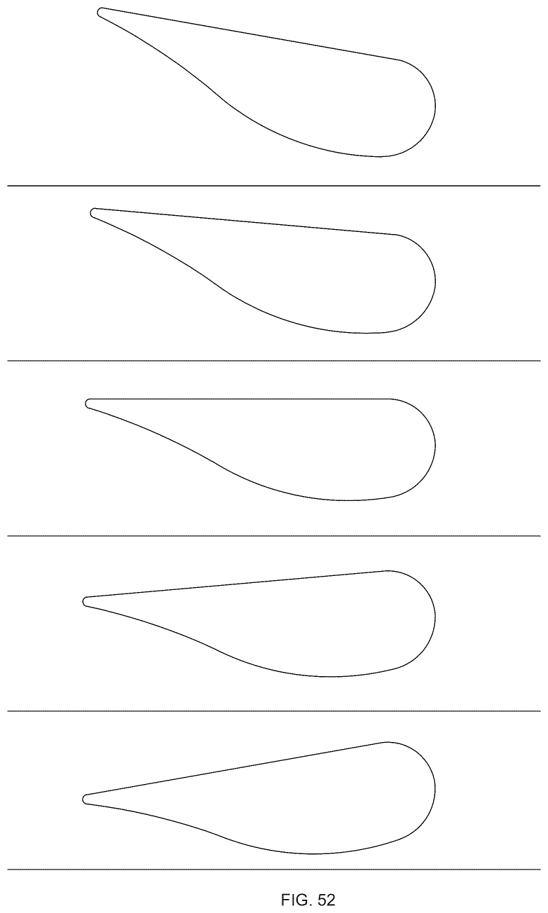

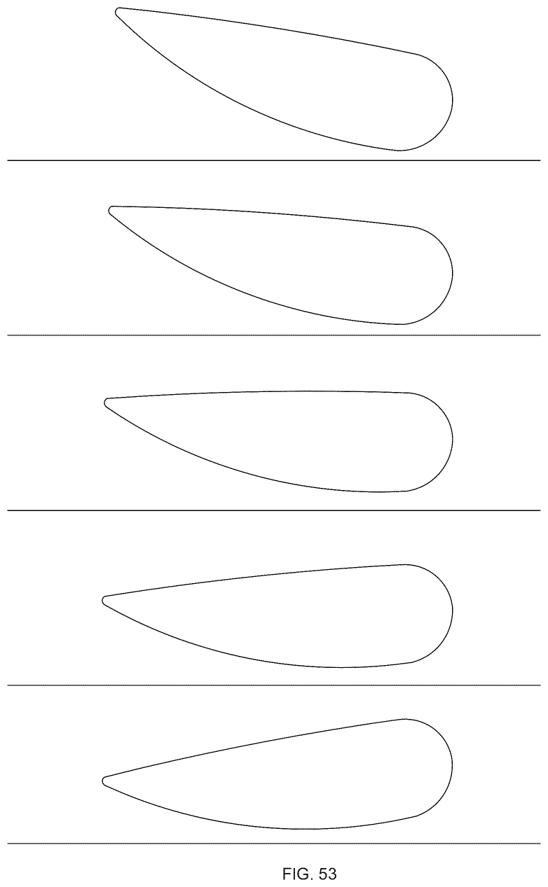

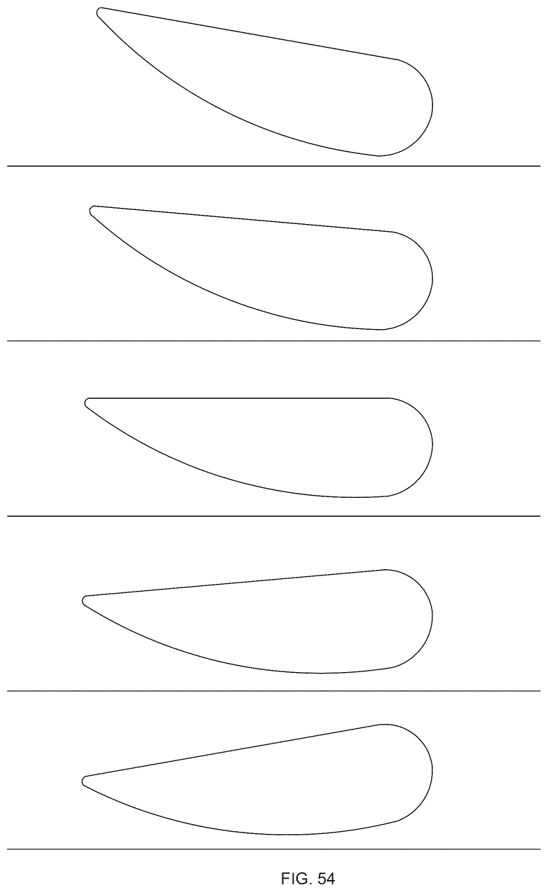

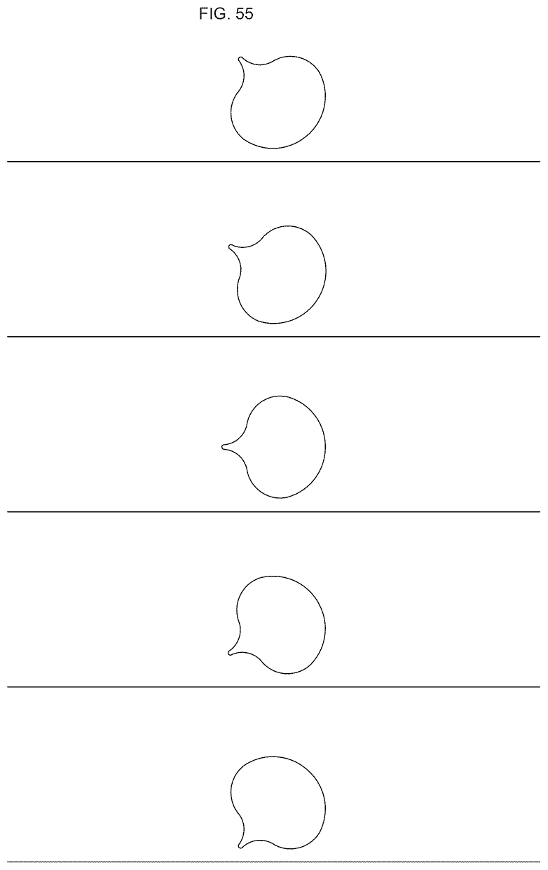

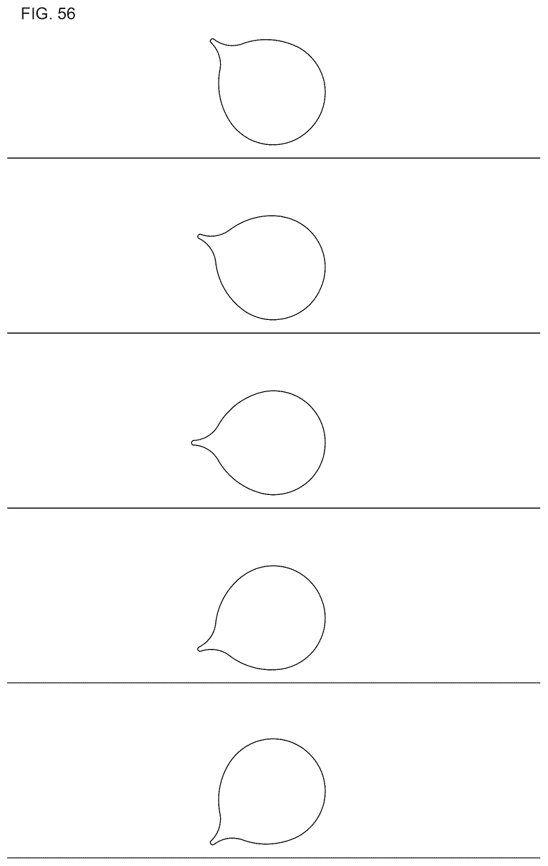

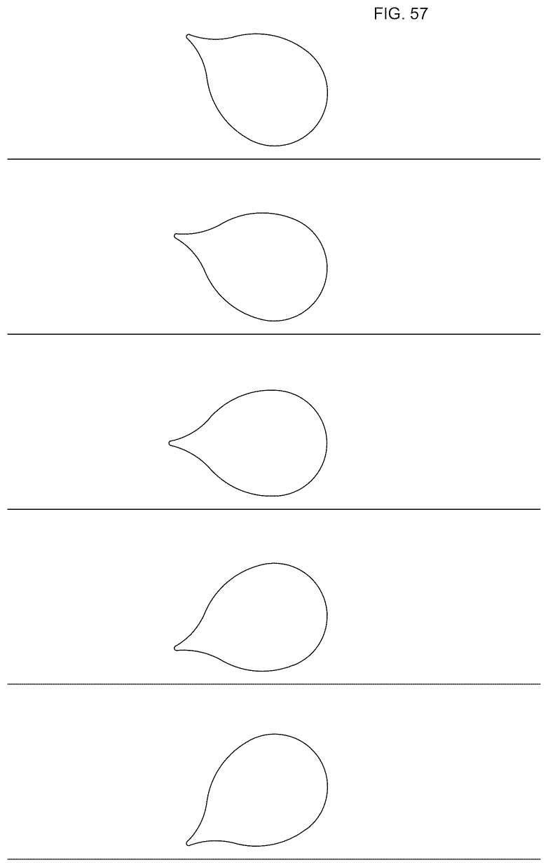

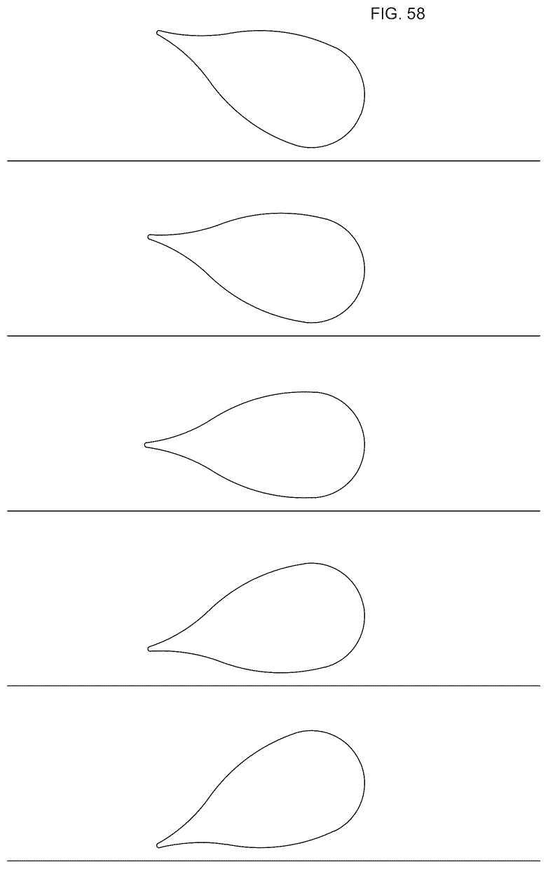

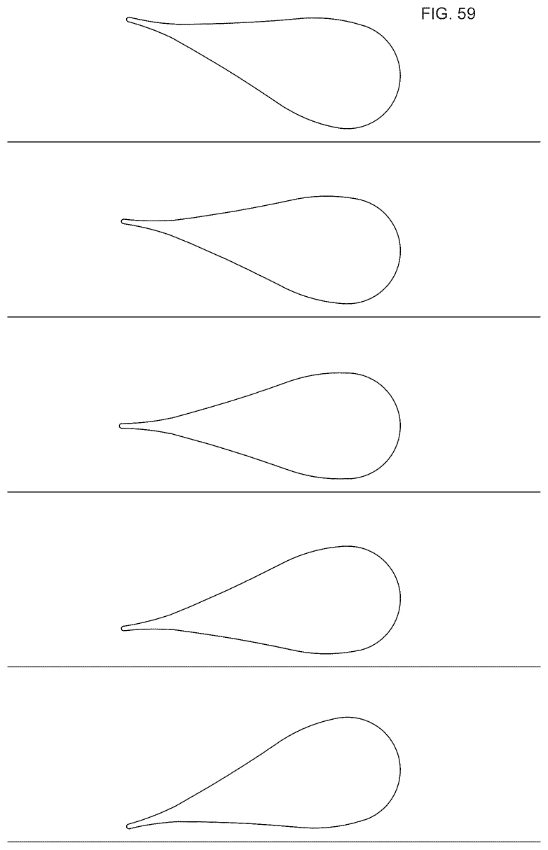

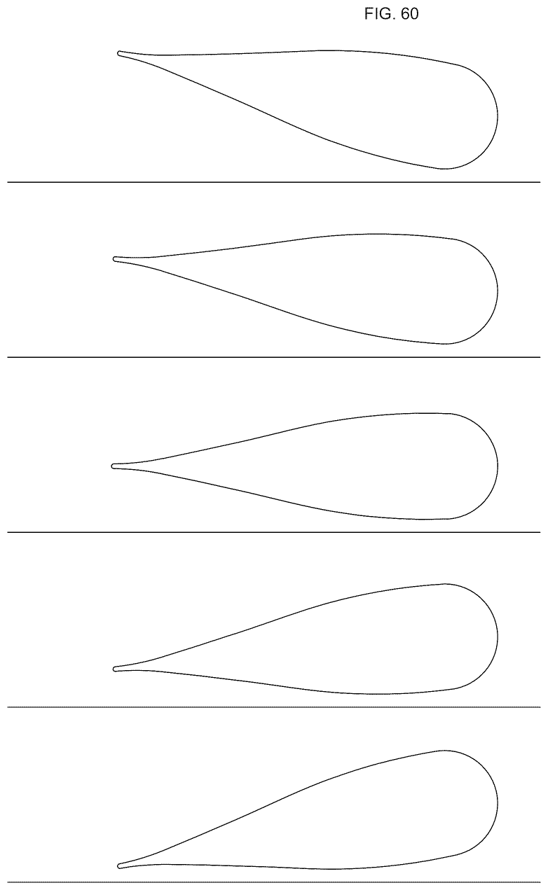

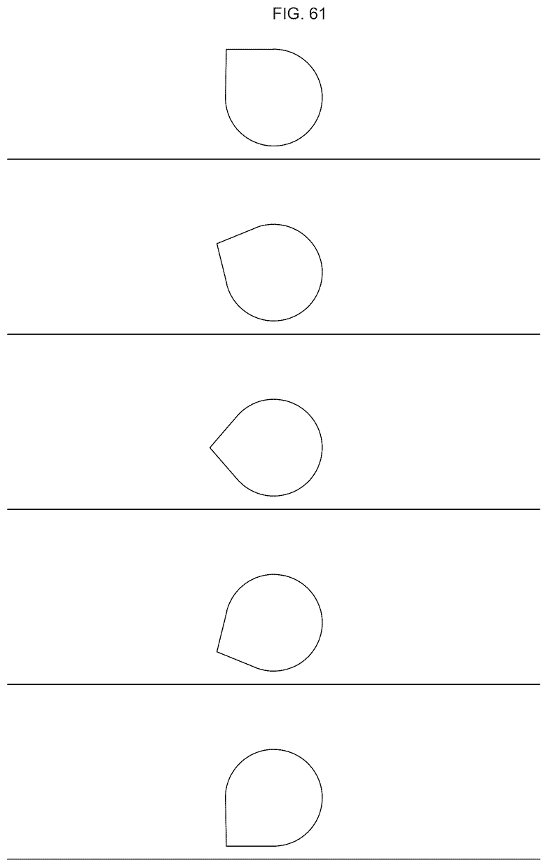

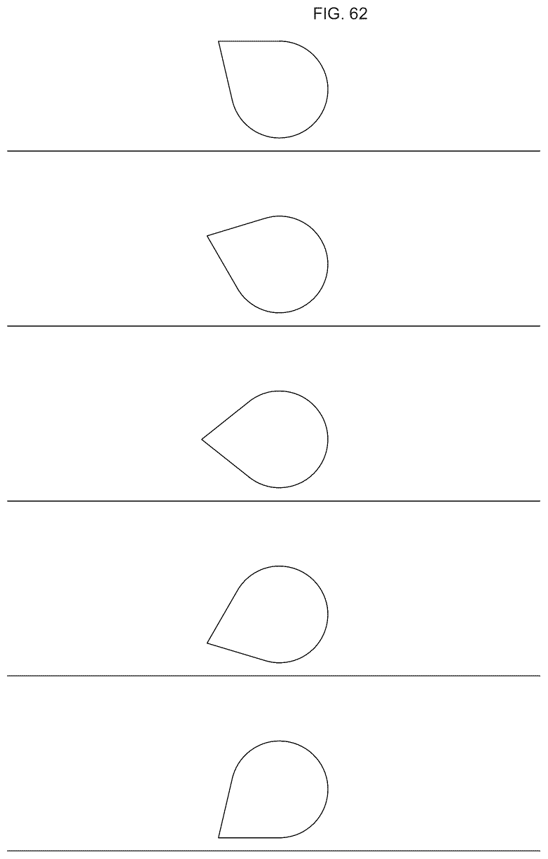

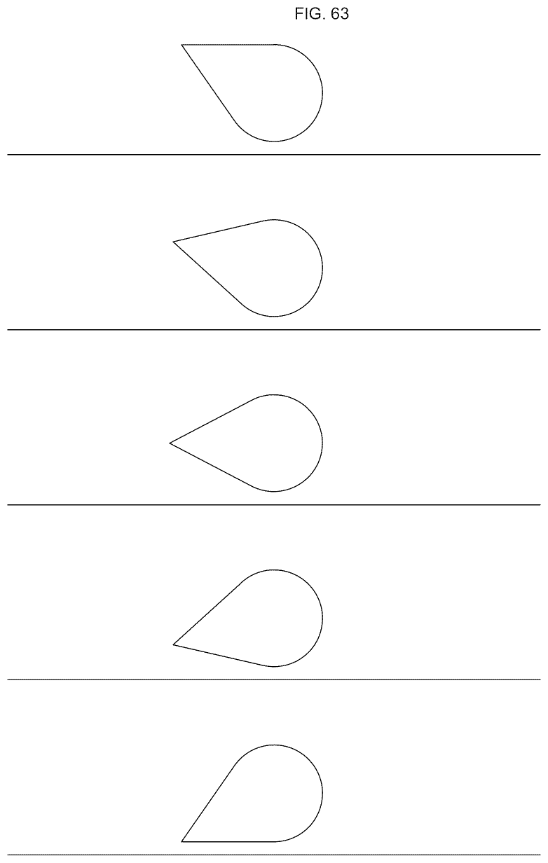

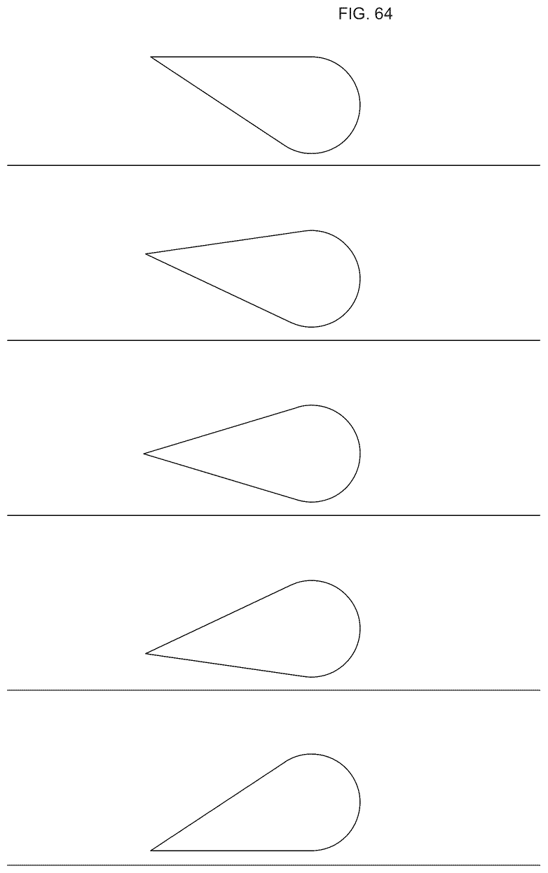

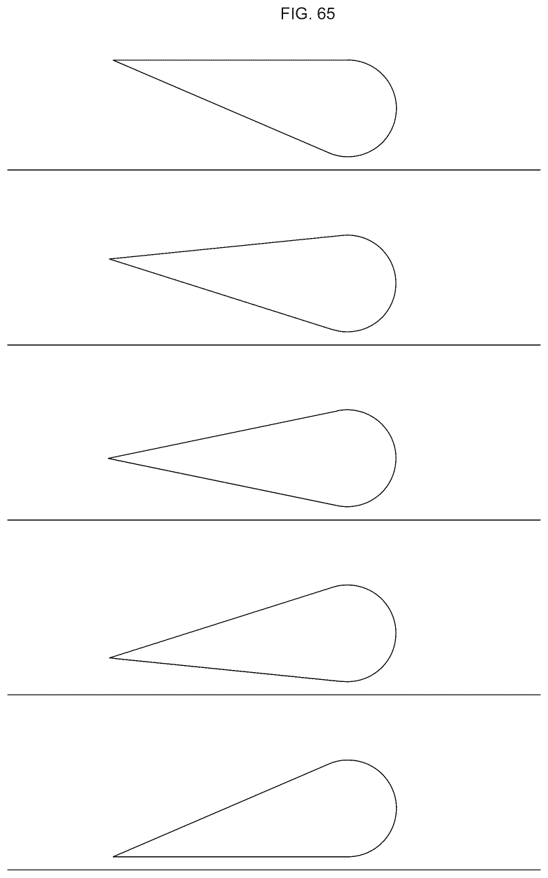

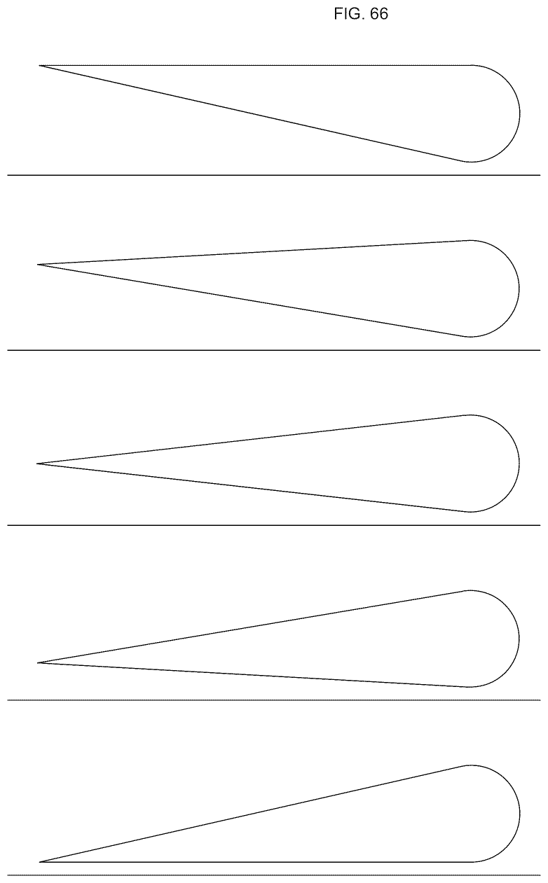

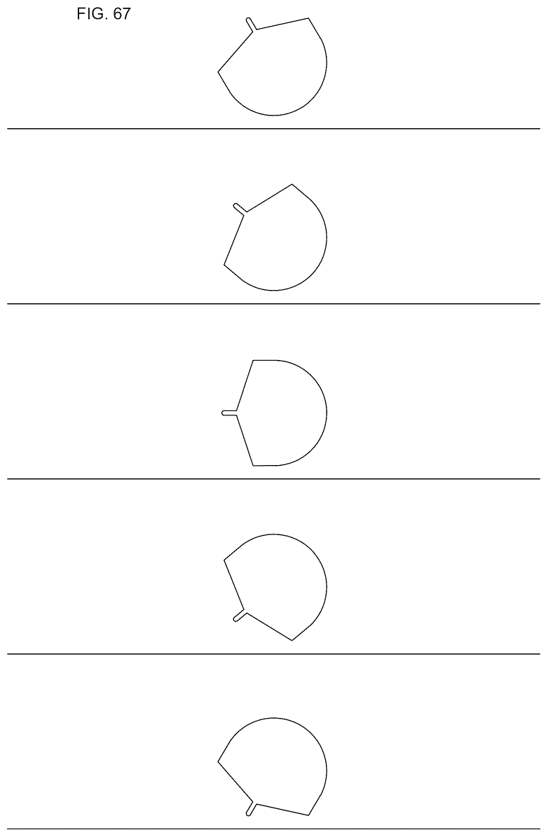

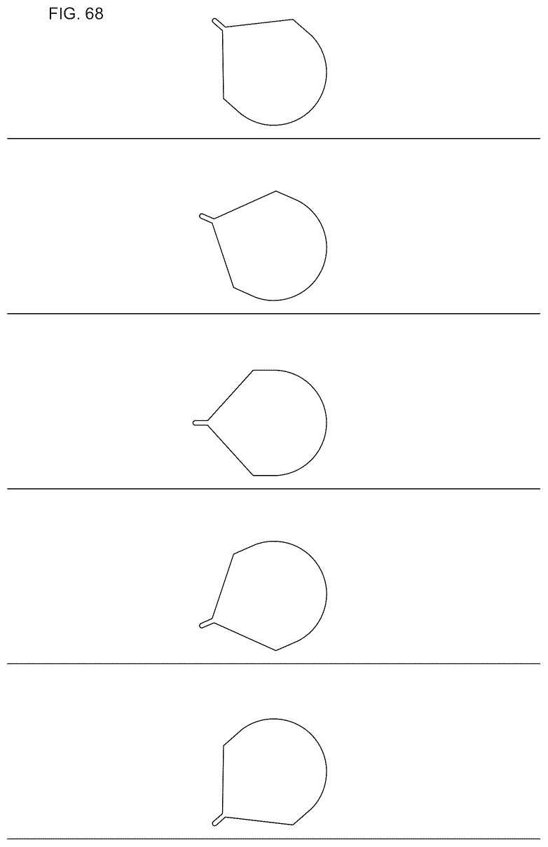

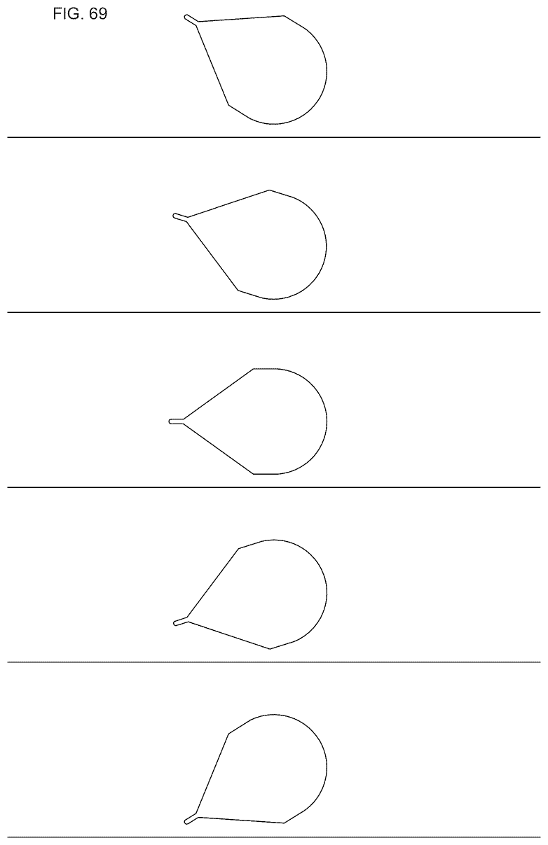

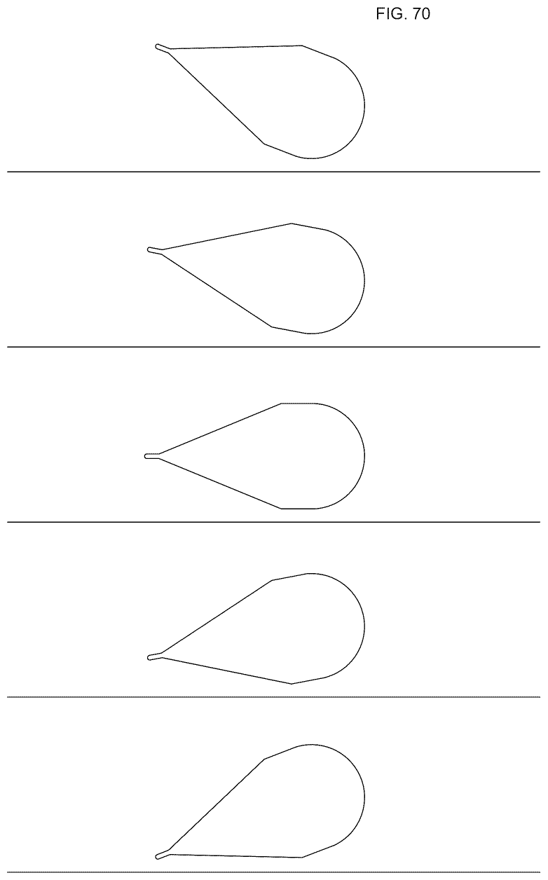

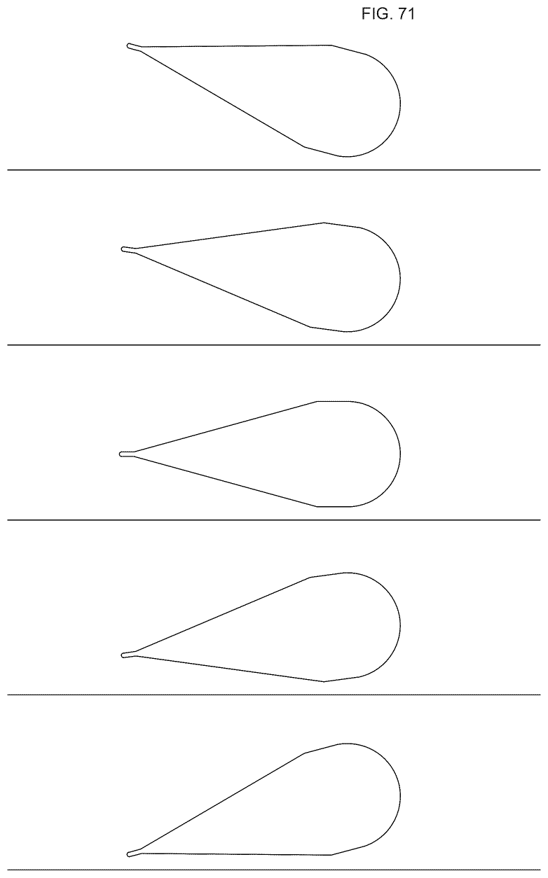

FIG. 46 to FIG. 72 illustrates certain airfoil profiles particular to each FIG., where the airfoil profile is shown in each FIG. in various “tilts” and orientations relative to the level bottom representing how they would be configured to be oriented when attached to the trawl's fishing line or footrope main tow chain, the exact orientation for each airfoil type to be experimentally determined as useful. The shorter airfoil profiles are may be useful mainly in the footrope wings, whereas the longer airfoil profiles may be useful in the center of the footrope. The footrope may comprise in combination airfoil profiles with cambered and/or bent plate profiles, especially where the airfoil profiles are situated in the center of the footrope.

FIG. 73 illustrates a back plan view of a portion of a footrope of the present disclosure that in the instant example is the center of the footrope, where footrope unit bodies 5 are configured to overlap each other by means of flanges 71 (shown on the port side footrope unit bodies) and flanges 72 (shown on the starboard side footrope unit bodies), whereas central footrope unit body 73 has two flanges, one on each lateral side. The overlapped regions of footrope unit bodies are shown in dashed lines. Part or all of the footrope may be constructed with overlapping footrope unit bodies, that may be flanged, or that simply may be connected to the main tow chain of the footrope and/or fishing line of a trawl in such a fashion that they overlap.

In another particularly presently preferred embodiment, the bodies are formed of a cambered wall formed from plastic and/or synthetic material, where the portion of the wall formed from the plastic and/or synthetic material comprises a “half of an annulus” form in at least most of its cross section, and where the different thickness of the body is formed by attaching at least one portion of metal and/or solid material and preferably attaching a plurality of portions of metal and/or solid material to at least one and preferably a plurality of portions of the plastic and/or synthetic wall comprising a “half of an annulus” form in at least most of its cross section, thereby forming at least and preferably a plurality of bodies comprising the convex exterior forward facing and comprising a wall having at least one region of the wall having a different thickness in comparison to at least one other region of the wall.

A method for the construction of the particularly preferred embodiment described immediately above that comprises a “half an annulus” in cross section comprises steps of providing a SCG plastic plate, providing at least one portion and preferably a plurality of portions of metal and/or solid material, and attaching the portion(s) of metal and/or solid material to the SCG plastic plate. Preferably, the portion(s) of metal and/or solid material is/are attached to regions of the SCG plastic plates that are situated between the lower terminal edge of the SCG plastic plate and the connection of the main tow chain to the SCG plastic plate and/or the connection of the bottom trawl's fishing line to the SCG plastic plate. Preferably again, the portions of metal and/or solid material are formed as elongated strips and/or plates of metal and/or solid material are lesser in length in comparison to the width W of the SCG plastic plate to which they attach, such as by way of example may be one to six centimeters lesser. Preferably, two and/or at minimum two of such elongated strips and/or plates and yet more preferably three and/or at minimum three of such elongated strips and/or plates are attached to the regions of the SCG plastic plates that are situated between the lower terminal edge of the SCG plastic plate and the connection of the main tow chain to the SCG plastic plate, and preferably the elongated strips and/or plates of metal and/or solid material are situated parallel to one another. Preferably, the elongated strips and/or plates of metal and/or solid material are attached to the forward facing surface of the SCG plastic plate, thus forming a particularly preferred construction of the present invention. Alternatively, plastic and/or synthetic material may be bolted, welded, adhered and/or otherwise connected to the exterior of the SCG plastic plate in order to form the region or regions having a greater thickness in comparison to the remainder of the wall of the SCG plastic plate. Yet alternatively again, another method for forming a body comprising a SCG plastic plate differing from known SCG plastic plates in that it has a region or regions to its wall that are thicker in comparison to the remainder of the wall of the SCG plastic plate is to extrude plastic such as HDPE or HMPE through a die having the desired shape, or through a die having a shape of a annulus except that the annulus includes enlarged regions of greater thickness in comparison to the majority of the annulus' wall, and then cutting the extruded pipe in half so as to arrive at two half annuluses each having an enlarged region and/or regions in comparison to the remainder of the half annuluses wall.

In yet another presently preferred embodiments of the footrope unit body of the present disclosure, where the footrope unit bodies are formed of cambered and/or bent plates, i.e., where the wall 6 of the footrope unit body has a convex forward facing surface and a concave rearward facing surface, the wall preferably may be formed from plastic and/or synthetic material, that may or may not be combined with steel or metal or other natural material, and the wall 6 of the footrope unit body has regions having differing thicknesses. That is, each of at least some of and preferably all of the plurality of the interconnected bodies cambered plates forming the footrope have regions of their cambered plate that have a thickness that differs from a thickness of other regions of the same cambered plate. In a particularly preferred embodiment, the regions of the plate situated below the main tow chain may have a thickness that is greater in comparison to the thickness of the cambered plate in regions of the cambered plate situated above the main tow chain.

For purposes of the present disclosure, and strictly when referring to the inventions disclosed in the present disclosure and not when referring to the prior art, the term “plate” or “sheet” includes: a structural element which is characterized by a three-dimensional solid whose thickness is lesser than its other dimensions, and, where the thickness is not necessarily uniform.

In another particular embodiment of the present disclosure, the footrope of the present disclosure is formed of a series of interconnected bent plates comprising in one preferred embodiment a plurality of cambered plates each having a convex forward facing outer side surface, and a concave surface opposite the forward facing outer side surface, where some regions of preferably all, and at least some, of the cambered plates have regions that have differing thicknesses, that is, each of at least some of and preferably all of the cambered plates forming the footrope have regions of their cambered plate that have a thickness that differs from a thickness of other regions of the same cambered plate. In a particularly preferred embodiment, the regions of the plate situated below the main tow chain may have a thickness that is greater in comparison to the thickness of the cambered plate in regions of the cambered plate situated above the main tow chain.

In more detail, in one preferred embodiment of the present disclosure, the footrope of the present disclosure is formed of a series of interconnected bent plates comprising in one preferred embodiment a cambered shape, and in another preferred embodiment comprising a cambered shape comprising an arc of a circle when viewed in cross section and/or a portion of an annulus when viewed in cross section, that may be half of an annulus, and in another preferred embodiment comprises a variety of cross sectional shapes that, preferably but not necessarily, may comprise a cambered shape comprising all, most or at least some of the bent plates' lower portion (i.e. that portion of the bent plate that is situated below the connection of the bent plate to the main tow chain) configured such that the bent plate is configured so that its forward facing side comprises a convex cambered shape for all and/or most and/or at least some of its lower portion, where the cambered region of said lower portion cambered body may comprise in cross sectional view an arc of a circle and/or a segment of an annulus and/or a semi-circle in outline when viewing its exterior forward side surface, or where the entire exterior side surface of the plate body portion of the cambered plate comprises in outline an arc of a circle including but not limited to a semicircle and/or comprising a plate having at least a portion of the plate comprising a cambered plate, where the plate exhibits a non-uniform thickness (i.e. where different regions of the same cambered plate exhibit and/or have differing thicknesses; for example, where the region of the cambered plate situated at and also below and/or below the connection of the cambered plate to the tow chain (and/or the connection of hardware that is mounted to the cambered plate where such hardware is used for connecting the tow chain to the cambered plate) includes regions of the bent and/or cambered plate having greater thickness in comparison to other regions of the cambered plate (when measured from free forward side surface to free back side surface and including any and all features including the bent plate as well as any additional plates and/or additional layers of solid material attached to the bent plate). Most preferably, the lower portion of the plate, that is the portion of the plate below the connection point of the plate to the tow line (the terms “tow chain” and “tow line” being interchangeable for purposes of the present disclosure), comprises one or more regions that is greater in thickness in comparison to the thickness of at least some regions of the plate forming the upper portion of the plate, that is the portion of the plate above the connection point of the plate to the tow chain. Surprisingly, shockingly, unexpectedly and contrary to the prior art, against the trend in the industry, and against the widely held belief of those in the industry, such a configuration of the present disclosure's bent plate footrope actually reduced the dust cloud formed by the gear in comparison to known gear while simultaneously resulting in a catch efficacy sufficient to obtain interest from industry participants to utilize the present disclosure's low impact footrope.

One method to form such a bent cambered plate of the present disclosure is to form it using a mold and to form it from a plastic including a thermoplastic. Another method to make such a bent cambered plate of the present disclosure is to provide a half-pipe, preferably formed of thermoplastic such as HDPE, to then cut the half pipe into a plurality of segments so as to provide a plurality of cambered plate segments having a semi-circle cross-sectional shape, and to affix layers of material to individual of those segments at regions of those segments corresponding to that portion of the bent plates of those segments that are configured to be situated and/or are intended to be situated and/or are situated below the tow chain when the bent plate segments are situated in the finished footrope. The additional material may be situated on the bent plastic plate either when it is present in a complete plastic pipe; or after cutting a plastic pipe and forming a plastic half-pipe (i.e. attaching the additional layers of material to the half-pipe); or by attaching the additional layers of material to the segments of cut half-pipe that form the present disclosure's cambered plates having a semi-circular cross-sectional shape to at least the portion of the bent plastic plates that were obtained by cutting a plastic pipe.

In another preferred embodiment, the plate is of either continuous or alternating thickness, where a top region of the plate is affixed to the fishing line of a bottom trawl and where a central region of the plate is affixed to the main tow line of the trawl's footrope, and where the bottom region of the plate is configured so as to comprise a layer of solid material affixed to the bottom region of the plate so as to form an enlarged region to the thickness of the plate when the layer of solid material and the plate's own thickness are added together, and where the layer of solid material can be formed of plastic, including of the same plastic forming the plate, such as by cutting a pipe of the same camber as the plates camber and then taking a an portion of the cut pipe comprising a smaller arc of a circle than the arc of the circle of the plate, and attaching that portion of pipe comprising a smaller arc of a circle to the surface of the cambered plate in such a way that the concave side of one contacts the convex side of another. In one preferred embodiment, the additional layer of solid material is situated on the rear-facing side and/or the concave side of the main plate. In another embodiment, it is situated on the forward-facing side. It had been contemplated that it would be best to situated the additional layer of material on the rear-facing side of the cambered plate in order to preserve the smooth exterior surface of the forward facing portion of the main plate and especially of its lower region (the region of the plate below the attachment point to the tow line, where the tow line could be a chain) in order to preserve the smooth exterior forward facing surface of the main plate as it was widely held by all those in the industry that a smooth forward facing surface to at least the lower portion of the plate was essential to facilitate its deflecting over and/or “riding over” obstacles. However, in experimentation with situating the extra layer of material both on the rear-facing as well as on the forward facing portion of the main plate and below the attachment point to the main tow chain/tow line and below the hardware attaching the plate to the main tow chain/tow line, it was found surprisingly, shockingly, unexpectedly and contrary to the prior art, against the trend in the industry, and against the widely held belief of those in the industry, that such a configuration actually reduced the dust cloud formed by the gear in comparison to known gear while simultaneously resulting in a catch efficacy sufficient to obtain interest from industry participants to utilize the present disclosure's low impact footrope whereas the industry was not willing to utilize known semi-circle gear footropes.

In a further version of this embodiment, the additional layer of solid material was formed of a metallic half-pipe affixed to the main semi-circle plastic plate proximal the bottom of the plate and preferably covering the front side of at least a portion of the bottom of the plate, preferably in a row spanning all or most of the plate's width. Despite this construction of a semi-circle footrope being contrary to the prior art, against the trend in the industry and against the widely held belief of those in the industry, that belief and trend and prior art being that the semi-circle gear must be as light weight as possible when measured submerged in either sea water and/or fresh water so that the cambered semi-circle plates are not able to press upon the ocean and/or sea floor by virtue of their own weight and rather are actually being forced upward away from the ocean and/or sea floor by water pressure resultant of the forward motion of the entire footrope during towing by a vessel during trawling operations, the present disclosure's semi-circle footrope exhibits a lesser dust cloud and lesser bottom impact in comparison to the prior art, despite having a greater and/or heavier weight when measured submerged in sea water and/or fresh water.

At present and at the time of writing this text, the physical phenomenon responsible for the lesser dust cloud formation of semi-circle gear of the present disclosure in comparison to prior art and in comparison to semi-circle gear of the prior art is not entirely understood. However, it is observed in trials that the prior art semi-circle gear “rides” or “fishes” with greater contact with the bottom of the ocean and/or sea in comparison to the present disclosure's semi-circle gear. One theory is that the known semi-circle gear's smooth forward facing exterior cambered surface acts like an upside down wing and thus pulls the gear down to the bottom of the sea and/or ocean, whereas by enacting the teachings of the present disclosure and thickening especially the lower portion of the plate, which if considered as an airfoil would comprise the rear portion of the airfoil's cross section, has an effect of spoiling the flow of fluid (water) around the cambered plate and thus reducing the downward pull of the gear against the bottom of the sea and/or ocean, which, if the theory is correct, would account for the lesser dust cloud formation.

When forming the plate's discontinuous thickness without assistance of a mold but by adding a layer of material and/or a plurality of layers of material at various locations along the main plates surface, most preferably, the additional layer of material formed of either plastic, steel and/or other metallic commences at the bottom edge of the plate and/or more proximal the lower edge of the plate than proximal to the upper edge of the plate, so as to cause a thicker aft portion to the “airfoil” and/or “hydrofoil” of the plate, thus damaging the flow properties of the cambered surface of the plate and reducing the downward pull of the plate toward the bottom of the sea and/or ocean, that is to be protected.

In one embodiment, the additional layer of solid material is situated in a space extending beyond the bottom edge of the plate, spans the entire horizontal width of the plate and/or the majority of the horizontal width of the plate, and also extends towards the upper region of the plate a distance that is at least eleven millimeters but preferably is in a range of from a minimum of four centimeters to a minimum of twelve centimeters.

Surprisingly and unexpectedly, a footrope formed with an series of interconnected cambered plates formed as described above and configured with at least a convex cambered surface directed forward towards the trawl's open mouth when the plates are in the central region of the footrope and/or inward and aimed at an opposite side wing when the plates are situated in the footropes wing, has shown surprisingly lesser dust cloud generation compared to known footropes while surprisingly and unexpectedly sufficiently conserving efficacy of allocated quota harvest to at least an extent that it is contemplated that industry participants shall be willing to adopt use of the present disclosure's more environmentally protective footrope in place of presently used and less environmentally protective footropes.

In one embodiment of the present disclosure, the cambered plates are formed by first providing a plurality of bent plates formed of a plastic material having a uniform wall thickness and a cross-sectional shape comprising an arc of a circle, such as can be accomplished by cutting a plastic pipe of desired diameter into two and/or at least one length of half pipe, then cutting a length of half pipe into multiple segments, then attaching at least one layer of a solid material affixed to and covering and/or mainly covering the lower half of the forward facing exterior lower region of the bent plastic plate formed from the cut half-pipe segments, so that the layer of solid material (that can be plate steel that can be bent to a camber that matches the plates camber in the region it is affixed to the plate, or that can be a plastic layer, also ideally bent to match the main plate's camber) extends from at least the lower edge of the plate to at least eight centimeters distant from the lower edge of the plate in the direction toward the plate's upper edge.

In another embodiment, the solid additional layer of material covers both the lower forward region of the plate as described above while also covering the terminal lower edge of the plate itself.

In another embodiment, the additional layer of solid material formed of plastic, steel and/or metal covers both the lower forward region of the plate as described above while also covering the terminal lower edge of the plate itself and also covering at least some of the back side surface of the lower region of the plate.

Surprisingly and unexpectedly and contrary to the trend of the industry and against the widely held beliefs and presumptions of those skilled in the field, the above described embodiment of the present disclosure demonstrates a lesser dust cloud in comparison to known used footropes with concurrent acceptable efficacy of catch operations in comparison to known used footropes, thus accomplishing the goals of the present disclosure and satisfying needs long felt in the industry.

In one particularly preferred embodiment, the cambered plates themselves are formed of plastic, such as a thermoplastic such as HDPE, and can be made by cutting a plastic pipe in half along its long dimension, and the cutting the half-pipe fillet into sections that, preferably, have a width greater than their height (the width measured from side edge to side edge, and the height measured from the upper edge to the lower edge of the plate when it is situated in the fully assembled footrope). Then, layers of either plastic or steel are affixed to the regions the plates as described above.

In another particularly preferred embodiment of the present disclosure, the present disclosure's footrope is formed of a plurality of main cambered semi-circle plates comprising both cambered main plates formed of plastic as well as distinct cambered main plates formed of metal such as steel. The cambered main plates formed from plastic can be formed from a half-pipe as described above, or by use of a mold, and can either possess or lack an additional solid material layer at the lower region of the plastic plate, and also include steel and/or metal plates, whereas the metal cambered main plates can be formed by bending metal plates into a suitable camber (preferably pre-cut metal plates are bend to the suitable camber, however, the plates also can be further cut and shaped after being bent to the desired camber), and the footrope is formed of a combination of the plastic cambered plates and the steel and/or metal cambered plates, where the plastic and metal plates may be situated alternately along the length of the footrope so that every other cambered plate is formed of plastic (or mainly of plastic) or steel. That is, the plastic and metal plates may be situated alternately along the length of the footrope so that at least some length of the footrope has alternating plastic and metal plates. Or, the center of the footrope may have mainly or exclusive metal plates while the wings of the footrope have exclusive or mainly plastic plates, that is one presently preferred construction of the present disclosure's footrope. In all embodiments of the present disclosure's footrope that include forming the footrope with a combination of both (a) cambered plates formed entirely or mainly of plastic; and (b) other cambered plates formed entirely or mainly of metal, it presently is preferred that the metal plates extend lower in absolute distance below the footropes main tow line in comparison to the plastic plates and/or non-metal plates.

Surprisingly and unexpectedly and contrary to the trend of the industry and against the widely held beliefs and presumptions of those skilled in the field, the above described embodiment of the present disclosure demonstrates a low dust cloud in comparison to known used footropes with concurrent acceptable efficacy of catch operations in comparison to known used footropes, thus accomplishing the goals of the present disclosure and satisfying needs long felt in the industry.

### Rigidly Attached Connection Hardware Embodiments:

The present disclosure's footrope is also based upon the surprising and unexpected discovery that, contrary to the prior art and against the trend in the industry and contrary to the widely held beliefs of those in the industry, a semi-circle gear footrope formed with hardware (“hardware” in this text shall include also meaning at least one solid body and/or solid object) rigidly and/or permanently affixed and/or mounted and/or attached (and/or formed into) and/or connected to a cambered plate footrope unit body (including but not limited to a SCG plate), and/or rigidly connected to and/or formed into another footrope unit body of the present disclosure, where such hardware and/or at least one solid body and/or solid object is configured to be capable of being connected to the main tow chain and/or main tow line and/or fishing line, results in lesser dust cloud formation in comparison to the prior art, while also providing a sufficiently efficacious fishing efficacy to cause it to be adopted by the industry, thus satisfying a long felt need in the industry.

Accordingly, in one embodiment of the present disclosure, the footrope of the preset disclosure comprises a footrope unit body comprising a cambered plate having a convex forward facing surface and having a concave rear facing surface, the footrope unit body further comprising a solid object rigidly attached to the cambered plate, where the solid object is configured to permit joining the footrope unit body to a tow chain of the footrope and/or to a fishing line of a trawl. In one preferred embodiment, the solid object rigidly attached to the cambered plate and configured to permit joining the footrope unit body to the tow chain and/or fishing line of a trawl is attached to the rear facing side surface of the cambered plate.

Furthermore, the footrope unit body additionally may comprise at least one spanning bridge comprising a solid object spanning the back side of the cambered plate (and, most preferably, comprises two and/or a plurality of spanning bridges each comprising a solid object spanning the back side of the cambered plate, most preferably wherein at least one the spanning bridges spanning the back side of the cambered plate proximal the lateral edges of the back side of the cambered plate is situated to span at least one lateral edge of the back side of the cambered plate; and, yet more preferably, where each lateral edge of the back side of the cambered plate has at least one of the spanning bridges spanning it. Most preferably, the spanning bridges spanning the back side of the cambered plate extend from an upper edge to a lower edge of the cambered plate, however, in other embodiments, the spanning bridge are located recessed within the concavity formed by the concave rear facing surface of the cambered plate.

In one embodiment, the bent plate gear (including but not limited to the semi-circle cambered plate gear) is equipped with hardware attached to the plate by means of bolts passing through pre-formed apertures in the plate and/or by being welded to the plate, and also being fixed with suitably situated and sized nuts and backing plates and/or washers and/or other suitable fasteners so as to provide a connection point configured to be attachable to the main tow chain where such connection point is rigidly and/or permanently and/or fixedly and/or immovably attached to the bent plate. In other embodiments, the bent plate is formed in a mold where a connection point separate and in addition to the plate body is part of the molded structure and integrally molded to the bent plate and the connection point is configured to be connectable to the main tow chain and/or main tow line and to provide a rigid and/or fixed and/or non-moveable connection between that portion of itself configured to be connectable to the main tow chain and the remainder of the bent plate, that, in the case of semi-circle gear, is that portion of the semi-circle cambered plate that is a cambered plate itself.

In other embodiments, each of the solid objects includes a convex forward facing surface, where, preferably, each of a plurality of the solid objects:
a) includes a solid and/or rigid object configured to:
i) permit affixing the solid object having the cambered cross sectional form to the bottom trawl, and, preferably, but optionally, includes a solid and rigid object configured to permit affixing the solid object having the cambered cross sectional form to the bottom trawl by being situated intermediary between the cambered cross sectional formed solid object and the trawl's main tow line/tow chain, and, preferably, but optionally,
ii) permit affixing a main tow line of the trawl to an exterior portion of a wall defining at least a portion of the solid object; preferably where the exterior portion of the wall is facing rearward and is opposite an exterior portion of the wall that is facing forward, and where, preferably, the portion of the wall facing forward has a convex cambered forward facing surface.
b) where a each of a plurality of the solid objects may have a width greater than their height when viewed in a front plan view of their forward facing surfaces when arranged and situated in the finished footrope; or, may have a greater height than their width when viewed in a front plan view of their forward facing surfaces when arranged and situated in the finished footrope.

In embodiments of the present disclosure, the present invention comprises a footrope unit body of the present disclosure, (such as may be a bent plate gear footrope unit body, including but not limited to such as may be the semi-circle cambered plate gear, that may be formed of steel or other metal or that may be formed of plastic or other material) that is equipped with a rigid and/or immoveable solid body connected to and/or formed into the remainder of the footrope unit body, where the solid body is configured to be connectable to the/a main tow chain of the footrope and/or fishing line of a trawl, thereby causing the remainder of the footrope unit body itself to be connected to the main tow chain of the footrope and/or fishing line of a trawl when the rigid and/or immoveable solid body is itself connected to the main tow chain of the footrope and/or fishing line of a trawl.

In other embodiments, the connection of the solid body to the main tow chain of the footrope and/or fishing line of a trawl is by welding and/or otherwise connecting a ring or chain link or other solid object to at least a portion of the wall of the cambered plate footrope unit body that preferably is the rear facing wall 8 so as to form a solid body comprising an aperture permanently connected to the rear facing wall 8 of the footrope unit body formed from the solid body, where there may be two of such solid bodies each comprising an aperture connected to the rear facing wall 8 of the footrope unit body, and attaching the main tow chain of the footrope and/or fishing line of a trawl to at least one and preferably two or a plurality of such apertures (where the apertures may for example be formed by connecting a ring or chain link or U bolt or other suitably configured object to the rear facing wall 8 of the footrope unit body) by means of a connector that connects at least one link of the main tow chain and/or fishing line of the trawl to at least one solid body having at least one such aperture.

### Moveable Connection Embodiments

Surprisingly, and contrary to the prior art and trend in the industry, the present disclosure's moveable connection embodiments for connecting footrope unit bodies including but not limited to SCG footrope unit bodies has been found to exhibit dramatically lesser environmental impacts to the sea and/or ocean floor than known moveable connections of the known art, as demonstrated by dramatically lesser drag forces imparted to the footrope. Accordingly, such embodiments are described further below and herein:

In another embodiment of the present disclosure, the footrope unit body of the present disclosure such as may be a bent plate gear footrope unit body (including but not limited to such as may be the semi-circle cambered plate gear), that may be formed of steel or other metal or that may be formed of plastic or other material, has at least one through-hole formed into it, and a solid object is configured to be connected to the footrope unit body by having at least a portion of the solid object passed through the at least one through hole, with the solid object also configured to not be able to fall out of the at least one through hole, such as may be accomplished by selecting for the solid object a bolt or other rod or other solid body that passes through the at least one through hole and is retained at least at its forward end (the end of the bold or other rod or other solid body passing through the at least one through hole that is most proximal the forward facing surface of the footrope unit body) by an enlarged portion of itself where the enlarged portion is too large to pass through the through hole, and/or by a second solid body attached the solid body at its forward end where the second solid body is too large to pass through the through hole, where the solid body that is configured to pass through the through hold is configured to be connectable to the main tow chain of the footrope and/or fishing line of a trawl at its end that is situated on and/or at and/or protruding from the side of the plate that is opposite the footrope unit body's forward facing side surface.

In another embodiment of the present disclosure, the footrope unit body of the present disclosure such as may be a bent plate gear footrope unit body (including but not limited to such as may be the semi-circle cambered plate gear), that may be formed of steel or other metal or that may be formed of plastic or other material, has a connection assembly attached to the bent plate and/or other footrope unit body, where the connection assembly comprises at least two through-hole formed into the bent plate and/or other footrope unit body, and where a solid object such as may be a cable, chain, rope, bent rod of steel or other metal, or a suitably sized quick line, is passed through both at least two through holes, and connected to the main tow chain of the footrope and/or fishing line of a trawl on the rear facing convex surface of the bent plate or other solid footrope unit body, there connecting the bent plate and/or other footrope unit body to the main tow chain of the footrope and/or fishing line of a trawl. The at least one solid object passing through the at least two through holes may be a metal body formed like a chain link and/or a quick link, and may be connected to the main tow chain of the footrope and/or fishing line of a trawl, such as may be accomplished by using another quick link and/or other link, portion of rope or cable, a U bolt with backing plate, or other connection hardware. Alternatively, at least a pair of through holes is formed into the footrope unit body such as a bent plate footrope unit body, that may be done by forming a pair of at least two adjacent through-holes into the bent plate or other footrope unit body, where each pair of at least two through holes is situated more proximal one lateral edge of the footrope unit body than is the other, and where at least one solid object such as may be a quick link and/or other link, or where a portion of rope or cable, or where a U bolt or other solid object is passed through each of the two through holes in one of the at least one pair of through holes, so as to have protruding on the forward facing convex side surface of a bent plate footrope unit body a portion of the at least one solid object, that preferably may be a quick link and/or U bolt, and where another portion of the at least one solid object protrudes from and/or is accessible from the rear side of the wall of the footrope unit body which the through holes are formed within, and to which another portion of the at least one solid object is attached the main tow chain of the footrope and/or fishing line of a trawl, where the another portion of the at least one solid object may be configured to be attached to the main tow chain of the footrope and/or fishing line of a trawl, or may have attached to it yet another solid body that is configured to be attached to the main tow chain of the footrope and/or fishing line of a trawl, or that may be welded to the main tow chain of the footrope and/or fishing line of a trawl, thereby allowing the footrope unit body to be attached to the main tow chain of the footrope and/or fishing line of a trawl.

In another embodiment of the present disclosure, the footrope of the present disclosure comprises at least one footrope unit body of the present disclosure (such as may be a bent plate gear footrope unit body, including but not limited to such as may be the semi-circle cambered plate gear, that may be formed of steel or other metal or that may be formed of plastic or other material) that is equipped with at least one through hole through which is passed at least one solid object that is configured at one end of the solid body to be incapable of passing its entire body through the entire through hole passage, and that is configured at its other end to be capable of being connected to the and/or a main tow chain of the footrope and/or fishing line of a trawl.

In other embodiments the connection is made by passing at least a portion of the solid body through at least one portion of the main tow chain of the footrope and/or fishing line of a trawl (such as may for example be done by attaching a quick link to one wire of a chain link of the main two chain and/or fishing line); and, in another embodiment the connection is made by passing at least a portion of the main tow chain of the footrope and/or fishing line of a trawl through at least a portion of the solid body (such as may be accomplishable for example by passing the main tow chain of the footrope and/or fishing line of a trawl through the solid body where the solid body may be formed as a sleeve (including a pipe and/or a tunnel) configured to permit the main tow chain to pass through it while also permitting links of the main tow chain to be accessible on either side of the sleeve, or where the solid body is formed from a quick link (“quick link” including a chain link in this text) or through a loop of cable or rope or chain forming the solid body).

In certain embodiments of a moveable connection assembly:

Also contrary the prior art and against the trend in the industry, that may be, by way of non-limiting example, a connector that is moveably connected directly to the wall 6 and/or to the remainder of the footrope unit body 5 (such as, by way of non-limiting example, in reference to FIG. 135A-C and FIG. 136A-C, that are front plan views and side plan views, respectively, of an alternative embodiment of the present disclosure's footrope unit body that may comprise a connector 90—a quick-link connector in FIGS. 135B and 136B and a chain link connector in FIGS. 135C and 136C—directly attached to a portion of the wall 6 itself by connecting to an inter-wall span portion 91 of the wall 6 itself situated between two or a plurality of apertures 92 formed into wall 6; OR, such as, by way of non-limiting example, in reference to FIG. 137 and FIG. 138, that are front plan views and side plan views, respectively, of an alternative embodiment of the present disclosure's footrope unit body that may comprise a connector (not shown), such as a quick-link connector, where the connector is directly attached to a portion of a solid body 94 permanently connected to the wall 6 (such as by welding when the wall 6 is formed of metal), where the solid body is configured to be capable of being connected to the main tow chain and/or trawl's fishing line by the connector, where the solid body 94 may, by way of non-limiting example, be a metal rod connected to the forward side of the wall 6 itself, where at least a portion of the connector passes through an aperture 95 formed into wall 6; OR, such as, by way of non-limiting example, in reference to FIG. 139 and FIG. 140, that are front plan views and side plan views, respectively, of an alternative embodiment of the present disclosure's footrope unit body, that may comprise a connector (not shown) such as a quick-link directly attached to a portion of a solid body 94A such as may for example be a metal rod rigidly connected to the back side of the wall 6 itself (such as by welding when the wall 6 is formed of metal), where, in some examples, an aperture and/or indent 95A may be formed into wall 6 in such a fashion as to provide void space configured to permit situating the connector in place).

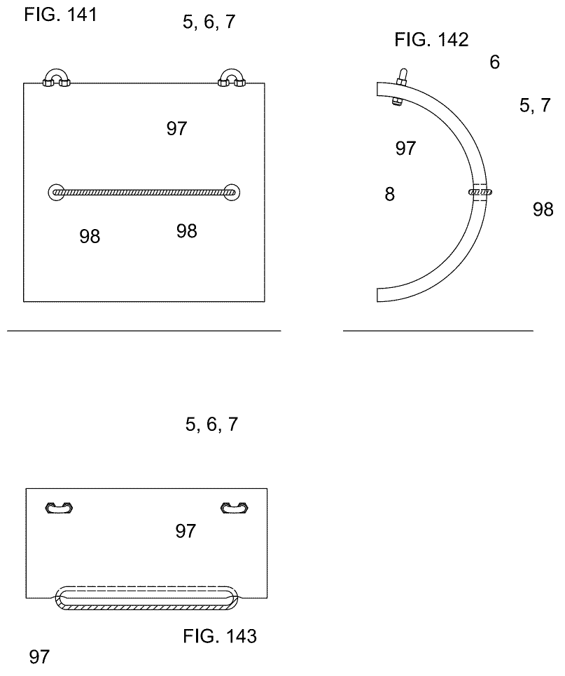

In another embodiment, in reference to FIG. 141, FIG. 142 and FIG. 143, that are a front plan view, a side plan view, and a top plan view, respectively, of an alternative embodiment of the present disclosure's footrope unit body, a strength member 97 passes through two through holes apertures 98 situated in the wall 6 of the footrope unit body and is configured to be connectable on the rear side of the footrope unit body to the main tow chain and/or to the trawl's fishing line (the strength member 97 may be a loop of pliable cable or rigid cable or metal or other solid material, or any other suitable solid object, and does not need to necessarily form a loop but may have a “U” shape with sharp bends proximal where the strength member passes through the apertures 98).

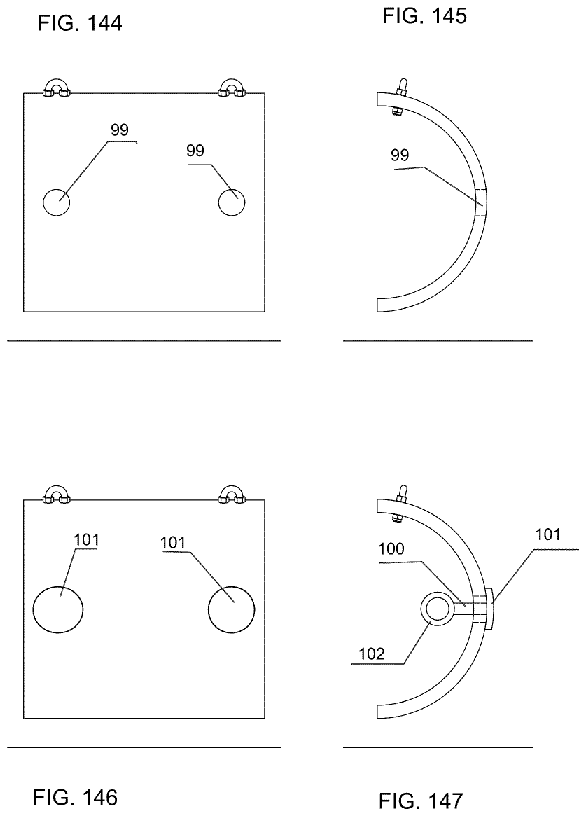

In another embodiment of the present disclosure, in reference to FIGS. 144 and 145, that are front and side plan views of a footrope unit body of the present disclosure having a plurality of through hole apertures 99 formed into the footrope unit body's wall 6, and also in reference to FIG. 146 and FIG. 147, that are modified views of FIG. 144 and FIG. 145, respectively, where FIG. 146 and FIG. 147 additionally illustrate a moveable connector of the present disclosure attached to a footrope unit body of the present disclosure, the footrope of the present disclosure comprises at least one footrope unit body of the present disclosure (such as may be a bent plate gear footrope unit body formed of metal or plastic, including but not limited to such as may be the semi-circle cambered plate gear, that may be formed of steel or other metal or that may be formed of plastic or other material) that is equipped with at least one through hole 99 through which is moveably situated at least one solid object 100 that is configured at one end 101 of the solid object to be incapable of passing its entire body through the entire through hole passage, and that is configured at its other end 102 to be capable of being connected to the main tow chain of the footrope and/or the fishing line of a trawl. The end 101 may preferably be situated proximal the forward facing surface 7 of the footrope unit body, and, may be capped or covered with a portion of metal or other solid material that prevents it from being accessed from the forward facing surface 7, such as so as to prevent netting from being caught by the moveable connector.

### Extended in Length and Extended in Height Embodiments

In another preferred embodiment of the present disclosure, the footrope of the present disclosure is formed of a series of interconnected solid objects, including but not limited to bent and/or curved plates and/or bent and/or curved walls, the solid objects having a cambered cross sectional form and/or being cambered in side view, has a greater width (w) than it has a height (H) and/or in certain other embodiments, it may be preferable that each of the cambered cross sectional formed solid objects has a greater height (H) than it has a width (w); and, in yet certain other embodiments, it may be preferable that each of the cambered cross sectional formed solid objects has a shape that is neither square nor rectangular, when:
I) viewed in a front plan view of their forward facing surfaces when arranged and situated in the finished footrope; AND/OR
II) viewed, in the case of bent and/or curved plates and/or walls, where each of the bent and/or curved plates and/or walls is situated with its tail end edge in contact with a floor and with its head end edge as its highest/most vertical region; AND/OR
III) viewed from a top plan view while either or both: (a) laying on its convex side surface on a level surface; and/or (b) situated on a level surface and laying on its convex side surface that is intended to be situated as its most forward side surface when positioned in the finished and assembled footrope; AND/OR
IV) viewed from a top plan view while either or both: (a) laying on a level surface in a position that is a stable position (for example, a “stable position” is a position from where it cannot fall into a different position as a result of being vibrated or shaken) with its convex side surface on the level surface; and/or (b) situated on a level surface and laying on its convex side surface that is intended to be situated as its most forward side surface when positioned in the finished and assembled footrope.

In another preferred embodiment of the present disclosure, the footrope of the present disclosure is formed of a series of interconnected solid objects, including but not limited to bent and/or curved plates and/or bent and/or curved walls, the solid objects having a cambered cross sectional form and/or being cambered in side view, the solid objects having a shape other than a square when:
I) viewed from a top plan view while either or both: (a) laying on its convex side surface on a level surface; and/or (b) situated on a level surface and laying on its convex side surface that is intended to be situated as its most forward side surface when positioned in the finished and assembled footrope; AND/OR
II) viewed from a top plan view while either or both: (a) laying on a level surface in a position that is a stable position (for example, a “stable position” is a position from where it cannot fall into a different position as a result of being vibrated or shaken) with its convex side surface on the level surface; and/or (b) situated on a level surface and laying on its convex side surface that is intended to be situated as its most forward side surface when positioned in the finished and assembled footrope.

FIGS. 79 and 79a illustrate a front side plan view and a side plan view, respectively, of an alternative embodiment of a bent plate footrope unit body of the present disclosure where the bent plate's upper and lower edges each have been enclosed in a shoe formed of steel and/or other metal. The ears to which the fishing line attaches are connected to the upper shoe.

FIGS. 101 and 101 a illustrate a back side plan view and a side plan view, respectively, of an alternative embodiment of a bent plate footrope unit body of the present disclosure where the bent plate's side edges as well as its upper and lower edges all have been attached to a frame formed of steel and/or other metal. The ears (not shown) to which the fishing line attaches are connected to the upper edge of the metal frame. The plate enclosed by the frame preferably is formed of plastic. It may also be formed of any material such as metal or steel. A span portion of steel or other metal or other material spans the back side surface of the bent plate and connects the left and right sides of the metal frame to one another. Connection hardware for connecting the bent plate and frame assembly to the tow chain may be attached to the span portion of steel, or, and preferably, may be attached to the back side concave surface of the bent plate.

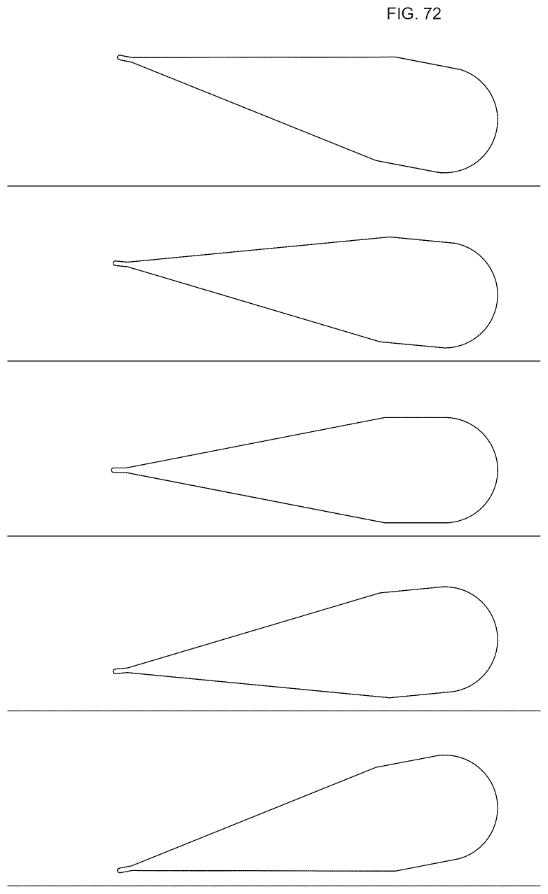

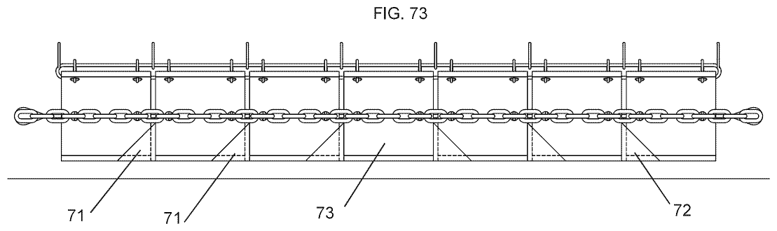

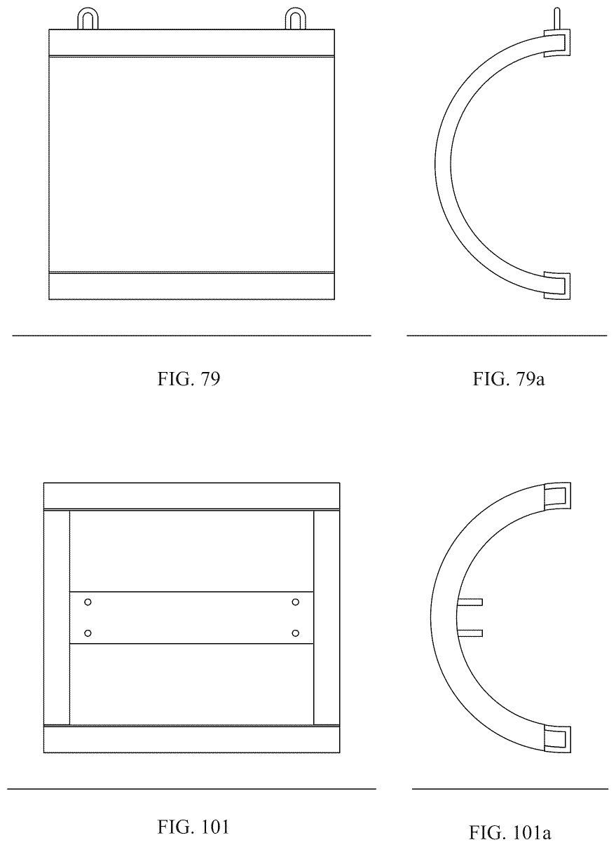

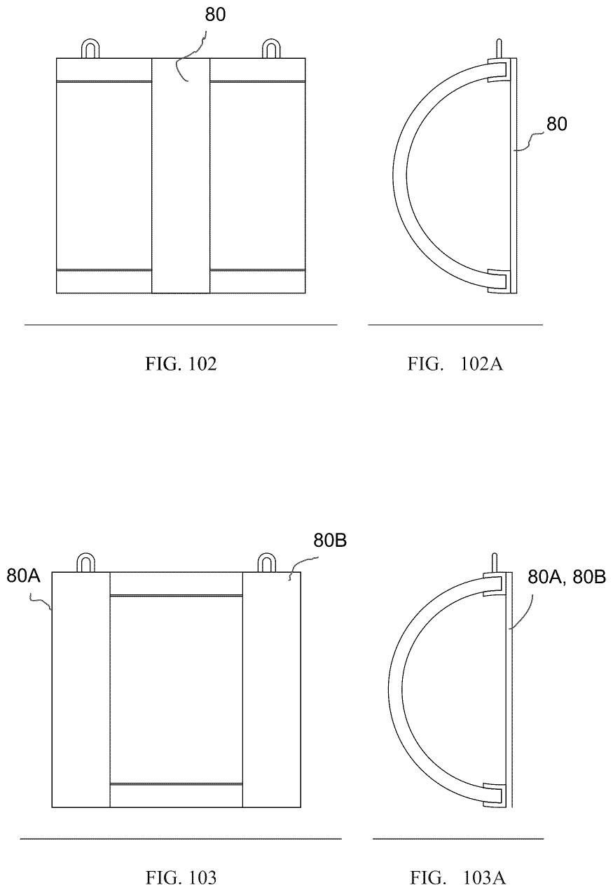

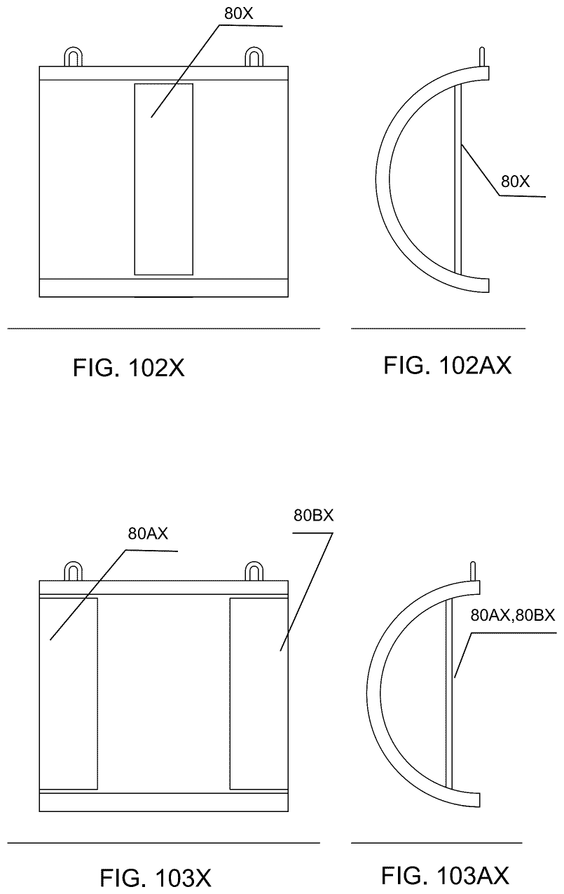

FIGS. 102 and 102A illustrate a back side plan view and a side plan view, respectively, of an alternative embodiment of a bent plate footrope unit body of the present disclosure. A span portion 80 of steel or other metal or other material spans the back side surface of the bent plate and connects the upper and lower edges of the bent plate to one another. Connection hardware for connecting the bent plate and frame assembly to the tow chain may be attached to the span portion of steel, or, and preferably, may be attached to the back side concave surface of the bent plate.

FIGS. 102X and 102AX illustrate a back side plan view and a side plan view, respectively, of an alternative embodiment of the bent plate footrope unit body of FIGS. 102 and 102A. A span portion 80X of steel or other metal or other material is situated recessed within the concavity of the back side surface of the bent plate and connects to inner walls of the back side surface at locations recessed into the concavity and removed from the upper and lower edges of the bent plate footrope unit body. Connection hardware for connecting the bent plate and frame assembly to the tow chain may be attached to the span portion of steel, or, and preferably, may be attached to the back side concave surface of the bent plate.

FIGS. 103 and 103A illustrate a back side plan view and a side plan view, respectively, of an alternative embodiment of the bent plate footrope body of the present disclosure having a construction and/or configuration that differs from that of the footrope unit body of the present disclosure illustrated in FIG. 102 and FIG. 102A mainly and/or only in that in place of a single span portion 80 of steel or other metal or other material, two (or a plurality) of span portions 80A and 80B connect the upper and lower edges of the bent plate to one another, and may be situated proximal the left and right side edges of the bent plate.

FIGS. 103X and 103AX illustrate a back side plan view and a side plan view, respectively, of an alternative embodiment of the bent plate footrope body of the FIGS. 103 and 103A having a construction and/or configuration that differs from that of the footrope unit body of the present disclosure illustrated in FIG. 103 and FIG. 103A mainly and/or only in that in place of a single span portion 80X of steel or other metal or other material, two (or a plurality) of span portions 80AX and 80BX are situated recessed within the concavity of the back side surface of the bent plate and connect to inner walls of the back side surface at locations recessed into the concavity and removed from the upper and lower edges of the bent plate footrope unit body, and may preferably be situated proximal the left and right side edges of the bent plate. Connection hardware for connecting the bent plate and frame assembly to the tow chain may be attached to the span portions of steel, or, and preferably, may be attached to the back side concave surface of the bent plate as disclosed herein in, by way of non-limiting example, as described relative to rigidly attached connection assembly 24, 24A.

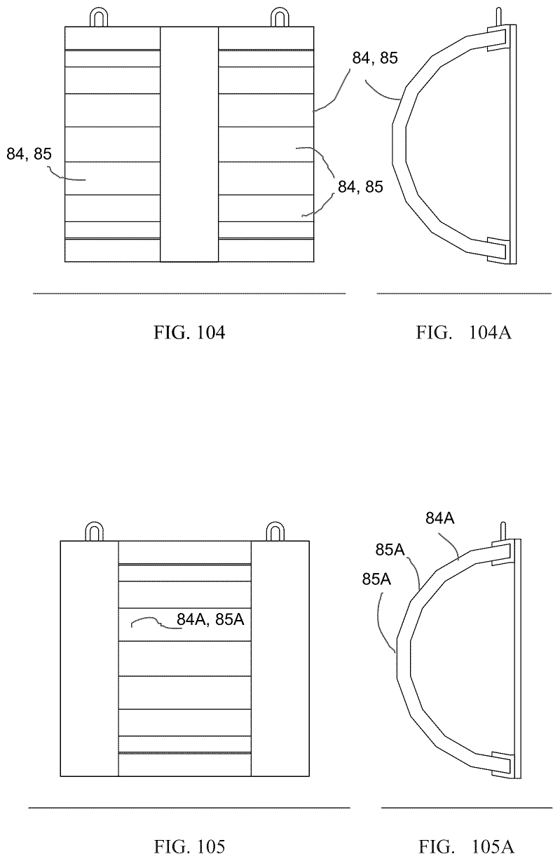

FIGS. 104 and 104A illustrate a back side plan view and a side plan view, respectively, of an alternative embodiment of the bent plate footrope body of the present disclosure having a construction and/or configuration that differs from that of the footrope body of the present disclosure illustrated in FIG. 102 and FIG. 102A mainly and/or only in that the bent plate is formed of a multiply bent plate 84 that may have a cross section corresponding to a portion of a polygon, and/or that may have multiple flat sides 85 and/or facets 85 comprising the multiply bent plate and/or at least the convex side front surface of the multiply bent plate. Connection hardware for connecting the bent plate and frame assembly to the tow chain may be attached to the span portion of steel, or, and preferably, may be attached to the back side concave surface of the bent plate as disclosed herein in, by way of non-limiting example, as described relative to rigidly attached connection assembly 24, 24A.

FIGS. 105 and 105A illustrate a back side plan view and a side plan view, respectively, of an alternative embodiment of the bent plate footrope body of the present disclosure having a construction and/or configuration that differs from that of the footrope body of the present disclosure illustrated in FIG. 103 and FIG. 103A mainly and/or only in that the bent plate is formed of a multiply bent plate 84A that may have a cross section corresponding to a portion of a polygon, and/or that may have multiple flat sides and/or facets 85A comprising the multiply bent plate and/or at least the convex side front surface of the multiply bent plate. Connection hardware for connecting the bent plate and frame assembly to the tow chain may be attached to the span portions of steel, or, and preferably, may be attached to the back side concave surface of the bent plate as disclosed herein in, by way of non-limiting example, as described relative to rigidly attached connection assembly 24, 24A.

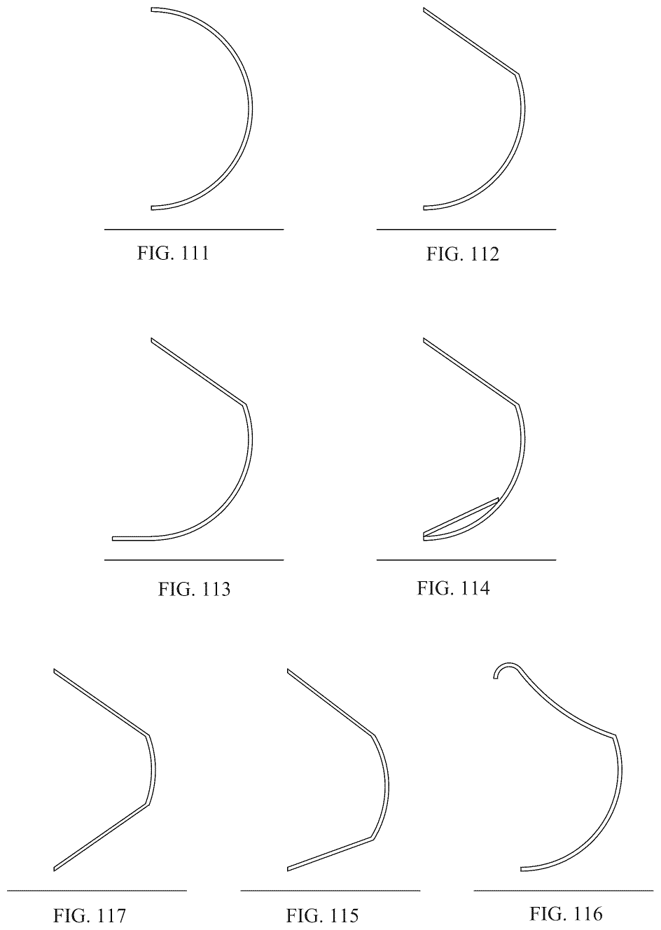

FIG. 111 through FIG. 117 illustrate side plan views of various embodiments of alternative configurations of bent plates for forming footropes of the present disclosure.

FIG. 111 illustrates a semi-circle shaped bent plate of the present disclosure.

FIG. 112 illustrates a bent plate of the present disclosure similar to that shown in FIG. 111 except that the cambered portion of plate in FIG. 111 that is situated above the tow chain is entirely or mainly substituted by a flat portion of steel plate forming a ramp running upward and aft.

FIG. 113 illustrates a bent plate footrope unit body of the present disclosure similar to that shown in FIG. 112 except where a portion of the bent plate footrope unit body proximal the lower edge of the bent plate footrope unit body has been replaced by a flat portion of steel plate, the length of the flat portion of steel plate is able to be empirically determined best.

FIG. 114 illustrates a bent plate footrope unit body of the present disclosure similar to that shown in FIG. 112 except where a portion of flat steel plate is attached to the rear concave side cambered surface of the bent plate footrope unit body proximal the lower edge of the bent plate footrope unit body and extending forward and upward a length as able to be empirically determined best.

FIG. 115 illustrates a bent plate footrope unit body of the present disclosure similar to that shown in FIG. 112 except where a portion of the bent plate footrope unit body proximal the lower edge of the bent plate footrope unit body and extending forward and upward a length as able to be empirically determined best has been replaced by a flat, uncambered portion.

FIG. 116 illustrates a bent plate footrope unit body of the present disclosure similar to that shown in FIG. 112 except where the flat portion of steel plate is replaced by an inwardly and/or downwardly bowed curved plate portion, so that the bent plate footrope unit body has a convex cambered front side surface below the tow chain, and a concave cambered front side surface above the tow chain.

FIG. 117 illustrates a bent plate footrope unit body of the present disclosure similar to that shown in FIG. 111 where the cambered portions of the plate above and below a central region of the tow plate have been replaced by flat regions where the lower flat region slopes downward and aft and where the upper flat region slopes upward and aft.

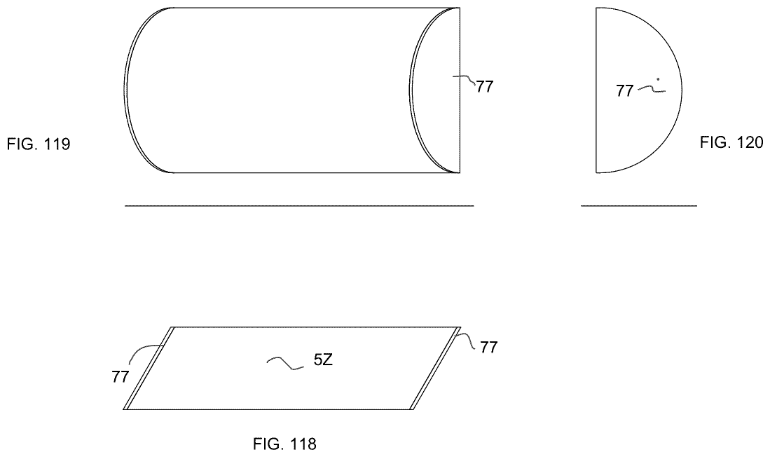

FIG. 118 illustrates a top plan view of an alternative footrope unit body 5X of the present disclosure that has a parallelogram outline when viewed from above such a when viewed from a top plan view. Optionally, side end plates 77 may be situated at the lateral openings of the footrope unit body and serve to obstruct at least portions of the lateral side channel opening formed by at least one open lateral end of the concave portion of the bent plate footrope unit body 5. The side end plates may be formed of either a rigid plastic, metal or other material, or a flexible wall of plastic, or a flexible sheet of pliable rubber, plastic or other synthetic material. FIGS. 119 and 120 are a perspective front plan view and a side plan view of the footrope unit body of FIG. 118, respectively.

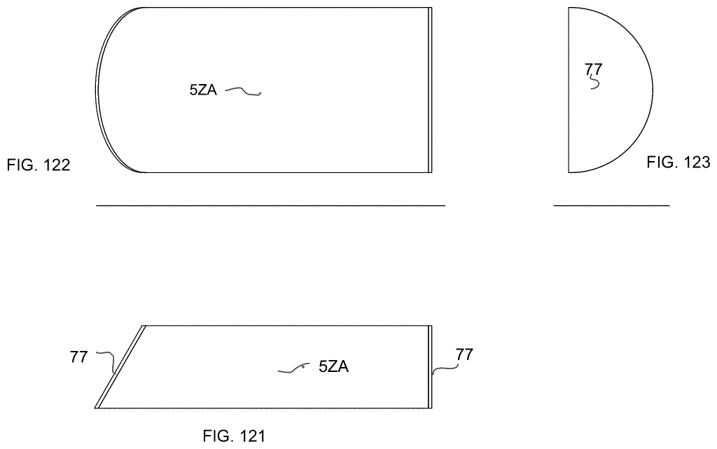

FIG. 121, FIG. 122 and FIG. 123 are top plan, perspective front plan and side plan views, respectively, of an alternative footrope unit body 5ZA (e.g., an alternative to at least the footrope unit body shown FIG. 118, FIG. 119 and FIG. 123, respectively), that exhibits when viewed in top plan view a trapezoid that exhibits different angles forming its corners at one lateral end in comparison with angles forming its corners at its other lateral end. In the present example, one end of the top plan view parallelogram outline of the footrope unit body 5ZA has one interior angel with an obtuse angle and another interior angle with an acute angle, whereas the other end of the parallelogram has different angles than its opposite end, and in this case, may have ninety degree angles. Side end plates 77 may optionally be present, and may be formed of either a rigid plastic, metal or other material, or a flexible wall of plastic, or a flexible sheet of pliable rubber, plastic or other synthetic material.

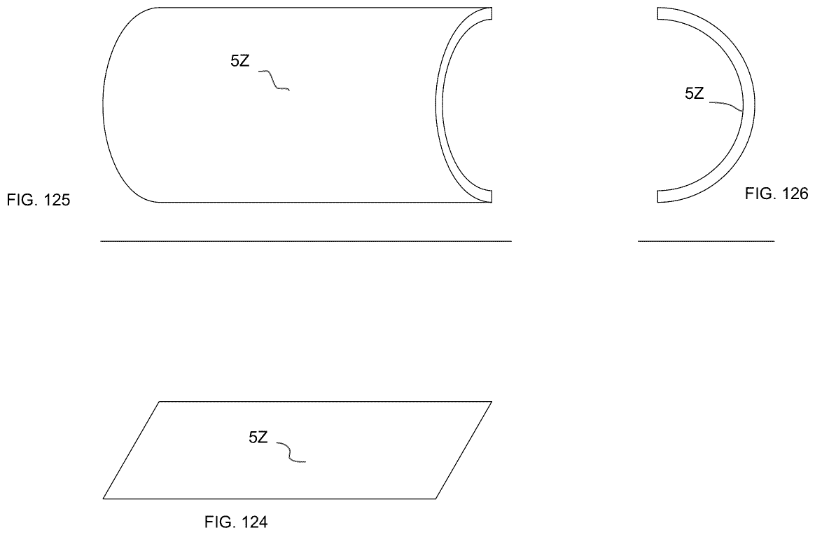

FIG. 124, FIG. 125 and FIG. 126 are alternative embodiments of the footrope unit body shown in FIG. 118, FIG. 119 and FIG. 120, respectively, where the side end plates 77 are not present.

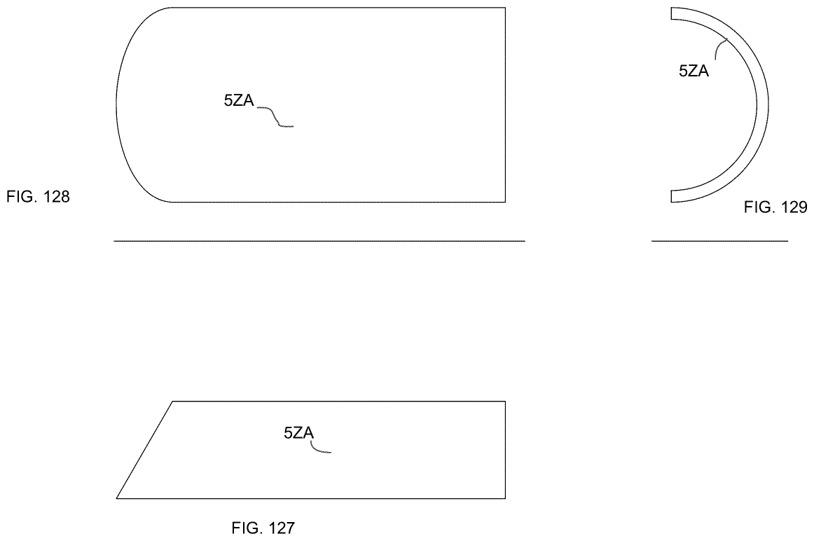

FIG. 127, FIG. 128 and FIG. 129 are alternative embodiments of the footrope unit body shown in FIG. 121, FIG. 122 and FIG. 123, respectively, where the side end plates 77 are not present.

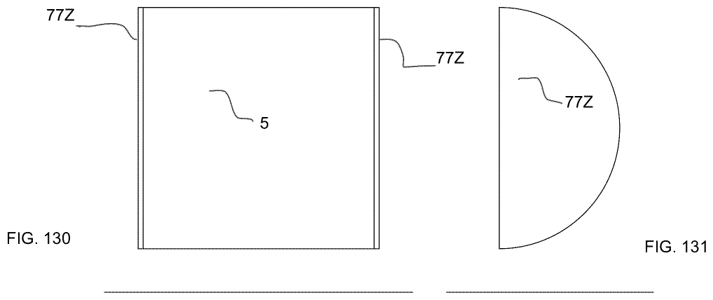

FIG. 130 and FIG. 131 are a front plan view and a side plan view, respectively, of a footrope unit body 5 that is a SCG bent plate footrope unit body where side end plates 77Z are present, serving to obstruct at least portions of the lateral side channel opening formed by at least one open lateral end of the concave portion of the bent plate footrope unit body 5, and may be formed of either a rigid plastic, metal or other material, or a flexible wall of plastic, or a flexible sheet of pliable rubber, plastic or other synthetic material.

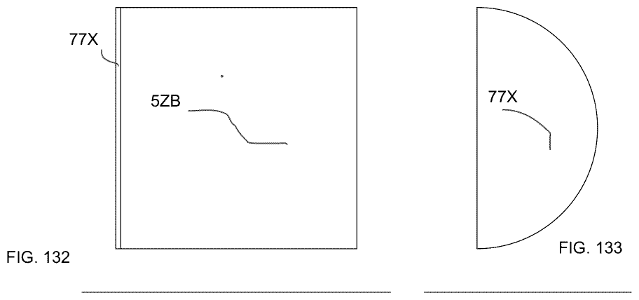

FIG. 132 and FIG. 133 are a front plan view and a side plan view, respectively, of an alternative footrope unit body 5ZB of the footrope unit body shown in FIG. 130 and FIG. 131, where only one side end plate 77 is present.

FIG. 134 illustrates a top plan view of an alternative embodiment of the footrope of the present disclosure illustrated in FIG. 14C, except where the footrope has been modified so as have footrope unit bodies 5X of the type described in reference to FIG. 118, FIG. 119 and FIG. 120 situated in the wings of the footrope, where, to avoid cluttering the drawing, shown only are the footrope unit bodies 5X and 5, without any attachment hardware and without any other elements of the footrope described and illustrated in reference to FIG. 14C, yet it is to be understood that those may be present.

In summary, a person having ordinary skill in the art will understand that the present disclosure provides various examples of aspects of the present disclosure, whether they be alone or in combination with one another, where such example aspects include at least Examples:
1. A footrope for a bottom trawl, the footrope comprising:
a starboard wing terminal end point;
a port wing terminal end point opposite the starboard wing terminal end point;
a plurality of interconnected footrope unit bodies located between the starboard and port wing terminal end points, each footrope unit body comprising a wall having opposing forward and rearward facing surfaces, at least a portion of the forward facing surface being convex, a least a portion of the rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
2. The footrope of Example 1, wherein a least one rockhopper disk is located between the starboard most one of the footrope unit bodies and the starboard wing terminal end point, the footrope further comprising a starboard delta plate located between the at least one rockhopper disk and the starboard wing terminal end point.
3. The footrope of any of Examples 1-2, wherein a least one rockhopper disk is located between the port most one of the footrope unit bodies and the port wing terminal end point, the footrope further comprising a port delta plate located between the at least one rockhopper disk and the port wing terminal end point.
4. The footrope of any of Examples 1-3, wherein the footrope includes a plurality of rockhopper disks.
5. The footrope of Example 4, wherein dimensions of at least one of the rockhopper disks are different than dimensions of at least one other of the rockhopper disks.
6. The footrope of any of Examples 4-5, wherein the dimensions of at least one of the rockhopper disks is such that a lower most edge of the footrope unit bodies extends lower than a lower most edge of said at least one rockhopper disk.
7. The footrope of any of Examples 4-6, wherein the dimensions of at least one of the rockhopper disks is such its lower most edge extends vertically lower than a lower most edge of the footrope unit bodies.
8. The footrope of any of Examples 1-7, wherein at least one weighted ballast is located between the starboard most one of the footrope unit bodies and the starboard wing terminal end point, the footrope further comprising a starboard delta plate located between the starboard most one of the footrope unit bodies and the at least one weighted ballast.
9. The footrope of any of Examples 1-8, wherein at least one weighted ballast is located between the port most one of the footrope unit bodies and the port wing terminal end point, the footrope further comprising a port delta plate located between the port most one of the footrope unit bodies and the at least one weighted ballast.
10. The footrope of any of Examples 8-9, wherein each weighted ballast includes a bobbin having a through-hole in which a spindle is inserted.
11. The footrope of any of Examples 1-10, wherein the at least weighted ballast is configured such that a lower most edge of the at least one weighted ballast extends lower than a lower most edge of the footrope unit bodies.
12. The footrope of any of Examples 1-10, wherein the at least one weighted ballast is configured such that a lower most edge of the footrope unit bodies extends vertically lower than a lower most edge of the at least one weighted ballast.
13. The footrope of any of Examples 1-12, wherein the footrope includes a plurality of the weighted ballasts.
14. The footrope of any of Examples 1-12, wherein the footrope unit bodies are connected to one another and to (a) the at least one rockhopper disk and/or (b) the at least one weighted ballast via at least one line, the at least one line being a main tow chain of the footrope, a false fishing line of the footrope, and/or a fishing line of the bottom trawl.
15. The footrope of any of Examples 1-13, wherein each footrope unit body is connected to a line via at least one connector such the footrope unit bodies are connected to one another via the line and the connectors, the line being a main tow chain of the footrope or a fishing line of the bottom trawl.
16. The footrope of Example 15, wherein each connector is rigidly attached to the wall of an associated footrope unit body such that each connector is prevented or substantially prevented from moving relative to an associated footrope unit body during use.
17. The footrope of Example 16, wherein each connector includes a first backing plate on the forward facing surface of an associated footrope unit body, a second backing plate on and/or adjacent to the rearward facing surface of the associated footrope unit body, and at least one fastener extending through the wall of the associated footrope unit body from the first backing plate to at least the second backing plate.
18. The footrope of Example 17, wherein the second backing plate includes a notch configured to at least partially receive a portion of the line so as to hold the received portion of the line in place between second backing plate and the rearward facing surface.
19. The footrope of Example 17, wherein each connector further includes a third backing plate on the rearward facing surface of the associated footrope unit body such that the third backing plate is interposed between the rearward facing surface of the associated footrope unit body and the second backing plate, each fastener extending through an associated third backing plate.
20. The footrope of Example 19, wherein the second and third backing plates of each connector include corresponding and mirrored notches, a portion of the line being received between associated notches so as to hold the received portion of the line in place between associated second and third backing plates.
21. The footrope of Example 15, wherein each connector is moveably connected to the wall of an associated footrope unit body such that each connector is moveable relative to the associated footrope unit body during use.
22. The footrope of Example 21, wherein at least one of the connectors comprises a chain link connector and/or a quick-link connector
23. The footrope unit body assembly of any of Examples 21-22, wherein each connector is moveably connected directly to the wall of an associated footrope unit body.
24. The footrope of Example 23, wherein each connector extends through a corresponding aperture in an associated wall, each connector having a first end on and/or adjacent to the forward facing surface of an associated footrope unit body and a second end on and/or adjacent to the rearward facing surface of an associated footrope unit body such that the first and second ends are on opposing sides of the wall of the associated footrope unit body, each first end being larger than the corresponding aperture so as to be prevented from passing into and/or through the corresponding aperture, each second end being configured to be connected to the line.
25. The footrope of any of Examples 21-22, wherein each connector is moveably connected indirectly to the wall of an associated footrope unit body.
26. The footrope of Example 25, wherein each connector is moveably connected directly to an associated solid body, each solid body being separate from and rigidly attached to the wall of an associated footrope unit body.
27. The footrope of Example 26, wherein each solid body is attached to one of the frontward and rearward facing surfaces of an associated footrope unit body.
28. The footrope of Example 25, wherein each connector is moveably connected directly to an associated strength member that is connected to the wall of an associated footrope unit body via being passed through two apertures of the wall of the associated footrope unit body.
29. The footrope of Example 28, wherein each strength member is a loop or U-shaped.
30. The footrope of any of Examples 28-29, wherein each strength member is a loop of pliable cable, rigid cable, or metal.
31. The footrope of any of Examples 15-30, wherein the line is the main tow chain line of the footrope, each footrope further comprising at least one body-to-line connector, each body-to-line connector being configured to directly and/or indirectly connect an associated footrope unit body to the fishing line of the bottom trawl.
32. The footrope of Example 31, wherein each body-to-line connector is configured to be directly connected to the fishing line so as to directly connect the footrope unit bodies to the fishing line.
33. The footrope unit body assembly of Example 31, wherein each body-to-line connector is configured to be indirectly connected to the fishing line so as to indirectly connect the footrope unit bodies to the fishing line.
34. The footrope of Example 33, wherein each body-to-line connector is connected to the fishing line via an associated drop chain.
35. The footrope of Example 33, wherein each body-to-line connector is configured to connect an associated footrope unit body to a false fishing line of the footrope, the false fishing line being connected to the fishing line such that the footrope unit body is indirectly connected to the fishing line via at least the body-to-line connector and the false fishing line.
36. The footrope of Example 35, wherein each body-to-line connector is connected to the false fishing line and an associated footrope unit body in such a manner that the body-to-line connector is prevented from freely sliding along a portion of the entire exterior surface of the false fishing line.
37. The footrope of any of Examples 31-36, wherein each body-to-line connector at least partially defines a body-to-line connector aperture.
38. The footrope of Example 37, wherein each body-to-line connector aperture extends perpendicular to a lateral direction relative to an associated footrope unit body, a width of each footrope unit body being measured in the lateral direction.
39. The footrope of Example 37, wherein each body-to-line connector aperture extends in a lateral direction relative to an associated footrope unit body, a width of each footrope unit body being measured in the lateral direction.
40. The footrope of any of Examples 31-39, wherein each body-to-line connector is a quick-link.
41. The footrope of any of Examples 31-40, wherein each body-to-line connector is connected directly to the wall of an associated footrope unit body via being threaded through through-holes of the wall.
42. The footrope of any of Examples 31-40, wherein each footrope unit body includes at least one ear attached thereto, each body-to-line connector being connected to an associated ear.
43. The footrope of Example 42, wherein each ear is formed by a U-bolt that is affixed to the wall of an associated footrope unit body.
44. The footrope of any of Examples 41-42, wherein each ear at least partially defines an ear aperture.
45. The footrope of Example 44, wherein each ear aperture extends perpendicular to a lateral direction relative to an associated footrope unit body, a width of each footrope unit body being measured in the lateral direction.
46. The footrope of Example 44, wherein each ear aperture extends in a lateral direction relative to an associated footrope unit body, a width of each footrope unit body being measured in the lateral direction.
47. The footrope of any of Examples 42 and 45-46, wherein each wall includes upper and lower edges, the upper and lower edges of each wall being at least partially enclosed in a shoe, each ear being connected to an associated shoe that encloses the upper edge of an associated wall.
48. The footrope of any of Examples 42 and 45-46, wherein each wall includes lateral sides and upper and lower edges, the lateral sides and the upper and lower edges of each wall being attached to an associated frame, each ear being connected to an associated frame adjacent to the upper edge of an associated wall.
49. The footrope of any of Examples 15-48, wherein each footrope unit body is configured to be connected to a barrier structure of the bottom trawl via a barrier connector.
50. The footrope of any of Examples 15-49, wherein at least one of the footrope unit bodies includes a sleeve rigidly attached to the rearward facing surface of the footrope unit body, at least a portion of an associated connector being located in the sleeve.
51. The footrope of Example 15, wherein at least one of the connectors comprises at least one sleeve that is rigidly attached to the rearward facing surface of an associated footrope unit body.
52. The footrope of Example 15, wherein each connector comprises at least one body-to-line connector and the line is the fishing line of the bottom trawl, each body-to-line connector being configured to directly and/or indirectly connecting an associated footrope unit body to the fishing line of the bottom trawl.
53. The footrope of Example 52, wherein each body-to-line connector is configured to be directly connected to the fishing line so as to directly connect an associated footrope unit body to fishing line.
54. The footrope of Example 52, wherein each body-to-line connector is configured to be indirectly connected to the fishing line so as to indirectly connect an associated footrope unit body to fishing line.
55. The footrope of Example 54, wherein each body-to-line connector is connected to the fishing line via an associated drop chain.
56. The footrope of Example 52, wherein each body-to-line connector is configured to connect an associated footrope unit body to a false fishing line of the footrope, the false fishing line being connected to the fishing line such that each footrope unit body is indirectly connected to the fishing line via an associated body-to-line connector and the false fishing line.
57. The footrope of Example 56, wherein each body-to-line connector is connected to the false fishing line and an associated footrope unit body in such a manner that each body-to-line connector is prevented from freely sliding along a portion of the entire exterior surface of the false fishing line.
58. The footrope of any of Examples 52-57, each body-to-line connector at least partially defines a body-to-line connector aperture.
59. The footrope of Example 58, wherein each body-to-line connector aperture extends perpendicular to a lateral direction relative to an associated footrope unit body, a width of each footrope unit body being measured in the lateral direction.
60. The footrope of Example 58, wherein each body-to-line connector aperture extends in a lateral direction relative to an associated footrope unit body, a width of each footrope unit body being measured in the lateral direction.
61. The footrope of any of Examples 52-60, wherein each body-to-line connector is a quick-link.
62. The footrope of any of Examples 52-61, wherein each body-to-line connector is connected directly to the wall of an associated footrope unit body via being threaded through through-holes of the wall.
63. The footrope of any of Examples 52-62, wherein each footrope unit body has at least one ear attached thereto, each body-to-line connector being connected to an associated ear.
64. The footrope of Example 63, wherein each ear is formed by a U-bolt that is affixed to an associated wall.
65. The footrope of any of Examples 63-64, wherein each ear at least partially defines an ear aperture.
66. The footrope of Example 65, wherein each ear aperture extends perpendicular to a lateral direction relative to an associated footrope unit body, a width of each footrope unit body being measured in the lateral direction.
67. The footrope of Example 65, wherein each ear aperture extends in a lateral direction relative to an associated footrope unit body, a width of each footrope unit body being measured in the lateral direction.
68. The footrope of any of Examples 63 and 65-67, wherein the wall of each footrope unit body has upper and lower edges, the upper and lower edges of each wall being at least partially enclosed in a shoe, each ear being connected to an associated shoe that encloses the upper edge of an associated wall.
69. The footrope of any of Examples 63 and 65-67, wherein the wall of each footrope unit body has lateral sides and the upper and lower edges, the lateral sides and the upper and lower edges of each wall are attached to an associated frame, each ear being connected to an associated frame adjacent to the upper edge of an associated wall.
70. The footrope of any of Examples 52-69, wherein each footrope unit body is configured to be connected to a barrier structure of the bottom trawl via an associated barrier connector.
71. The footrope of any of Examples 1-70, wherein at least one of the footrope unit bodies is a varying thickness footrope unit body, each varying thickness footrope unit body has at least one first wall region and at least one second wall region, the at least one second wall regions having a different thickness than a thickness of the at least one first wall regions.
72. The footrope of Example 71, wherein the thickness of the at least one first wall region is greater than the thickness of the at least one second wall region.
73. The footrope Example 72, wherein at least a portion of the at least one first wall region protrudes forward and outward from an associated forward facing surface.
74. The footrope of any of Examples 71-73, wherein the at least one first wall region of each varying thickness footrope unit body comprises a rearward portion and a forward portion.
75. The footrope of Example 74, wherein each forward portion is positioned on and connected to an associated forward facing surface.
76. The footrope of Example 74, wherein each forward portion is at least partially recessed into an associated forward facing surface.
77. The footrope of any of Examples 74-76, wherein the forward and rearward portions extend vertically between upper and lower edges of an associated wall.
78. The footrope of any of Examples 74-76, wherein the forward and rearward portions extend laterally between opposing lateral edges of an associated wall.
79. The footrope of any of Examples 74-78, wherein each second region of each varying thickness footrope unit body includes each portion of an associated wall that does not include the forward and/or rearward portions.
80. The footrope of any of Examples 74-78, wherein forward portion is formed from metal and/or a synthetic material.
81. The footrope of any of Examples 74-80, wherein the rearward portion is formed a synthetic material and/or metal.
82. The footrope of any of Examples 74-81, wherein each second wall region is integrally formed as a single monolithic piece with an associated rearward portion of an associated first wall region.
83. The footrope of any of Examples 74-82, wherein each forward portion is connected to an associated rearward region via adhesion, vulcanization, and/or at least one mechanical fastener.
84. The footrope of any of Examples 71-76 and 78-83, wherein for each varying thickness footrope unit body, an entirety of each first wall region is located at a lower portion of the wall such that each first wall region does not extend vertically beyond the lower portion to an upper portion of the wall.
85. The footrope of Example 84, wherein the lower portion of the wall of each varying thickness footrope unit body is equal or substantially equal to a lower half of the wall and the upper portion is equal or substantially equal to an upper half of the wall.
86. The footrope of Example 84, wherein each footrope unit body is connected to a line via at least one connector such the footrope unit bodies are connected to one another via the line and the connectors, the line being a main tow chain of the footrope or a fishing line of the bottom trawl, each connector being connected to the wall of an associated footrope unit body at a location that is above the lower portion of the wall of the associated footrope unit body.
87. The footrope of any of Examples 1-86, wherein the wall of at least one of the footrope unit bodies is configured such that, in use, at least the convex portion of the forward facing surface is directed away from a surface on and/or above which the footrope unit body is situated, and/or at least the concave portion of rearward facing surface is directed toward the surface on and/or above which the footrope unit body is situated.
88. The footrope of any of Examples 1-86, wherein a side plan view profile of at least one of the walls is or is substantially a tear drop shape and/or an airfoil shape.
89. The footrope of Example 88, wherein each tear drop shaped wall is truncated such that each tear dropped shaped wall has an opening at a narrow and rearward end of each tear dropped shaped wall.
90. The footrope of any of Examples 1-89, wherein the wall of at least one of the footrope unit bodies is a multiply bent plate and/or wall having a cross-sectional and or side plan view shape that corresponds to a portion of a polygon.
91. The footrope of any of Examples 1-89, wherein the wall of at least one of the footrope unit bodies is a multiply bent plate and/or wall, the forward facing surface and/or the rearward facing surface of each multiply bent plate and/or wall having multiple flat sides and/or facets.
92. The footrope of any of Examples 90-91, wherein at least the forward facing surface of each multiply bent plate and/or wall has multiple flat sides and/or facets.
93. The footrope of any of Examples 1-87 and 90-92, wherein the wall of at least one of the footrope unit bodies is shaped as a half-annulus in cross-section and/or when viewed in side plan view.
94. The footrope of any of Examples 1-87 and 90-92, wherein a cross-sectional and/or side plan view shape of the wall of at least one of the footrope unit bodies is an arcuate shape that is greater than half an annulus, but less than a full annulus.
95. The footrope of any of Examples 1-87 and 90-92, wherein the wall of at least one of the footrope unit bodies has an upper flat portion at and/or adjacent to upper edge of the wall, the upper flat portion that extends vertically upward and aft from the portion of the wall that has the convex forward facing surface and/or the concave rearward facing surface to or toward the upper edge of the wall.
96. The footrope of Example 95, wherein for each footrope unit body that includes an upper flat portion, the wall has a lower flat portion at and/or adjacent to the lower edge of the wall, the lower flat portion extending aft from the portion of the wall that has the convex forward facing surface and/or the concave rearward facing surface to or toward the lower edge of the wall.
97. The footrope of Example 96, wherein for each footrope unit body that includes the upper and lower flat portions, the lower flat portion extends vertically downward and aft from the portion of the wall that has the convex forward facing surface and/or the concave rearward facing surface to or toward the upper edge of the wall.
98. The footrope of Example 97, wherein a slope of the upper flat portion is the same as or different than the lower flat portion.
99. The footrope of Example 95, wherein for each footrope unit body that includes an upper flat portion, a lower plate is attached to the rearward side of the wall at and/or adjacent to the lower edge of the wall, the flat plate extending forward and vertically upward from where the plate is attached to the rearward side of the wall.
100. The footrope of any of Examples 1-87 and 90-92, wherein for at least one of the footrope unit bodies:
at an upper portion of the wall, at least a portion the forward facing surface is concave and at least a portion of the rearward facing surface is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
101. The footrope of any of Examples 1-87 and 90-93, wherein in top plan view, the wall of at least one of the footrope unit bodies is shaped as a parallelogram.
102. The footrope of any of Examples 1-87 and 90-93, wherein in top plan view, the wall of at least one of the footrope unit bodies is shaped as a trapezoid that exhibits different angles forming its corners at one lateral end in comparison with angles forming its corners at its other lateral end.
103. The footrope of any of Example 93-102, wherein a side end plate may be situated at one or both of lateral sides of the wall of at least one of the footrope unit bodies, each side end plate at least partially obstructing an associated lateral side channel opening of an associated wall.
104. The footrope of Example 103, wherein at least one of the footrope unit bodies has a side end plate is situated at each lateral side of its wall.
105. The footrope of any of Examples 1-87, wherein the forward facing surface is a convex cambered forward facing surface, a convex sloping forward facing surface, a convex bent forward facing surface, and/or a convex multiply bent forward facing surface.
106. The footrope of any of Examples 1-87 and 90-105, wherein at least one of the footrope unit bodies includes at least one spanning bridge that is separate from and connected to the wall on a rearward side of the wall so as to span at least a portion of the rearward side of the wall.
107. The footrope of Example 106, wherein for each footrope body that has the at least one spanning bridge, the at least one spanning bridge spans between the lateral edges of the wall such that a first lateral end of the at least one spanning bridge is connected to the wall adjacent to a first one of the lateral edges of the wall and a second lateral end of the at least one spanning bridge is connected to the wall adjacent to a second one of the lateral edges.
108. The footrope of Example 107, wherein for each footrope body that has the at least one spanning bridge, the lateral edges of the wall and the upper and lower edges are attached to a frame, the first end of the at least one spanning bridge being attached to the frame adjacent the first one of the lateral edges, the second end of the at least one spanning bridge being attached to the frame adjacent the second one of the lateral edges.
109. The footrope of Example 106, wherein for each footrope body that has the at least one spanning bridge, the at least one spanning bridge is spaced from and spans between the upper and edges of the wall such that an upper end of the at least one spanning bridge is connected to the rearward facing surface adjacent to the upper edge of the wall and a lower end of the at least one spanning bridge is connected to the rearward facing surface adjacent to the lower edge of the wall.
110. The footrope of Example 109, wherein for each footrope body that has the at least one spanning bridge, the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
111. The footrope of Example 106, wherein for each footrope body that has the at least one spanning bridge, the at least one spanning bridge spans between the upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
112. The footrope of Example 111, wherein for each footrope body that has the at least one spanning bridge, the upper and lower edges of the wall are each at least partially enclosed in a shoe, the upper end of the at least one spanning bridge being attached to the shoe that at least partially encloses the upper edge of the wall, the lower end of the at least one spanning bridge being attached to the shoe that at least partially encloses the lower edge of the wall.
113. The footrope of any of Examples 111-112, wherein for each footrope body that has the at least one spanning bridge, the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
114. The footrope of any of Examples 1-113, wherein the wall of each footrope unit body includes at least one flange connected thereto that extends laterally outward beyond a corresponding lateral edge of the wall, each flange of each footrope unit body being configured to overlap a portion of a separate and directly adjacent footrope unit body.
115. The footrope of any of Examples 1-114, wherein the wall of at least one of the footrope unit bodies has a total height that is equal to its total width.
116. The footrope of any of Examples 1-114, wherein the wall of at least one of the footrope unit bodies has a ratio of a total and/or average width of the wall to a total and/or average height of the wall in the range of 1.01:1 to 22:1.
117. The footrope of any of Examples 1-116, wherein the footrope has at least one starboard segment having a plurality of the footrope unit bodies, at least one port segment having a plurality of the footrope unit bodies, and a central segment having a plurality of the footrope unit bodies.
118. The footrope of Example 117, wherein the footrope unit bodies of the central segment have a different width than a width of the footrope unit bodies of the starboard segment and/or than a width of the footrope unit bodies of the port segment.
119. The footrope of Example 118, wherein the width of the footrope unit bodies of the central segment is lesser width than the width of the footrope unit bodies of the starboard segment and/or than the width of the footrope unit bodies of the port segment.
120. The footrope of any of Examples 1-116, wherein the footrope has at least one starboard segment having a plurality of the footrope unit bodies, at least one port segment having a plurality of the footrope unit bodies, and a central segment having a plurality of the footrope unit bodies, the shape of the footrope unit bodies of the central segment being different than the shape of the footrope unit bodies of the at least one starboard segment and/or the shape of the footrope unit body of the at least one port segment.
121. The footrope of Example 120, wherein a side plan view profile of the wall of each footrope unit body of the central segment is or is substantially a tear drop shape and/or an airfoil shape, and
(a) a side plan view profile of the wall of each footrope unit body of the at least one starboard segment is a half annulus, and/or
(b) a side plan view profile of the wall of each footrope unit body of the at least one port segment is a half annulus.
122. The footrope of Example 120, wherein a top plan view profile of the wall of each footrope unit body of the central segment is a square and/or rectangle, and
(a) a top plan view profile of the wall of each footrope unit body of the at least one starboard segment is a parallelogram, and/or
(b) a top plan view profile of the wall of each footrope unit body of the at least one port segment is a parallelogram.
123. The footrope of any of Examples 1-122, wherein at least one of the walls includes at least one perforation and/or at least one perforated slit.
124. The footrope of any of Examples 1-123, wherein each footrope unit body is formed from a synthetic material and/or metal.
125. The footrope of any of Examples 1-79 and 82-124, wherein at least one of the footrope unit bodies is formed from a synthetic material and at least one of the footrope unit bodies is formed from metal.
126. The footrope of Example 125, wherein the footrope unit bodies are arranged such that the synthetic material footrope unit bodies are arranged in alternating order with the metal footrope unit bodies.
127. A bottom trawl, comprising the footrope of any of Examples 1-126.
128. The bottom trawl of Example 127, wherein the footrope comprises a main tow chain, the bottom trawl further comprising a fishing line, each of the footrope unit bodies being connected directly and/or indirectly to each of the main tow chain and the fishing line, the main tow chain and/or the bottom trawl being configured such that fishing line is located aft of the main tow chain at least during use.
129. The footrope of Example 1, further comprising a plurality of connectors, each connector being rigidly attached to a wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
130. The footrope of Example 1, a side plan view profile of the wall of at least a portion of the plurality of footrope unit bodies being or substantially being a tear drop shape and/or an airfoil shape
131. The footrope of Example 1, wherein at least the forward facing surface of at least a portion of the walls being a multiply bent surface having multiple flat sides and/or facets.
132. The footrope of Example 1, wherein the wall of at least one of the footrope unit bodies has at least one first wall region and at least one second wall region, where the at least one second wall region has a different thickness than a thickness of the at least one first wall region.
133. The footrope of Example 1, wherein the wall of at least one of the footrope unit bodies comprises a body in the form of a bent plate and at least one exterior feature, the body has the forward facing surface, the at least one exterior feature connected to and/or at least partially recessed into the forward facing surface.
134. A bottom trawl, comprising:
a fishing line; and
the footrope of Example 1 connected to the fishing line, the footrope including a main tow chain configured such that the fishing line is located aft of the main tow chain, the footrope unit bodies being connect to and connected to one another via the main tow chain.
134. A bottom trawl, comprising:
a fishing line; and
the footrope of Example 1, the footrope including a main tow chain, a false fishing line, and a plurality of slidable connectors, the slidable connectors connecting the false fishing line to the fishing line, each slidable connector being slidably connected to and slidable along a portion of the false fishing line, the footrope unit bodies being connected to the main tow chain and the false fishing line.
135. A footrope for a bottom trawl, the footrope comprising a plurality of interconnected footrope unit bodies, each footrope unit body comprising a wall having opposing forward and rearward facing surfaces, at least a portion of the forward facing surface being convex, a least a portion of the rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
136. The footrope of Example 135, wherein the thickness of the at least one first wall region is greater than the thickness of the at least one second wall region.
137. The footrope Example 136, wherein at least a portion of the at least one first wall region protrudes forward and outward from an associated forward facing surface.
138. The footrope of any of Examples 135-137, wherein the at least one first wall region of each varying thickness footrope unit body comprises a rearward portion and a forward portion.
139. The footrope of Example 138, wherein each forward portion is positioned on and connected to an associated forward facing surface.
140. The footrope of Example 138, wherein each forward portion is at least partially recessed into an associated forward facing surface.
141. The footrope of any of Examples 138-140, wherein the forward and rearward portions extend vertically between upper and lower edges of an associated wall.
142. The footrope of any of Examples 138-140, wherein the forward and rearward portions extend laterally between opposing lateral edges of an associated wall.
143. The footrope of any of Examples 138-142, wherein each second region of each varying thickness footrope unit body includes each portion of an associated wall that does not include the forward and/or rearward portions.
144. The footrope of any of Examples 138-142, wherein forward portion is formed from metal and/or a synthetic material.
145. The footrope of any of Examples 138-144, wherein the rearward portion is formed a synthetic material and/or metal.
146. The footrope of any of Examples 138-145, wherein each second wall region is integrally formed as a single monolithic piece with an associated rearward portion of an associated first wall region.
147. The footrope of any of Examples 138-146, wherein each forward portion is connected to an associated rearward region via adhesion, vulcanization, and/or at least one mechanical fastener.
148. The footrope of any of Examples 135-140 and 142-147, wherein for each varying thickness footrope unit body, an entirety of each first wall region is located at a lower portion of the wall such that each first wall region does not extend vertically beyond the lower portion to an upper portion of the wall.
149. The footrope of Example 148, wherein the lower portion of the wall of each varying thickness footrope unit body is equal or substantially equal to a lower half of the wall and the upper portion is equal or substantially equal to an upper half of the wall.
150. The footrope of Example 148, wherein each footrope unit body is connected to a line via at least one connector such the footrope unit bodies are connected to one another via the line and the connectors, the line being a main tow chain of the footrope or a fishing line of the bottom trawl, each connector being connected to the wall of an associated footrope unit body at a location that is above the lower portion of the wall of the associated footrope unit body.
151. The footrope of any of Examples 135-150, wherein the wall of at least one of the footrope unit bodies is configured such that, in use, at least the convex portion of the forward facing surface is directed away from a surface on and/or above which the footrope unit body is situated, and/or at least the concave portion of rearward facing surface is directed toward the surface on and/or above which the footrope unit body is situated.
152. The footrope of any of Examples 135-150, wherein a side plan view profile of at least one of the walls is or is substantially a tear drop shape and/or an airfoil shape.
153. The footrope of Example 152, wherein each tear drop shaped wall is truncated such that each tear dropped shaped wall has an opening at a narrow and rearward end of each tear dropped shaped wall.
154. The footrope of any of Examples 135-153, wherein the wall of at least one of the footrope unit bodies is a multiply bent plate and/or wall having a cross-sectional and or side plan view shape that corresponds to a portion of a polygon.
155. The footrope of any of Examples 135-153, wherein the wall of at least one of the footrope unit bodies is a multiply bent plate and/or wall, the forward facing surface and/or the rearward facing surface of each multiply bent plate and/or wall having multiple flat sides and/or facets.
156. The footrope of any of Examples 154-155, wherein at least the forward facing surface of each multiply bent plate and/or wall has multiple flat sides and/or facets.
157. The footrope of any of Examples 135-151 and 154-156, wherein the wall of at least one of the footrope unit bodies is shaped as a half-annulus in cross-section and/or when viewed in side plan view.
158. The footrope of any of Examples 135-151 and 154-156, wherein a cross-sectional and/or side plan view shape of the wall of at least one of the footrope unit bodies is an arcuate shape that is greater than half an annulus, but less than a full annulus.
159. The footrope of any of Examples 135-151 and 154-156, wherein the wall of at least one of the footrope unit bodies has an upper flat portion at and/or adjacent to upper edge of the wall, the upper flat portion that extends vertically upward and aft from the portion of the wall that has the convex forward facing surface and/or the concave rearward facing surface to or toward the upper edge of the wall.
160. The footrope of Example 159, wherein for each footrope unit body that includes an upper flat portion, the wall has a lower flat portion at and/or adjacent to the lower edge of the wall, the lower flat portion extending aft from the portion of the wall that has the convex forward facing surface and/or the concave rearward facing surface to or toward the lower edge of the wall.
161. The footrope of Example 160, wherein for each footrope unit body that includes the upper and lower flat portions, the lower flat portion extends vertically downward and aft from the portion of the wall that has the convex forward facing surface and/or the concave rearward facing surface to or toward the upper edge of the wall.
162. The footrope of Example 161, wherein a slope of the upper flat portion is the same as or different than the lower flat portion.
163. The footrope of Example 159, wherein for each footrope unit body that includes an upper flat portion, a lower plate is attached to the rearward side of the wall at and/or adjacent to the lower edge of the wall, the flat plate extending forward and vertically upward from where the plate is attached to the rearward side of the wall.
164. The footrope of any of Examples 135-151 and 154-156, wherein for at least one of the footrope unit bodies:
at an upper portion of the wall, at least a portion the forward facing surface is concave and at least a portion of the rearward facing surface is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
165. The footrope of any of Examples 135-151 and 154-157, wherein in top plan view, the wall of at least one of the footrope unit bodies is shaped as a parallelogram.
166. The footrope of any of Examples 135-151 and 154-157, wherein in top plan view, the wall of at least one of the footrope unit bodies is shaped as a trapezoid that exhibits different angles forming its corners at one lateral end in comparison with angles forming its corners at its other lateral end.
167. The footrope of any of Example 157-166, wherein a side end plate may be situated at one or both of lateral sides of the wall of at least one of the footrope unit bodies, each side end plate at least partially obstructing an associated lateral side channel opening of an associated wall.
168. The footrope of Example 167, wherein at least one of the footrope unit bodies has a side end plate is situated at each lateral side of its wall.
169. The footrope of any of Examples 135-151, wherein the forward facing surface is a convex cambered forward facing surface, a convex sloping forward facing surface, a convex bent forward facing surface, and/or a convex multiply bent forward facing surface.
170. The footrope of any of Examples 135-149 and 151-169, wherein each footrope unit body is connected to a line via at least one connector such the footrope unit bodies are connected to one another via the line and the connectors, the line being a main tow chain of the footrope or a fishing line of the bottom trawl.
171. The footrope of Example 170, wherein each connector is rigidly attached to the wall of an associated footrope unit body such that each connector is prevented or substantially prevented from moving relative to an associated footrope unit body during use.
172. The footrope of Example 170, wherein each connector is moveably connected to the wall of an associated footrope unit body such that each connector is moveable relative to the associated footrope unit body during use.
173. The footrope of any of Examples 179-172, wherein the line is the main tow chain line of the footrope, each footrope further comprising at least one body-to-line connector, each body-to-line connector being configured to directly and/or indirectly connect an associated footrope unit body to the fishing line of the bottom trawl.
174. The footrope of Example 173, wherein each body-to-line connector is configured to be directly connected to the fishing line so as to directly connect the footrope unit bodies to the fishing line.
175. The footrope unit body assembly of Example 173, wherein each body-to-line connector is configured to be indirectly connected to the fishing line so as to indirectly connect the footrope unit bodies to the fishing line.
176. The footrope of Example 175, wherein each body-to-line connector is connected to the fishing line via an associated drop chain.
177. The footrope of Example 175, wherein each body-to-line connector is configured to connect an associated footrope unit body to a false fishing line of the footrope, the false fishing line being connected to the fishing line such that the footrope unit body is indirectly connected to the fishing line via at least the body-to-line connector and the false fishing line.
178. The footrope of Example 177, wherein each body-to-line connector is connected to the false fishing line and an associated footrope unit body in such a manner that the body-to-line connector is prevented from freely sliding along a portion of the entire exterior surface of the false fishing line.
179. The footrope of any of Examples 173-178, wherein each body-to-line connector is connected directly to the wall of an associated footrope unit body via being threaded through through-holes of the wall.
180. The footrope of any of Examples 173-178, wherein each footrope unit body includes at least one ear attached thereto, each body-to-line connector being connected to an associated ear.
181. The footrope of any of Examples 170-180, wherein each footrope unit body is configured to be connected to a barrier structure of the bottom trawl via a barrier connector.
182. The footrope of any of Examples 170-180, wherein at least one of the footrope unit bodies includes a sleeve rigidly attached to the rearward facing surface of the footrope unit body, at least a portion of an associated connector being located in the sleeve.
183. The footrope of Example 170, wherein at least one of the connectors comprises at least one sleeve that is rigidly attached to the rearward facing surface of an associated footrope unit body.
184. The footrope of Example 170, wherein each connector comprises at least one body-to-line connector and the line is the fishing line of the bottom trawl, each body-to-line connector being configured to directly and/or indirectly connecting an associated footrope unit body to the fishing line of the bottom trawl.
185. The footrope of Example 184, wherein each body-to-line connector is configured to be directly connected to the fishing line so as to directly connect an associated footrope unit body to fishing line.
186. The footrope of Example 184, wherein each body-to-line connector is configured to be indirectly connected to the fishing line so as to indirectly connect an associated footrope unit body to fishing line.
187. The footrope of Example 186, wherein each body-to-line connector is connected to the fishing line via an associated drop chain.
188. The footrope of Example 184, wherein each body-to-line connector is configured to connect an associated footrope unit body to a false fishing line of the footrope, the false fishing line being connected to the fishing line such that each footrope unit body is indirectly connected to the fishing line via an associated body-to-line connector and the false fishing line.
189. The footrope of Example 188, wherein each body-to-line connector is connected to the false fishing line and an associated footrope unit body in such a manner that each body-to-line connector is prevented from freely sliding along a portion of the entire exterior surface of the false fishing line.
190. The footrope of any of Examples 184-189, wherein each body-to-line connector is connected directly to the wall of an associated footrope unit body via being threaded through through-holes of the wall.
191. The footrope of any of Examples 184-190, wherein each footrope unit body has at least one ear attached thereto, each body-to-line connector being connected to an associated ear.
192. The footrope of any of Examples 184-191, wherein each footrope unit body is configured to be connected to a barrier structure of the bottom trawl via an associated barrier connector.
193. The footrope of any of Examples 135-151 and 153-192, wherein at least one of the footrope unit bodies includes at least one spanning bridge that is separate from and connected to the wall on a rearward side of the wall so as to span at least a portion of the rearward side of the wall.
194. The footrope of any of Examples 135-193, wherein the wall of each footrope unit body includes at least one flange connected thereto that extends laterally outward beyond a corresponding lateral edge of the wall, each flange of each footrope unit body being configured to overlap a portion of a separate and directly adjacent footrope unit body.
195. The footrope of any of Examples 135-194, wherein the wall of at least one of the footrope unit bodies has a total height that is equal to its total width.
196. The footrope of any of Examples 135-194, wherein the wall of at least one of the footrope unit bodies has a ratio of a total and/or average width of the wall to a total and/or average height of the wall in the range of 1.01:1 to 22:1.
197. The footrope of any of Examples 135-196, wherein the footrope has at least one starboard segment having a plurality of the footrope unit bodies, at least one port segment having a plurality of the footrope unit bodies, and a central segment having a plurality of the footrope unit bodies.
198. The footrope of Example 197, wherein the footrope unit bodies of the central segment have a different width than a width of the footrope unit bodies of the starboard segment and/or than a width of the footrope unit bodies of the port segment.
199. The footrope of Example 198, wherein the width of the footrope unit bodies of the central segment is lesser width than the width of the footrope unit bodies of the starboard segment and/or than the width of the footrope unit bodies of the port segment.
200. The footrope of any of Examples 135-196, wherein the footrope has at least one starboard segment having a plurality of the footrope unit bodies, at least one port segment having a plurality of the footrope unit bodies, and a central segment having a plurality of the footrope unit bodies, the shape of the footrope unit bodies of the central segment being different than the shape of the footrope unit bodies of the at least one starboard segment and/or the shape of the footrope unit body of the at least one port segment.
201. The footrope of Example 200, wherein a side plan view profile of the wall of each footrope unit body of the central segment is or is substantially a tear drop shape and/or an airfoil shape, and
(a) a side plan view profile of the wall of each footrope unit body of the at least one starboard segment is a half annulus, and/or
(b) a side plan view profile of the wall of each footrope unit body of the at least one port segment is a half annulus.
202. The footrope of Example 200, wherein a top plan view profile of the wall of each footrope unit body of the central segment is a square and/or rectangle, and
(a) a top plan view profile of the wall of each footrope unit body of the at least one starboard segment is a parallelogram, and/or
(b) a top plan view profile of the wall of each footrope unit body of the at least one port segment is a parallelogram.
203. The footrope of any of Examples 135-202, wherein at least one of the walls includes at least one perforation and/or at least one perforated slit.
204. The footrope of any of Examples 135-203, wherein each footrope unit body is formed from a synthetic material and/or metal.
205. The footrope of any of Examples 135-143 and 146-204, wherein at least one of the footrope unit bodies is formed from a synthetic material and at least one of the footrope unit bodies is formed from metal.
206. The footrope of Example 205, wherein the footrope unit bodies are arranged such that the synthetic material footrope unit bodies are arranged in alternating order with the metal footrope unit bodies.
207. A bottom trawl, comprising the footrope of any of Examples 135-206.
208. The bottom trawl of Example 207, wherein the footrope comprises a main tow chain, the bottom trawl further comprising a fishing line, each of the footrope unit bodies being connected directly and/or indirectly to each of the main tow chain and the fishing line, the main tow chain and/or the bottom trawl being configured such that fishing line is located aft of the main tow chain at least during use.
209. The footrope of Example 135, further comprising a plurality of connectors, each connector being rigidly attached to the wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
210. The footrope of Example 135, wherein a side plan view profile of the wall of at least a portion of the plurality of footrope unit bodies being or substantially being a tear drop shape and/or an airfoil shape.
211. A bottom trawl, comprising:
a fishing line; and
the footrope of Example 135 connected to the fishing line, the footrope comprising a main tow chain configured such that the fishing line is located aft of the main tow chain, the plurality of footrope unit bodies connected to and connected to one another via the main tow chain.
212. A bottom trawl, comprising:
a fishing line; and
the footrope of Example 135, the footrope including a main tow chain, a false fishing line, and a plurality of slidable connectors, the slidable connectors connecting the false fishing line to the fishing line, each slidable connector being slidably connected to and slidable along a portion of the false fishing line, the footrope unit bodies being connected to the main tow chain and the false fishing line.
213. A footrope for a bottom trawl, the footrope comprising:
a plurality of footrope unit bodies; and
a plurality of connectors, each connector being rigidly attached to a wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
214. The footrope of Example 213, wherein each connector has a first portion on a forward side of the wall of an associated footrope unit body and a second portion on a rearward side of the wall of the associated footrope unit body.
215. The footrope of any of Examples 213-214, wherein the line is the main tow chain line of the footrope, each footrope further comprising at least one body-to-line connector, each body-to-line connector being configured to directly and/or indirectly connect an associated footrope unit body to the fishing line of the bottom trawl.
216. The footrope of Example 215, wherein each body-to-line connector is configured to be directly connected to the fishing line so as to directly connect the footrope unit bodies to the fishing line.
217. The footrope unit body assembly of Example 215, wherein each body-to-line connector is configured to be indirectly connected to the fishing line so as to indirectly connect the footrope unit bodies to the fishing line.
218. The footrope of Example 217, wherein each body-to-line connector is connected to the fishing line via an associated drop chain.
219. The footrope of Example 217, wherein each body-to-line connector is configured to connect an associated footrope unit body to a false fishing line of the footrope, the false fishing line being connected to the fishing line such that the footrope unit body is indirectly connected to the fishing line via at least the body-to-line connector and the false fishing line.
220. The footrope of Example 219, wherein each body-to-line connector is connected to the false fishing line and an associated footrope unit body in such a manner that the body-to-line connector is prevented from freely sliding along a portion of the entire exterior surface of the false fishing line.
221. The footrope of any of Examples 215-220, wherein each body-to-line connector is connected directly to the wall of an associated footrope unit body via being threaded through through-holes of the wall.
222. The footrope of any of Examples 215-220, wherein each footrope unit body includes at least one ear attached thereto, each body-to-line connector being connected to an associated ear.
223. The footrope of any of Examples 213-222, wherein each footrope unit body is configured to be connected to a barrier structure of the bottom trawl via a barrier connector.
224. The footrope of any of Examples 213-222, wherein at least one of the footrope unit bodies includes a sleeve rigidly attached to the rearward facing surface of the footrope unit body, at least a portion of an associated connector being located in the sleeve.
225. The footrope of Example 213, wherein at least one of the connectors comprises at least one sleeve that is rigidly attached to the rearward facing surface of an associated footrope unit body.
226. The footrope of any of Examples 213-225, wherein the wall of at least one of the footrope unit bodies is configured such that, in use, at least a convex portion of a forward facing surface of the wall is directed away from a surface on and/or above which the footrope unit body is situated, and/or at least a concave portion of a rearward facing surface of the wall is directed toward the surface on and/or above which the footrope unit body is situated.
227. The footrope of any of Examples 213-225, wherein a side plan view profile of at least one of the walls is or is substantially a tear drop shape and/or an airfoil shape.
228. The footrope of Example 227, wherein each tear drop shaped wall is truncated such that each tear dropped shaped wall has an opening at a narrow and rearward end of each tear dropped shaped wall.
229. The footrope of any of Examples 213-228, wherein the wall of at least one of the footrope unit bodies is a multiply bent plate and/or wall having a cross-sectional and or side plan view shape that corresponds to a portion of a polygon.
230. The footrope of any of Examples 213-228, wherein the wall of at least one of the footrope unit bodies is a multiply bent plate and/or wall, a forward facing surface and/or a rearward facing surface of each multiply bent plate and/or wall having multiple flat sides and/or facets.
231. The footrope of any of Examples 229-230, wherein at least the forward facing surface of each multiply bent plate and/or wall has multiple flat sides and/or facets.
232. The footrope of any of Examples 213-226 and 229-231, wherein the wall of at least one of the footrope unit bodies is shaped as a half-annulus in cross-section and/or when viewed in side plan view.
233. The footrope of any of Examples 213-226 and 229-231, wherein a cross-sectional and/or side plan view shape of the wall of at least one of the footrope unit bodies is an arcuate shape that is greater than half an annulus, but less than a full annulus.
234. The footrope of any of Examples 213-226 and 229-231, wherein the wall of at least one of the footrope unit bodies has an upper flat portion at and/or adjacent to upper edge of the wall, the upper flat portion that extends vertically upward and aft from a portion of the wall that has a convex forward facing surface and/or a concave rearward facing surface to or toward the upper edge of the wall.
235. The footrope of Example 234, wherein for each footrope unit body that includes an upper flat portion, the wall has a lower flat portion at and/or adjacent to the lower edge of the wall, the lower flat portion extending aft from the portion of the wall that has the convex forward facing surface and/or the concave rearward facing surface to or toward the lower edge of the wall.
236. The footrope of Example 235, wherein for each footrope unit body that includes the upper and lower flat portions, the lower flat portion extends vertically downward and aft from the portion of the wall that has the convex forward facing surface and/or the concave rearward facing surface to or toward the upper edge of the wall.
237. The footrope of Example 236, wherein a slope of the upper flat portion is the same as or different than the lower flat portion.
238. The footrope of Example 234, wherein for each footrope unit body that includes an upper flat portion, a lower plate is attached to the rearward side of the wall at and/or adjacent to the lower edge of the wall, the flat plate extending forward and vertically upward from where the plate is attached to the rearward side of the wall.
239. The footrope of any of Examples 213-226 and 229-231, wherein for at least one of the footrope unit bodies:
at an upper portion of the wall, at least a portion a forward facing surface of the wall is concave and at least a portion of a rearward facing surface of the wall is convex, and
at a lower portion of the wall, at least a portion of the forward facing surface is convex and at least a portion of the rearward facing portion is concave, the lower portion extending vertically downward form the upper portion, the upper portion including an upper edge of the wall, the lower portion including a lower edge of the wall.
240. The footrope of any of Examples 213-226 and 229-232, wherein in top plan view, the wall of at least one of the footrope unit bodies is shaped as a parallelogram.
241. The footrope of any of Examples 213-226 and 229-232, wherein in top plan view, the wall of at least one of the footrope unit bodies is shaped as a trapezoid that exhibits different angles forming its corners at one lateral end in comparison with angles forming its corners at its other lateral end.
242. The footrope of any of Example 232-241, wherein a side end plate may be situated at one or both of lateral sides of the wall of at least one of the footrope unit bodies, each side end plate at least partially obstructing an associated lateral side channel opening of an associated wall.
243. The footrope of Example 242, wherein at least one of the footrope unit bodies has a side end plate is situated at each lateral side of its wall.
244. The footrope of any of Examples 213-226, wherein the forward facing surface is a convex cambered forward facing surface, a convex sloping forward facing surface, a convex bent forward facing surface, and/or a convex multiply bent forward facing surface.
245. The footrope of any of Examples 213-226 and 229-244, wherein at least one of the footrope unit bodies includes at least one spanning bridge that is separate from and connected to the wall on a rearward side of the wall so as to span at least a portion of the rearward side of the wall.
246. The footrope of any of Examples 213-245, wherein the wall of each footrope unit body includes at least one flange connected thereto that extends laterally outward beyond a corresponding lateral edge of the wall, each flange of each footrope unit body being configured to overlap a portion of a separate and directly adjacent footrope unit body.
247. The footrope of any of Examples 213-246, wherein the wall of at least one of the footrope unit bodies has a total height that is equal to its total width.
248. The footrope of any of Examples 213-246, wherein the wall of at least one of the footrope unit bodies has a ratio of a total and/or average width of the wall to a total and/or average height of the wall in the range of 1.01:1 to 22:1.
249. The footrope of any of Examples 213-248, wherein the footrope has at least one starboard segment having a plurality of the footrope unit bodies, at least one port segment having a plurality of the footrope unit bodies, and a central segment having a plurality of the footrope unit bodies.
250. The footrope of Example 249, wherein the footrope unit bodies of the central segment have a different width than a width of the footrope unit bodies of the starboard segment and/or than a width of the footrope unit bodies of the port segment.
251. The footrope of Example 250, wherein the width of the footrope unit bodies of the central segment is lesser width than the width of the footrope unit bodies of the starboard segment and/or than the width of the footrope unit bodies of the port segment.
252. The footrope of any of Examples 213-248, wherein the footrope has at least one starboard segment having a plurality of the footrope unit bodies, at least one port segment having a plurality of the footrope unit bodies, and a central segment having a plurality of the footrope unit bodies, the shape of the footrope unit bodies of the central segment being different than the shape of the footrope unit bodies of the at least one starboard segment and/or the shape of the footrope unit body of the at least one port segment.
253. The footrope of Example 252, wherein a side plan view profile of the wall of each footrope unit body of the central segment is or is substantially a tear drop shape and/or an airfoil shape, and
(a) a side plan view profile of the wall of each footrope unit body of the at least one starboard segment is a half annulus, and/or
(b) a side plan view profile of the wall of each footrope unit body of the at least one port segment is a half annulus.
254. The footrope of Example 252, wherein a top plan view profile of the wall of each footrope unit body of the central segment is a square and/or rectangle, and
(a) a top plan view profile of the wall of each footrope unit body of the at least one starboard segment is a parallelogram, and/or
(b) a top plan view profile of the wall of each footrope unit body of the at least one port segment is a parallelogram.
255. The footrope of any of Examples 213-254, wherein at least one of the walls includes at least one perforation and/or at least one perforated slit.
256. The footrope of any of Examples 213-255, wherein each footrope unit body is formed from a synthetic material and/or metal.
257. The footrope of any of Examples 213-256, wherein at least one of the footrope unit bodies is formed from a synthetic material and at least one of the footrope unit bodies is formed from metal.
258. The footrope of Example 257, wherein the footrope unit bodies are arranged such that the synthetic material footrope unit bodies are arranged in alternating order with the metal footrope unit bodies.
259. A bottom trawl, comprising the footrope of any of Examples 213-258.
260. The bottom trawl of Example 259, wherein the footrope comprises a main tow chain, the bottom trawl further comprising a fishing line, each of the footrope unit bodies being connected directly and/or indirectly to each of the main tow chain and the fishing line, the main tow chain and/or the bottom trawl being configured such that fishing line is located aft of the main tow chain at least during use.
261. The footrope of Example 213, wherein a side plan view profile of the wall of at least a portion of the plurality of footrope unit bodies is or substantially is a tear drop shape and/or an airfoil shape.
262. The footrope of Example 213, wherein each wall has a forward facing surface, at least the forward facing surface of at least a portion of the walls being a multiply bent surface having multiple flat sides and/or facets.
263. The footrope of Example 213, wherein at least one of the walls has a forward facing surface, a rearward facing surface opposite the forward facing surface, at least one first wall region, and at least one second wall region, the forward facing surface being at least partially convex, the rearward facing surface being at least partially concave, the at least one second wall region having a different thickness than a thickness of the at least one first wall region.
264. The footrope of Example 213, wherein for at least one of the walls, the wall comprise a body in the form of a bent plate and at least one exterior feature, the body having the forward facing surface, the at least one exterior feature being connected to and/or at least partially recessed into the forward facing surface, portions of the wall that include the exterior feature having a greater thickness than the portions of the wall that do not include the exterior feature.
265. A bottom trawl, comprising:
the fishing line; and
the footrope of Example 213 connected to the fishing line, the footrope comprising the main tow chain configured such that the fishing line is located aft of the main tow chain, the plurality of footrope unit bodies connected to and connected to one another via the main tow chain.
266. A bottom trawl, comprising:
the fishing line; and
the footrope of Example 213, the footrope including the main tow chain, a false fishing line, and a plurality of slidable connectors, the slidable connectors connecting the false fishing line to the fishing line, each slidable connector being slidably connected to and slidable along a portion of the false fishing line, the footrope unit bodies being connected to the main tow chain and the false fishing line.
267. A footrope for a bottom trawl, the footrope comprising a plurality of footrope unit bodies, a side plan view profile of a wall of at least a portion of the plurality of footrope unit bodies being or substantially being a tear drop shape and/or an airfoil shape.
268. The footrope of Example 267, wherein each tear drop shaped wall includes a cylindrical pipe portion and an extension portion that extends from the cylindrical pipe portion, the cylindrical pipe portion and the extension portion collectively defining the tear drop shape of each tear drop shaped wall.
269. The footrope of Example 267, wherein each cylindrical pipe portion defines a pipe opening that extends widthwise and/or laterally through the cylindrical pipe portion, each pipe opening being configured to receive a roller therein, each roller being configured to be attached to a main tow chain of the footrope and/or a fishing line of the bottom trawl in such a manner that each tear dropped shaped wall is rotatable about a central axis of the pipe opening when in use.
270. The footrope of Example 267, wherein each tear drop and/or airfoil shaped wall includes a support structure connected to at least a rearward facing surface of the tear drop and/or airfoil shaped wall, each support structure being in the shape of a cylinder or a half annulus.
271. The footrope of any of Examples 267 and 270, wherein each tear drop and/or air foil shaped wall has an opening at a narrow and rearward end of the tear drop and/or air foil shaped wall.
272. The footrope of Example 271, wherein each opening is configured to receive a fishing line of the bottom trawl and a portion of a bottom netting panel of the bottom trawl that is adjacent and/or proximal to the fishing line, the bottom netting panel being connected to the fishing line.
273. The footrope of any of Examples 267-272, wherein the wall of each footrope unit body includes at least one flange connected thereto that extends laterally outward beyond a corresponding lateral edge of the wall, each flange of each footrope unit body being configured to overlap a portion of a separate and directly adjacent footrope unit body.
274. The footrope of any of Examples 267-273, wherein the wall of at least one of the footrope unit bodies has a total height that is equal to its total width.
275. The footrope of any of Examples 267-273, wherein the wall of at least one of the footrope unit bodies has a ratio of a total and/or average width of the wall to a total and/or average height of the wall in the range of 1.01:1 to 22:1.
276. The footrope of any of Examples 267-275, wherein the footrope has at least one starboard segment having a plurality of the footrope unit bodies, at least one port segment having a plurality of the footrope unit bodies, and a central segment having a plurality of the footrope unit bodies.
277. The footrope of Example 276, wherein the footrope unit bodies of the central segment have a different width than a width of the footrope unit bodies of the starboard segment and/or than a width of the footrope unit bodies of the port segment.
278. The footrope of Example 277, wherein the width of the footrope unit bodies of the central segment is lesser width than the width of the footrope unit bodies of the starboard segment and/or than the width of the footrope unit bodies of the port segment.
279. The footrope of any of Examples 267-275, wherein the footrope has at least one starboard segment having a plurality of the footrope unit bodies, at least one port segment having a plurality of the footrope unit bodies, and a central segment having a plurality of the footrope unit bodies, the shape of the footrope unit bodies of the central segment being different than the shape of the footrope unit bodies of the at least one starboard segment and/or the shape of the footrope unit body of the at least one port segment.
280. The footrope of Example 279, wherein each footrope unit body of the central segment has or substantially has the tear drop shape and/or the airfoil shape, and
(a) a side plan view profile of the wall of each footrope unit body of the at least one starboard segment is a half annulus, and/or
(b) a side plan view profile of the wall of each footrope unit body of the at least one port segment is a half annulus.
281. The footrope of Example 280, wherein a top plan view profile of the wall of each footrope unit body of the central segment is a square and/or rectangle, each footrope unit body of the central segment having the tear drop shape and/or the airfoil shape, and
(a) a top plan view profile of the wall of each footrope unit body of the at least one starboard segment is a parallelogram, and/or
(b) a top plan view profile of the wall of each footrope unit body of the at least one port segment is a parallelogram.
282. The footrope of any of Examples 267-281, wherein each footrope unit body is connected to a line via at least one connector such the footrope unit bodies are connected to one another via the line and the connectors, the line being a main tow chain of the footrope or a fishing line of the bottom trawl.
283. The footrope of Example 282, wherein each connector is rigidly attached to the wall of an associated footrope unit body such that each connector is prevented or substantially prevented from moving relative to an associated footrope unit body during use.
284. The footrope of Example 282, wherein each connector is moveably connected to the wall of an associated footrope unit body such that each connector is moveable relative to the associated footrope unit body during use.
285. The footrope of any of Examples 282-284, wherein the line is the main tow chain line of the footrope, each footrope further comprising at least one body-to-line connector, each body-to-line connector being configured to directly and/or indirectly connect an associated footrope unit body to the fishing line of the bottom trawl.
286. The footrope of Example 285, wherein each body-to-line connector is configured to be directly connected to the fishing line so as to directly connect the footrope unit bodies to the fishing line.
287. The footrope unit body assembly of Example 285, wherein each body-to-line connector is configured to be indirectly connected to the fishing line so as to indirectly connect the footrope unit bodies to the fishing line.
288. The footrope of Example 287, wherein each body-to-line connector is connected to the fishing line via an associated drop chain.
289. The footrope of Example 287, wherein each body-to-line connector is configured to connect an associated footrope unit body to a false fishing line of the footrope, the false fishing line being connected to the fishing line such that the footrope unit body is indirectly connected to the fishing line via at least the body-to-line connector and the false fishing line.
290. The footrope of Example 289, wherein each body-to-line connector is connected to the false fishing line and an associated footrope unit body in such a manner that the body-to-line connector is prevented from freely sliding along a portion of the entire exterior surface of the false fishing line.
291. The footrope of any of Examples 285-290, wherein each body-to-line connector is connected directly to the wall of an associated footrope unit body via being threaded through through-holes of the wall.
292. The footrope of any of Examples 285-290, wherein each footrope unit body includes at least one ear attached thereto, each body-to-line connector being connected to an associated ear.
293. The footrope of any of Examples 285-292, wherein each footrope unit body is configured to be connected to a barrier structure of the bottom trawl via a barrier connector.
294. The footrope of any of Examples 285-292, wherein at least one of the footrope unit bodies includes a sleeve rigidly attached to the rearward facing surface of the footrope unit body, at least a portion of an associated connector being located in the sleeve.
295. The footrope of Example 285, wherein at least one of the connectors comprises at least one sleeve that is rigidly attached to the rearward facing surface of an associated footrope unit body.
296. The footrope of Example 285, wherein each connector comprises at least one body-to-line connector and the line is the fishing line of the bottom trawl, each body-to-line connector being configured to directly and/or indirectly connecting an associated footrope unit body to the fishing line of the bottom trawl.
297. The footrope of Example 296, wherein each body-to-line connector is configured to be directly connected to the fishing line so as to directly connect an associated footrope unit body to fishing line.
298. The footrope of Example 296, wherein each body-to-line connector is configured to be indirectly connected to the fishing line so as to indirectly connect an associated footrope unit body to fishing line.
299. The footrope of Example 298, wherein each body-to-line connector is connected to the fishing line via an associated drop chain.
300. The footrope of Example 296, wherein each body-to-line connector is configured to connect an associated footrope unit body to a false fishing line of the footrope, the false fishing line being connected to the fishing line such that each footrope unit body is indirectly connected to the fishing line via an associated body-to-line connector and the false fishing line.
301. The footrope of Example 300, wherein each body-to-line connector is connected to the false fishing line and an associated footrope unit body in such a manner that each body-to-line connector is prevented from freely sliding along a portion of the entire exterior surface of the false fishing line.
302. The footrope of any of Examples 296-301, wherein each body-to-line connector is connected directly to the wall of an associated footrope unit body via being threaded through through-holes of the wall.
303. The footrope of any of Examples 296-302, wherein each footrope unit body has at least one ear attached thereto, each body-to-line connector being connected to an associated ear.
304. The footrope of any of Examples 296-303, wherein each footrope unit body is configured to be connected to a barrier structure of the bottom trawl via an associated barrier connector.
305. The footrope of any of Examples 267-304, wherein the wall of at least one of the footrope unit bodies is configured such that, in use, at least a convex portion of a forward facing surface of the wall is directed away from a surface on and/or above which the footrope unit body is situated, and/or at least a concave portion of a rearward facing surface of the wall is directed toward the surface on and/or above which the footrope unit body is situated.
306. The footrope of any of Examples 267-305, wherein the wall of at least one of the footrope unit bodies is a multiply bent plate and/or wall having a cross-sectional and or side plan view shape that corresponds to a portion of a polygon.
307. The footrope of any of Examples 267-305, wherein the wall of at least one of the footrope unit bodies is a multiply bent plate and/or wall, a forward facing surface and/or a rearward facing surface of each multiply bent plate and/or wall having multiple flat sides and/or facets.
308. The footrope of any of Examples 306-307, wherein at least the forward facing surface of each multiply bent plate and/or wall has multiple flat sides and/or facets.
309. The footrope of any of Examples 267-308, wherein at least one of the walls includes at least one perforation and/or at least one perforated slit.
310. The footrope of any of Examples 267-309, wherein each footrope unit body is formed from a synthetic material and/or metal.
311. The footrope of any of Examples 267-310, wherein at least the tear drop and/or airfoil shaped walls are formed from a deformable or elastically deformable material.
312. A bottom trawl, comprising the footrope of any of Examples 267-311.
313. The bottom trawl of Example 312, wherein the footrope comprises a main tow chain, the bottom trawl further comprising a fishing line, each of the footrope unit bodies being connected directly and/or indirectly to each of the main tow chain and the fishing line, the main tow chain and/or the bottom trawl being configured such that fishing line is located aft of the main tow chain at least during use.
314. The footrope of Example 267, wherein at least a forward facing surface of at least a portion of the walls being a multiply bent surface having multiple flat sides and/or facets.
315. The footrope of Example 267, wherein at least one of the walls has a forward facing surface, a rearward facing surface opposite the forward facing surface, at least one first wall region, and at least one second wall region, the forward facing surface being at least partially convex, the rearward facing surface being at least partially concave, the at least one second wall region having a different thickness than a thickness of the at least one first wall region.
316. The footrope of Example 267, wherein for at least one of the walls, the wall comprise a body in the form of a bent plate and at least one exterior feature, the body having the forward facing surface, the at least one exterior feature being connected to and/or at least partially recessed into the forward facing surface, portions of the wall that include the exterior feature having a greater thickness than the portions of the wall that do not include the exterior feature.
317. A bottom trawl, comprising:
a fishing line; and
the footrope of Example 267 connected to the fishing line, the footrope comprising a main tow chain configured such that the fishing line is located aft of the main tow chain, the plurality of footrope unit bodies connected to and connected to one another via the main tow chain.
318. A bottom trawl, comprising:
a fishing line; and
the footrope of Example 267, the footrope including a main tow chain, a false fishing line, and a plurality of slidable connectors, the slidable connectors connecting the false fishing line to the fishing line, each slidable connector being slidably connected to and slidable along a portion of the false fishing line, the footrope unit bodies being connected to the main tow chain and the false fishing line.
319. The footrope of Example 267, wherein at least a portion of the plurality of footrope unit bodies having a varying thickness, each varying thickness footrope unit body having at least one first wall region and at least one second wall region, the at least one second wall regions having a different thickness than a thickness of the at least one first wall regions.
320. A footrope for a bottom trawl, the footrope comprising a plurality of footrope unit bodies each having a wall with a forward facing surface, at least the forward facing surface of at least a portion of the walls being a multiply bent surface having multiple flat sides and/or facets.
321. The footrope of Example 320, wherein at least a portion of each multiply bent forward facing surface is convex.
322. The footrope of any of Examples 320-321, wherein each wall has a rearward facing surface opposite the forward facing surface, and wherein the rearward surface of each wall that has the multiply bent forward facing surface is a multiply bent surface having multiple flat sides and/or facets.
333. The footrope of Example 322, wherein at least a portion of each multiply bent rearward facing surface is concave.
334. The footrope of any of Examples 320-333, wherein each wall that has a multiply bent forward facing surface is a multiply bent plate.
335. The footrope of any of Examples 320-334, wherein each wall that has a multiply bent forward facing surface has a cross-sectional and or side plan view shape that corresponds to a portion of a polygon.
336. The footrope of any of Examples 320-335, wherein upper and lower edges of at least the footrope unit bodies that have the multiply bent surface are each at least partially enclosed in a shoe.
337. The footrope of any of Examples 320-335, wherein each wall that has the multiply bent surface includes at least one spanning bridge connected thereto, each spanning bridge being separate from and connected to an associated wall on a rearward side of the associated wall so as to span at least a portion of the rearward side of the associated wall.
338. The footrope of Example 337, wherein each spanning bridge spans between lateral edges of an associated wall such that a first lateral end of each spanning bridge is connected to the associated wall adjacent to a first one of the lateral edges of the associated wall and a second lateral end of each spanning bridge is connected to the associated wall adjacent to a second one of the lateral edges.
339. The footrope of Example 338, wherein the lateral edges and the upper and lower edges of each wall that has the multiply bent surface are attached to a frame, the first end of each spanning bridge being attached to an associated frame adjacent the first one of the lateral edges of an associated wall, the second end of each spanning bridge being attached to the associated frame adjacent the second one of the lateral edges of the associated wall.
340. The footrope of Example 337, wherein each spanning bridge is spaced from and spans between the upper and edges of an associated wall such that an upper end of the spanning bridge is connected to a rearward facing surface of the associated wall adjacent to the upper edge of the associated wall and a lower end of the spanning bridge is connected to the rearward facing surface adjacent to the lower edge of the associated wall.
341. The footrope of Example 340, wherein each wall that has the multiply bent surface has a plurality of spanning bridges connected thereto, and wherein for each wall that has a plurality of spanning bridges connected thereto, a first one of the spanning bridges is adjacent to a first one of the lateral edges of the wall and a second one of the spanning bridges is adjacent to a second one of the lateral edges of the wall.
342. The footrope of Example 337, wherein for each wall that has the at least one spanning bridge connected thereto, the at least one spanning bridge spans between the upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
343. The footrope of Example 342, wherein the upper and lower edges of each wall that has the at least one spanning bridge connected thereto are each at least partially enclosed in a shoe, the upper end of each spanning bridge being attached to an associated shoe that at least partially encloses the upper edge of an associated wall, the lower end of each spanning bridge being attached to an associated shoe that at least partially encloses the lower edge of an associated wall.
344. The footrope of any of Examples 342-343, wherein each wall that has the multiply bent surface has a plurality of spanning bridges connected thereto, and wherein for each wall that has a plurality of spanning bridges connected thereto, a first one of the spanning bridges is adjacent to a first one of the lateral edges of the wall and a second one of the spanning bridges is adjacent to a second one of the lateral edges of the wall.
345. The footrope of any of Examples 320-344, wherein each wall that has the multiply bent surface is shaped as a half-annulus in cross-section and/or when viewed in side plan view.
346. The footrope of any of Examples 320-344, wherein a cross-sectional and/or side plan view shape of each wall that has the multiply bent surface is an arcuate shape that is greater than half an annulus, but less than a full annulus.
347. The footrope of any of Examples 320-345, wherein each wall that has the multiply bent surface is shaped as a parallelogram in top plan view.
348. The footrope of any of Examples 320-345, wherein in top plan view, each wall that has the multiply bent surface is shaped as a trapezoid that exhibits different angles forming its corners at one lateral end in comparison with angles forming its corners at its other lateral end.
349. The footrope of any of Example 320-348, wherein a side end plate may be situated at one or both of lateral sides of each wall that has the multiply bent surface, each side end plate at least partially obstructing an associated lateral side channel opening of an associated wall.
350. The footrope of Example 349, wherein a side end plate is situated at each lateral side of each wall that has the multiply bent surface.
351. The footrope of any of Examples 320-350, wherein the wall of each footrope unit body includes at least one flange connected thereto that extends laterally outward beyond a corresponding lateral edge of the wall, each flange of each footrope unit body being configured to overlap a portion of a separate and directly adjacent footrope unit body.
352. The footrope of any of Examples 320-351, wherein the wall of at least one of the footrope unit bodies has a total height that is equal to its total width.
353. The footrope of any of Examples 320-351, wherein the wall of at least one of the footrope unit bodies has a ratio of a total and/or average width of the wall to a total and/or average height of the wall in the range of 1.01:1 to 22:1.
354. The footrope of any of Examples 320-353, wherein the footrope has at least one starboard segment having a plurality of the footrope unit bodies, at least one port segment having a plurality of the footrope unit bodies, and a central segment having a plurality of the footrope unit bodies.
355. The footrope of Example 354, wherein the footrope unit bodies of the central segment have a different width than a width of the footrope unit bodies of the starboard segment and/or than a width of the footrope unit bodies of the port segment.
356. The footrope of Example 355, wherein the width of the footrope unit bodies of the central segment is lesser width than the width of the footrope unit bodies of the starboard segment and/or than the width of the footrope unit bodies of the port segment.
357. The footrope of any of Examples 320-356, wherein the footrope has at least one starboard segment having a plurality of the footrope unit bodies, at least one port segment having a plurality of the footrope unit bodies, and a central segment having a plurality of the footrope unit bodies, the shape of the footrope unit bodies of the central segment being different than the shape of the footrope unit bodies of the at least one starboard segment and/or the shape of the footrope unit body of the at least one port segment.
358. The footrope of Example 357, wherein a top plan view profile of the wall of each footrope unit body of the central segment is a square and/or rectangle, and
(a) a top plan view profile of the wall of each footrope unit body of the at least one starboard segment is a parallelogram, and/or
(b) a top plan view profile of the wall of each footrope unit body of the at least one port segment is a parallelogram.
359. The footrope of any of Examples 320-358, wherein each footrope unit body is connected to a line via at least one connector such the footrope unit bodies are connected to one another via the line and the connectors, the line being a main tow chain of the footrope or a fishing line of the bottom trawl.
360. The footrope of Example 359, wherein each connector is rigidly attached to the wall of an associated footrope unit body such that each connector is prevented or substantially prevented from moving relative to an associated footrope unit body during use.
361. The footrope of Example 359, wherein each connector is moveably connected to the wall of an associated footrope unit body such that each connector is moveable relative to the associated footrope unit body during use.
362. The footrope of any of Examples 359-361, wherein the line is the main tow chain line of the footrope, each footrope further comprising at least one body-to-line connector, each body-to-line connector being configured to directly and/or indirectly connect an associated footrope unit body to the fishing line of the bottom trawl.
363. The footrope of Example 362, wherein each body-to-line connector is configured to be directly connected to the fishing line so as to directly connect the footrope unit bodies to the fishing line.
364. The footrope unit body assembly of Example 362, wherein each body-to-line connector is configured to be indirectly connected to the fishing line so as to indirectly connect the footrope unit bodies to the fishing line.
365. The footrope of Example 364, wherein each body-to-line connector is connected to the fishing line via an associated drop chain.
366. The footrope of Example 364, wherein each body-to-line connector is configured to connect an associated footrope unit body to a false fishing line of the footrope, the false fishing line being connected to the fishing line such that the footrope unit body is indirectly connected to the fishing line via at least the body-to-line connector and the false fishing line.
367. The footrope of Example 366, wherein each body-to-line connector is connected to the false fishing line and an associated footrope unit body in such a manner that the body-to-line connector is prevented from freely sliding along a portion of the entire exterior surface of the false fishing line.
368. The footrope of any of Examples 362-367, wherein each body-to-line connector is connected directly to the wall of an associated footrope unit body via being threaded through through-holes of the wall.
369. The footrope of any of Examples 362-367, wherein each footrope unit body includes at least one ear attached thereto, each body-to-line connector being connected to an associated ear.
370. The footrope of any of Examples 362-369, wherein each footrope unit body is configured to be connected to a barrier structure of the bottom trawl via a barrier connector.
371. The footrope of any of Examples 362-369, wherein at least one of the footrope unit bodies includes a sleeve rigidly attached to the rearward facing surface of the footrope unit body, at least a portion of an associated connector being located in the sleeve.
372. The footrope of Example 362, wherein at least one of the connectors comprises at least one sleeve that is rigidly attached to the rearward facing surface of an associated footrope unit body.
373. The footrope of Example 362, wherein each connector comprises at least one body-to-line connector and the line is the fishing line of the bottom trawl, each body-to-line connector being configured to directly and/or indirectly connecting an associated footrope unit body to the fishing line of the bottom trawl.
374. The footrope of Example 373, wherein each body-to-line connector is configured to be directly connected to the fishing line so as to directly connect an associated footrope unit body to fishing line.
375. The footrope of Example 373, wherein each body-to-line connector is configured to be indirectly connected to the fishing line so as to indirectly connect an associated footrope unit body to fishing line.
376. The footrope of Example 375, wherein each body-to-line connector is connected to the fishing line via an associated drop chain.
377. The footrope of Example 373, wherein each body-to-line connector is configured to connect an associated footrope unit body to a false fishing line of the footrope, the false fishing line being connected to the fishing line such that each footrope unit body is indirectly connected to the fishing line via an associated body-to-line connector and the false fishing line.
378. The footrope of Example 377, wherein each body-to-line connector is connected to the false fishing line and an associated footrope unit body in such a manner that each body-to-line connector is prevented from freely sliding along a portion of the entire exterior surface of the false fishing line.
379. The footrope of any of Examples 373-378, wherein each body-to-line connector is connected directly to the wall of an associated footrope unit body via being threaded through through-holes of the wall.
380. The footrope of any of Examples 373-379, wherein each footrope unit body has at least one ear attached thereto, each body-to-line connector being connected to an associated ear.
381. The footrope of any of Examples 373-380, wherein each footrope unit body is configured to be connected to a barrier structure of the bottom trawl via an associated barrier connector.
382. The footrope unit body of any of Examples 320-381, wherein the wall of at least one of the footrope unit bodies is configured such that, in use, at least a convex portion of the forward facing surface of the wall is directed away from a surface on and/or above which the footrope unit body is situated, and/or at least a concave portion of a rearward facing surface of the wall is directed toward the surface on and/or above which the footrope unit body is situated.
383. The footrope unit body of any of Examples 320-381, wherein at least one of the walls includes at least one perforation and/or at least one perforated slit.
384. The footrope of any of Examples 320-383, wherein each footrope unit body is formed from a synthetic material and/or metal.
385. A bottom trawl, comprising the footrope of any of Examples 320-384.
386. The bottom trawl of Example 385, wherein the footrope comprises a main tow chain, the bottom trawl further comprising a fishing line, each of the footrope unit bodies being connected directly and/or indirectly to each of the main tow chain and the fishing line, the main tow chain and/or the bottom trawl being configured such that fishing line is located aft of the main tow chain at least during use.
387. The footrope of Example 320, wherein each wall has a rearward facing surface, wherein for at least one of thew walls, at least a portion of the forward facing surface is convex, a least a portion of the rearward facing surface is concave, wherein at least a portion of the plurality of footrope unit bodies having a varying thickness, each varying thickness footrope unit body having at least one first wall region and at least one second wall region, the at least one second wall regions having a different thickness than a thickness of the at least one first wall regions.
388. The footrope of Example 320, further comprising a plurality of connectors, each connector being rigidly attached to the wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
389. The footrope of Example 320, wherein a side plan view profile of the wall of at least a portion of the plurality of footrope unit bodies being or substantially being a tear drop shape and/or an airfoil shape.
390. The footrope of Example 320, wherein for at least one of the walls, the wall comprises a body in the form of a bent plate and at least one exterior feature, the body having the forward facing surface, the at least one exterior feature being connected to and/or at least partially recessed into the forward facing surface, portions of the wall that include the exterior feature having a greater thickness than the portions of the wall that do not include the exterior feature.
391. A bottom trawl, comprising:
a fishing line; and
the footrope of Example 320 connected to the fishing line, the footrope comprising a main tow chain configured such that the fishing line is located aft of the main tow chain, the plurality of footrope unit bodies connected to and connected to one another via the main tow chain.
392. A bottom trawl, comprising:
a fishing line; and
the footrope of Example 320, the footrope including a main tow chain, a false fishing line, and a plurality of slidable connectors, the slidable connectors connecting the false fishing line to the fishing line, each slidable connector being slidably connected to and slidable along a portion of the false fishing line, the footrope unit bodies being connected to the main tow chain and the false fishing line.
393. A footrope unit body assembly for a footrope that is for a bottom trawl, the footrope unit body assembly comprising:
a footrope unit body; and
at least one connector for connecting the footrope unit body to a chain and/or cable of the footrope and/or bottom trawl, the at least one connector being rigidly attached to a wall of the footrope unit body such that the at least one connector is prevented or substantially prevented from moving relative to the footrope unit body at least during use.
394. The footrope unit body assembly of Example 393, wherein the chain comprises a main tow chain of the footrope, the at least one connector being configured for connecting the footrope unit body to the main tow chain.
395. The footrope unit body assembly of Example 393, wherein the cable comprises a fishing line of the bottom trawl, the at least one connector being configured for connecting the footrope unit body to the fishing line.
396. The footrope unit body assembly of any of Examples 393-395, wherein the at least one connector includes a first backing plate on a forward facing surface of a wall of the footrope unit body, a second backing plate on and/or adjacent to the rearward facing surface, and at least one fastener extending through the wall from the first backing plate to at least the second backing plate.
397. The footrope unit body assembly of Example 396, wherein the second backing plate includes a notch configured to at least partially receive a portion of the chain and/or a portion of the cable so as to hold the received portion of the chain and/or cable in place between second backing plate and the rearward facing surface.
398. The footrope unit body assembly of any of Examples 396-397, wherein the connector further comprises at least one sleeve rigidly attached to the rearward facing surface of the footrope unit body, at least the second backing plate being located in the at least one sleeve.
399. The footrope unit body assembly of Example 396, wherein the at least one connector further includes a third backing plate on the rearward facing surface such that the third backing plate is interposed between the rearward facing surface and the second backing plate, the at least one fastener extend through the third backing plate.
400. The footrope unit body assembly of Example 399, wherein the second and third backing plates include corresponding and mirrored notches, a portion of the chain and/or a portion of the cable being received between the notches so as to hold the received portion of the chain and/or cable in place between second and third backing plates.
401. The footrope unit body assembly of any of Examples 399-400, wherein the connector further comprises at least one sleeve rigidly attached to the rearward facing surface of the footrope unit body, at least the second and third backing plates being located in the at least one sleeve.
402. The footrope unit body assembly of Example 393, wherein the at least one connector comprises at least one sleeve that is rigidly attached to the rearward facing surface of the footrope unit body.
403. The footrope unit body assembly of any of Examples 394 and 396-402, wherein the cable comprises a fishing line of the bottom trawl, the footrope unit body assembly further comprising at least one body-to-line connector for directly and/or indirectly connecting the footrope unit body to the fishing line of the bottom trawl.
404. The footrope unit body assembly of Example 403, wherein the at least one body-to-line connector is configured to be directly connected to the fishing line so as to directly connect the footrope unit body to the fishing line.
405. The footrope unit body assembly of Example 403, wherein the at least one body-to-line connector is configured to be indirectly connected to the fishing line so as to indirectly connect the footrope unit body to the fishing line.
406. The footrope unit body assembly of Example 405, wherein the at least one body to line connector is connected to the fishing line via a drop chain.
407. The footrope unit body assembly of Example 405, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
408. The footrope unit body assembly of Example 407, wherein each body-to-line connector is connected to the false fishing line and the footrope unit body in such a manner that the body-to-line connector is prevented from freely sliding along a portion of the entire exterior surface of the false fishing line.
409. The footrope unit body assembly of any of Examples 403-408, wherein the at least body-to-line connector comprises a plurality of body-to-line connectors, each body-to-line connector at least partially defining a body-to-line connector aperture.
410. The footrope unit body assembly of Example 409, wherein each body-to-line connector aperture extends perpendicular to a lateral direction, a width of the footrope unit body being measured in the lateral direction.
411. The footrope unit body assembly of Example 409, wherein each body-to-line connector aperture extends in a lateral direction, a width of the footrope unit body being measured in the lateral direction.
412. The footrope unit body assembly of any of Examples 403-411, wherein the at least one body-to-line connector is a quick-link.
413. The footrope unit body assembly of any of Examples 403-412, wherein the body-to-line connector is connected directly to the wall via being threaded through through-holes of the wall.
414. The footrope unit body assembly of any of Examples 403-412, further comprising at least one ear attached to the wall of the footrope unit body, the at least one body-to-line connector being connected to the at least one ear.
415. The footrope unit body assembly of Example 414, wherein the at least one ear is formed by a U-bolt that is affixed to the wall.
416. The footrope unit body assembly of any of Examples 414-415, wherein the at least one ear comprises a plurality of ears, each ear at least partially defining an ear aperture.
417. The footrope unit body assembly of Example 415, wherein each ear aperture extends perpendicular to a lateral direction, a width of the footrope unit body being measured in the lateral direction.
418. The footrope unit body assembly of Example 415, wherein each ear aperture extends in a lateral direction, a width of the footrope unit body being measured in the lateral direction.
419. The footrope unit body assembly of any of Examples 414 and 417-418, wherein the upper and lower edges of the wall are each at least partially enclosed in a shoe, each ear being connected to shoe that encloses the upper edge of the wall.
420. The footrope unit body assembly of any of Examples 414 and 417-418, wherein the lateral sides and the upper and lower edges are attached to a frame, each ear being connected to the frame adjacent to the upper edge.
421. The footrope unit body assembly of any of Examples 393-420, further comprising a barrier connector configured for connecting a barrier structure of the bottom trawl to the footrope unit body.
422. The footrope unit body assembly of any of Examples 393-421, wherein at least a portion of the wall of the footrope unit body is formed from a synthetic material and/or metal, at least a portion of the wall being rigid and/or deformable.
423. The footrope unit body assembly of any of Examples 393-418 and 321-422, wherein the wall has opposing lateral edges and opposing upper and lower edges, the opposing upper and lower edges extending laterally between the lateral edges, the footrope unit body further comprising at least one wear shoe, each wear shoe being on and/or adjacent to an associated one of the lateral edges so as to cover a lower portion of the wall at and/or adjacent to the associated lateral edge, the lower portion of the wall being proximate to the lower edge.
424. The footrope unit body assembly of Example 423, wherein the footrope unit body includes a wear shoe for each lateral edge or for only one of the lateral edges.
425. The footrope unit body assembly of any of Examples 423-424, wherein each wear shoe includes an edge cap plate that is conformed to and covers a portion of an associated one of the lateral edges at the lower portion of the wall.
426. The footrope unit body assembly of any of Examples 423-425, wherein each wear shoe includes a front side surface cap plate that is conformed to and covers a portion of a forward facing surface of the wall at the lower portion of the wall.
427. The footrope unit body assembly of any of Examples 323-426, wherein each wear shoe includes a rear side surface cap plate that is conformed to and covers a portion of a rearward facing surface of the wall at the lower portion of the wall.
428. The footrope unit body assembly of any of Examples 393-427, wherein a total height of the wall is equal to a total width of the wall.
429. The footrope unit body assembly of any of Examples 393-427, wherein a ratio of a total and/or average width of the wall to a total and/or average height of the wall is in the range of 1.01:1 to 22:1.
430. The footrope unit body assembly of any of Examples 393-429, wherein the wall includes at least one perforation and/or at least one perforated slit.
431. The footrope unit body assembly of any of Examples 393-430, wherein the wall is configured such that, in use, at least a convex portion of a forward facing surface of the wall is directed away from a surface on and/or above which the footrope unit body is situated, and/or at least a concave portion of a rearward facing surface of the wall is directed toward the surface on and/or above which the footrope unit body is situated.
432. The footrope unit body assembly of any of Examples 393-431, wherein a side plan view profile of wall is or is substantially a tear drop shape and/or an airfoil shape.
433. The footrope unit body assembly of Example 432, wherein the wall includes a cylindrical pipe portion and an extension portion that extends from the cylindrical pipe portion, the cylindrical pipe portion and the extension portion collectively defining the tear drop shape of the wall.
434. The footrope unit body assembly of Example 432, further comprising a support structure connected to at least a rearward facing surface of the wall, the support structure being in the shape of a cylinder or a half annulus.
435. The footrope unit body assembly of any of Examples 432 and 434, wherein the tear drop shape of the wall is truncated such that the wall has an opening at a narrow and rearward end of the wall.
436. The footrope unit body assembly of any of Examples 393-435, further comprising at least one flange connected to the wall that extends laterally outward beyond a corresponding lateral edge of the wall.
437. The footrope unit body assembly of any of Examples 393-436, further comprising at least one spanning bridge separate from and connected to the wall on a rearward side of the wall so as to span at least a portion of the rearward side of the wall.
438. The footrope unit body assembly of Example 437, wherein the at least one spanning bridge spans between the lateral edges of the wall such that a first lateral end of the at least one spanning bridge is connected to the wall adjacent to a first one of the lateral edges of the wall and a second lateral end of the at least one spanning bridge is connected to the wall adjacent to a second one of the lateral edges.
439. The footrope unit body assembly of any of Examples 438, wherein the lateral edges of the wall and the upper and lower edges are attached to a frame, the first end of the at least one spanning bridge being attached to the frame adjacent the first one of the lateral edges, the second end of the at least one spanning bridge being attached to the frame adjacent the second one of the lateral edges.
440. The footrope unit body assembly of any of Example 437, wherein the at least one spanning bridge is spaced from and spans between the upper and edges of the wall such that an upper end of the at least one spanning bridge is connected to a rearward facing surface of the wall adjacent to the upper edge of the wall and a lower end of the at least one spanning bridge is connected to the rearward facing surface adjacent to the lower edge of the wall.
441. The footrope unit body assembly of Example 440, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
442. The footrope unit body assembly of Example 437, wherein the at least one spanning bridge spans between the upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
443. The footrope unit body assembly of Example 442, wherein the upper and lower edges of the wall are each at least partially enclosed in a shoe, the upper end of the at least one spanning bridge being attached to the shoe that at least partially encloses the upper edge of the wall, the lower end of the at least one spanning bridge being attached to the shoe that at least partially encloses the lower edge of the wall.
444. The footrope unit body assembly of any of Examples 442-443, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
445. The footrope unit body assembly of any of Examples 393-444, wherein the wall is a multiply bent plate and/or wall having a cross-sectional and or side plan view shape that corresponds to a portion of a polygon.
446. The footrope unit body assembly of any of Examples 393-444, wherein the wall is a multiply bent plate and/or wall such that a forward facing surface of the wall and/or a rearward facing surface of the wall has multiple flat sides and/or facets.
447. The footrope unit body assembly of any of Examples 445-446, wherein at least a forward facing surface of the multiply bent wall and/or plate has multiple flat sides and/or facets.
448. The footrope unit body assembly of any of Examples 393-431 and 436-447, wherein the wall is shaped as a half-annulus in cross-section and/or when viewed in side plan view.
449. The footrope unit body assembly of any of Examples 393-431 and 436-447, wherein a cross-sectional and/or side plan view shape of the wall is an arcuate shape that is greater than half an annulus, but less than a full annulus.
450. The footrope unit body assembly of any of Examples 393-431 and 436-447, wherein the wall has an upper flat portion at and/or adjacent to upper edge of the wall, the upper flat portion that extends vertically upward and aft from a portion of the wall that has a convex forward facing surface and/or a concave rearward facing surface to or toward the upper edge of the wall.
451. The footrope unit body assembly of Example 450, wherein the wall has a lower flat portion at and/or adjacent to the lower edge of the wall, the lower flat portion extending aft from a portion of the wall that has a convex forward facing surface and/or a concave rearward facing surface to or toward the lower edge of the wall.
452. The footrope unit body assembly of Example 451, wherein the lower flat portion extends vertically downward and aft from a portion of the wall that has a convex forward facing surface and/or a concave rearward facing surface to or toward the upper edge of the wall.
453. The footrope unit body assembly of Example 452, wherein a slope of the upper flat portion is the same as or different than the lower flat portion.
454. The footrope unit body assembly of Example 450, wherein a lower plate is attached to a rearward side of the wall at and/or adjacent to the lower edge of the wall, the flat plate extending forward and vertically upward from where the plate is attached to the rearward side of the wall.
455. The footrope unit body assembly of any of Examples 393-431 and 436-447, wherein
at an upper portion of the wall, at least a portion a forward facing surface of the wall is concave and at least a portion of a rearward facing surface of the wall is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
456. The footrope unit body assembly of any of Examples 393-431 and 436-448, wherein in top plan view, the wall is shaped as a parallelogram.
457. The footrope unit body assembly of any of Examples 393-431 and 436-448, wherein in top plan view, the wall is shaped as a trapezoid that exhibits different angles forming its corners at one lateral end in comparison with angles forming its corners at its other lateral end.
458. The footrope unit body assembly of any of Example 448-457, wherein a side end plate may be situated at one or both of lateral sides of the wall, each side end plate at least partially obstructing an associated lateral side channel opening of the wall.
459. The footrope unit body assembly of Example 458, wherein a side end plate is situated at each lateral side of the wall.
460. The footrope unit body assembly of any of Examples 458-459, wherein each side end plate may be formed of a rigid or flexible material.
461. The footrope unit body assembly of any of Examples 393-444, wherein a forward facing surface of the wall is a convex cambered forward facing surface, a convex sloping forward facing surface, a convex bent forward facing surface, and/or a convex multiply bent forward facing surface.
462. A footrope for a bottom trawl, the footrope comprising at least one footrope unit body assembly of Examples 393-461.
463. A footrope for a bottom trawl, the footrope comprising:
a starboard wing terminal end point;
a port wing terminal end point opposite the starboard wing terminal end point;
a plurality of the footrope unit body assembly of Example 393, the footrope unit bodies being interconnected, the wall of each footrope unit body comprising having opposing forward and rearward facing surfaces, at least a portion of the forward facing surface being convex, a least a portion of the rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
464. A footrope for a bottom trawl, the footrope comprising:
a plurality of the footrope unit body assembly of Example 393, the footrope unit bodies being interconnected, the wall of each footrope unit body having opposing forward and rearward facing surfaces, at least a portion of the forward facing surface being convex, a least a portion of the rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
465. A footrope for a bottom trawl, the footrope comprising:
a plurality of footrope unit body assemblies of Example 393, each connector being rigidly attached to a wall of an associated footrope unit body such that each connector is prevented or substantially prevented from moving relative to an associated footrope unit body at least during use, each connector connecting an associated footrope unit body to the chain and/or cable such that the footrope unit bodies are connected to one another at least via the connectors and the chain and/or cable.
466. A footrope for a bottom trawl, the footrope comprising a plurality of the footrope unit body assembly of Example 393, a side plan view profile of a wall of at least a portion of the plurality of footrope unit bodies being or substantially being a tear drop shape and/or an airfoil shape.
467. A footrope for a bottom trawl, the footrope comprising a plurality of the footrope unit body assembly of Example 393, each wall having a forward facing surface, at least the forward facing surface of at least a portion of the walls being a multiply bent surface having multiple flat sides and/or facets.
468. The footrope unit body assembly of Example 393, wherein the wall comprises:
a forward facing surface, at least a portion of the forward facing surface being convex;
a rearward facing surface opposite the forward facing surface, at least a portion of the rearward facing surface being concave;
at least one first wall region; and
at least one second wall region, the at least one second wall region having a different thickness than a thickness of the at least one first wall region.
469. The footrope unit body assembly of Example 393, wherein the wall comprises:
a body in the form of a bent plate, the body having a forward facing surface; and
at least one exterior feature connected to and/or at least partially recessed into the forward facing surface;
wherein portions of the wall that include the exterior feature having a greater thickness than the portions of the wall that do not include the exterior feature.
470. A bottom trawl, comprising:
a fishing line; and
a footrope connected to the fishing line, the footrope comprising:
a main tow chain configured such that the fishing line is located aft of the main tow chain; and
a plurality of the footrope unit body assembly of Example 393, each footrope unit body being connected to and connected to one another via the main tow chain via one or more associated rigid connectors.
471. A bottom trawl, comprising:
a fishing line; and
a footrope, the footrope comprising:
a false fishing;
a main tow chain;
a plurality of slidable connectors for connecting the false fishing line to the fishing line, each slidable connector being slidably connected to and slidable along a portion of the false fishing line; and
a plurality of the footrope unit body assembly of Example 393, each footrope unit body being connected to the main tow chain via the rigid connector, each footrope unit body being connected to the false fishing line.
472. A footrope unit body for a footrope that is for a bottom trawl, the footrope unit body comprising:
a wall having opposing forward and rearward facing surfaces; and
at least one spanning bridge separate from and connected to the wall on a rearward side of the wall, the rearward facing surface being on the rearward side of the wall, the spanning bridge spanning at least a portion of the rearward side of the wall.
473. The footrope unit body of Example 472, wherein the at least one spanning bridge spans between lateral edges of the wall such that a first lateral end of the at least one spanning bridge is connected to the wall adjacent to a first one of the lateral edges of the wall and a second lateral end of the at least one spanning bridge is connected to the wall adjacent to a second one of the lateral edges.
474. The footrope unit body of Example 473, wherein the lateral edges of the wall and upper and lower edges are attached to a frame, the first end of the at least one spanning bridge being attached to the frame adjacent the first one of the lateral edges, the second end of the at least one spanning bridge being attached to the frame adjacent the second one of the lateral edges.
475. The footrope unit body of any of Example 472, wherein the at least one spanning bridge is spaced from and spans between upper and edges of the wall such that an upper end of the at least one spanning bridge is connected to the rearward facing surface adjacent to the upper edge of the wall and a lower end of the at least one spanning bridge is connected to the rearward facing surface adjacent to the lower edge of the wall.
476. The footrope unit body of Example 475, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
477. The footrope unit body of Example 472, wherein the at least one spanning bridge spans between upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
478. The footrope unit body of Example 477, wherein the upper and lower edges of the wall are each at least partially enclosed in a shoe, the upper end of the at least one spanning bridge being attached to the shoe that at least partially encloses the upper edge of the wall, the lower end of the at least one spanning bridge being attached to the shoe that at least partially encloses the lower edge of the wall.
479. The footrope unit body of any of Examples 477-478, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
480. The footrope unit body of any of Examples 472-475 and 477-478, wherein the at least one spanning bridges comprises a plurality of spanning bridges.
481. The footrope unit body of any of Examples 472-473, 477 and 479-480, wherein each spanning bridge is attached directly or indirectly to the wall.
482. The footrope unit body of any of Examples 472-481, wherein at least a portion of the wall is formed from a synthetic material and/or metal, at least a portion of the wall being rigid and/or deformable.
483. The footrope unit body of any of Examples 472-482, wherein the wall has opposing lateral edges and opposing upper and lower edges, the opposing upper and lower edges extending laterally between the lateral edges, the footrope unit body further comprising at least one wear shoe, each wear shoe being on and/or adjacent to an associated one of the lateral edges so as to cover a lower portion of the wall at and/or adjacent to the associated lateral edge, the lower portion of the wall being proximate to the lower edge.
484. The footrope unit body of Example 483, wherein the footrope unit body includes a wear shoe for each lateral edge or for only one of the lateral edges.
485. The footrope unit body of any of Examples 483-484, wherein each wear shoe includes an edge cap plate that is conformed to and covers a portion of an associated one of the lateral edges at the lower portion of the wall.
486. The footrope unit body of any of Examples 483-485, wherein each wear shoe includes a front side surface cap plate that is conformed to and covers a portion of the forward facing surface at the lower portion of the wall.
487. The footrope unit body of any of Examples 483-486, wherein each wear shoe includes a rear side surface cap plate that is conformed to and covers a portion of the rearward facing surface at the lower portion of the wall.
488. The footrope unit body of any of Examples 472-487, wherein a total height of the wall is equal to a total width of the wall.
489. The footrope unit body of any of Examples 472-487, wherein a ratio of a total and/or average width of the wall to a total and/or average height of the wall is in the range of 1.01:1 to 22:1.
490. The footrope unit body of any of Examples 472-489, wherein the wall includes at least one perforation and/or at least one perforated slit.
491. The footrope unit body of any of Examples 472-490, wherein the rearward facing surface defines an opening, the wall being configured such that the opening extends in a direction that is non-parallel and/or non-perpendicular to a plane that is perpendicular to the earth's gravitational force.
492. The footrope unit body of any of Examples 472-490, wherein the rearward facing surface defines an opening, the wall being configured such that the opening is directed towards a surface on and/or above which the footrope unit body is situated when in use.
493. The footrope unit body of any of Examples 472-490, wherein the wall is configured such that, in use, at least a convex portion of the forward facing surface is directed away from a surface on and/or above which the footrope unit body is situated, and/or at least a concave portion of rearward facing surface is directed toward the surface on and/or above which the footrope unit body is situated.
494. The footrope unit body of any of Examples 472-482, 388-490 and 493, wherein a side plan view profile of wall is or is substantially a tear drop shape and/or an airfoil shape.
495. The footrope unit body of Example 494, wherein the wall includes a cylindrical pipe portion and an extension portion that extends from the cylindrical pipe portion, the cylindrical pipe portion and the extension portion collectively defining the tear drop shape of the wall.
496. The footrope unit body of Example 494, wherein the tear drop shape of the wall is truncated such that the wall has an opening at a narrow and rearward end of the wall.
497. The footrope unit body of Example 496, wherein the opening is configured to receive a fishing line of the bottom trawl and a portion of a bottom netting panel of the bottom trawl that is adjacent and/or proximal to the fishing line, the bottom netting panel being connected to the fishing line.
498. The footrope unit body of any of Examples 472-497, further comprising at least one flange connected to the wall that extends laterally outward beyond a corresponding lateral edge of the wall.
499. The footrope unit body of any of Examples 472-498, wherein the wall is a multiply bent plate and/or wall having a cross-sectional and or side plan view shape that corresponds to a portion of a polygon.
500. The footrope unit body of any of Examples 472-498, wherein the wall is a multiply bent plate and/or wall, the forward facing surface and/or the rearward facing surface of the multiply bent plate having multiple flat sides and/or facets.
501. The footrope unit body of any of Examples 499-500, wherein at least the forward facing surface of the multiply bent plate and/or wall has multiple flat sides and/or facets.
502. The footrope unit body of any of Examples 472-493 and 498-501, wherein the wall is shaped as a half-annulus in cross-section and/or when viewed in side plan view.
503. The footrope unit body of any of Examples 472-493 and 498-501, wherein a cross-sectional and/or side plan view shape of the wall is an arcuate shape that is greater than half an annulus, but less than a full annulus.
504. The footrope unit body of any of Examples 472-493 and 498-501, wherein the wall has an upper flat portion at and/or adjacent to upper edge of the wall, the upper flat portion that extends vertically upward and aft from a portion of the wall where the forward facing surface is convex and/or where the rearward facing surface is concave to or toward the upper edge of the wall.
505. The footrope unit body of Example 504, wherein the wall has a lower flat portion at and/or adjacent to the lower edge of the wall, the lower flat portion extending aft from the portion of the wall that has the convex forward facing surface and/or the concave rearward facing surface to or toward the lower edge of the wall.
506. The footrope unit body of Example 505, wherein the lower flat portion extends vertically downward and aft from the portion of the wall that has the convex forward facing surface and/or the concave rearward facing surface to or toward the upper edge of the wall.
507. The footrope unit body of Example 506, wherein a slope of the upper flat portion is the same as or different than the lower flat portion.
508. The footrope unit body of Example 504, wherein a lower plate is attached to the rearward side of the wall at and/or adjacent to the lower edge of the wall, the flat plate extending forward and vertically upward from where the plate is attached to the rearward side of the wall.
509. The footrope unit body of any of Examples 472-493 and 498-501, wherein
at an upper portion of the wall, at least a portion the forward facing surface is concave and at least a portion of the rearward facing surface is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
510. The footrope unit body of any of Examples 472-493 and 498-502, wherein in top plan view, the wall is shaped as a parallelogram.
511. The footrope unit body of any of Examples 472-493 and 498-502, wherein in top plan view, the wall is shaped as a trapezoid that exhibits different angles forming its corners at one lateral end in comparison with angles forming its corners at its other lateral end.
512. The footrope unit body of any of Example 502-511, wherein a side end plate may be situated at one or both of lateral sides of the wall, each side end plate at least partially obstructing an associated lateral side channel opening of the wall.
513. The footrope unit body of Example 512, wherein a side end plate is situated at each lateral side of the wall.
514. The footrope unit body of any of Examples 512-513, wherein each side end plate may be formed of a rigid or flexible material.
515. The footrope unit body of any of Examples 472-498, wherein the forward facing surface is a convex cambered forward facing surface, a convex sloping forward facing surface, a convex bent forward facing surface, and/or a convex multiply bent forward facing surface.
516. The footrope unit body of any of Examples 472-492, 494-501, 510-514, wherein at least a portion of the forward facing surface is convex, and/or at least a portion of the rearward facing surface is concave.
517. A footrope unit body assembly for a footrope that is for a bottom trawl, the footrope unit body assembly comprising:
the footrope unit body of any of Examples 472-516; and
at least one connector connected to the footrope unit body and for connecting the footrope unit body to a chain and/or cable of the footrope and/or bottom trawl.
518. The footrope unit body assembly of Example 517, wherein the chain comprises a main tow chain of the footrope.
519. The footrope unit body assembly of any of Examples 517-518, wherein the cable comprises a fishing line of the bottom trawl.
520. The footrope unit body assembly of any of Examples 517-519, wherein the at least one connector is rigidly attached to the wall of the footrope unit body such that the at least one connector is prevented or substantially prevented from moving relative to the footrope unit body during use.
521. The footrope unit body assembly of Example 520, wherein the at least one connector includes a first backing plate on the forward facing surface, a second backing plate on and/or adjacent to the rearward facing surface, and at least one fastener extending through the wall from the first backing plate to at least the second backing plate.
522. The footrope unit body assembly of Example 521, wherein the second backing plate includes a notch configured to at least partially receive a portion of the chain and/or a portion of the cable so as to hold the received portion of the chain and/or cable in place between second backing plate and the rearward facing surface.
523. The footrope unit body assembly of any of Examples 520-522, wherein the connector further comprises at least one sleeve rigidly attached to the rearward facing surface of the footrope unit body, at least the second backing plate being located in the at least one sleeve.
524. The footrope unit body assembly of Example 520, wherein the at least one connector further includes a third backing plate on the rearward facing surface such that the third backing plate is interposed between the rearward facing surface and the second backing plate, the at least one fastener extend through the third backing plate.
525. The footrope unit body assembly of Example 524, wherein the second and third backing plates include corresponding and mirrored notches, a portion of the chain and/or a portion of the cable being received between the notches so as to hold the received portion of the chain and/or cable in place between second and third backing plates.
526. The footrope unit body assembly of any of Examples 524-525, wherein the connector further comprises at least one sleeve rigidly attached to the rearward facing surface of the footrope unit body, at least the second and third backing plates being located in the at least one sleeve.
527. The footrope unit body assembly of Example 520, wherein the at least one connector comprises at least one sleeve that is rigidly attached to the rearward facing surface of the footrope unit body.
528. The footrope unit body assembly of any of Examples 517-519, wherein the at least one connector is moveably connected to the wall of the footrope unit body such that the at least one connector is moveable relative to the footrope unit body during use.
529. The footrope unit body assembly of Example 528, wherein the at least one connector comprises a chain link connector and/or a quick-link connector
530. The footrope unit body assembly of any of Examples 528-529, wherein the at least one connector is moveably connected directly to the wall of the footrope unit body.
531. The footrope unit body assembly of Example 530, wherein the at least one connector extends through a corresponding aperture in the wall, the connector having a first end on and/or adjacent to the forward facing surface and a second end on and/or adjacent to the rearward facing surface such that the first and second ends are on opposing sides of the wall, the first end being larger than the corresponding aperture so as to be prevented from passing into and/or through the corresponding aperture, the second end being configured to be connected to the chain and/or cable of the footrope and/or bottom trawl.
532. The footrope unit body assembly of any of Examples 528-529, wherein the at least one connector is moveably connected indirectly to the wall of the footrope unit body.
533. The footrope unit body assembly of Example 532, wherein the at least one connector is moveably connected directly to a solid body, the solid body being separate from and rigidly attached to the wall.
534. The footrope unit body assembly of Example 533, wherein the solid body is attached to one of the frontward and rearward facing surfaces.
535. The footrope unit body assembly of Example 432, wherein the at least one connector is moveably connected directly to a strength member that is connected to the wall via being passed through two apertures of the wall.
536. The footrope unit body assembly of Example 535, wherein the strength member is a loop or U-shaped.
537. The footrope unit body assembly of any of Examples 535-536, wherein the strength member is a loop of pliable cable, rigid cable, or metal.
538. The footrope unit body assembly of any of Examples 528-537, further comprising at least one sleeve that is rigidly attached to the rearward facing surface of the footrope unit body, at least a portion of the at least one connector being located in the at least one sleeve.
539. The footrope unit body assembly of any of Examples 517-538, wherein the cable comprises a fishing line of the bottom trawl, the footrope unit body assembly further comprising at least one body-to-line connector for directly and/or indirectly connecting the footrope unit body to the fishing line of the bottom trawl.
540. The footrope unit body assembly of Example 539, wherein the at least one body-to-line connector is configured to be directly connected to the fishing line so as to directly connect the footrope unit body to fishing line.
541. The footrope unit body assembly of Example 539, wherein the at least one body-to-line connector is configured to be indirectly connected to the fishing line so as to indirectly connect the footrope unit body to fishing line.
542. The footrope unit body assembly of Example 541, wherein the at least one body to line connector is connected to the fishing line via a drop chain.
543. The footrope unit body assembly of Example 541, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
544. The footrope unit body assembly of Example 543, wherein each body-to-line connector is connected to the false fishing line and the footrope unit body in such a manner that the body-to-line connector is prevented from freely sliding along a portion of the entire exterior surface of the false fishing line.
545. The footrope unit body assembly of any of Examples 539-544, wherein the at least body-to-line connector comprises a plurality of body-to-line connectors, each body-to-line connector at least partially defining a body-to-line connector aperture.
546. The footrope unit body assembly of Example 545, wherein each body-to-line connector aperture extends perpendicular to a lateral direction, a width of the footrope unit body being measured in the lateral direction.
547. The footrope unit body assembly of Example 545, wherein each body-to-line connector aperture extends in a lateral direction, a width of the footrope unit body being measured in the lateral direction.
548. The footrope unit body assembly of any of Examples 539-547, wherein the at least one body-to-line connector is a quick-link.
549. The footrope unit body assembly of any of Examples 539-547, wherein the body-to-line connector is connected directly to the wall via being threaded through through-holes of the wall.
550. The footrope unit body assembly of any of Examples 539-547, further comprising at least one ear attached to the wall of the footrope unit body, the at least one body-to-line connector being connected to the at least one ear.
551. The footrope unit body assembly of Example 550, wherein the at least one ear is formed by a U-bolt that is affixed to the wall.
552. The footrope unit body assembly of any of Examples 550-551, wherein the at least one ear comprises a plurality of ears, each ear at least partially defining an ear aperture.
553. The footrope unit body assembly of Example 552, wherein each ear aperture extends perpendicular to a lateral direction, a width of the footrope unit body being measured in the lateral direction.
554. The footrope unit body assembly of Example 552, wherein each ear aperture extends in a lateral direction, a width of the footrope unit body being measured in the lateral direction.
555. The footrope unit body assembly of any of Examples 550 and 553-554, wherein the upper and lower edges of the wall are each at least partially enclosed in a shoe, each ear being connected to shoe that encloses the upper edge of the wall.
556. The footrope unit body assembly of any of Examples 550 and 553-554, wherein the lateral sides and the upper and lower edges are attached to a frame, each ear being connected to the frame adjacent to the upper edge.
557. The footrope unit body assembly of any of Examples 517-556, further comprising a barrier connector configured for connecting a barrier structure of the bottom trawl to the footrope unit body.
558. The footrope unit body assembly of Example 517, wherein the at least one connector comprises at least one body-to-line connector and the cable comprises a fishing line of the bottom trawl, the at least one body-to-line connector being configured to directly and/or indirectly connecting the footrope unit body to the fishing line of the bottom trawl.
559. The footrope unit body assembly of Example 558, wherein the at least one body-to-line connector is configured to be directly connected to the fishing line so as to directly connect the footrope unit body to fishing line.
560. The footrope unit body assembly of Example 558, wherein the at least one body-to-line connector is configured to be indirectly connected to the fishing line so as to indirectly connect the footrope unit body to fishing line.
561. The footrope unit body assembly of Example 560, wherein the at least one body to line connector is connected to the fishing line via a drop chain.
562. The footrope unit body assembly of Example 558, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
563. The footrope unit body assembly of Example 562, wherein each body-to-line connector is connected to the false fishing line and the footrope unit body in such a manner that the body-to-line connector is prevented from freely sliding along a portion of the entire exterior surface of the false fishing line.
564. The footrope unit body assembly of any of Examples 558-563, wherein the at least body-to-line connector comprises a plurality of body-to-line connectors, each body-to-line connector at least partially defining a body-to-line connector aperture.
565. The footrope unit body assembly of Example 564, wherein each body-to-line connector aperture extends perpendicular to a lateral direction, a width of the footrope unit body being measured in the lateral direction.
566. The footrope unit body assembly of Example 564, wherein each body-to-line connector aperture extends in a lateral direction, a width of the footrope unit body being measured in the lateral direction.
567. The footrope unit body assembly of any of Examples 558-566, wherein the at least one body-to-line connector is a quick-link.
568. The footrope unit body assembly of any of Examples 558-567, wherein the body-to-line connector is connected directly to the wall via being threaded through through-holes of the wall.
569. The footrope unit body assembly of any of Examples 558-567, further comprising at least one ear attached to the wall of the footrope unit body, the at least one body-to-line connector being connected to the at least one ear.
570. The footrope unit body assembly of Example 569, wherein the at least one ear is formed by a U-bolt that is affixed to the wall.
571. The footrope unit body assembly of any of Examples 569-570, wherein the at least one ear comprises a plurality of ears, each ear at least partially defining an ear aperture.
572. The footrope unit body assembly of Example 571, wherein each ear aperture extends perpendicular to a lateral direction, a width of the footrope unit body being measured in the lateral direction.
573. The footrope unit body assembly of Example 571, wherein each ear aperture extends in a lateral direction, a width of the footrope unit body being measured in the lateral direction.
574. The footrope unit body assembly of any of Examples 569 and 571-573, wherein the upper and lower edges of the wall are each at least partially enclosed in a shoe, each ear being connected to shoe that encloses the upper edge of the wall.
575. The footrope unit body assembly of any of Examples 569 and 571-573, wherein the lateral sides and the upper and lower edges are attached to a frame, each ear being connected to the frame adjacent to the upper edge.
576. The footrope unit body assembly of any of Examples 558-575, further comprising a barrier connector configured for connecting a barrier structure of the bottom trawl to the footrope unit body.
577. A footrope for a bottom trawl, the footrope comprising:
at least one footrope unit body of Examples 472-516, or
at least one footrope unit body assembly of Examples 517-576.
578. A bottom trawl, comprising:
a fishing line; and
a footrope connected to the fishing line, the footrope comprising:
a main tow chain configured such that the fishing line is located aft of the main tow chain; and
a plurality of any of the footrope unit bodies of Examples 472-516, each of the footrope unit bodies being connected to and connected to one another via the main tow chain.
579. A bottom trawl, comprising:
a fishing line; and
a footrope, the footrope comprising:
a false fishing;
a main tow chain;
a plurality of slidable connectors for connecting the false fishing line to the fishing line, each slidable connector being slidably connected to and slidable along a portion of the false fishing line; and
a plurality of any of the footrope unit bodies of Examples 472-516, each footrope unit body being connected to the false fishing line and to the main tow chain.
580. A footrope for a bottom trawl, the footrope comprising:
a starboard wing terminal end point;
a port wing terminal end point opposite the starboard wing terminal end point;
a plurality of any of the footrope unit bodies of Examples 472-516, the footrope unit bodies being interconnected to one another and located between the starboard and port wing terminal end points, the wall of each footrope unit body having opposing forward and rearward facing surfaces, at least a portion of each forward facing surface being convex, a least a portion of each rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
581. A footrope for a bottom trawl, the footrope comprising a plurality of any of the footrope unit bodies of Examples 472-516, the footrope unit bodies being interconnected, the wall of each footrope unit body comprising having opposing forward and rearward facing surfaces, at least a portion of each forward facing surface being convex, a least a portion of each rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions
582. A footrope for a bottom trawl, the footrope comprising a plurality of any of the footrope unit bodies of Examples 472-581, a side plan view profile of a wall of at least a portion of the plurality of footrope unit bodies being or substantially being a tear drop shape and/or an airfoil shape.
583. A footrope for a bottom trawl, the footrope comprising a plurality of any of the footrope unit bodies of Examples 472-581, each wall having a forward facing surface, at least the forward facing surface of at least a portion of the walls being a multiply bent surface having multiple flat sides and/or facets.
584. The footrope of Example 472, wherein the wall comprises:
a body in the form of a bent plate, the body having a forward facing surface; and
at least one exterior feature connected to and/or at least partially recessed into the forward facing surface;
wherein portions of the wall that include the exterior feature having a greater thickness than the portions of the wall that do not include the exterior feature
585. A footrope unit body assembly for a footrope that is for a bottom trawl, the footrope unit body assembly comprising:
the footrope unit body of any of Examples 472-516; and
at least one connector for connecting the footrope unit body to a chain and/or cable of the footrope and/or bottom trawl, the at least one connector being rigidly attached to the wall of the footrope unit body such that the at least one connector is prevented or substantially prevented from moving relative to the footrope unit body at least during use.
586. A footrope unit body for a footrope that is for a bottom trawl, the footrope unit body comprising a wall having a forward facing surface, at least the forward facing surface of the wall being a multiply bent surface having multiple flat sides and/or facets.
587. The footrope unit body of Example 586, wherein at least a portion of the forward facing surface is convex.
588. The footrope unit body of any of Examples 586-587, wherein the wall has a rearward facing surface opposite the forward facing surface, the rearward facing surface of the wall being a multiply bent surface having multiple flat sides and/or facets.
589. The footrope unit body of Example 588, wherein at least a portion of the rearward facing surface is concave.
600. The footrope unit body of any of Examples 586-589, wherein the wall is a multiply bent plate.
601. The footrope unit body of any of Examples 586-600, wherein the wall has a cross-sectional and or side plan view shape that corresponds to a portion of a polygon.
602. The footrope unit body of any of Examples 586-601, wherein at least a portion of the wall is formed from a synthetic material and/or metal, at least a portion of the wall being rigid and/or deformable.
603. The footrope unit body of any of Examples 586-602, wherein the wall has opposing lateral edges and opposing upper and lower edges, the opposing upper and lower edges extending laterally between the lateral edges, the footrope unit body further comprising at least one wear shoe, each wear shoe being on and/or adjacent to an associated one of the lateral edges so as to cover a lower portion of the wall at and/or adjacent to the associated lateral edge, the lower portion of the wall being proximate to the lower edge.
604. The footrope unit body of Example 603, wherein the footrope unit body includes a wear shoe for each lateral edge or for only one of the lateral edges.
605. The footrope unit body of any of Examples 603-604, wherein each wear shoe includes an edge cap plate that is conformed to and covers a portion of an associated one of the lateral edges at the lower portion of the wall.
606. The footrope unit body of any of Examples 603-605, wherein each wear shoe includes a front side surface cap plate that is conformed to and covers a portion of the forward facing surface at the lower portion of the wall.
607. The footrope unit body of any of Examples 604-606, wherein each wear shoe includes a rear side surface cap plate that is conformed to and covers a portion of a rearward facing surface of the wall at the lower portion of the wall.
608. The footrope unit body of any of Examples 586-607, wherein a total height of the wall is equal to a total width of the wall.
609. The footrope unit body of any of Examples 586-607, wherein a ratio of a total and/or average width of the wall to a total and/or average height of the wall is in the range of 1.01:1 to 22:1.
610. The footrope unit body of any of Examples 586-609, wherein the wall includes at least one perforation and/or at least one perforated slit.
611. The footrope unit body of any of Examples 586-610, wherein a rearward facing surface of the wall defines an opening, the wall being configured such that the opening extends in a direction that is non-parallel and/or non-perpendicular to a plane that is perpendicular to the earth's gravitational force.
612. The footrope unit body of any of Examples 586-610, wherein a rearward facing surface of the wall defines an opening, the wall being configured such that the opening is directed towards a surface on and/or above which the footrope unit body is situated when in use.
613. The footrope unit body of any of Examples 586-610, wherein the wall is configured such that, in use, at least a convex portion of the forward facing surface is directed away from a surface on and/or above which the footrope unit body is situated, and/or at least a concave portion of a rearward facing surface of the wall is directed toward the surface on and/or above which the footrope unit body is situated.
614. The footrope unit body of any of Examples 586-602, 608-610, and 613, wherein a side plan view profile of wall is or is substantially a tear drop shape and/or an airfoil shape.
615. The footrope unit body of Example 614, wherein the wall includes a cylindrical pipe portion and an extension portion that extends from the cylindrical pipe portion, the cylindrical pipe portion and the extension portion collectively defining the tear drop shape of the wall.
616. The footrope unit body of Example 615, wherein the cylindrical pipe portion defines a pipe opening that extends widthwise and/or laterally through the cylindrical pipe portion, the pipe opening being configured to receive a roller therein, the roller being configured to be attached to a main tow chain of the footrope and/or a fishing line of the bottom trawl in such a manner that the footrope unit body is rotatable about a central axis of the pipe opening when in use.
617. The footrope unit body of Example 614, further comprising a support structure connected to at least a rearward facing surface of the wall, the support structure being in the shape of a cylinder or a half annulus.
618. The footrope unit body of any of Examples 614 and 617, wherein the tear drop shape of the wall is truncated such that the wall has an opening at a narrow and rearward end of the wall.
619. The footrope unit body of Example 618, wherein the opening is configured to receive a fishing line of the bottom trawl and a portion of a bottom netting panel of the bottom trawl that is adjacent and/or proximal to the fishing line, the bottom netting panel being connected to the fishing line.
620. The footrope unit body of any of Examples 586-619, further comprising at least one flange connected to the wall that extends laterally outward beyond a corresponding lateral edge of the wall.
621. The footrope unit body of any of Examples 586-602, 608-613, and 620, wherein the upper and lower edges of the wall are each at least partially enclosed in a shoe.
622. The footrope unit body of any of Examples 586-621, further comprising at least one spanning bridge separate from and connected to the wall on a rearward side of the wall so as to span at least a portion of the rearward side of the wall.
623. The footrope unit body of Example 622, wherein the at least one spanning bridge spans between the lateral edges of the wall such that a first lateral end of the at least one spanning bridge is connected to the wall adjacent to a first one of the lateral edges of the wall and a second lateral end of the at least one spanning bridge is connected to the wall adjacent to a second one of the lateral edges.
624. The footrope unit body of Example 623, wherein the lateral edges of the wall and the upper and lower edges are attached to a frame, the first end of the at least one spanning bridge being attached to the frame adjacent the first one of the lateral edges, the second end of the at least one spanning bridge being attached to the frame adjacent the second one of the lateral edges.
625. The footrope unit body of Example 622, wherein the at least one spanning bridge is spaced from and spans between the upper and edges of the wall such that an upper end of the at least one spanning bridge is connected to a rearward facing surface of the wall adjacent to the upper edge of the wall and a lower end of the at least one spanning bridge is connected to the rearward facing surface adjacent to the lower edge of the wall.
626. The footrope unit body of Example 625, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
627. The footrope unit body of Example 622, wherein the at least one spanning bridge spans between the upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
628. The footrope unit body of Example 627, wherein the upper and lower edges of the wall are each at least partially enclosed in a shoe, the upper end of the at least one spanning bridge being attached to the shoe that at least partially encloses the upper edge of the wall, the lower end of the at least one spanning bridge being attached to the shoe that at least partially encloses the lower edge of the wall.
629. The footrope unit body of any of Examples 627-628, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
630. The footrope unit body of any of Examples 586-613 and 620-629, wherein the wall is shaped as a half-annulus in cross-section and/or when viewed in side plan view.
631. The footrope unit body of any of Examples 586-613 and 620-629, wherein a cross-sectional and/or side plan view shape of the wall is an arcuate shape that is greater than half an annulus, but less than a full annulus.
632. The footrope unit body of any of Examples 586-613 and 620-629, wherein the wall has an upper flat portion at and/or adjacent to upper edge of the wall, the upper flat portion that extends vertically upward and aft from a portion of the wall where the forward facing surface is convex and/or where a rearward facing surface of the wall is concave to or toward the upper edge of the wall.
633. The footrope unit body of Example 632, wherein the wall has a lower flat portion at and/or adjacent to the lower edge of the wall, the lower flat portion extending aft from the portion of the wall that has the convex forward facing surface and/or the concave rearward facing surface to or toward the lower edge of the wall.
634. The footrope unit body of Example 633, wherein the lower flat portion extends vertically downward and aft from the portion of the wall that has the convex forward facing surface and/or the concave rearward facing surface to or toward the upper edge of the wall.
635. The footrope unit body of Example 634, wherein a slope of the upper flat portion is the same as or different than the lower flat portion.
636. The footrope unit body of Example 632, wherein a lower plate is attached to the rearward side of the wall at and/or adjacent to the lower edge of the wall, the flat plate extending forward and vertically upward from where the plate is attached to the rearward side of the wall.
637. The footrope unit body of any of Examples 586-613 and 620-629, wherein
at an upper portion of the wall, at least a portion the forward facing surface is concave and at least a portion of a rearward facing surface of the wall is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
638. The footrope unit body of any of Examples 586-613 and 620-630, wherein in top plan view, the wall is shaped as a parallelogram.
639. The footrope unit body of any of Examples 586-613 and 620-630, wherein in top plan view, the wall is shaped as a trapezoid that exhibits different angles forming its corners at one lateral end in comparison with angles forming its corners at its other lateral end.
640. The footrope unit body of any of Example 630-639, wherein a side end plate may be situated at one or both of lateral sides of the wall, each side end plate at least partially obstructing an associated lateral side channel opening of the wall.
641. The footrope unit body of Example 640, wherein a side end plate is situated at each lateral side of the wall.
642. The footrope unit body of any of Examples 640-641, wherein each side end plate may be formed of a rigid or flexible material.
643. A footrope unit body assembly for a footrope that is for a bottom trawl, the footrope unit body assembly comprising:
the footrope unit body of any of Examples 586-642; and
at least one connector connected to the footrope unit body and for connecting the footrope unit body to a chain and/or cable of the footrope and/or bottom trawl.
644. The footrope unit body assembly of Example 643, wherein the chain comprises a main tow chain of the footrope.
645. The footrope unit body assembly of any of Examples 643-644, wherein the cable comprises a fishing line of the bottom trawl.
646. The footrope unit body assembly of any of Examples 643-645, wherein the at least one connector is rigidly attached to the wall of the footrope unit body such that the at least one connector is prevented or substantially prevented from moving relative to the footrope unit body during use.
647. The footrope unit body assembly of Example 646, wherein the at least one connector includes a first backing plate on the forward facing surface, a second backing plate on and/or adjacent to a rearward facing surface of the wall, and at least one fastener extending through the wall from the first backing plate to at least the second backing plate.
648. The footrope unit body assembly of Example 647, wherein the second backing plate includes a notch configured to at least partially receive a portion of the chain and/or a portion of the cable so as to hold the received portion of the chain and/or cable in place between second backing plate and the rearward facing surface.
649. The footrope unit body assembly of any of Examples 647-648, wherein the connector further comprises at least one sleeve rigidly attached to the rearward facing surface of the footrope unit body, at least the second backing plate being located in the at least one sleeve.
650. The footrope unit body assembly of Example 647, wherein the at least one connector further includes a third backing plate on the rearward facing surface such that the third backing plate is interposed between the rearward facing surface and the second backing plate, the at least one fastener extend through the third backing plate.
651. The footrope unit body assembly of Example 650, wherein the second and third backing plates include corresponding and mirrored notches, a portion of the chain and/or a portion of the cable being received between the notches so as to hold the received portion of the chain and/or cable in place between second and third backing plates.
652. The footrope unit body assembly of any of Examples 650-651, wherein the connector further comprises at least one sleeve rigidly attached to the rearward facing surface of the footrope unit body, at least the second and third backing plates being located in the at least one sleeve.
653. The footrope unit body assembly of Example 646, wherein the at least one connector comprises at least one sleeve that is rigidly attached to the rearward facing surface of the footrope unit body.
654. The footrope unit body assembly of any of Examples 643-645, wherein the at least one connector is moveably connected to the wall of the footrope unit body such that the at least one connector is moveable relative to the footrope unit body during use.
655. The footrope unit body assembly of Example 654, wherein the at least one connector comprises a chain link connector and/or a quick-link connector
656. The footrope unit body assembly of any of Examples 654-655, wherein the at least one connector is moveably connected directly to the wall of the footrope unit body.
657. The footrope unit body assembly of Example 656, wherein the at least one connector extends through a corresponding aperture in the wall, the connector having a first end on and/or adjacent to the forward facing surface and a second end on and/or adjacent to a rearward facing surface of the wall such that the first and second ends are on opposing sides of the wall, the first end being larger than the corresponding aperture so as to be prevented from passing into and/or through the corresponding aperture, the second end being configured to be connected to the chain and/or cable of the footrope and/or bottom trawl.
658. The footrope unit body assembly of any of Examples 654-655, wherein the at least one connector is moveably connected indirectly to the wall of the footrope unit body.
659. The footrope unit body assembly of Example 658, wherein the at least one connector is moveably connected directly to a solid body, the solid body being separate from and rigidly attached to the wall.
660. The footrope unit body assembly of Example 659, wherein the solid body is attached to one of the frontward and rearward facing surfaces.
661. The footrope unit body assembly of Example 658, wherein the at least one connector is moveably connected directly to a strength member that is connected to the wall via being passed through two apertures of the wall.
662. The footrope unit body assembly of Example 661, wherein the strength member is a loop or U-shaped.
663. The footrope unit body assembly of any of Examples 659-660, wherein the strength member is a loop of pliable cable, rigid cable, or metal.
664. The footrope unit body assembly of any of Examples 654-663, further comprising at least one sleeve that is rigidly attached to the rearward facing surface of the footrope unit body, at least a portion of the at least one connector being located in the at least one sleeve.
665. The footrope unit body assembly of any of Examples 643-664, wherein the cable comprises a fishing line of the bottom trawl, the footrope unit body assembly further comprising at least one body-to-line connector for directly and/or indirectly connecting the footrope unit body to the fishing line of the bottom trawl.
666. The footrope unit body assembly of Example 665, wherein the at least one body-to-line connector is configured to be directly connected to the fishing line so as to directly connect the footrope unit body to fishing line.
667. The footrope unit body assembly of Example 666, wherein the at least one body-to-line connector is configured to be indirectly connected to the fishing line so as to indirectly connect the footrope unit body to fishing line.
668. The footrope unit body assembly of Example 667, wherein the at least one body to line connector is connected to the fishing line via a drop chain.
669. The footrope unit body assembly of Example 667, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
670. The footrope unit body assembly of Example 669, wherein each body-to-line connector is connected to the false fishing line and the footrope unit body in such a manner that the body-to-line connector is prevented from freely sliding along a portion of the entire exterior surface of the false fishing line.
671. The footrope unit body assembly of any of Examples 665-670, wherein the at least body-to-line connector comprises a plurality of body-to-line connectors, each body-to-line connector at least partially defining a body-to-line connector aperture.
672. The footrope unit body assembly of Example 671, wherein each body-to-line connector aperture extends perpendicular to a lateral direction, a width of the footrope unit body being measured in the lateral direction.
673. The footrope unit body assembly of Example 671, wherein each body-to-line connector aperture extends in a lateral direction, a width of the footrope unit body being measured in the lateral direction.
674. The footrope unit body assembly of any of Examples 665-673, wherein the at least one body-to-line connector is a quick-link.
675. The footrope unit body assembly of any of Examples 665-674, wherein the body-to-line connector is connected directly to the wall via being threaded through through-holes of the wall.
676. The footrope unit body assembly of any of Examples 665-674, further comprising at least one ear attached to the wall of the footrope unit body, the at least one body-to-line connector being connected to the at least one ear.
677. The footrope unit body assembly of Example 676, wherein the at least one ear is formed by a U-bolt that is affixed to the wall.
678. The footrope unit body assembly of any of Examples 676-677, wherein the at least one ear comprises a plurality of ears, each ear at least partially defining an ear aperture.
679. The footrope unit body assembly of Example 678, wherein each ear aperture extends perpendicular to a lateral direction, a width of the footrope unit body being measured in the lateral direction.
680. The footrope unit body assembly of Example 678, wherein each ear aperture extends in a lateral direction, a width of the footrope unit body being measured in the lateral direction.
681. The footrope unit body assembly of any of Examples 676 and 679-680, wherein the upper and lower edges of the wall are each at least partially enclosed in a shoe, each ear being connected to shoe that encloses the upper edge of the wall.
682. The footrope unit body assembly of any of Examples 676 and 679-680, wherein the lateral sides and the upper and lower edges are attached to a frame, each ear being connected to the frame adjacent to the upper edge.
683. The footrope unit body assembly of any of Examples 643-682, further comprising a barrier connector configured for connecting a barrier structure of the bottom trawl to the footrope unit body.
684. The footrope unit body assembly of Example 643, wherein the at least one connector comprises at least one body-to-line connector and the cable comprises a fishing line of the bottom trawl, the at least one body-to-line connector being configured to directly and/or indirectly connecting the footrope unit body to the fishing line of the bottom trawl.
685. The footrope unit body assembly of Example 684, wherein the at least one body-to-line connector is configured to be directly connected to the fishing line so as to directly connect the footrope unit body to fishing line.
686. The footrope unit body assembly of Example 684, wherein the at least one body-to-line connector is configured to be indirectly connected to the fishing line so as to indirectly connect the footrope unit body to fishing line.
687. The footrope unit body assembly of Example 686, wherein the at least one body to line connector is connected to the fishing line via a drop chain.
688. The footrope unit body assembly of Example 684, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
689. The footrope unit body assembly of Example 688, wherein each body-to-line connector is connected to the false fishing line and the footrope unit body in such a manner that the body-to-line connector is prevented from freely sliding along a portion of the entire exterior surface of the false fishing line.
690. The footrope unit body assembly of any of Examples 684-689, wherein the at least body-to-line connector comprises a plurality of body-to-line connectors, each body-to-line connector at least partially defining a body-to-line connector aperture.
691. The footrope unit body assembly of Example 690, wherein each body-to-line connector aperture extends perpendicular to a lateral direction, a width of the footrope unit body being measured in the lateral direction.
692. The footrope unit body assembly of Example 690, wherein each body-to-line connector aperture extends in a lateral direction, a width of the footrope unit body being measured in the lateral direction.
693. The footrope unit body assembly of any of Examples 684-692, wherein the at least one body-to-line connector is a quick-link.
694. The footrope unit body assembly of any of Examples 684-693, wherein the body-to-line connector is connected directly to the wall via being threaded through through-holes of the wall.
695. The footrope unit body assembly of any of Examples 684-693, further comprising at least one ear attached to the wall of the footrope unit body, the at least one body-to-line connector being connected to the at least one ear.
696. The footrope unit body assembly of Example 695, wherein the at least one ear is formed by a U-bolt that is affixed to the wall.
697. The footrope unit body assembly of any of Examples 695-696, wherein the at least one ear comprises a plurality of ears, each ear at least partially defining an ear aperture.
698. The footrope unit body assembly of Example 697, wherein each ear aperture extends perpendicular to a lateral direction, a width of the footrope unit body being measured in the lateral direction.
699. The footrope unit body assembly of Example 697, wherein each ear aperture extends in a lateral direction, a width of the footrope unit body being measured in the lateral direction.
700. The footrope unit body assembly of any of Examples 695 and 697-699, wherein the upper and lower edges of the wall are each at least partially enclosed in a shoe, each ear being connected to shoe that encloses the upper edge of the wall.
701. The footrope unit body assembly of any of Examples 695 and 697-699, wherein the lateral sides and the upper and lower edges are attached to a frame, each ear being connected to the frame adjacent to the upper edge.
702. The footrope unit body assembly of any of Examples 684-701, further comprising a barrier connector configured for connecting a barrier structure of the bottom trawl to the footrope unit body.
703. A footrope for a bottom trawl, the footrope comprising:
at least one footrope unit body of Examples 586-642, or
at least one footrope unit body assembly of Examples 643-702.
704. A footrope for a bottom trawl, the footrope comprising:
a starboard wing terminal end point;
a port wing terminal end point opposite the starboard wing terminal end point;
a plurality of any of the footrope unit bodies of Examples 586-642, the footrope unit bodies being interconnected to one another and located between the starboard and port wing terminal end points, the wall of each footrope unit body having a rearward facing surface opposite the forward facing surface, each forward facing surfaces being at least partially convex, each rearward facing surface being at least partially concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
705. A footrope for a bottom trawl, the footrope comprising a plurality of any of the footrope unit bodies of Examples 586-642, the footrope unit bodies being interconnected to one another, each wall having a rearward facing surface that is opposite the forward facing surface, each forward facing surface being at least partially convex, each rearward facing surface being at least partially concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
706. A footrope for a bottom trawl, the footrope comprising:
a plurality of any of the footrope unit bodies of Examples 586-642; and
a plurality of connectors, each connector being rigidly attached to the wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
707. A footrope for a bottom trawl, the footrope comprising a plurality of any of the footrope unit bodies of Examples 586-642, a side plan view profile of the wall of at least a portion of the plurality of footrope unit bodies being or substantially being a tear drop shape and/or an airfoil shape.
708. The footrope unit body of any of Examples 586-642, wherein the wall comprises:
a body in the form of a bent plate, the body having the forward facing surface; and
at least one exterior feature connected to and/or at least partially recessed into the forward facing surface;
wherein portions of the wall that include the exterior feature having a greater thickness than the portions of the wall that do not include the exterior feature.
709. A bottom trawl, comprising:
a fishing line; and
a footrope connected to the fishing line, the footrope comprising:
a main tow chain configured such that the fishing line is located aft of the main tow chain; and
a plurality of any of the footrope unit bodies of Examples 586-642, the footrope unit bodies being connected to and connected to one another via the main tow chain.
710. A bottom trawl, comprising:
a fishing line; and
a footrope, the footrope comprising:
a false fishing;
a main tow chain;
a plurality of slidable connectors for connecting the false fishing line to the fishing line, each slidable connector being slidably connected to and slidable along a portion of the false fishing line; and
a plurality of any of the footrope unit bodies of Examples 586-642, each footrope unit body being connected to the false fishing line and to the main tow chain.
711. A footrope unit body for a footrope that is for a bottom trawl, the footrope unit body comprising a wall, the wall having:
a forward facing surface, at least a portion of the forward facing surface being convex;
a rearward facing surface opposite the forward facing surface, at least a portion of the rearward facing surface being concave;
at least one first wall region; and
at least one second wall region, the at least one second wall region having a different thickness than a thickness of the at least one first wall region.
712. The footrope unit body of Example 711, wherein at least a portion of the wall is formed from a synthetic material and/or metal.
713. The footrope unit body of Example 712, wherein the synthetic material is plastic.
714. The footrope unit body of any of Examples 711-713, wherein the thickness of the at least one first wall region is greater than the thickness of the at least one second wall region.
715. The footrope unit body of Example 714, wherein at least a portion of the at least one first wall region protrudes forward and outward from the forward facing surface.
716. The footrope unit body of Example 715, wherein an entirety of the at least one first wall region protrudes forward and outward from the forward facing surface.
717. The footrope unit body of Example 716, wherein only a portion of the at least one first wall region that protrudes forward and outward from the forward facing surface.
718. The footrope unit body of any of Examples 711-717, wherein the wall has opposing lateral edges and opposing upper and lower edges, the opposing upper and lower edges extending laterally between the lateral edges, the footrope unit body further comprising at least one wear shoe, each wear shoe being on and/or adjacent to an associated one of the lateral edges so as to cover a lower portion of the wall at and/or adjacent to the associated lateral edge, the lower portion of the wall being proximate to the lower edge.
719. The footrope unit body of Example 718, wherein the footrope unit body includes a wear shoe for each lateral edge or for only one of the lateral edges.
720. The footrope unit body of any of Examples 718-719, wherein each wear shoe includes an edge cap plate that is conformed to and covers a portion of an associated one of the lateral edges at the lower portion of the wall.
721. The footrope unit body of any of Examples 718-720, wherein each wear shoe includes a front side surface cap plate that is conformed to and covers a portion of the forward facing surface at the lower portion of the wall.
722. The footrope unit body of any of Examples 718-721, wherein each wear shoe includes a rear side surface cap plate that is conformed to and covers a portion of the rearward facing surface at the lower portion of the wall.
723. The footrope unit body of any of Examples 711-717, wherein the at least one first wall region comprises a rearward portion and a forward portion.
724. The footrope unit body of Example 723, wherein the forward portion is positioned on and connected to the forward facing surface.
725. The footrope unit body of Example 723, wherein the forward portion is at least partially recessed into the forward facing surface.
726. The footrope unit body of any of Examples 723-725, wherein the forward and rearward portions extend vertically between upper and lower edges of the wall.
727. The footrope unit body of any of Examples 723-725, wherein the forward and rearward portions extend laterally between opposing lateral edges of the wall.
728. The footrope unit body of Example 723, wherein the wall has opposing lateral edges, a width of the wall being defined by the distance between the lateral edges, at least the forward portion of the at least one first wall region extending from one of the lateral edges to the other of the lateral edges such that the at least the forward portion extends the entire width of the wall.
729. The footrope unit body of any of Examples 727-728, wherein lateral ends of the forward portion are flush or in contact with the lateral edges.
730. The footrope unit body of Example 723, wherein the wall has opposing lateral edges, a width of the wall being defined by the distance between the lateral edges, at least the forward portion of the at least one first wall region being spaced from and extending between the lateral edges such that the at least the forward portion extends less than entire width of the wall.
731. The footrope unit body of any of Examples 723-730, wherein a thickness of the forward portion is the same as or different than a thickness of the rearward portion.
732. The footrope unit body of any of Examples 723-731, wherein a thickness of the rearward portion is the same as or different than a thickness of the at least one second region.
733. The footrope unit body of any of Examples 723-732, wherein the at least one second region includes each portion of the wall that does not include the forward and/or rearward portions.
734. The footrope unit body of any of Examples 723-733, wherein forward portion is formed from metal.
735. The footrope unit body of Example 734, wherein the metal forward portion is configured for use in and/or compatible with salt water.
736. The footrope unit body of any of Examples 734-735, wherein the metal forward portion is or is formed from a metallic bar, a metal half-round bar, a metallic sheet, a metallic plate, a metallic chain, and/or metallic chain mail.
737. The footrope unit body of any of Examples 723-736, wherein the rearward portion is formed a synthetic material and/or metal.
738. The footrope unit body of Example 737, wherein the rearward portion is formed a synthetic material, the synthetic material being plastic, laminate, and/or a synthetic rubber.
739. The footrope unit body of any of Examples 723-733, wherein each of the rearward and forward portions are formed from a synthetic material, the synthetic material of the rearward portion being the same as or different than the synthetic material of the forward portion.
740. The footrope unit body of Example 739, wherein the synthetic material of the forward portion is and/or comprises synthetic rubber, vulcanized rubber, a material used in forming tires and/or tire treads, a material used in forming conveyor belts, and/or a combination of woven fabric material and rubber material such as may be synthetic woven material infused with rubber material, with or without a treaded pattern to the exterior surface of this material.
741. The footrope unit body of any of Examples 739-740, wherein the synthetic material of the rearward portion is and/or comprises from plastic, laminate, and/or a synthetic rubber.
742. The footrope unit body of any of Examples 723-741, wherein the second wall region is integrally formed as a single monolithic piece with the rearward portion of each first wall region.
743. The footrope unit body of any of Examples 723-742, wherein the at least forward portion is connected to at least the rearward region via adhesion, vulcanization, and/or at least one mechanical fastener.
744. The footrope unit body of Example 743, wherein the at least one mechanical fastener is configured for use in and/or compatible with salt water.
745. The footrope unit body of any of Examples 743-744, wherein the at least one mechanical fastener comprises at least one bolt, the at least one bolt being inserted through corresponding through-holes of the forward and rearward portions.
746. The footrope unit body of Example 745, wherein the at least one bolt is elongatable so as to increase a length of the at least one bolt.
747. The footrope unit body of any of Examples 745-746, wherein the at least one bolt maintained inserted through the corresponding through-holes via welding.
748. The footrope unit body of any of Examples 745-747, wherein the number of bolts and corresponding pairs of through-holes of the forward and rearward portions is in the range of 1 to 5.
749. The footrope unit body of any of Examples 711-748, wherein the at least one first wall region comprises a plurality of first wall regions, each first wall region having the same thickness as each of the other first wall regions.
750. The footrope unit body of any of Examples 711-749, wherein the at least one first wall region comprises a plurality of first wall regions, at least one of the first wall regions having a thickness that is different than at least one other of the first wall regions.
751. The footrope unit body of any of Examples 711-750, wherein the at least one second wall region comprises a plurality of second wall regions, each second wall region having the same thickness as each of the other second wall regions.
752. The footrope unit body of any of Examples 711-750, wherein the at least one second wall region comprises a plurality of second wall regions, at least one of the second wall regions having a thickness that is different than at least one other of the second wall regions.
753. The footrope unit body of any of Examples 711-752, wherein a total height of the wall is equal to a total width of the wall.
754. The footrope unit body of any of Examples 711-752, wherein a ratio of a total and/or average width of the wall to a total and/or average height of the wall is in the range of 1.01:1 to 22:1.
755. The footrope unit body of any of Examples 723-724 and 727-754, wherein the wall has opposing lateral edges and opposing upper and lower edges, the opposing upper and lower edges extending laterally between the lateral edges, the footrope unit body further comprising at least one wear shoe, each wear shoe being on and/or adjacent to an associated one of the lateral edges so as to cover a lower portion of the wall at and/or adjacent to the associated lateral edge, the lower portion of the wall being proximate to the lower edge.
756. The footrope unit body of Example 755, wherein the footrope unit body includes a wear shoe for each lateral edge or for only one of the lateral edges.
757. The footrope unit body of any of Examples 755-756, wherein each wear shoe includes an edge cap plate that is conformed to and covers a portion of an associated one of the lateral edges at the lower portion of the wall.
758. The footrope unit body of any of Examples 755-757, wherein each wear shoe includes a front side surface cap plate that is conformed to and covers a portion of the forward facing surface at the lower portion of the wall.
759. The footrope unit body of Example 758, wherein a portion of the forward portion(s) overlaps the front side surface cap plate of the at least one wear shoe, the portion of the forward portion(s) that overlaps the front side surface cap plate of the at least one wear shoe having a thickness that is less than a thickness of portions of the forward portion(s) that do not overlap the front side surface cap plate of the at least one wear shoe.
760. The footrope unit body of Example 758, wherein each front side surface cap plate includes a raised portion, each raised portion being coaxial with and/or in-line with an associated forward portion.
761. The footrope unit body of any of Examples 755-760, wherein each wear shoe includes a rear side surface cap plate that is conformed to and covers a portion of the rearward facing surface at the lower portion of the wall.
762. The footrope unit body of any of Examples 723-761, further comprising at least one backing plate situated on the rearward facing surface and configured to provide pressure distribution for pressure exerted by fasteners and/or bolts that connect the at least one backing plate to an associated forward portion.
763. The footrope unit body of any of Examples 711-762, wherein the wall includes at least one perforation and/or at least one perforated slit.
764. The footrope unit body of any of Examples 711-763, wherein the rearward facing surface defines an opening, the wall being configured such that the opening extends in a direction that is non-parallel and/or non-perpendicular to a plane that is perpendicular to the earth's gravitational force.
765. The footrope unit body of any of Examples 711-763, wherein the rearward facing surface defines an opening, the wall being configured such that the opening is directed towards a surface on and/or above which the footrope unit body is situated when in use.
766. The footrope unit body of any of Examples 711-763, wherein the wall is configured such that, in use, at least the convex portion of the forward facing surface is directed away from a surface on and/or above which the footrope unit body is situated, and/or at least the concave portion of rearward facing surface is directed toward the surface on and/or above which the footrope unit body is situated.
767. The footrope unit body of any of Examples 711-717, 723-725, 728-754, 762-763, and 766, wherein a side plan view profile of wall is or is substantially a tear drop shape and/or an airfoil shape.
768. The footrope unit body of Example 767, wherein the wall includes a cylindrical pipe portion and an extension portion that extends from the cylindrical pipe portion, the cylindrical pipe portion and the extension portion collectively defining the tear drop shape of the wall.
769. The footrope unit body of Example 768, wherein the cylindrical pipe portion defines a pipe opening that extends widthwise and/or laterally through the cylindrical pipe portion, the pipe opening being configured to receive a roller therein, the roller being configured to be attached to a main tow chain of the footrope and/or a fishing line of the bottom trawl in such a manner that the footrope unit body is rotatable about a central axis of the pipe opening when in use.
770. The footrope unit body of Example 767, further comprising a support structure connected to at least the rearward facing surface of the wall, the support structure being in the shape of a cylinder or a half annulus.
771. The footrope unit body of any of Examples 767 and 770, wherein the tear drop shape of the wall is truncated such that the wall has an opening at a narrow and rearward end of the wall.
772. The footrope unit body of Example 771, wherein the opening is configured to receive a fishing line of the bottom trawl and a portion of a bottom netting panel of the bottom trawl that is adjacent and/or proximal to the fishing line, the bottom netting panel being connected to the fishing line.
773. The footrope unit body of any of Examples 767-772, wherein the rearward portion(s) of the first wall region(s) and/or the second wall region(s) are formed from a deformable or elastically deformable material.
774. The footrope unit body of any of Examples 767-773, wherein the forward portion(s) of the first wall region(s) are formed from metal.
775. The footrope unit body of any of Examples 711-774, further comprising at least one flange connected to the wall that extends laterally outward beyond a corresponding lateral edge of the wall.
776. The footrope unit body of any of Examples 711-725 and 727-775, wherein an entirety of each first wall region is located at a lower portion of the wall such that each first wall region does not extend vertically beyond the lower portion to an upper portion of the wall.
777. The footrope unit body of Example 776, wherein the lower portion of the wall is equal or substantially equal to a lower half of the wall, the upper portion being equal or substantially equal to an upper half of the wall.
778. The footrope unit body of any of Examples 711-777, wherein each second region is formed from metal and/or a synthetic material.
779. The footrope unit body of Example 778, wherein each second region is formed from the synthetic material, the synthetic material being plastic, laminate, and/or a synthetic rubber.
780. The footrope unit body of any of Examples 711-717, 723-754, 762-766, and 775-779, wherein the upper and lower edges of the wall are each at least partially enclosed in a shoe.
781. The footrope unit body of any of Examples 711-780, further comprising at least one spanning bridge that is separate from and connected to the wall on a rearward side of the wall so as to span at least a portion of the rearward side of the wall.
782. The footrope unit body of Example 781, wherein the at least one spanning bridge spans between the lateral edges of the wall such that a first lateral end of the at least one spanning bridge is connected to the wall adjacent to a first one of the lateral edges of the wall and a second lateral end of the at least one spanning bridge is connected to the wall adjacent to a second one of the lateral edges.
783. The footrope unit body of Example 782, wherein the lateral edges of the wall and the upper and lower edges are attached to a frame, the first end of the at least one spanning bridge being attached to the frame adjacent the first one of the lateral edges, the second end of the at least one spanning bridge being attached to the frame adjacent the second one of the lateral edges.
784. The footrope unit body of Example 781, wherein the at least one spanning bridge is spaced from and spans between the upper and edges of the wall such that an upper end of the at least one spanning bridge is connected to the rearward facing surface adjacent to the upper edge of the wall and a lower end of the at least one spanning bridge is connected to the rearward facing surface adjacent to the lower edge of the wall.
785. The footrope unit body of Example 784, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
786. The footrope unit body of Example 781, wherein the at least one spanning bridge spans between the upper and lower edges of the wall such that an upper end of the at least one spanning bridge is connected to the wall at and/or adjacent to the upper edge of the wall and a lower end of the at least one spanning bridge is connected to the wall at and/or adjacent to the lower edge of the wall.
787. The footrope unit body of Example 786, wherein the upper and lower edges of the wall are each at least partially enclosed in a shoe, the upper end of the at least one spanning bridge being attached to the shoe that at least partially encloses the upper edge of the wall, the lower end of the at least one spanning bridge being attached to the shoe that at least partially encloses the lower edge of the wall.
788. The footrope unit body of any of Examples 786-787, wherein the at least one spanning bridge comprises a plurality of spanning bridges, a first one of the spanning bridges being adjacent to a first one of the lateral edges of the wall, a second one of the spanning bridges being adjacent to a second one of the lateral edges of the wall.
789. The footrope unit body of any of Examples 711-788, wherein the wall is a multiply bent plate and/or wall having a cross-sectional and or side plan view shape that corresponds to a portion of a polygon.
790. The footrope unit body of any of Examples 711-788, wherein the wall is a multiply bent plate and/or wall, the forward facing surface and/or the rearward facing surface of the multiply bent plate and/or wall having multiple flat sides and/or facets.
791. The footrope unit body of any of Examples 789-790, wherein at least the forward facing surface of the multiply bent plate and/or wall has multiple flat sides and/or facets.
792. The footrope unit body of any of Examples 711-766 and 775-791, wherein the wall is shaped as a half-annulus in cross-section and/or when viewed in side plan view.
793. The footrope unit body of any of Examples 711-766 and 775-791, wherein a cross-sectional and/or side plan view shape of the wall is an arcuate shape that is greater than half an annulus, but less than a full annulus.
794. The footrope unit body of any of Examples 711-766 and 775-791, wherein the wall has an upper flat portion at and/or adjacent to upper edge of the wall, the upper flat portion that extends vertically upward and aft from the portion of the wall that has the convex forward facing surface and/or the concave rearward facing surface to or toward the upper edge of the wall.
795. The footrope unit body of Example 794, wherein the wall has a lower flat portion at and/or adjacent to the lower edge of the wall, the lower flat portion extending aft from the portion of the wall that has the convex forward facing surface and/or the concave rearward facing surface to or toward the lower edge of the wall.
796. The footrope unit body of Example 795, wherein the lower flat portion extends vertically downward and aft from the portion of the wall that has the convex forward facing surface and/or the concave rearward facing surface to or toward the upper edge of the wall.
797. The footrope unit body of Example 796, wherein a slope of the upper flat portion is the same as or different than the lower flat portion.
798. The footrope unit body of Example 794, wherein a lower plate is attached to the rearward side of the wall at and/or adjacent to the lower edge of the wall, the flat plate extending forward and vertically upward from where the plate is attached to the rearward side of the wall.
799. The footrope unit body of any of Examples 711-766 and 775-791, wherein
at an upper portion of the wall, at least a portion the forward facing surface is concave and at least a portion of the rearward facing surface is convex, and
at a lower portion of the wall, at least a portion of the forward facing surface is convex and at least a portion of the rearward facing portion is concave, the lower portion extending vertically downward form the upper portion, the upper portion including the upper edge of the wall, the lower portion including the lower edge of the wall.
800. The footrope unit body of any of Examples 711-766 and 775-792, wherein in top plan view, the wall is shaped as a parallelogram.
801. The footrope unit body of any of Examples 711-766 and 775-792, wherein in top plan view, the wall is shaped as a trapezoid that exhibits different angles forming its corners at one lateral end in comparison with angles forming its corners at its other lateral end.
802. The footrope unit body of any of Example 792-801, wherein a side end plate may be situated at one or both of lateral sides of the wall, each side end plate at least partially obstructing an associated lateral side channel opening of the wall.
803. The footrope unit body of Example 802, wherein a side end plate is situated at each lateral side of the wall.
804. The footrope unit body of any of Examples 802-803, wherein each side end plate may be formed of a rigid or flexible material.
805. The footrope unit body of any of Examples 711-788, wherein the forward facing surface is a convex cambered forward facing surface, a convex sloping forward facing surface, a convex bent forward facing surface, and/or a convex multiply bent forward facing surface.
806. A footrope unit body assembly for a footrope that is for a bottom trawl, the footrope unit body assembly comprising:
the footrope unit body of any of Examples 711-805; and
at least one connector connected to the footrope unit body and for connecting the footrope unit body to a chain and/or cable of the footrope and/or bottom trawl.
807. The footrope unit body assembly of Example 806, wherein the chain comprises a main tow chain of the footrope.
808. The footrope unit body assembly of any of Examples 806-807, wherein the cable comprises a fishing line of the bottom trawl.
809. The footrope unit body assembly of any of Examples 806-808, wherein the at least one connector is rigidly attached to the wall of the footrope unit body such that the at least one connector is prevented or substantially prevented from moving relative to the footrope unit body during use.
810. The footrope unit body assembly of Example 809, wherein the at least one connector includes a first backing plate on the forward facing surface, a second backing plate on and/or adjacent to the rearward facing surface, and at least one fastener extending through the wall from the first backing plate to at least the second backing plate.
811. The footrope unit body assembly of Example 810, wherein the second backing plate includes a notch configured to at least partially receive a portion of the chain and/or a portion of the cable so as to hold the received portion of the chain and/or cable in place between second backing plate and the rearward facing surface.
812. The footrope unit body assembly of any of Examples 810-811, wherein the connector further comprises at least one sleeve rigidly attached to the rearward facing surface of the footrope unit body, at least the second backing plate being located in the at least one sleeve.
813. The footrope unit body assembly of Example 810, wherein the at least one connector further includes a third backing plate on the rearward facing surface such that the third backing plate is interposed between the rearward facing surface and the second backing plate, the at least one fastener extend through the third backing plate.
814. The footrope unit body assembly of Example 813, wherein the second and third backing plates include corresponding and mirrored notches, a portion of the chain and/or a portion of the cable being received between the notches so as to hold the received portion of the chain and/or cable in place between second and third backing plates.
815. The footrope unit body assembly of any of Examples 813-814, wherein the connector further comprises at least one sleeve rigidly attached to the rearward facing surface of the footrope unit body, at least the second and third backing plates being located in the at least one sleeve.
816. The footrope unit body assembly of Example 809, wherein the at least one connector comprises at least one sleeve that is rigidly attached to the rearward facing surface of the footrope unit body.
817. The footrope unit body assembly of any of Examples 806-808, wherein the at least one connector is moveably connected to the wall of the footrope unit body such that the at least one connector is moveable relative to the footrope unit body during use.
818. The footrope unit body assembly of Example 817, wherein the at least one connector comprises a chain link connector and/or a quick-link connector
819. The footrope unit body assembly of any of Examples 817-818, wherein the at least one connector is moveably connected directly to the wall of the footrope unit body.
820. The footrope unit body assembly of Example 819, wherein the at least one connector extends through a corresponding aperture in the wall, the connector having a first end on and/or adjacent to the forward facing surface and a second end on and/or adjacent to the rearward facing surface such that the first and second ends are on opposing sides of the wall, the first end being larger than the corresponding aperture so as to be prevented from passing into and/or through the corresponding aperture, the second end being configured to be connected to the chain and/or cable of the footrope and/or bottom trawl.
821. The footrope unit body assembly of any of Examples 817-818, wherein the at least one connector is moveably connected indirectly to the wall of the footrope unit body.
822. The footrope unit body assembly of Example 821, wherein the at least one connector is moveably connected directly to a solid body, the solid body being separate from and rigidly attached to the wall.
823. The footrope unit body assembly of Example 822, wherein the solid body is attached to one of the frontward and rearward facing surfaces.
824. The footrope unit body assembly of Example 821, wherein the at least one connector is moveably connected directly to a strength member that is connected to the wall via being passed through two apertures of the wall.
825. The footrope unit body assembly of Example 824, wherein the strength member is a loop or U-shaped.
826. The footrope unit body assembly of any of Examples 824-825, wherein the strength member is a loop of pliable cable, rigid cable, or metal.
827. The footrope unit body assembly of any of Examples 817-826, further comprising at least one sleeve that is rigidly attached to the rearward facing surface of the footrope unit body, at least a portion of the at least one connector being located in the at least one sleeve.
828. The footrope unit body assembly of any of Examples 806-827, wherein the cable comprises a fishing line of the bottom trawl, the footrope unit body assembly further comprising at least one body-to-line connector for directly and/or indirectly connecting the footrope unit body to the fishing line of the bottom trawl.
829. The footrope unit body assembly of Example 828, wherein the at least one body-to-line connector is configured to be directly connected to the fishing line so as to directly connect the footrope unit body to the fishing line.
830. The footrope unit body assembly of Example 828, wherein the at least one body-to-line connector is configured to be indirectly connected to the fishing line so as to indirectly connect the footrope unit body to the fishing line.
831. The footrope unit body assembly of Example 830, wherein the at least one body to line connector is connected to the fishing line via a drop chain.
832. The footrope unit body assembly of Example 830, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
833. The footrope unit body assembly of Example 832, wherein each body-to-line connector is connected to the false fishing line and the footrope unit body in such a manner that the body-to-line connector is prevented from freely sliding along a portion of the entire exterior surface of the false fishing line.
834. The footrope unit body assembly of any of Examples 828-833, wherein the at least body-to-line connector comprises a plurality of body-to-line connectors, each body-to-line connector at least partially defining a body-to-line connector aperture.
835. The footrope unit body assembly of Example 834, wherein each body-to-line connector aperture extends perpendicular to a lateral direction, a width of the footrope unit body being measured in the lateral direction.
836. The footrope unit body assembly of Example 834, wherein each body-to-line connector aperture extends in a lateral direction, a width of the footrope unit body being measured in the lateral direction.
837. The footrope unit body assembly of any of Examples 828-836, wherein the at least one body-to-line connector is a quick-link.
838. The footrope unit body assembly of any of Examples 828-837, wherein the body-to-line connector is connected directly to the wall via being threaded through through-holes of the wall.
839. The footrope unit body assembly of any of Examples 828-837, further comprising at least one ear attached to the wall of the footrope unit body, the at least one body-to-line connector being connected to the at least one ear.
840. The footrope unit body assembly of Example 839, wherein the at least one ear is formed by a U-bolt that is affixed to the wall.
841. The footrope unit body assembly of any of Examples 839-840, wherein the at least one ear comprises a plurality of ears, each ear at least partially defining an ear aperture.
842. The footrope unit body assembly of Example 841, wherein each ear aperture extends perpendicular to a lateral direction, a width of the footrope unit body being measured in the lateral direction.
843. The footrope unit body assembly of Example 841, wherein each ear aperture extends in a lateral direction, a width of the footrope unit body being measured in the lateral direction.
844. The footrope unit body assembly of any of Examples 839 and 842-843, wherein the upper and lower edges of the wall are each at least partially enclosed in a shoe, each ear being connected to shoe that encloses the upper edge of the wall.
845. The footrope unit body assembly of any of Examples 839 and 842-843, wherein the lateral sides and the upper and lower edges are attached to a frame, each ear being connected to the frame adjacent to the upper edge.
846. The footrope unit body assembly of any of Examples 806-845, further comprising a barrier connector configured for connecting a barrier structure of the bottom trawl to the footrope unit body.
847. The footrope unit body assembly of any of Examples 806-846, wherein each first wall region is located at a lower portion of the wall, the lower portion of the wall being located below the at least one connector.
848. The footrope unit body assembly of Example 847, wherein the at least one connector is for connecting the footrope unit body to a main tow chain of the footrope such that each first wall region is located below the at least one connector and/or the main tow chain.
849. The footrope unit body assembly of Example 846, wherein the at least one connector comprises at least one body-to-line connector and the cable comprises a fishing line of the bottom trawl, the at least one body-to-line connector being configured to directly and/or indirectly connecting the footrope unit body to the fishing line of the bottom trawl.
850. The footrope unit body assembly of Example 849, wherein the at least one body-to-line connector is configured to be directly connected to the fishing line so as to directly connect the footrope unit body to the fishing line.
851. The footrope unit body assembly of Example 849, wherein the at least one body-to-line connector is configured to be indirectly connected to the fishing line so as to indirectly connect the footrope unit body to the fishing line.
852. The footrope unit body assembly of Example 851, wherein the at least one body to line connector is connected to the fishing line via a drop chain.
853. The footrope unit body assembly of Example 849, wherein each body-to-line connector is configured to connect the footrope unit body to a false fishing line of the footrope, the false fishing line being connected to the fishing line such that the footrope unit body is indirectly connected to the fishing line via at least the body-to-line connector and the false fishing line.
854. The footrope unit body assembly of Example 853, wherein each body-to-line connector is connected to the false fishing line and the footrope unit body in such a manner that the body-to-line connector is prevented from freely sliding along a portion of the entire exterior surface of the false fishing line.
855. The footrope unit body assembly of any of Examples 849-854, wherein the at least body-to-line connector comprises a plurality of body-to-line connectors, each body-to-line connector at least partially defining a body-to-line connector aperture.
856. The footrope unit body assembly of Example 855, wherein each body-to-line connector aperture extends perpendicular to a lateral direction, a width of the footrope unit body being measured in the lateral direction.
857. The footrope unit body assembly of Example 855, wherein each body-to-line connector aperture extends in a lateral direction, a width of the footrope unit body being measured in the lateral direction.
858. The footrope unit body assembly of any of Examples 849-857, wherein the at least one body-to-line connector is a quick-link.
859. The footrope unit body assembly of any of Examples 849-858, wherein the body-to-line connector is connected directly to the wall via being threaded through through-holes of the wall.
860. The footrope unit body assembly of any of Examples 849-858, further comprising at least one ear attached to the wall of the footrope unit body, the at least one body-to-line connector being connected to the at least one ear.
861. The footrope unit body assembly of Example 860, wherein the at least one ear is formed by a U-bolt that is affixed to the wall.
862. The footrope unit body assembly of any of Examples 860-861, wherein the at least one ear comprises a plurality of ears, each ear at least partially defining an ear aperture.
863. The footrope unit body assembly of Example 862, wherein each ear aperture extends perpendicular to a lateral direction, a width of the footrope unit body being measured in the lateral direction.
864. The footrope unit body assembly of Example 862, wherein each ear aperture extends in a lateral direction, a width of the footrope unit body being measured in the lateral direction.
865. The footrope unit body assembly of any of Examples 860 and 862-864, wherein the upper and lower edges of the wall are each at least partially enclosed in a shoe, each ear being connected to shoe that encloses the upper edge of the wall.
866. The footrope unit body assembly of any of Examples 860 and 862-864, wherein the lateral sides and the upper and lower edges are attached to a frame, each ear being connected to the frame adjacent to the upper edge.
867. The footrope unit body assembly of any of Examples 849-866, further comprising a barrier connector configured for connecting a barrier structure of the bottom trawl to the footrope unit body.
868. A footrope for a bottom trawl, the footrope comprising:
at least one footrope unit body of Examples 711-805, or
at least one footrope unit body assembly of Examples 806-867.
869. A footrope for a bottom trawl, the footrope comprising:
a starboard wing terminal end point;
a port wing terminal end point opposite the starboard wing terminal end point;
a plurality any of the footrope unit bodies of Examples 711-805, the footrope unit bodies being interconnected to one another and located between the starboard and port wing terminal end points; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
870. A footrope for a bottom trawl, the footrope comprising:
a plurality of any of the footrope unit bodies of Examples 711-805; and
a plurality of connectors, each connector being rigidly attached to the wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
871. A footrope for a bottom trawl, the footrope comprising a plurality of any of the footrope unit bodies of Examples 711-805, a side plan view profile of the wall of at least a portion of the plurality of footrope unit bodies being or substantially being a tear drop shape and/or an airfoil shape.
872. A footrope for a bottom trawl, the footrope comprising a plurality of any of the footrope unit bodies of Examples 711-805, at least the forward facing surface of at least a portion of the walls being a multiply bent surface having multiple flat sides and/or facets.
874. A combination comprising a bottom trawl and a footrope for a bottom trawl, the bottom trawl comprising a fishing line, the footrope comprising a false fishing line and a main tow chain, the footrope's false fishing line configured to have slidably connected to at least portions of the false fishing line a plurality of slidable connectors for connecting the false fishing line to the fishing line, each slidable connector being slidably connected to and slidable along a portion of the false fishing line.
875. A footrope unit body for a footrope that is for a bottom trawl, the footrope unit body comprising a wall, the wall comprising:
a body in the form of a bent plate, the body having a forward facing surface; and
at least one exterior feature connected to and/or at least partially recessed into the forward facing surface;
wherein portions of the wall that include the exterior feature having a greater thickness than the portions of the wall that do not include the exterior feature.
876. The footrope unit body of Example 875, wherein the body is formed from a synthetic material and/or metal.
877. The footrope unit body of Example 876, wherein the body is formed from a synthetic material, the synthetic material being plastic, laminate, and/or a synthetic rubber.
878. The footrope unit body of any of Examples 875-877, wherein the at least one exterior feature is formed from the same material as the body or a different material.
879. The footrope unit body of any of Examples 875-878, wherein the at least one exterior feature is formed from a synthetic material and/or metal.
880. The footrope unit body of any of Examples 875-879, wherein the at least one exterior feature is connected to the forward facing surface via adhesion, vulcanization, and/or one or more mechanical fasteners.
881. The footrope unit body of any of Examples 875-880, wherein the at least one exterior feature extends vertically between upper and lower edges of the body.
882. The footrope unit body of any of Examples 875-880, wherein the at least one exterior feature extends laterally between opposing lateral edges of the body.
883. The footrope unit body of any of Examples 875-880 and 882, wherein an upper region of the body is configured to be affixed to a fishing line of the bottom trawl, a central region of the body is configured to be affixed to a main tow line of the footrope, and a bottom region of the body comprises the at least one exterior feature such that the at least one exterior feature is spaced from each of the upper and central regions.
884. The footrope unit body of any of Examples 875-883, wherein at least a portion of the forward facing surface is convex.
885. The footrope unit body of any of Examples 875-884, wherein the body has a rearward facing surface opposite the forward facing surface, at least a portion of the rearward facing surface being concave.
886. A footrope unit body assembly for a footrope that is for a bottom trawl, the footrope unit body assembly comprising:
the footrope unit body of any of Examples 875-885; and
at least one connector connected to the footrope unit body and for connecting the footrope unit body to a chain and/or cable of the footrope and/or bottom trawl.
887. The footrope unit body assembly of Example 886, wherein the chain comprises a main tow chain of the footrope.
888. The footrope unit body assembly of any of Examples 886-887, wherein the cable comprises a fishing line of the bottom trawl.
889. The footrope unit body assembly of any of Examples 886-888, wherein the at least one connector is rigidly attached to the wall of the footrope unit body such that the at least one connector is prevented or substantially prevented from moving relative to the footrope unit body during use.
890. The footrope unit body assembly of any of Examples 886-888, wherein the at least one connector is moveably connected to the wall of the footrope unit body such that the at least one connector is moveable relative to the footrope unit body during use.
891. The footrope unit body assembly of any of Examples 886-890, further comprising at least one body-to-line connector for directly and/or indirectly connecting the footrope unit body to the fishing line of the bottom trawl.
892. The footrope unit body assembly of Example 886, wherein the at least one connector comprises at least one body-to-line connector, the at least one body-to-line connector being configured to directly and/or indirectly connecting the footrope unit body to the fishing line of the bottom trawl.
893. A footrope for a bottom trawl, the footrope comprising:
at least one footrope unit body of Examples 875-885, or
at least one footrope unit body assembly of Examples 886-892.
894. A footrope for a bottom trawl, the footrope comprising:
a starboard wing terminal end point;
a port wing terminal end point opposite the starboard wing terminal end point;
a plurality any of the footrope unit bodies of Examples 875-885, the footrope unit bodies being interconnected to one another and located between the starboard and port wing terminal end points; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
894. A footrope for a bottom trawl, the footrope comprising:
a plurality of any of the footrope unit bodies of Examples 875-885; and
a plurality of connectors, each connector being rigidly attached to the wall of an associated footrope unit body such that each connector is prevented or substantially prevented from moving relative to an associated footrope unit body at least during use, each connector connecting an associated footrope unit body to a line such that the footrope unit bodies are connected to one another at least via the line and the connectors, the line being a main tow chain of the footrope or a fishing line of the bottom trawl.
895. A footrope for a bottom trawl, the footrope comprising a plurality of any of the footrope unit bodies of Examples 875-885, a side plan view profile of the wall of at least a portion of the plurality of footrope unit bodies being or substantially being a tear drop shape and/or an airfoil shape.
896. A footrope for a bottom trawl, the footrope comprising a plurality of any of the footrope unit bodies of Examples 875-885, at least the forward facing surface of at least a portion of the walls being a multiply bent surface having multiple flat sides and/or facets.
897. A bottom trawl, comprising:
a fishing line; and
a footrope connected to the fishing line, the footrope comprising:
a main tow chain configured such that the fishing line is located aft of the main tow chain; and
a plurality of any of the footrope unit bodies of Examples 875-885, the footrope unit bodies being connected to and connected to one another via the main tow chain.
898. A bottom trawl, comprising:
a fishing line; and
a footrope, the footrope comprising:
a false fishing;
a main tow chain;
a plurality of slidable connectors for connecting the false fishing line to the fishing line, each slidable connector being slidably connected to and slidable along a portion of the false fishing line; and
a plurality of any of the footrope unit bodies of Examples 875-885, each footrope unit body being connected to the false fishing line and to the main tow chain.
899. The footrope unit body of any of Examples 875-885, wherein the forward facing surface of the wall is a multiply bent surface having multiple flat sides and/or facets.
900. The footrope unit body of any of Examples 875-885 and 899, wherein at least one spanning bridge separate from and connected to the wall on a rearward side of the wall, the rearward facing surface being on the rearward side of the wall, the spanning bridge spanning at least a portion of the rearward side of the wall.
901. A bottom trawl, comprising:
a fishing line; and
a footrope connected to the fishing line, the footrope comprising:
a main tow chain configured such that the fishing line is located aft of the main tow chain; and
a plurality of footrope unit bodies connected to and connected to one another via the main tow chain.
902. The bottom trawl of Example 901, wherein the main tow chain is configured such that the fishing line fishes aft of the main tow chain during use.
903. The bottom trawl of any of Examples 901-902, wherein a length of the main tow chain is less than a length of the fishing line.
904. The bottom trawl of Example 903, wherein fishing line is in a range of from 0.1 percent to 5.9 percent longer than the main tow chain.
905. The bottom trawl of Example 903, wherein main tow chain is in a range of from 0.1 percent to 8.7 percent shorter than the fishing line.
906. The bottom trawl of any of Examples 903-905, wherein the length of the main tow chain is a taught straight line length of the main tow chain including all connectors.
907. The bottom trawl of any of Examples 903-906, wherein the length of the fishing line is a taught straight line length of the fishing line including all connectors.
908. The bottom trawl of any of Examples 906-907, wherein the footrope includes a starboard delta plate connected to a starboard terminal end of the main tow chain and a port delta plate connected to a port terminal end of the main tow chain.
909. The bottom trawl of Example 908, wherein the length of the main tow chain includes a distance from a connection point on the port delta plate at which the port terminal end of the main tow chain is connected to the port delta plate to a port most connection point of the port delta plate to which a port wing terminal end point of the footrope is connected, the length of the main tow chain further including a distance from a connection point on the starboard delta plate at which the starboard terminal end of the main tow chain is connected to the starboard delta plate to a starboard most connection point of the starboard delta plate to which a starboard wing terminal end point of the footrope is connected.
910. The bottom trawl of any of Examples 908-909, wherein the length of the fishing line includes a distance from a connection point on the port delta plate at which a port terminal end of the fishing line is connected to the port delta plate to a port most connection point of the port delta plate to which a port wing terminal end point of the footrope is connected, the length of the fishing line further including a distance from a connection point on the starboard delta plate at which a starboard terminal end of the fishing line is connected to the starboard delta plate to a starboard most connection point of the starboard delta plate to which a starboard wing terminal end point of the footrope is connected.
911. The bottom trawl of any of Examples 901-907, wherein at least one rockhopper disk is located between a starboard most one of the footrope unit bodies and a starboard wing terminal end point of the footrope.
912. The bottom trawl of any of Examples 901-907 and 911, wherein at least one rockhopper disk is located between a port most one of the footrope unit bodies and a port wing terminal end point of the footrope.
913. The bottom trawl of any of Examples 901-907 and 911-912, wherein at least one weighted ballast is located between a starboard most one of the footrope unit bodies and a starboard wing terminal end point of the footrope.
914. The bottom trawl of any of Examples 901-907 and 911-913, wherein at least one weighted ballast is located between a port most one of the footrope unit bodies and a port wing terminal end point of the footrope.
915. The bottom trawl of any of Examples 913-914, wherein each weighted ballast includes a bobbin having a through-hole in which a spindle is inserted.
916. The bottom trawl of any of Examples 901-915, wherein the footrope includes a false fishing line connected to each of the footrope unit bodies such that each of the footrope unit bodies is indirectly connected to the fishing line via the false fishing line.
917. The bottom trawl of Example 916, wherein the false fishing is connected to the fishing line via a plurality of slidable connectors, each slidable connector being slidably connected to and slidable along a portion of the false fishing line.
918. The bottom trawl of Example 917, wherein each footrope unit body includes laterally spaced first and second body-to-line connectors for connecting footrope unit body to the false fishing line, each slidable connector being slidably connected to the false fishing line at a location that is between associated first and second body-to-line connectors, the associated first and second body-to-line connectors of each footrope unit body defining and bounding the portion of the false fishing line that an associated slidable connector is slidable along.
919. The bottom trawl of Example 918, wherein each body-to-line connector is a quick-link.
920. The bottom trawl of any of Examples 918-919, wherein each body-to-line connector is connected directly to a wall of an associated footrope unit body via being threaded through through-holes of the wall.
921. The bottom trawl of any of Examples 918-920, wherein each footrope unit body includes laterally spaced ears connected directly and/or indirectly to a wall of the footrope unit body, each body-to-line connector being connected to an associated ear.
922. The bottom trawl of Example 921, wherein each ear is formed by a U-bolt that is affixed directly and/or indirectly to the wall of an associated footrope unit body.
923. The bottom trawl of any of Examples 921-922, wherein each ear is directly connected to an associated footrope unit body at and/or adjacent to an upper edge of the wall of the associated footrope unit body.
924. The bottom trawl of any of Examples 921-922, wherein each ear is directly connected to a shoe, each shoe at least partially enclosing an upper edge of the wall of the associated footrope unit body such that each ear is indirectly connected to the wall of an associated footrope unit body via an associated shoe.
925. The bottom trawl of any of Examples 917-924, wherein each slidable connector comprises a quick link connected to the fishing line and a pear link connected to the quick link and to the false fishing line such that the pear link is slidable along a portion of the false fishing line.
926. The bottom trawl of any of Examples 901-925, wherein the main tow chain comprises a plurality of main tow chain segments, each main tow chain segment being connected to at least one separate and directly adjacent main tow chain segment via a hammerlock.
927. The bottom trawl of any of Examples 901-926, wherein at least one of the footrope unit bodies is a varying thickness footrope unit body, each varying thickness footrope unit body has at least one first wall region and at least one second wall region, the at least one second wall regions having a different thickness than a thickness of the at least one first wall regions.
928. The bottom trawl of any of Examples 901-927, wherein at least one of the footrope unit bodies includes at least one spanning bridge, each spanning bridge being separate from and connected to a wall of an associated footrope unit body on a rearward side of the wall so as to span at least a portion of the rearward side of the wall.
929. The bottom trawl of any of Examples 901-928, wherein a wall of at least one of the footrope unit bodies is a multiply bent plate and/or wall having a cross-sectional and or side plan view shape that corresponds to a portion of a polygon.
930. The bottom trawl of any of Examples 901-928, wherein a wall of at least one of the footrope unit bodies is a multiply bent plate and/or wall, a forward facing surface and/or a rearward facing surface of each multiply bent plate and/or wall having multiple flat sides and/or facets.
931. The bottom trawl of any of Examples 901-930, wherein each footrope unit body is connected to the main tow chain via at least one connector, each connector being rigidly attached to the wall of an associated footrope unit body such that each connector is prevented or substantially prevented from moving relative to an associated footrope unit body during use.
932. The bottom trawl of any of Examples 901-931, wherein at least one of the footrope unit bodies is a bent plate.
933. The bottom trawl of any of Examples 901-907 and 917-932, wherein the footrope comprises:
a starboard wing terminal end point;
a port wing terminal end point opposite the starboard wing terminal end point, the plurality of footrope unit bodies being located between the starboard and port wing terminal end points, each footrope unit body comprising a wall having opposing forward and rearward facing surfaces, at least a portion of the forward facing surface being convex, a least a portion of the rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
934. The bottom trawl of any of Examples 901-926 and 928-932, wherein each footrope unit body comprising a wall having opposing forward and rearward facing surfaces, at least a portion of the forward facing surface being convex, a least a portion of the rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
935. The bottom trawl of any of Examples 901-932, wherein a side plan view profile of a wall of at least a portion of the plurality of footrope unit bodies being or substantially being a tear drop shape and/or an airfoil shape.
936. The bottom trawl of any of Examples 901-928 and 931-932, wherein each footrope unit body has a wall with a forward facing surface, at least the forward facing surface of at least a portion of the walls being a multiply bent surface having multiple flat sides and/or facets.
937. The bottom trawl of claims 901-926 and 928-931, wherein each footrope unit body has a wall, the wall comprising a body in the form of a bent plate, each body having a forward facing surface, the wall of at least a portion of the footrope unit bodies having an exterior feature connected to and/or at least partially recessed into the forward facing surface, and wherein for each wall that includes the at least one exterior feature, portions of the wall that include the exterior feature has a greater thickness than the portions of the wall that do not include the exterior feature.
938. A bottom trawl, comprising:
a fishing line; and
a footrope, the footrope comprising:
a false fishing;
a main tow chain;
a plurality of slidable connectors for connecting the false fishing line to the fishing line, each slidable connector being slidably connected to and slidable along a portion of the false fishing line; and
a plurality of footrope unit bodies, each footrope unit body being connected to the false fishing line and to the main tow chain.
939. The bottom trawl of Example 938, wherein each footrope unit body includes laterally spaced first and second body-to-line connectors for connecting footrope unit body to the false fishing line, each slidable connector being slidably connected to the false fishing line at a location that is between associated first and second body-to-line connectors, the associated first and second body-to-line connectors of each footrope unit body defining and bounding the portion of the false fishing line that an associated slidable connector is slidable along.
940. The bottom trawl of Example 939, wherein each body-to-line connector is a quick-link.
941. The bottom trawl of any of Examples 939-940, wherein each body-to-line connector is connected directly to a wall of an associated footrope unit body via being threaded through through-holes of the wall.
942. The bottom trawl of any of Examples 939-941, wherein each footrope unit body includes laterally spaced ears connected directly and/or indirectly to a wall of the footrope unit body, each body-to-line connector being connected to an associated ear.
943. The bottom trawl of Example 942, wherein each ear is formed by a U-bolt that is affixed directly and/or indirectly to the wall of an associated footrope unit body.
944. The bottom trawl of any of Examples 942-943, wherein each ear is directly connected to an associated footrope unit body at and/or adjacent to an upper edge of the wall of the associated footrope unit body.
945. The bottom trawl of any of Examples 942-943, wherein each ear is directly connected to a shoe, each shoe at least partially enclosing an upper edge of the wall of the associated footrope unit body such that each ear is indirectly connected to the wall of an associated footrope unit body via an associated shoe.
946. The bottom trawl of any of Examples 938-945, wherein each slidable connector comprises a quick link connected to the fishing line and a pear link connected to the quick link and to the false fishing line such that the pear link is slidable along a portion of the false fishing line.
947. The bottom trawl of any of Examples 938-946, wherein at least one rockhopper disk is located between a starboard most one of the footrope unit bodies and a starboard wing terminal end point of the footrope.
948. The bottom trawl of any of Examples 938-947, wherein at least one rockhopper disk is located between a port most one of the footrope unit bodies and a port wing terminal end point of the footrope.
949. The bottom trawl of any of Examples 938-948, wherein at least one weighted ballast is located between a starboard most one of the footrope unit bodies and a starboard wing terminal end point of the footrope.
950. The bottom trawl of any of Examples 938-949, wherein at least one weighted ballast is located between a port most one of the footrope unit bodies and a port wing terminal end point of the footrope.
951. The bottom trawl of any of Examples 949-950, wherein each weighted ballast includes a bobbin having a through-hole in which a spindle is inserted.
952. The bottom trawl of any of Examples 938-951, wherein the footrope includes a starboard delta plate connected to a starboard terminal end of the main tow chain and a starboard terminal end of the fishing line, the footrope including a port delta plate connected to a port terminal end of the main tow chain and a port terminal end of the fishing line.
953. The bottom trawl of any of Examples 938-952, wherein the main tow chain comprises a plurality of main tow chain segments, each main tow chain segment being connected to at least one separate and directly adjacent main tow chain segment via a hammerlock.
954. The bottom trawl of any of Examples 938-953, wherein at least one of the footrope unit bodies is a varying thickness footrope unit body, each varying thickness footrope unit body has at least one first wall region and at least one second wall region, the at least one second wall regions having a different thickness than a thickness of the at least one first wall regions.
955. The bottom trawl of any of Examples 938-954, wherein at least one of the footrope unit bodies includes at least one spanning bridge, each spanning bridge being separate from and connected to a wall of an associated footrope unit body on a rearward side of the wall so as to span at least a portion of the rearward side of the wall.
956. The bottom trawl of any of Examples 938-955, wherein a wall of at least one of the footrope unit bodies is a multiply bent plate and/or wall having a cross-sectional and or side plan view shape that corresponds to a portion of a polygon.
957. The bottom trawl of any of Examples 938-955, wherein a wall of at least one of the footrope unit bodies is a multiply bent plate and/or wall, a forward facing surface and/or a rearward facing surface of each multiply bent plate and/or wall having multiple flat sides and/or facets.
958. The bottom trawl of any of Examples 938-957, wherein each footrope unit body is connected to the main tow chain via at least one connector, each connector being rigidly attached to the wall of an associated footrope unit body such that each connector is prevented or substantially prevented from moving relative to an associated footrope unit body during use.
959. The bottom trawl of any of Examples 938-958, wherein at least one of the footrope unit bodies is a bent plate.
960. The bottom trawl of any of Examples 938-946 and 953-959, wherein the footrope comprises:
a starboard wing terminal end point;
a port wing terminal end point opposite the starboard wing terminal end point, the plurality of footrope unit bodies being located between the starboard and port wing terminal end points, each footrope unit body comprising a wall having opposing forward and rearward facing surfaces, at least a portion of the forward facing surface being convex, a least a portion of the rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
961. The bottom trawl of any of Examples 938-953 and 955-959, wherein each footrope unit body comprising a wall having opposing forward and rearward facing surfaces, at least a portion of the forward facing surface being convex, a least a portion of the rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
962. The bottom trawl of any of Examples 938-959, wherein a side plan view profile of a wall of at least a portion of the plurality of footrope unit bodies being or substantially being a tear drop shape and/or an airfoil shape.
963. The bottom trawl of any of Examples 938-955 and 958-959, wherein each footrope unit body has a wall with a forward facing surface, at least the forward facing surface of at least a portion of the walls being a multiply bent surface having multiple flat sides and/or facets.
964. The bottom trawl of Examples 938-953 and 955-958, wherein each footrope unit body has a wall, the wall comprising a body in the form of a bent plate, each body having a forward facing surface, the wall of at least a portion of the footrope unit bodies having an exterior feature connected to and/or at least partially recessed into the forward facing surface, and wherein for each wall that includes the at least one exterior feature, portions of the wall that include the exterior feature has a greater thickness than the portions of the wall that do not include the exterior feature.
965. The bottom trawl of Examples 938-959, wherein the main tow chain is configured such that the fishing line is located aft of the main tow chain.
966. A footrope for a bottom trawl, the footrope comprising:
a false fishing line configured to be capable of being connected to a fishing line of a bottom trawl; and
a main tow chain;
wherein the false fishing line configured to be capable of having slidably attached to portions of the false fishing line a plurality of slidable connectors for connecting the false fishing line to the fishing line of a bottom trawl, each slidable connector being capable of being slidably connected to and slidable along a portion of the false fishing line.
967. The footrope of Example 966, further comprising a plurality of footrope unit bodies, each footrope unit body being connected to the false fishing line and to the main tow chain.
968. A footrope of Example 967, wherein each the footrope unit body comprises a wall, at least one of the walls comprising:
a body in the form of a bent plate, the body having a forward facing surface; and
at least one exterior feature connected to and/or at least partially recessed into the forward facing surface;
wherein portions of the wall that include the exterior feature having a greater thickness than the portions of the wall that do not include the exterior feature.
969. The footrope of Example 968, wherein each body is formed from a synthetic material and/or metal.
970. The footrope of Example 969, wherein each body is formed from a synthetic material, the synthetic material being plastic, laminate, and/or a synthetic rubber.
971. The footrope of any of Examples 968-970, wherein each exterior feature is formed from the same material as an associated body or a different material.
972. The footrope of any of Examples 968-971, wherein each exterior feature is formed from a synthetic material and/or metal.
973. The footrope of any of Examples 968-972, wherein each exterior feature is connected to an associated forward facing surface via adhesion, vulcanization, and/or one or more mechanical fasteners.
974. The footrope of any of Examples 968-973, wherein each exterior feature extends vertically between upper and lower edges of an associated body.
975. The footrope of any of Examples 968-973, wherein each exterior feature extends laterally between opposing lateral edges of the body.
976. The footrope of any of Examples 968-973 and 975, wherein for each body, an upper region of the body is configured to be affixed to the false fishing line, a central region of the body is configured to be affixed to the main tow line of the footrope, and a bottom region of the body comprises the at least one exterior feature such that the at least one exterior feature is spaced from each of the upper and central regions of the body.
977. The footrope of any of Examples 968-976, wherein at least a portion of each forward facing surface is convex.
978. The footrope of any of Examples 968-977, wherein each body has a rearward facing surface opposite the forward facing surface, at least a portion of the rearward facing surface being concave.
979. A footrope for a bottom trawl, the footrope comprising:
a false fishing line configured to be connectable to a fishing line of a bottom trawl; and
a main tow chain configured such that portions of the false fishing line are located aft of the main tow chain.
980. The footrope of Example 979, wherein the main tow chain is configured such that the portions of the false fishing line that are located mainly aft of the main tow chain comprise at least the one third of the false fishing line's length situated most proximal the center of the footrope.
981. The footrope of any of Examples 979-980, further comprising a plurality of footrope unit bodies, each footrope unit body being connected to the false fishing line and to the main tow chain.
982. The footrope of any of Examples 979-981, wherein the main tow chain is configured such that the fishing line is fishes aft of the main tow chain during use.
983. The footrope of any of Examples 979-981, wherein a length of the main tow chain is less than a length of the fishing line.
984. The footrope of Example 983, wherein fishing line is in a range of from 0.1 percent to 5.9 percent longer than the main tow chain.
985. The footrope of Example 983, wherein main tow chain is in a range of from 0.1 percent to 8.7 percent shorter than the fishing line.
986. The footrope of any of Examples 983-985, wherein the length of the main tow chain is a taught straight line length of the main tow chain including all connectors.
987. The footrope of any of Examples 983-986, wherein the length of the fishing line is a taught straight line length of the fishing line including all connectors.
988. The footrope of any of Examples 986-987, further comprising a starboard delta plate connected to a starboard terminal end of the main tow chain and a port delta plate connected to a port terminal end of the main tow chain.
989. The footrope of Example 988, wherein the length of the main tow chain includes a distance from a connection point on the port delta plate at which the port terminal end of the main tow chain is connected to the port delta plate to a port most connection point of the port delta plate to which a port wing terminal end point of the footrope is connected, the length of the main tow chain further including a distance from a connection point on the starboard delta plate at which the starboard terminal end of the main tow chain is connected to the starboard delta plate to a starboard most connection point of the starboard delta plate to which a starboard wing terminal end point of the footrope is connected.
990. The footrope of any of Examples 988-989, wherein the length of the fishing line includes a distance from a connection point on the port delta plate at which a port terminal end of the fishing line is connected to the port delta plate to a port most connection point of the port delta plate to which a port wing terminal end point of the footrope is connected, the length of the fishing line further including a distance from a connection point on the starboard delta plate at which a starboard terminal end of the fishing line is connected to the starboard delta plate to a starboard most connection point of the starboard delta plate to which a starboard wing terminal end point of the footrope is connected.
991. The footrope of any of Examples 981-987, wherein at least one rockhopper disk is located between a starboard most one of the footrope unit bodies and a starboard wing terminal end point of the footrope.
992. The footrope of any of Examples 979-987 and 991, wherein at least one rockhopper disk is located between a port most one of the footrope unit bodies and a port wing terminal end point of the footrope.
993. The footrope of any of Examples 979-987 and 991-992, wherein at least one weighted ballast is located between a starboard most one of the footrope unit bodies and a starboard wing terminal end point of the footrope.
994. The footrope of any of Examples 979-987 and 991-993, wherein at least one weighted ballast is located between a port most one of the footrope unit bodies and a port wing terminal end point of the footrope.
995. The footrope of any of Examples 993-994, wherein each weighted ballast includes a bobbin having a through-hole in which a spindle is inserted.
996. The footrope of any of Examples 981-995, wherein the false fishing is connected to the fishing line via a plurality of slidable connectors, each slidable connector being slidably connected to and slidable along a portion of the false fishing line.
997. The footrope of Example 996, wherein each footrope unit body includes laterally spaced first and second body-to-line connectors for connecting footrope unit body to the false fishing line, each slidable connector being slidably connected to the false fishing line at a location that is between associated first and second body-to-line connectors, the associated first and second body-to-line connectors of each footrope unit body defining and bounding the portion of the false fishing line that an associated slidable connector is slidable along.
998. The footrope of Example 998, wherein each body-to-line connector is a quick-link.
999. The footrope of any of Examples 997-998, wherein each body-to-line connector is connected directly to a wall of an associated footrope unit body via being threaded through through-holes of the wall.
1000. The footrope of any of Examples 997-999, wherein each footrope unit body includes laterally spaced ears connected directly and/or indirectly to a wall of the footrope unit body, each body-to-line connector being connected to an associated ear.
1001. The footrope of Example 1000, wherein each ear is formed by a U-bolt that is affixed directly and/or indirectly to the wall of an associated footrope unit body.
1002. The footrope of any of Examples 1000-1001, wherein each ear is directly connected to an associated footrope unit body at and/or adjacent to an upper edge of the wall of the associated footrope unit body.
1003. The footrope of any of Examples 1000-1001, wherein each ear is directly connected to a shoe, each shoe at least partially enclosing an upper edge of the wall of the associated footrope unit body such that each ear is indirectly connected to the wall of an associated footrope unit body via an associated shoe.
1004. The footrope of any of Examples 996-1003, wherein each slidable connector comprises a quick link connected to the fishing line and a pear link connected to the quick link and to the false fishing line such that the pear link is slidable along a portion of the false fishing line.
1005. The footrope of any of Examples 979-1004, wherein the main tow chain comprises a plurality of main tow chain segments, each main tow chain segment being connected to at least one separate and directly adjacent main tow chain segment via a hammerlock.
1006. The footrope of any of Examples 981-1005, wherein at least one of the footrope unit bodies is a varying thickness footrope unit body, each varying thickness footrope unit body has at least one first wall region and at least one second wall region, the at least one second wall regions having a different thickness than a thickness of the at least one first wall regions.
1007. The footrope of any of Examples 981-1006, wherein at least one of the footrope unit bodies includes at least one spanning bridge, each spanning bridge being separate from and connected to a wall of an associated footrope unit body on a rearward side of the wall so as to span at least a portion of the rearward side of the wall.
1008. The footrope of any of Examples 981-1007, wherein a wall of at least one of the footrope unit bodies is a multiply bent plate and/or wall having a cross-sectional and or side plan view shape that corresponds to a portion of a polygon.
1009. The footrope of any of Examples 981-1007, wherein a wall of at least one of the footrope unit bodies is a multiply bent plate and/or wall, a forward facing surface and/or a rearward facing surface of each multiply bent plate and/or wall having multiple flat sides and/or facets.
1010. The footrope of any of Examples 981-1009, wherein each footrope unit body is connected to the main tow chain via at least one connector, each connector being rigidly attached to the wall of an associated footrope unit body such that each connector is prevented or substantially prevented from moving relative to an associated footrope unit body during use.
1011. The footrope of any of Examples 981-1010, wherein at least one of the footrope unit bodies is a bent plate.
1012. The footrope of any of Examples 981-987 and 996-1011, wherein the footrope comprises:
a starboard wing terminal end point;
a port wing terminal end point opposite the starboard wing terminal end point, the plurality of footrope unit bodies being located between the starboard and port wing terminal end points, each footrope unit body comprising a wall having opposing forward and rearward facing surfaces, at least a portion of the forward facing surface being convex, a least a portion of the rearward facing surface being concave; and
at least one rockhopper disk and/or at least one weighted ballast located between
(a) a starboard most one of the footrope unit bodies and the starboard wing terminal end point, and/or
(b) a port most one of the footrope unit bodies and the port wing terminal end point.
1013. The footrope of any of Examples 981-1005 and 1007-1011, wherein each footrope unit body comprising a wall having opposing forward and rearward facing surfaces, at least a portion of the forward facing surface being convex, a least a portion of the rearward facing surface being concave, at least a portion of the plurality of footrope unit bodies having a varying thickness, each varying thickness footrope unit body having at least one first wall region and at least one second wall region, the at least one second wall regions having a different thickness than a thickness of the at least one first wall regions.
1014. The footrope of any of Examples 981-1011, wherein a side plan view profile of a wall of at least a portion of the plurality of footrope unit bodies being or substantially being a tear drop shape and/or an airfoil shape.
1015. The footrope of any of Examples 981-1007 and 1010-1011, wherein each footrope unit body has a wall with a forward facing surface, at least the forward facing surface of at least a portion of the walls being a multiply bent surface having multiple flat sides and/or facets.
1016. The footrope of any of Examples 981-1005 and 1007-1010, wherein each footrope unit body has a wall, the wall comprising a body in the form of a bent plate, each body having a forward facing surface, the wall of at least a portion of the footrope unit bodies having an exterior feature connected to and/or at least partially recessed into the forward facing surface, and wherein for each wall that includes the at least one exterior feature, portions of the wall that include the exterior feature has a greater thickness than the portions of the wall that do not include the exterior feature.
1017. A footrope for a bottom trawl, the footrope comprising:
a false fishing line;
a main tow chain;
a plurality of slidable connectors for connecting the false fishing line to the fishing line, each slidable connector being slidably connected to and slidable along a portion of the false fishing line; and
a plurality of footrope unit bodies, each footrope unit body being connected to the false fishing line and to the main tow chain.
1018. A footrope for a bottom trawl, the footrope comprising:
a false fishing line configured to be connectable to a fishing line of the bottom trawl; and
a main tow chain;
wherein the footrope is configured such that portions of the false fishing line are located aft of the main tow chain when the footrope is towed upon at port and starboard forward wing points of the footrope.
1019. The footrope of Example 1018, wherein the main tow chain is configured such that the portions of the false fishing line that are located aft of the main tow chain comprise at least the one third of the false fishing line's length situated most proximal the center of the footrope.
1020. The footrope of any of Examples 1018-1019, further comprising a plurality of slidable connectors for connecting the false fishing line to the fishing line of the bottom trawl, each slidable connector being slidably connected to and slidable along a portion of the false fishing line.
1021. The footrope of any of Examples 1018-1020, further comprising a plurality of footrope unit bodies connected to the main tow chain and connected to one another via the main tow chain, each footrope unit body having a wall.
1022. The footrope of Example 1021, wherein the footrope unit bodies comprise a bent plate body where the wall is a curving and/or bending wall having opposing forward and rearward facing surfaces, the forward facing surface being mainly convex and/or convex, the rearward facing surface being mainly concave and/or concave and open to contact with water from the exterior environment, the bent plate body being configured so that in side plan view and/or cross sectional view it comprises the curving and/or bending wall.
1023. The footrope of Example 1022, wherein each bent plate body lacks a 180-degree arc of a circle in the cross-sectional form of the bent plate body.
1024. The footrope of Example 1021, wherein the wall of each of a plurality of the footrope unit bodies comprises regions of different thicknesses.
1025. The footrope of Example 1024, wherein the wall regions of different thicknesses further comprise a combination of metal portions and synthetic portions.
1026. The footrope of Example 1021, wherein a plurality of the footrope unit bodies each comprises in side plan view and/or cross sectional view at least a portion of a polygon.
1027. The footrope of any of Examples 1021-1026, wherein each wall of a plurality of the footrope unit bodies includes at least one spanning bridge that is separate from and connected to the wall on a rearward side of the wall so as to span at least a portion of the rearward side of the wall.
1028. The footrope of any of Examples 1021-1027, wherein the wall of a plurality of the footrope unit bodies is mainly a synthetic wall to which is connected at least one portion of metal, and wherein each portion of metal protrudes from at least an associated forward facing surface of an associated wall.
1029. The footrope of Example 1028, wherein each portion of metal is situated on a region of an associated footrope unit body that is below a connection assembly of the associated footrope unit body, each connection assembly being configured to permit connecting an associated footrope unit body to the main tow chain.
1030. The footrope of any of Examples 1021-1028, wherein the wall of each of a plurality of the footrope unit bodies has a greater width (w) at its lower region proximal to and/or in contact with a lower edge of the wall compared to its width (w) at other regions of the wall.
1031. The footrope of any of Examples 1021-1030, wherein a plurality of the footrope unit bodies comprises at least a portion of a connection between the main tow chain and the false fishing line.
1032. The footrope of Example 1031, wherein at least one ear is affixed proximally to the upper edge of a plurality of footrope unit bodies, and wherein the false fishing line is permanently connected to a plurality of the ears.
1033. The footrope of Example 1032, wherein the false fishing line that is permanently connected to a plurality of the ears is configured so that there is slack in the false fishing line between adjacent ears.
1034. The footrope of Example 1032, wherein the false fishing line that is permanently connected to a plurality of the ears is configured so that the false fishing line is taught between adjacent ears.
1035. The footrope of any of Examples 1021-1022 and 1024-1034, wherein a plurality of the footrope unit bodies lack a 180-degree arc of a circle in the cross-sectional form of the footrope unit bodies.
1036. A method for forming a footrope, the footrope being for a bottom trawl, the method comprising:
providing a false fishing line that is configured to be connectable to a fishing line of the bottom trawl; and
providing a main tow chain that is configured such that portions of the false fishing line are located aft of the main tow chain when the footrope is towed upon at port and starboard forward wing points of the footrope
1037. The method of Example 1036, wherein the portions of the false fishing line that are located aft of the main tow chain comprise at least the one third of the false fishing line's length situated most proximal the center of the footrope.
1038. The method of any of Examples 1036-1037, further comprising:
providing a plurality of slidable connectors for connecting the false fishing line to the fishing line of the bottom trawl; and
slidably connecting each slidable connector to the false fishing line such that each slidable connector is slidable along a portion of the false fishing line.
1039. The method of any of Examples 1036-1038, further comprising:
providing a plurality of footrope unit bodies, each footrope unit body having a wall; and
connecting the footrope unit bodies to the main tow chain such that the footrope unit bodies are connected to one another via the main tow chain.
1040. The method of Example 1039, wherein the footrope unit bodies comprise a bent plate body where the wall is a curving and/or bending wall having opposing forward and rearward facing surfaces, the forward facing surface being mainly convex and/or convex, the rearward facing surface being mainly concave and/or concave and open to contact with water from the exterior environment, the bent plate body being configured so that in side plan view and/or cross sectional view it comprises the curving and/or bending wall.
1041. The method of Example 1040, wherein each bent plate body lacks a 180-degree arc of a circle in the cross-sectional form of the bent plate body.
1042. The method of Example 1039, wherein the wall of each of a plurality of the footrope unit bodies comprises regions of different thicknesses.
1043. The method of Example 1042, wherein the wall regions of different thicknesses further comprise a combination of metal portions and synthetic portions.
1044. The method of Example 1039, wherein a plurality of the footrope unit bodies each comprises in side plan view and/or cross sectional view at least a portion of a polygon.
1045. The method of Example 1044, wherein each footrope unit body that comprises in side plan view and/or cross sectional view at least a portion of a polygon is formed by the steps comprising bending a plate of steel multiple times and multiple different locations so as to arrive at a bent plate footrope unit body having in cross-sectional view and/or in side plan view at least a portion of a polygon.
1046. The method of Example 1045, wherein for each footrope unit body that comprises in side plan view and/or cross sectional view at least a portion of a polygon, the method further comprises:
after forming the bent plate body that has in side plan view and/or cross sectional view at least a portion of a polygon, attaching at least one spanning bridge to at least a portion of a rearward side of the bent plate body that has in side plan view and/or cross sectional view at least a portion of a polygon.
1047. The method of any of Examples 1039-1044, wherein each wall of a plurality of the footrope unit bodies includes at least one spanning bridge that is separate from and connected to the wall on a rearward side of the wall so as to span at least a portion of the rearward side of the wall.
1048. The method of any of Examples 1039-1047, wherein the wall of a plurality of the footrope unit bodies is mainly a synthetic wall to which is connected at least one portion of metal, and wherein each portion of metal protrudes from at least an associated forward facing surface of an associated wall.
1049. The method of Example 1048, wherein each portion of metal is situated on a region of an associated footrope unit body that is below a connection assembly of the associated footrope unit body, each connection assembly being configured to permit connecting an associated footrope unit body to the main tow chain.
1050. The method of any of Examples 1039-1049, wherein the wall of each of a plurality of the footrope unit bodies has a greater width (w) at its lower region proximal to and/or in contact with a lower edge of the wall compared to its width (w) at other regions of the wall.
1051. The method of any of Examples 1039-1050, wherein a plurality of the footrope unit bodies comprises at least a portion of a connection between the main tow chain and the false fishing line.
1052. The method of Example 1051, wherein at least one ear is affixed proximally to the upper edge of a plurality of footrope unit bodies, the method further comprising:
permanently connecting the false fishing line to a plurality of the ears.
1053. The method of Example 1052, wherein the false fishing line that is permanently connected to a plurality of the ears in such a manner that there is slack in the false fishing line between adjacent ears.
1054. The method of Example 1052, wherein the false fishing line that is permanently connected to a plurality of the ears in such a manner that the false fishing line is taught between adjacent ears.
1055. The method of any of Examples 1039-1040 and 1042-1054, wherein a plurality of the footrope unit bodies lack a 180-degree arc of a circle in the cross-sectional form of the footrope unit bodies.
1056. A footrope unit body for a footrope, the footrope unit body comprising a bent plate body where the bent plate body comprises a wall that is a curving and/or bending wall having opposing forward and rearward facing surfaces, the forward facing surface being mainly convex and/or convex, the rearward facing surface being mainly concave and/or concave, the bent plate body being configured so that in side plan view and/or cross sectional view it comprises the curving and/or bending wall, wherein the footrope unit body comprises at least one connection assembly comprising a solid body permanently and/or rigidly affixed to the footrope unit body and configured to permit joining at least a portion of a main tow chain of the footrope to the footrope unit body.
1057. The footrope unit body of Example 1056, wherein at least one metallic portion is situated on a region of the footrope unit body that is below a region of the footrope unit body that includes the at least one connection assembly of the footrope unit body.
1058. The footrope unit body of Example 1057, wherein at least one wear plate and/or shoe is situated on at least a region of the footrope unit body that is more proximal to a lower edge of the footrope unit body than it is to an upper edge of the footrope unit body and also is below each connection assembly of the footrope unit body.
1059. The footrope unit body of Example 1057, wherein at least one wear plate and/or shoe is situated on at least a region of the footrope unit body that includes a portion of at least one lateral edge of the footrope unit body that is more proximal to a lower edge of the footrope unit body than it is to an upper edge of the footrope unit body and also is below each connection assembly of the footrope unit body.
1060. The footrope unit body of Example 1056, wherein the footrope unit body includes at least one metallic portion.
1061. The footrope unit body of Example 1060, wherein at least a region of the footrope unit body that is proximal to a lower edge of the footrope unit body includes the at least one metallic portion.
1062. The footrope unit body of any of Examples 1060-1061, wherein at least a region of the footrope unit body that includes the lower edge of the footrope unit body includes the at least one metallic portion.
1063. The footrope unit body of any of Examples 1060-1062, wherein the at least one metallic portion comprises a metallic body that is permanently affixed to and situated on a region of the footrope unit body that includes the lower edge of the footrope unit body and is more proximal the lower edge of the footrope unit body than it is proximal the footrope unit bodies upper edge.
1064. The footrope unit body of any of Examples 1060-1063, wherein the at least one metallic portion comprises a metallic body that is permanently affixed to and situated on a region of the footrope unit body that includes the lower edge of the footrope unit body and also includes at least a portion of at least one lateral edge of the footrope unit body.
1065. The footrope unit body of any of Examples 1060-1064, wherein the at least one metallic portion comprises a plurality of metallic portions, at least one metallic portion of the plurality of metallic portions being permanently affixed to and situated on the region of the footrope unit body that includes the lower edge of the footrope unit body, at least one of metallic portion of the plurality of metallic portions being permanently affixed to and situated on a region of the footrope unit body that includes at least a portion of at least one lateral edge of the footrope unit body.
1066. The footrope unit body of Example 1065, wherein the at least one metallic portion situated on the region of the footrope unit body that includes the at least one lateral edge of the footrope unit body is distinct from the at least one metallic portion that is permanently affixed to and situated on the region of the footrope unit body that includes the lower edge of the footrope unit body.
1067. The footrope unit body of Example 1056 or 1057, wherein at least one wear plate and/or shoe is situated on at least a region of the footrope unit body that is proximal to a lower edge of the footrope unit body and below each connection assembly of the footrope unit body.
1068. The footrope unit body of Example 1056 or 1057, wherein at least one wear plate and/or shoe is situated on at least a region of the footrope unit body that is proximal to a lower edge of the footrope unit body.
1069. The footrope unit body of Example 1056 or 1057, wherein at least one wear plate and/or shoe is situated on at least a region of the footrope unit body that is more proximal to a lower edge of the footrope unit body than it is to an upper edge of the footrope unit body.
1070. The footrope unit body of Example 1056 or 1057, wherein at least one wear plate and/or shoe is situated on at least a region of the footrope unit body that includes a portion of at least one lateral edge of the footrope unit body that is more proximal to a lower edge of the footrope unit body than it is to an upper edge of the footrope unit body.
1071. The footrope unit body of any of Examples 1056-1070, wherein the footrope unit body has a greater width (w) at its lower region proximal to and/or in contact with the lower edge of the wall of the footrope unit body compared to its width (w) at other regions of the footrope unit body and/or compared to its width (w) at regions of the footrope unit body above a point where the footrope unit body is configured to be connectable to the main tow chain.
1072. The footrope unit body of any of Examples 1056-1071, wherein the footrope unit body has a greater material mass proximal its lower region proximal to and/or in contact with the lower edge of the wall of the footrope unit body compared to its material mass at other non-perforated regions of the footrope unit body and/or compared to regions of the footrope unit body above a point where the footrope unit body is configured to be connectable to the main tow chain.
1073. The footrope unit body of Examples 1071 or 1072, wherein the footrope unit body has a greater mass of metallic material proximal its lower region proximal to and/or in contact with the lower edge of the wall of the footrope unit body compared to its mass of metallic material at other regions of the footrope unit body and/or compared to regions of the footrope unit body above a point where the footrope unit body is configured to be connectable to the main tow chain.
1074. The footrope unit body of any one of Examples 1056-1073, wherein the rearward facing surface is mainly concave and/or concave and is configured to be open and capable of free contact with water when submerged in water.
1075. The footrope unit body of any of Examples 1056-1074, wherein the footrope unit bodies comprises in side plan view and/or cross sectional view at least a portion of a polygon.
1076. The footrope unit body of any of Examples 1056-1075, wherein a plurality of the footrope unit bodies lack a 180-degree arc of a circle in the cross-sectional form of the footrope unit bodies.
1077. The footrope unit body of any of Examples 1056-1076, wherein the footrope unit body is further configured to be connectable to a false fishing line, and wherein the footrope unit body serves to form at least a portion of a connection that serves to connect the false fishing line to the main tow chain.
1078. A method for forming a footrope for a bottom trawl, the method comprising forming the footrope by interconnecting a plurality of footrope unit bodies of Example 1077 to the main tow chain and interconnecting a plurality of the footrope unit bodies to the false fishing line.
1079. A method for forming a bottom trawl, the method comprising:
providing the footrope formed in accordance with the method of Example 1078; and
affixing the footrope to a fishing line of the bottom trawl.
1080. A footrope for a bottom trawl, comprising:
a main tow chain; and
a plurality of any of the footrope unit bodies of Examples 1056-1076, the footrope unit bodies being connected to at least a portion the main tow chain via the connection assemblies and connected to one another via the main tow chain.
1081. The footrope of Example 1080, further comprising a false fishing line connected to a plurality of the footrope unit bodies of the footrope.
1082. The footrope of Example 1080, further comprising a false fishing line connected to a plurality of the footrope unit bodies of the footrope, wherein the footrope is connected to a bottom trawl, the bottom trawl comprising a fishing line, and wherein the fishing line of the bottom trawl is connected to the false fishing line of the footrope.
1083. The footrope of Example 1082, further comprising connectors slidably connected to the false fishing line and joining the false fishing line to the bottom trawl's fishing line.
1084. A method for forming a footrope unit body, the footrope unit body being for a footrope, the method comprising:
bending a plate body such that the footrope unit body comprises a bent plate body, the bent plate body comprising a wall that is a curving and/or bending wall having opposing forward and rearward facing surfaces, the forward facing surface being mainly convex and/or convex, the rearward facing surface being mainly concave and/or concave, the bent plate body being configured so that in side plan view and/or cross sectional view it comprises the curving and/or bending wall; and
permanently and/or rigidly affixing at least one connection assembly to the bent plate body, the at least one connection assembly comprising a solid body and being configured to permit joining at least a portion of a main tow chain of the footrope to the footrope unit body.
1085. The method of Example 1084, further comprising:
situating at least one metallic portion on a region of the footrope unit body that is below a region of the footrope unit body that includes the at least one connection assembly of the footrope unit body.
1086. The method of Example 1085, further comprising:
situating at least one wear plate and/or shoe on at least a region of the footrope unit body that is more proximal to a lower edge of the footrope unit body than it is to an upper edge of the footrope unit body and also is below each connection assembly of the footrope unit body.
1087. The method of Example 1085, further comprising:
situating at least one wear plate and/or shoe on at least a region of the footrope unit body that includes a portion of at least one lateral edge of the footrope unit body that is more proximal to a lower edge of the footrope unit body than it is to an upper edge of the footrope unit body and also is below each connection assembly of the footrope unit body.
1088. The method of Example 1084, wherein the footrope unit body includes at least one metallic portion.
1089. The method of Example 1088, wherein at least a region of the footrope unit body that is proximal to a lower edge of the footrope unit body includes the at least one metallic portion.
1090. The method of any of Examples 1088-1089, wherein at least a region of the footrope unit body that includes the lower edge of the footrope unit body includes the at least one metallic portion.
1091. The method of any of Examples 1088-1090, wherein the at least one metallic portion comprises a metallic body that is permanently affixed to and situated on a region of the footrope unit body that includes the lower edge of the footrope unit body and is more proximal the lower edge of the footrope unit body than it is proximal the footrope unit bodies upper edge.
1092. The method of any of Examples 1088-1091, wherein the at least one metallic portion comprises a metallic body that is permanently affixed to and situated on a region of the footrope unit body that includes the lower edge of the footrope unit body and also includes at least a portion of at least one lateral edge of the footrope unit body.
1093. The method of any of Examples 1088-1090, wherein the at least one metallic portion comprises a plurality of metallic portions, at least one metallic portion of the plurality of metallic portions being permanently affixed to and situated on the region of the footrope unit body that includes the lower edge of the footrope unit body, at least one of metallic portion of the plurality of metallic portions being permanently affixed to and situated on a region of the footrope unit body that includes at least a portion of at least one lateral edge of the footrope unit body.
1094. The method of Example 1093, wherein the at least one metallic portion situated on the region of the footrope unit body that includes the at least one lateral edge of the footrope unit body is distinct from the at least one metallic portion that is permanently affixed to and situated on the region of the footrope unit body that includes the lower edge of the footrope unit body.
1095. The method of Example 1084 or 1085, further comprising:
situating at least one wear plate and/or shoe on at least a region of the footrope unit body that is proximal to a lower edge of the footrope unit body and below each connection assembly of the footrope unit body.
1096. The method of Example 1084 or 1085, further comprising:
situating at least one wear plate and/or shoe on at least a region of the footrope unit body that is proximal to a lower edge of the footrope unit body.
1097. The method of Example 1084 or 1085, further comprising:
situating at least one wear plate and/or shoe on at least a region of the footrope unit body that is more proximal to a lower edge of the footrope unit body than it is to an upper edge of the footrope unit body.
1098. The method of Example 1084 or 1085, further comprising:
situating at least one wear plate and/or shoe on at least a region of the footrope unit body that includes a portion of at least one lateral edge of the footrope unit body that is more proximal to a lower edge of the footrope unit body than it is to an upper edge of the footrope unit body.
1099. The method of any of Examples 1084-1098, wherein the footrope unit body is formed having a greater width (w) at its lower region proximal to and/or in contact with the lower edge of the wall of the footrope unit body compared to its width (w) at other regions of the footrope unit body and/or compared to its width (w) at regions of the footrope unit body above a point where the footrope unit body is configured to be connectable to the main tow chain.
1100. The method of any of Examples 1084-1099, wherein the footrope unit body is formed having a greater material mass proximal its lower region proximal to and/or in contact with the lower edge of the wall of the footrope unit body compared to its material mass at other non-perforated regions of the footrope unit body and/or compared to regions of the footrope unit body above a point where the footrope unit body is configured to be connectable to the main tow chain.
1101. The method of Examples 1099 or 1110, wherein the footrope unit body is formed a greater mass of metallic material proximal its lower region proximal to and/or in contact with the lower edge of the wall of the footrope unit body compared to its mass of metallic material at other regions of the footrope unit body and/or compared to regions of the footrope unit body above a point where the footrope unit body is configured to be connectable to the main tow chain.
1102. The method of any one of Examples 1084-1101, wherein the rearward facing surface is mainly concave and/or concave and is configured to be open and capable of free contact with water when submerged in water.
1103. The method of any of Examples 1084-1102, wherein the footrope unit bodies comprises in side plan view and/or cross sectional view at least a portion of a polygon.
1104. The method of any of Examples 1084-1103, wherein a plurality of the footrope unit bodies lack a 180-degree arc of a circle in the cross-sectional form of the footrope unit bodies.
1105. The method of any of Examples 1084-1104, wherein the footrope unit body is further configured to be connectable to a false fishing line, and wherein the footrope unit body serves to form at least a portion of a connection that serves to connect the false fishing line to the main tow chain.
1106. A method for forming a footrope for a bottom trawl, the method comprising forming the footrope by interconnecting a plurality of footrope unit bodies formed in accordance with the method of Example 1105 to the main tow chain and interconnecting a plurality of the footrope unit bodies formed in accordance with the method of Example 1055 to the false fishing line.
1107. A method for forming a bottom trawl, the method comprising:
providing the footrope formed in accordance with the method of Example 1106; and
affixing the footrope to a fishing line of the bottom trawl.
1108. A method for forming a footrope, the footrope being for a bottom trawl, the method comprising:
providing a main tow chain;
providing a plurality of footrope unit bodies formed in accordance with the method of any of Examples 1084-1104; and
connecting the footrope unit bodies to at least a portion of the main tow chain via the connection assemblies such that the footrope unit bodies are connected to one another via the main tow chain.
1109. The method of Example 1108, further comprising:
providing a false fishing line; and
connecting the false fishing line to a plurality of the footrope unit bodies of the footrope.
1110. The method of Example 1108, further comprising:
providing a false fishing line; and
connecting the false fishing line to a plurality of the footrope unit bodies of the footrope;
wherein the footrope is connected to a bottom trawl, the bottom trawl comprising a fishing line, the false fishing of the footrope line being connected to the fishing line of the bottom trawl.
1111. The method of Example 1110, further comprising:
slidably connecting a plurality of slidable connectors to the false fishing line, the slidable connectors joining the false fishing line to the bottom trawl's fishing line.
1112. A footrope for a bottom trawl, the footrope having port and starboard forward wing points and/or wing points, the footrope comprising:
a false fishing line configured to be connectable to a fishing line of a bottom trawl; and
a main tow chain configured such that a length of the main tow chain differs from a length of the false fishing line,
wherein a plurality of footrope unit bodies serve to connect the false fishing line to the main tow chain.
1113. The footrope of Example 1112, wherein at least one ear is affixed proximal the upper edge of a plurality of footrope unit bodies, the false fishing line being permanently connected to a plurality of the ears.
1114. The footrope of Example 1113, wherein the false fishing line that is permanently connected to a plurality of the ears is configured so that there is slack in the false fishing line between adjacent ears.
1115. The footrope of Example 1113, wherein the false fishing line that is permanently connected to a plurality of the ears is configured so that the false fishing line is taught between adjacent ears.
1116. The footrope of any of Examples 1112-1115, wherein the main tow chain is configured such that portions of the false fishing line are located aft of the main tow chain.
1117. The footrope of Example 1116, wherein the main tow chain is configured such that the portions of the false fishing line that are located aft of the main tow chain comprise at least the one third of the false fishing line's length situated most proximal the center of the footrope.
1118. The footrope of Example 1117, wherein the false fishing line is configured so that at least portions of the false fishing line comprising the central one third of the length of the false fishing line are located aft of the main tow chain when the footrope is towed upon at the port and starboard forward wing points of the footrope.
1119. The footrope of Example 1117, wherein the false fishing line is configured so that at least portions of the false fishing line comprising the central one third of the length of the false fishing line are located aft of the main tow chain when the footrope is towed upon during fishing operations.
1120. The footrope of Example 1117, wherein the false fishing line is configured so that portion of the false fishing line comprising the central one third of the length of the false fishing line mainly is located aft of the main tow chain when the footrope is towed upon during fishing operations.
1121. The footrope of any of Examples 1112-1120, wherein a plurality of the footrope unit bodies lack a 180-degree arc of a circle in the cross-sectional form of the footrope unit bodies.
1122. A method for forming a footrope, the footrope being for a bottom trawl, the footrope having port and starboard forward wing points and/or wing points, the method comprising:
providing a false fishing line configured to be connectable to a fishing line of a bottom trawl;
providing a main tow chain configured such that a length of the main tow chain differs from a length of the false fishing line; and
providing a plurality of footrope unit bodies that connect the false fishing line to the main tow chain.
1123. The method of Example 1122, wherein at least one ear is affixed proximal the upper edge of a plurality of footrope unit bodies, the method further comprising:
permanently connecting the false fishing line to a plurality of the ears.
1124. The method of Example 1123, wherein the false fishing line is permanently connected to a plurality of the ears in such a manner that there is slack in the false fishing line between adjacent ears.
1125. The method of Example 1123, wherein the false fishing line is permanently connected to a plurality of the ears in such a manner that the false fishing line is taught between adjacent ears.
1126. The method of any of Examples 1122-1125, wherein the main tow chain is configured such that portions of the false fishing line are located aft of the main tow chain.
1127. The method of Example 1126, wherein the main tow chain is configured such that the portions of the false fishing line that are located aft of the main tow chain comprise at least the one third of the false fishing line's length situated most proximal the center of the footrope.
1128. The method of Example 1127, wherein the false fishing line is configured so that at least portions of the false fishing line comprising the central one third of the length of the false fishing line are located aft of the main tow chain when the footrope is towed upon at the port and starboard forward wing points of the footrope.
1129. The method of Example 1127, wherein the false fishing line is configured so that at least portions of the false fishing line comprising the central one third of the length of the false fishing line are located aft of the main tow chain when the footrope is towed upon during fishing operations.
1130. The method of Example 1127, wherein the false fishing line is configured so that portion of the false fishing line comprising the central one third of the length of the false fishing line mainly is located aft of the main tow chain when the footrope is towed upon during fishing operations.
1131. The method of any of Examples 1122-1130, wherein a plurality of the footrope unit bodies lack a 180-degree arc of a circle in the cross-sectional form of the footrope unit bodies.

Although the present disclosure has been described in terms of the presently preferred embodiment, it is to be understood that such disclosure is purely illustrative and is not to be interpreted as limiting. Consequently, without departing from the spirit and scope of the disclosure, various alterations, modifications and/or alternative applications of the disclosure are, no doubt, able to be understood by those ordinarily skilled in the art upon having read the preceding disclosure. Accordingly, it is intended that the following claims be interpreted as encompassing all alterations, modifications or alternative applications as fall within the true spirit and scope of the disclosure. In an effort to maintain clarity in the Figures, certain components shown have not been specifically numbered in every Figure, but one of ordinary skill in the art will understand even the unnumbered Figures based upon the components that are/were numbered and/or described herein.

We claim:

1. A footrope for a bottom trawl, the footrope comprising:
a false fishing line configured to be connectable to a fishing line of the bottom trawl; and
a main tow chain;
wherein the footrope is configured such that portions of the false fishing line are located aft of the main tow chain when the footrope is towed upon at port and starboard forward wing points of the footrope.

2. The footrope of claim 1, wherein the main tow chain is configured such that the portions of the false fishing line that are located aft of the main tow chain comprise at least the one third of the false fishing line's length situated most proximal the center of the footrope.

3. The footrope of claim 1, further comprising a plurality of slidable connectors for connecting the false fishing line to the fishing line of the bottom trawl, each slidable connector being slidably connected to and slidable along a portion of the false fishing line.

4. The footrope of claim 1, further comprising a plurality of footrope unit bodies connected to the main tow chain and connected to one another via the main tow chain, each footrope unit body having a wall.

5. The footrope of claim 4, wherein the footrope unit bodies comprise a bent plate body where the wall is a curving and/or bending wall having opposing forward and rearward facing surfaces, the forward facing surface being mainly convex and/or convex, the rearward facing surface being mainly concave and/or concave and open to contact with water from the exterior environment, the bent plate body being configured so that in side plan view and/or cross sectional view it comprises the curving and/or bending wall.

6. The footrope of claim 5, wherein each bent plate body lacks a 180-degree arc of a circle in the cross-sectional form of the bent plate body.

7. The footrope of claim 4, wherein the wall of each of a plurality of the footrope unit bodies comprises regions of different thicknesses.

8. The footrope of claim 7, wherein the wall regions of different thicknesses further comprise a combination of metal portions and synthetic portions.

9. The footrope of claim 4, wherein a plurality of the footrope unit bodies each comprises in side plan view and/or cross sectional view at least a portion of a polygon.

10. The footrope of claim 4, wherein each wall of a plurality of the footrope unit bodies includes at least one spanning bridge that is separate from and connected to the wall on a rearward side of the wall so as to span at least a portion of the rearward side of the wall.

11. The footrope of claim 4, wherein the wall of a plurality of the footrope unit bodies is mainly a synthetic wall to which is connected at least one portion of metal, and wherein each portion of metal protrudes from at least an associated forward facing surface of an associated wall.

12. The footrope of claim 11, wherein each portion of metal is situated on a region of an associated footrope unit body that is below a connection assembly of the associated footrope unit body, each connection assembly being configured to permit connecting an associated footrope unit body to the main tow chain.

13. The footrope of claim 4, wherein the wall of each of a plurality of the footrope unit bodies has a greater width (w) at its lower region proximal to and/or in contact with a lower edge of the wall compared to its width (w) at other regions of the wall.

14. The footrope of claim 4, wherein a plurality of the footrope unit bodies comprises at least a portion of a connection between the main tow chain and the false fishing line.

15. The footrope of claim 14, wherein at least one ear is affixed proximally to the upper edge of a plurality of footrope unit bodies, and wherein the false fishing line is permanently connected to a plurality of the ears.

16. The footrope of claim 15, wherein the false fishing line that is permanently connected to a plurality of the ears is configured so that there is slack in the false fishing line between adjacent ears.

17. The footrope of claim 15, wherein the false fishing line that is permanently connected to a plurality of the ears is configured so that the false fishing line is taught between adjacent ears.

18. The footrope of claim 4, wherein a plurality of the footrope unit bodies lack a 180-degree arc of a circle in the cross-sectional form of the footrope unit bodies.

19. A method for forming a footrope, the footrope being for a bottom trawl, the method comprising:
providing a false fishing line that is configured to be connectable to a fishing line of the bottom trawl; and
providing a main tow chain that is configured such that portions of the false fishing line are located aft of the main tow chain when the footrope is towed upon at port and starboard forward wing points of the footrope.

20. The method of claim 19, wherein the portions of the false fishing line that are located aft of the main tow chain comprise at least the one third of the false fishing line's length situated most proximal the center of the footrope.

21. The method of claim 19, further comprising:
providing a plurality of slidable connectors for connecting the false fishing line to the fishing line of the bottom trawl; and
slidably connecting each slidable connector to the false fishing line such that each slidable connector is slidable along a portion of the false fishing line.

22. The method of claim 19, further comprising:
providing a plurality of footrope unit bodies, each footrope unit body having a wall; and
connecting the footrope unit bodies to the main tow chain such that the footrope unit bodies are connected to one another via the main tow chain.

23. The method of claim 22, wherein the footrope unit bodies comprise a bent plate body where the wall is a curving and/or bending wall having opposing forward and rearward facing surfaces, the forward facing surface being mainly convex and/or convex, the rearward facing surface being mainly concave and/or concave and open to contact with water from the exterior environment, the bent plate body being configured so that in side plan view and/or cross sectional view it comprises the curving and/or bending wall.

24. The method of claim 23, wherein each bent plate body lacks a 180-degree arc of a circle in the cross-sectional form of the bent plate body.

25. The method of claim 22, wherein the wall of each of a plurality of the footrope unit bodies comprises regions of different thicknesses.

26. The method of claim 25, wherein the wall regions of different thicknesses further comprise a combination of metal portions and synthetic portions.

27. The method of claim 22, wherein a plurality of the footrope unit bodies each comprises in side plan view and/or cross sectional view at least a portion of a polygon.

28. The method of claim 27, wherein each footrope unit body that comprises in side plan view and/or cross sectional view at least a portion of a polygon is formed by the steps comprising bending a plate of steel multiple times and multiple different locations so as to arrive at a bent plate footrope unit body having in cross-sectional view and/or in side plan view at least a portion of a polygon.

29. The method of claim 28, wherein for each footrope unit body that comprises in side plan view and/or cross sectional view at least a portion of a polygon, the method further comprises:
after forming the bent plate body that has in side plan view and/or cross sectional view at least a portion of a polygon, attaching at least one spanning bridge to at least a portion of a rearward side of the bent plate body that has in side plan view and/or cross sectional view at least a portion of a polygon.

30. The method of claim 22, wherein each wall of a plurality of the footrope unit bodies includes at least one spanning bridge that is separate from and connected to the wall on a rearward side of the wall so as to span at least a portion of the rearward side of the wall.

31. The method of claim 22, wherein the wall of a plurality of the footrope unit bodies is mainly a synthetic wall to which is connected at least one portion of metal, and wherein each portion of metal protrudes from at least an associated forward facing surface of an associated wall.

32. The method of claim 31, wherein each portion of metal is situated on a region of an associated footrope unit body that is below a connection assembly of the associated footrope unit body, each connection assembly being configured to permit connecting an associated footrope unit body to the main tow chain.

33. The method of claim 22, wherein the wall of each of a plurality of the footrope unit bodies has a greater width (w) at its lower region proximal to and/or in contact with a lower edge of the wall compared to its width (w) at other regions of the wall.

34. The method of claim 22, wherein a plurality of the footrope unit bodies comprises at least a portion of a connection between the main tow chain and the false fishing line.

35. The method of claim 34, wherein at least one ear is affixed proximally to the upper edge of a plurality of footrope unit bodies, the method further comprising:
permanently connecting the false fishing line to a plurality of the ears.

36. The method of claim 35, wherein the false fishing line that is permanently connected to a plurality of the ears in such a manner that there is slack in the false fishing line between adjacent ears.

37. The method of claim 35, wherein the false fishing line that is permanently connected to a plurality of the ears in such a manner that the false fishing line is taught between adjacent ears.

38. The method of claim 22, wherein a plurality of the footrope unit bodies lack a 180-degree arc of a circle in the cross-sectional form of the footrope unit bodies.
